(19) United States
(12) Patent Application Publication
(10) Pub. No.: US 2026/0222000 A1
(43) Pub. Date: Jul. 30, 2026

(54) ANTENNA SYSTEMS

(71) Applicant: Parsec Technologies, Inc., Plano, TX (US)

(72) Inventors: Michael A. Neenan, Plano, TX (US); Richard Loy Smith, JR., Grayling, MI (US); Rauhon Ahmed Shaik, Wylie, TX (US); George Alexander Bednekoff, Plano, TX (US)

(21) Appl. No.: 19/578,865

(22) Filed: Mar. 25, 2026

Related U.S. Application Data
(63) Continuation of application No. PCT/US2024/048705, filed on Sep. 26, 2024.
Application No. PCT/US2024/048705 is a continuation-in-part of application No. 18/894,607, filed on Sep. 24, 2024.
Application No. 18/894,607 is a continuation-in-part of application No. PCT/US2024/048461, filed on Sep. 25, 2024.
Application No. PCT/US2024/048461 is a continuation-in-part of application No. PCT/US2024/048229, filed on Sep. 24, 2024.
(60) Provisional application No. 63/585,186, filed on Sep. 25, 2023.
(60) Provisional application No. 63/540,335, filed on Sep. 25, 2023.
(60) Provisional application No. 63/585,502, filed on Sep. 26, 2023.
(60) Provisional application No. 63/585,541, filed on Sep. 26, 2023.
(60) Provisional application No. 63/586,356, filed on Sep. 28, 2023.
(60) Provisional application No. 63/624,693, filed on Jan. 24, 2024.
(60) Provisional application No. 63/550,834, filed on Feb. 7, 2024.
(60) Provisional application No. 63/637,247, filed on Apr. 22, 2024.
(60) Provisional application No. 63/638,330, filed on Apr. 24, 2024.
(60) Provisional application No. 63/647,436, filed on May 14, 2024.
(60) Provisional application No. 63/652,599, filed on May 28, 2024.
(60) Provisional application No. 63/653,697, filed on May 30, 2024.
(60) Provisional application No. 63/676,268, filed on Jul. 26, 2024.
(60) Provisional application No. 63/679,582, filed on Aug. 5, 2024.
(60) Provisional application No. 63/680,013, filed on Aug. 6, 2024.
(60) Provisional application No. 63/680,045, filed on Aug. 6, 2024.

(51) Int. Cl. H04B 1/3888; H01Q 1/42; H01Q 5/28; H04B 1/38

(52) U.S. Cl. CPC H04B 1/3888; H01Q 1/42; H01Q 5/28; H04B 2001/3894

(57) ABSTRACT

An antenna unit can include a case, a baseplate, and an antenna assembly. The case can include a base defining a first internal volume and a lid defining a second internal volume, the lid configured to couple to the base, the lid configured to move between a closed configuration and an open configuration to selectively permit access to an interior of the case. The baseplate can be configured to be removably coupled to the lid. The antenna assembly can include a plurality of antennas coupled to the baseplate and located within the second internal volume. The antenna unit can act as an emergency portable hot spot and serve as a complete portable network in a singular box and/or case. Additional antenna systems, including directional antenna systems, satellite terminal antenna systems and various other multi-band antennas and components are also disclosed.

### INCORPORATION BY REFERENCE TO ANY PRIORITY APPLICATIONS

The present application is a continuation of PCT Application No. PCT/US2024/048705, filed Sep. 26, 2024, entitled “ANTENNA SYSTEMS,” which claims priority benefit to U.S. Provisional Application No. 63/585,502, filed Sep. 26, 2023, entitled “ANTENNA SYSTEMS,” U.S. Provisional Application No. 63/586,356, filed Sep. 28, 2023, entitled “ANTENNA SYSTEMS,” U.S. Provisional Application No. 63/624,693, filed Jan. 24, 2024, entitled “ANTENNA SYSTEMS,” U.S. Provisional Application No. 63/550,834, filed Feb. 7, 2024, entitled “ANTENNA SYSTEMS,” U.S. Provisional Application No. 63/585,541, filed Sep. 26, 2023, entitled “ANTENNA SYSTEMS,” U.S. Provisional Application No. 63/637,247, filed Apr. 22, 2024, entitled “ANTENNA SYSTEMS,” U.S. Provisional Application No. 63/638,330, filed Apr. 24, 2024, entitled “ANTENNA SYSTEMS,” and U.S. Provisional Application No. 63/676,268, filed Jul. 26, 2024, entitled “ANTENNA SYSTEMS.” PCT Application No. PCT/US2024/048705, filed Sep. 26, 2024, entitled “ANTENNA SYSTEMS,” is a continuation-in-part of U.S. application Ser. No. 18/894,607, filed Sep. 24, 2024, entitled “ANTENNA SYSTEMS,” and is a continuation-in-part of PCT Application No. PCT/US2024/048461, filed Sep. 25, 2024, entitled “ANTENNA SYSTEMS,” which claims priority benefit to U.S. Provisional Application No. 63/585,186, filed Sep. 25, 2023, entitled “ANTENNA SYSTEMS,” U.S. Provisional Application No. 63/647,436, filed May 14, 2024, entitled “ANTENNA SYSTEMS,” U.S. Provisional Application No. 63/653,697, filed May 30, 2024, entitled “ANTENNA SYSTEMS,” U.S. Provisional Application No. 63/679,582, filed Aug. 5, 2024, entitled “ANTENNA SYSTEMS,” and U.S. Provisional Application No. 63/680,013, filed Aug. 6, 2024, entitled “ANTENNA SYSTEMS,” and is a continuation-in-part of PCT Application No. PCT/US2024/048229, filed Sep. 24, 2024, entitled “ANTENNA SYSTEMS,” which claims priority benefit to U.S. Provisional Application No. 63/540,335, filed Sep. 25, 2023, entitled “ANTENNA SYSTEMS,” U.S. Provisional Application No. 63/652,599, filed May 28, 2024, entitled “ANTENNA SYSTEMS,” and U.S. Provisional Application No. 63/680,045, filed Aug. 6, 2024, entitled “ANTENNA SYSTEMS.” All of the above-mentioned applications are hereby incorporated by reference herein in their entireties. Any and all applications for which a foreign or domestic priority claim is identified in the Application Data Sheet as filed with the present application are hereby incorporated by reference under 37 CFR 1.57 and made a part of this specification.

### BACKGROUND

### Field

The present disclosure relates to the field of wireless broadband communication, and more particularly to antenna systems and antennas that cover multiple frequency bands used in the telecommunication wireless spectrum.

### Description of the Related Art

Over the last few decades, 3GPP as a collaborative organization has developed protocols for mobile telecommunications. The latest operational standard is known as 5G. Wireless communication relies on a variety of radio components including radio antennas that are used for transmitting and receiving information via electromagnetic waves. To communicate to specific devices without interference from other devices, radio transceivers and receivers communicate within a dedicated frequency bandwidth and have associated antennas that are configured to electromagnetically resonate at frequencies within the dedicated bandwidth. As more wireless devices are used on a frequency bandwidth, a communication bottleneck occurs as wireless devices compete for frequency channels within a dedicated bandwidth. 3GPP frequency bands range from 450 MHz to 8 GHz and beyond, however, antennas configured to resonate within this spectrum only resonate below 8 GHz for mobile 3GPP telecommunication standards. To capture a greater portion of the 3GPP or other telecommunication spectrum, either an antenna array of various antenna configurations is used, or a single geometrically complex antenna can be used. An antenna array, in most instances, takes up too much space and is therefore impractical for small devices, but employing a single antenna will have a useable bandwidth that is limited by its geometrical configuration. In one example, a known antenna configuration permits a 700 MHz-2.7 GHz frequency band; however, a single antenna configuration that permits a wider frequency band is desired. Additionally, it can be difficult and expensive to manufacture, assemble, and procure materials for components of antenna array systems. This may result in a system with poor functionality and/or coverage.

### SUMMARY

This disclosure relates to antennas that cover multiple frequency bands that are prolific in today's telecommunication wireless spectrum. The advances of telecommunications wireless devices have expanded the number of frequency bands that a radio can support for prolific coverage. For example, there are over 30 5G Bands that a radio may be asked to support if the radio is to provide ubiquitous coverage for a mobile device. While some of the LTE Bands overlap one another, there are numerous gaps between the bands as well. A multi-band approach to the antenna's frequency response provides a unique and novel radiating structure to support the numerous 5G bands.

According to some advantageous implementations, an antenna unit is disclosed. The antenna unit can include: a case including: a base defining a first internal volume; and a lid defining a second internal volume, the lid coupled to the base, the lid configured to move between a closed configuration and an open configuration to selectively permit access to an interior of the case; one or more components located within the first internal volume of the base; a baseplate configured to be removably coupled to the lid; and an antenna assembly includes a plurality of antennas, the plurality of antennas coupled to the base plate and located within the second internal volume.

According to some implementations, an antenna system is disclosed. The antenna system can include a conductive sheet having a body portion with a front face, a head portion, a first left arm, and a first right arm; wherein the head portion angularly extends from the body portion; wherein the first left arm angularly extends from the body portion and the first right arm angularly extends from the body portion; wherein the front face is configured as a first resonating component, the head portion is configured as a second resonating component, the first left arm is configured as a third resonating component, and the first right arm is configured a fourth resonating component; and wherein at least one of the respective first, second, third, and fourth resonating components is configured to resonate within a low frequency band of between 600 MHz and 700 MHz during use and at least one of the respective first, second, third, and fourth resonating components is configured to resonate within a high frequency band of between 2.7 GHz and 6.0 GHz during use.

According to some implementations, an antenna system comprises: a base defining a first internal volume and a lid defining a second internal volume, wherein the lid is coupled to the base, wherein the lid is configured to move between a closed configuration and an open configuration to selectively permit access to an interior of the case. One or more components is located within the first internal volume of the base. An antenna assembly comprises a plurality of antennas coupled to a ground plane and located within the second internal volume of the lid, wherein the ground plane is configured to be removably coupled to the lid. The antenna system can further comprise a satellite terminal antenna.

According to some implementations, an antenna unit has an antenna assembly that can be configured to be supported by one or more ground planes in an arrangement with the one or more ground planes positioned below a lid, (e.g., on a horizontal surface during use). In some implementations, the ground planes and/or antenna case unit can be configured to be mounted vertically, and/or coupled to a vertical surface (e.g., a wall, a side of a compartment, a pole, etc.). Mounting the antenna assembly vertically (e.g., directly and/or by an additional component) can provide certain advantages, particularly when the antenna is configured as a directional antenna, as described herein. In some cases, the antenna assembly can be configured as a directional antenna, such as when one or more multi-band radiator portions and/or one or more stacked patch antennas are included in the antenna assembly. When the antenna assembly is configured as a directional antenna, mounting the antenna assembly on the wall can provide certain advantages. For example, a wall-mounted antenna assembly can allow for an elevated position, which can provide a clearer line of sight to the device or networks the antenna assembly is intending to communicate with (e.g., by reducing obstructions such as furniture, people, other objects) compared to if the antenna assembly was positioned on a table. The wall-mounting of the antenna assembly can also reduce potential interferences from other electronic devices positioned near the antenna assembly, which can improve signal quality and consistency in some cases. A wall-mounted antenna assembly configured as a directional antenna can be aimed in a specific direction. For example, by wall-mounting, the antenna assembly can be strategically pointed towards an area or device.

In some implementations, an antenna assembly is configured as a directional antenna (e.g., including one or more stacked patch antennas and/or multi-band radiator portions) it can be advantageous to position the base on a horizontal surface in some cases (e.g., to point vertically). For example, such an arrangement can be desirable when the antenna assembly is configured to communicate with a satellite. In this example, the vertical direction of the antenna assembly can provide improved line of sight to the satellite(s). For example, pointing the antenna assembly vertically toward the satellite ensures the strongest possible signal is directed at the target. Misalignment could result in signal loss or weak reception. In some cases, satellite communication systems often require precise alignment in both azimuth (horizontal) and elevation (vertical) to maintain an optimal connection. A vertically oriented antenna assembly configured as a directional antenna can be aimed at a specific elevation angle that matches the satellite's position relative to the ground station. An additional advantage of pointing the antenna assembly substantially vertically can include minimizing interference from terrestrial signals and reflections from the ground or nearby objects, which can be especially important when communicating with high-altitude satellites.

In some implementations, for example, the use of multiport directional antennas can provide advanced performance. A case system can utilize a multi-port directional antenna compared to the omni directional antennas installed into a case system. The directional antenna system may also utilize polarization diversity to improve data rates and signal to noise ratio. The directional antenna allows for an increased signal to noise ratio for the radio link when pointed toward to direction of the incoming signal. The higher signal to noise ratio most often allows for higher data rates and extended battery life. When used at the edges of the communication coverage area, the directional antenna most often will establish a usable radio link while the omnidirectional antennas may not be able to establish a useable radio link. The omni directional antenna most often is used with the lid closed or close to being closed for terrestrial communication while the directional antenna presented in this configuration would most likely be used with the lid open for typical terrestrial communication. The reversed configurations are true when establishing satellite telecommunication links. In other implementations, antenna PCB portion assemblies can be rotated 90 degrees so that the connectors point towards the case and not towards the neighboring PCB antenna assembly portion for advantageous benefits.

According to some implementations, in some aspects, the techniques described herein relate to a satellite terminal antenna case that can be configured to operate in the 600 MHz to 6 GHz range. In some aspects, the antenna case can be configured for cellular, 4G LTE, Gigabit LTE, CAT-18, CBRS, LAA, FirstNet, and/or the like.

According to some implementations, a multi-band antenna including a radiating element is disclosed. The radiating element includes an upright portion, a head portion, one or more first arms, and one or more second arms. The upright portion is configured for low-band radiation. The head portion extends from a top edge of the upright portion and is configured for low-band radiation. The one or more first arms extend from the upright portion and configured for mid-band radiation. The one or more second arms extend from the upright portion and are configured for C-band radiation.

According to some implementations, a multi-band antenna is disclosed. The multi-band antenna includes an upright portion, a head portion, a first left arm, a first right arm, a second left arm, and a second right arm. The upright portion is configured as a first resonating component. The head portion extends angularly from the upright portion and is configured as a second resonating component. The first left arm extends from a left edge of the upright portion and is configured as a third resonating component. The first right arm extends from a right edge of the upright portion and is configured as a fourth resonating component. The second left arm extends from the left edge of the upright portion and is configured as a fifth resonating component. The second right arm extends from the right edge of the upright portion and is configured as a sixth resonating component.

According to some implementations, an antenna assembly is disclosed. The antenna assembly includes a base, a radome, and a multi-element multi-band antenna. The base includes a conductive material and is configured as a ground reference for the antenna assembly. The radome is configured to be coupled to the base to define an internal volume. The multi-element multi-band antenna includes one or more multi-band antennas coupled to the base and one or more second radiating elements coupled to the base.

Some advantageous features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one implementation of the present disclosure in detail, it is to be understood that the implementations are not limited in its application to the details of construction and the arrangements of the components set forth in the following description or illustrated in the drawings. The implementations are capable of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. Accordingly, the claims should be regarded as including such equivalent constructions in so far as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1A illustrates a perspective view of an antenna unit, in accordance with some aspects of this disclosure.

FIGS. 1B-1F illustrate a right-side view, left-side view, front-side view, back-side view, and top-side view respectively of the antenna unit of FIG. 1A, in accordance with some aspects of this disclosure.

FIG. 1G illustrates a front section view of the antenna unit of FIG. 1A, in accordance with some aspects of this disclosure.

FIG. 1H illustrates a front perspective view of an internal volume of a base of the antenna unit of FIG. 1A, in accordance with some aspects of this disclosure.

FIG. 1J illustrates a perspective isolation view of a lid of the antenna unit of FIG. 1A, in accordance with some aspects of this disclosure.

FIGS. 2A and 2B illustrate a perspective view and a top side view respectively of an antenna assembly within the lid of the antenna unit of FIG. 1A including components of an implementation of a multi-band radiator portion that can be included in any antenna assembly described herein, in accordance with some aspects of this disclosure.

FIGS. 3A-3H illustrate various views of components of an implementation of a multi-band radiator portion that can be included in any antenna assembly described herein, in accordance with some aspects of this disclosure.

FIGS. 4A-4E illustrate various implementations of an antenna unit, in accordance with some aspects of this disclosure.

FIGS. 5A-5M are graphs of the antenna unit of FIG. 1 operating in different cellular band frequencies.

FIGS. 6A-6F are graphs of the antenna unit of FIG. 1 operating in different Wi-Fi band frequencies.

FIG. 7 illustrates a perspective view of an antenna unit, in accordance with some aspects of this disclosure.

FIG. 8A illustrates a top view of a base of the antenna unit of FIG. 7, in accordance with some aspects of this disclosure.

FIGS. 8B and 8C illustrate section views of the base of the antenna unit of FIG. 7, in accordance with some aspects of this disclosure.

FIG. 9A illustrates a perspective view of a router shell, in accordance with some aspects of this disclosure.

FIG. 9B illustrates a perspective view of a router and the router shell of FIG. 9A, in accordance with some aspects of this disclosure.

FIGS. 9C-9H illustrate a top-side view, bottom-side view, left-side view, right-side view, front-side view, back-side view respectively of the router shell, in accordance with some aspects of this disclosure.

FIGS. 10A-10J illustrate various views of components of another implementation of a multi-band radiator portion that can be included in any antenna assembly described herein, in accordance with some aspects of this disclosure.

FIGS. 11A-11C illustrate various views of an implementation of a multi-band antenna that can be included in any antenna assembly described herein, in accordance with some aspects of this disclosure.

FIGS. 12A-12B illustrate various views of another implementation of a multi-band antenna that can be included in any antenna assembly described herein, in accordance with some aspects of this disclosure.

FIGS. 13A-13C illustrate various views of another implementation of a multi-band antenna that can be included in any antenna assembly described herein, in accordance with some aspects of this disclosure.

FIGS. 14A-14D illustrate various views of another implementation of a multi-band antenna that can be included in any antenna assembly described herein, in accordance with some aspects of this disclosure.

FIGS. 15A-15B illustrate various views of another implementation of a multi-band antenna that can be included in any antenna assembly described herein, in accordance with some aspects of this disclosure.

FIG. 16 illustrates a perspective view of a stacked patch antenna on a ground plane that can be included in any antenna assembly described herein, in accordance with some aspects of this disclosure.

FIGS. 17A-17G illustrate various views of components of another implementation multi-band radiator portion that can be included in any antenna assembly described herein, in accordance with some aspects of this disclosure.

FIGS. 18A-18D illustrate various implementations of millimeter wave radios with their antennas that can be included in the any antenna assembly described herein, in accordance with some aspects of this disclosure.

FIGS. 19A-19C show various views of an implementation of an antenna case system, in accordance with some aspects of this disclosure.

FIG. 19D shows a case system, an antenna assembly, and an implementation of a multi-band antenna that can be included in any case system and/or antenna assembly described herein, in accordance with some aspects of this disclosure.

FIG. 20 shows an antenna case system, in accordance with some aspects of this disclosure.

FIG. 21 shows an antenna case system, in accordance with some aspects of this disclosure.

FIGS. 22A-22D show various views of an implementation of an antenna case system, in accordance with some aspects of this disclosure.

FIGS. 23A-23C show various views of an implementation of an antenna case system, in accordance with some aspects of this disclosure.

FIGS. 24A-24C show various views of an implementation of an antenna case system, in accordance with some aspects of this disclosure.

FIG. 25 shows a case system, an antenna assembly, and another implementation of a multi-band antenna that can be included in any case system and/or antenna assembly described herein, in accordance with some aspects of this disclosure.

FIG. 26 shows a case system, an antenna assembly, and another implementation of a multi-band antenna that can be included in any case system and/or antenna assembly described herein, in accordance with some aspects of this disclosure.

FIG. 27 shows a case system and an antenna assembly that can be included in any case system and/or antenna assembly described herein, in accordance with some aspects of this disclosure.

FIG. 28 shows a case system, an antenna assembly, and an implementation of a command center module having a multi-band antenna system, in accordance with some aspects of this disclosure.

FIG. 29 shows a case system, an antenna assembly, and an implementation of a command center module having one or more phone systems, in accordance with some aspects of this disclosure.

FIG. 30 shows a case system configured and adapted for body camera systems, including an antenna assembly, and cushioned storage features that can be included in any case system and/or antenna assembly described herein, in accordance with some aspects of this disclosure.

FIG. 31 shows a case system, an antenna assembly, and an implementation of a directional multi-band antenna that can be included in any case system and/or antenna assembly described herein, in accordance with some aspects of this disclosure.

FIG. 32 shows a case system, an antenna assembly, and an implementation of a directional multi-band antenna that can be included in any case system and/or antenna assembly described herein, in accordance with some aspects of this disclosure.

FIG. 33 shows a case system, an antenna assembly, and an implementation of a directional multi-band antenna that can be included in any case system and/or antenna assembly described herein, in accordance with some aspects of this disclosure.

FIG. 34 shows a case system, an antenna assembly, and an implementation of a directional multi-band antenna that can be included in any case system and/or antenna assembly described herein, in accordance with some aspects of this disclosure.

FIGS. 35A-35E show various views of an antenna case configured to support and connect to a satellite terminal, in accordance with some aspects of this disclosure.

FIGS. 36A-36E show various views of another implementation of an antenna case configured to support and connect to a satellite terminal, in accordance with some aspects of this disclosure.

FIG. 37 shows a perspective view of another implementation of an antenna case configured with wheels to facilitate mobility, in accordance with some aspects of this disclosure.

FIG. 38 shows a perspective view of another implementation of an antenna case configured with locking features to enhance security, in accordance with some aspects of this disclosure.

FIGS. 39A and 39B show perspective views of other implementations of antenna systems configured and adapted to operate on solar powered and/or other powered systems as well as advantageous mounting features and configurations, in accordance with some aspects of this disclosure.

FIG. 40 shows a perspective side view of other implementations of antenna case systems configured and adapted to provide a power connection and/or a power cord adapter, in accordance with some aspects of this disclosure.

FIG. 41 illustrates a perspective view of an antenna system, in accordance with some aspects of this disclosure.

FIG. 42 illustrates a side view of the antenna system of FIG. 41, in accordance with some aspects of this disclosure.

FIG. 43 illustrates a bottom view of the antenna system of FIG. 41, in accordance with some aspects of this disclosure.

FIG. 44A illustrates a perspective view the antenna system of FIG. 41 with a first mounting assembly, in accordance with some aspects of this disclosure.

FIGS. 44B and 44C illustrates side views of the antenna system of FIG. 41 with a second mounting assembly, in accordance with some aspects of this disclosure.

FIG. 45 illustrates a top isolation view of a base of the antenna system of FIG. 41, in accordance with some aspects of this disclosure.

FIGS. 46A and 46B illustrate a top view and a perspective view respectively of the antenna system of FIG. 41 with the radome removed, in accordance with some aspects of this disclosure.

FIG. 47A illustrates a side view of a first implementation of a Wi-Fi radiating element of the antenna system of FIG. 41, in accordance with some aspects of this disclosure.

FIG. 47B illustrates a side view of a second implementation of a Wi-Fi radiating element of the antenna system of FIG. 41, in accordance with some aspects of this disclosure.

FIGS. 48A-48H illustrate various views of components of a multi-band radiator portion of the antenna assembly of FIG. 41, in accordance with some aspects of this disclosure.

FIGS. 49A-49D illustrate various implementations of millimeter wave radios with their antennas that can be included in the antenna assembly of FIG. 41, in accordance with some aspects of this disclosure.

While the implementations and method of the present application is susceptible to various modifications and alternative forms, specific implementations thereof have been shown by way of example in the drawings and are herein described in detail. It should be understood, however, that the description herein of specific implementations is not intended to limit the application to the particular implementation disclosed, but on the contrary, the intention is to cover all modifications, equivalents, and alternatives falling within the spirit and scope of the process of the present application as defined by the appended claims.

### DETAILED DESCRIPTION

Illustrative implementations of the present disclosure are described below. In the interest of clarity, not all features of an actual implementation are described in this specification. It will of course be appreciated that in the development of any such actual implementation, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the implementations described herein may be oriented in any desired direction.

The system and method will be understood, both as to its structure and operation, from the accompanying drawings, taken in conjunction with the accompanying description. Several implementations of the system may be presented herein. It should be understood that various components, parts, and features of the different implementations may be combined together and/or interchanged with one another, all of which are within the scope of the present application, even though not all variations and particular implementations are shown in the drawings. It should also be understood that the mixing and matching of features, elements, and/or functions between various implementations is expressly contemplated herein so that one of ordinary skill in the art would appreciate from this disclosure that the features, elements, and/or functions of one implementation may be incorporated into another implementation as appropriate, unless otherwise described. As used herein, “system” and “assembly” are used interchangeably. It should be noted that the articles “a”, “an”, and “the”, as used in this specification, include plural referents unless the content clearly dictates otherwise. Dimensions provided herein provide for an exemplary implementation, however, alternate implementations having scaled and proportional dimensions of the presented exemplary implementation are also considered. Additional features and functions are illustrated and discussed below.

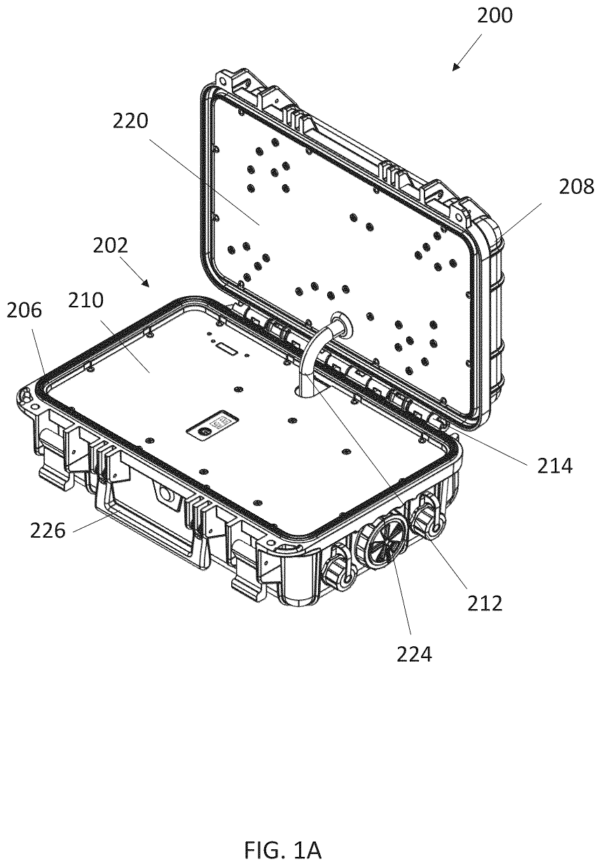

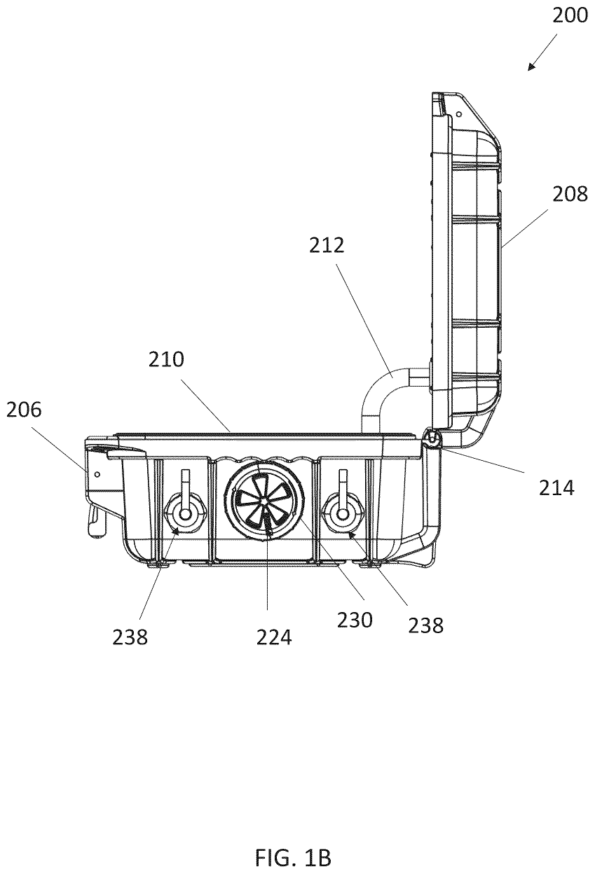

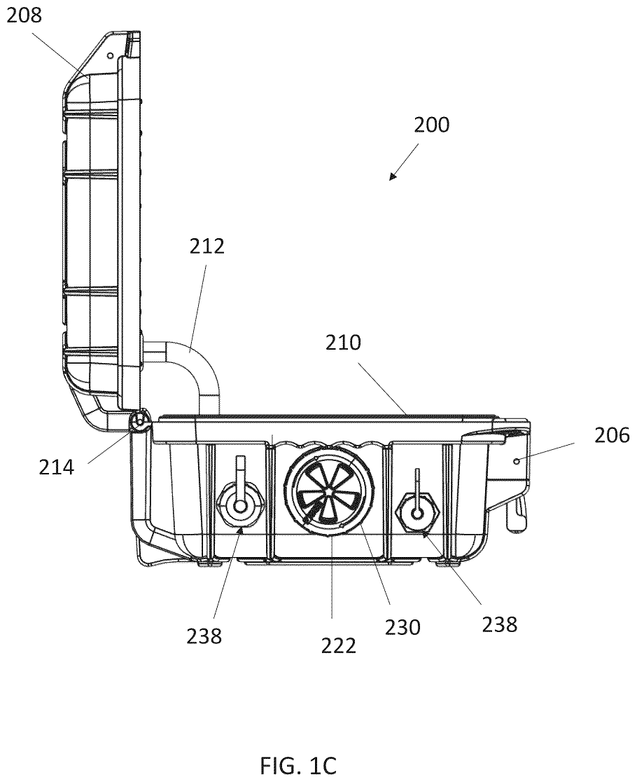

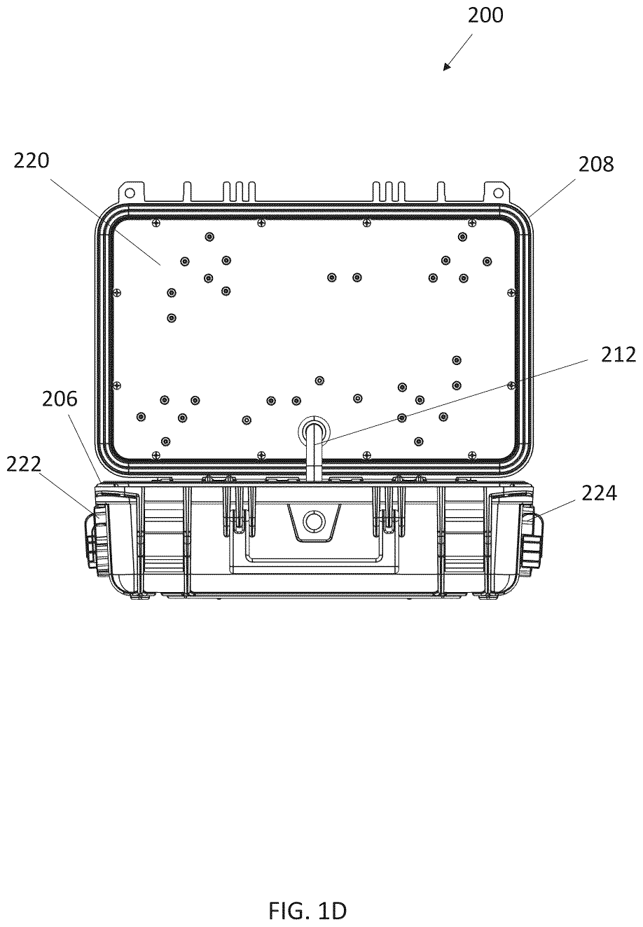

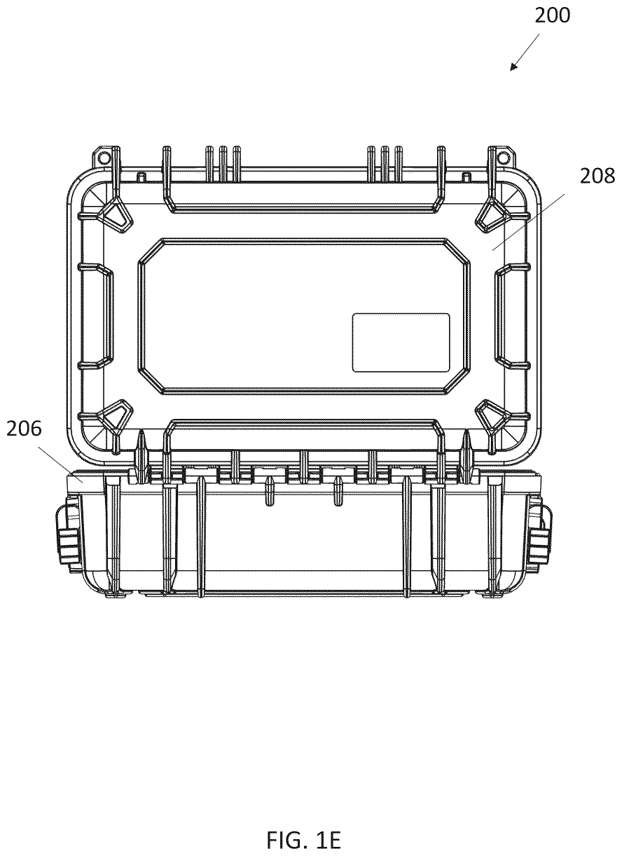

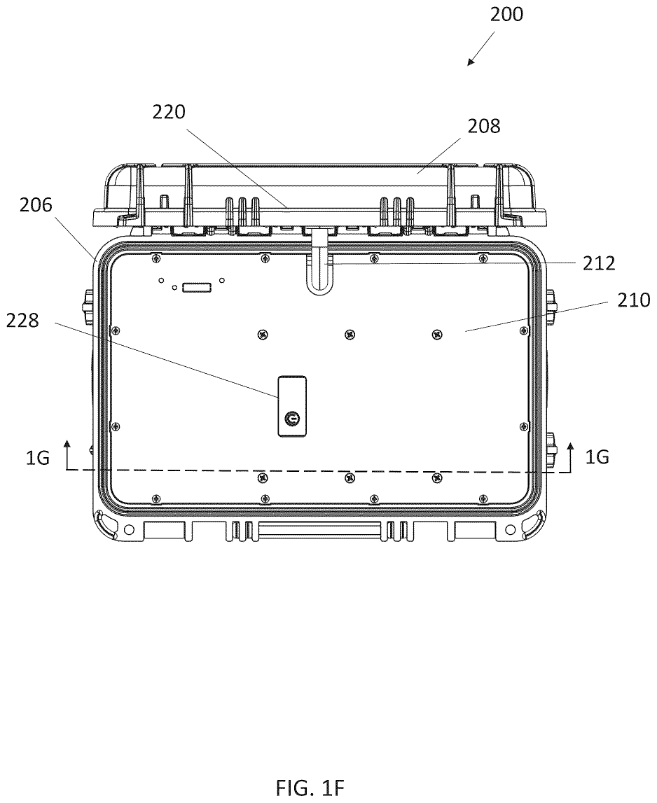

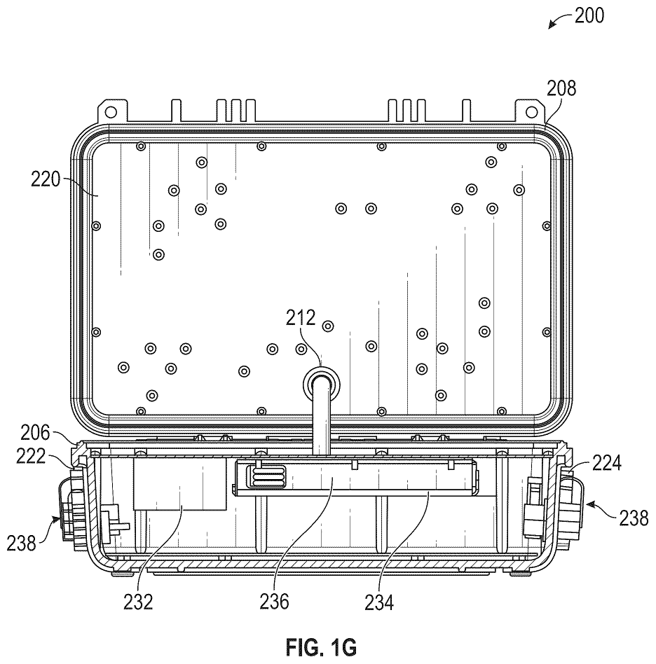

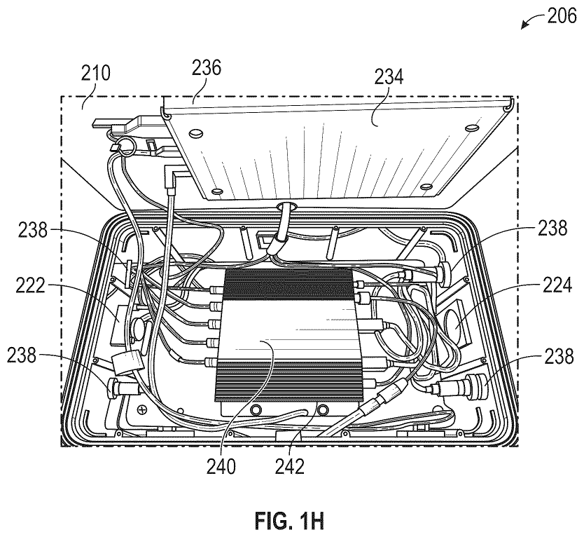

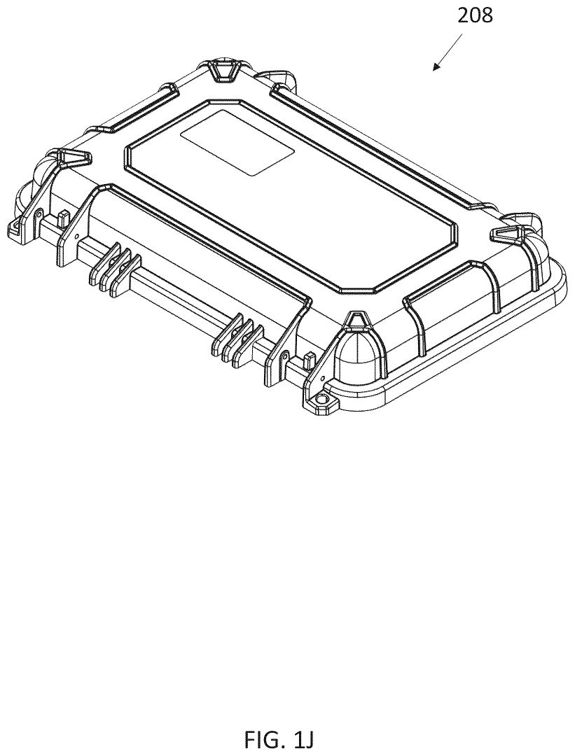

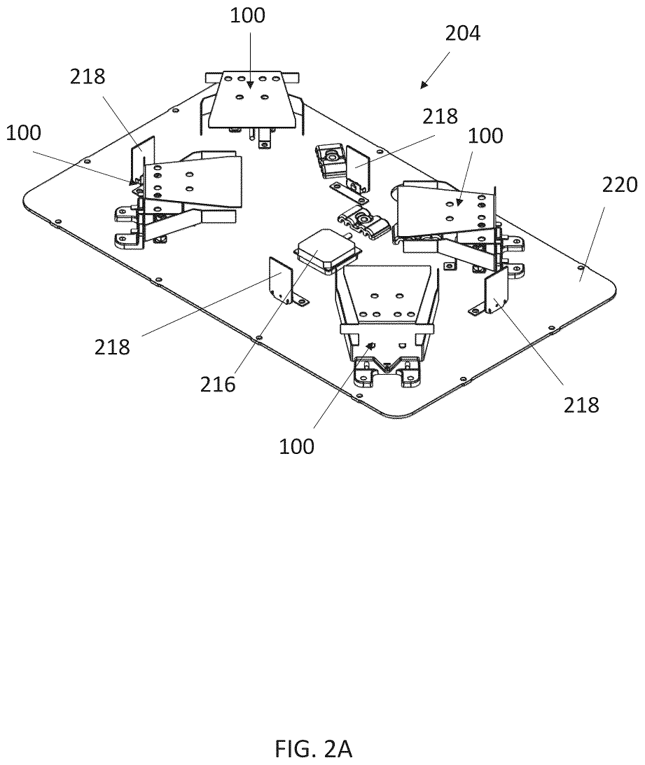

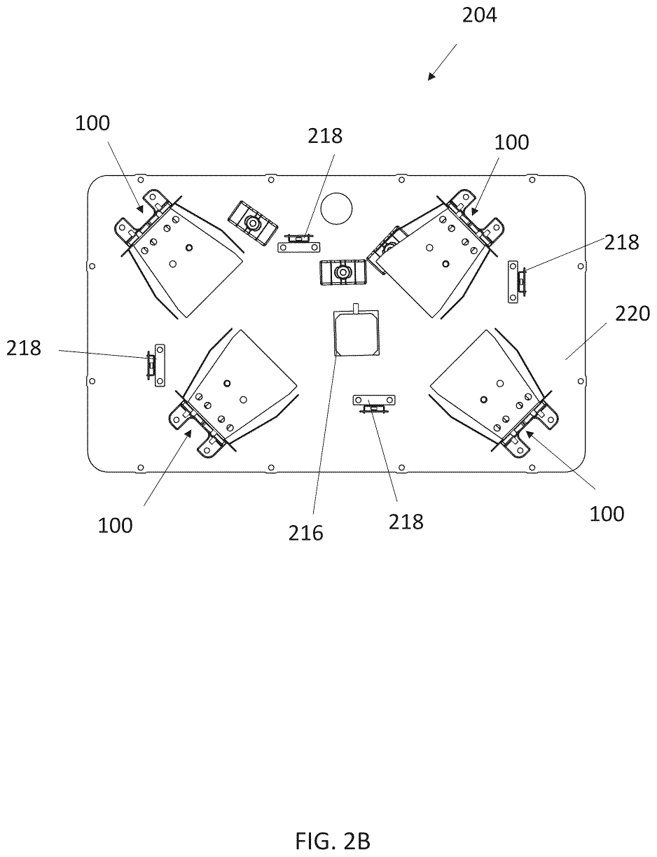

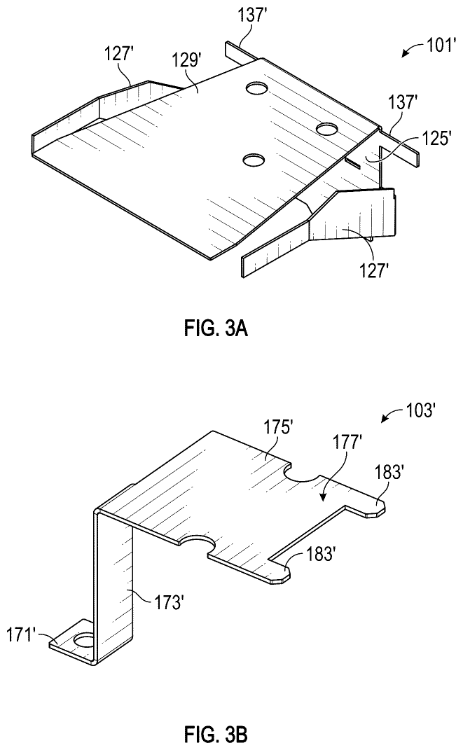

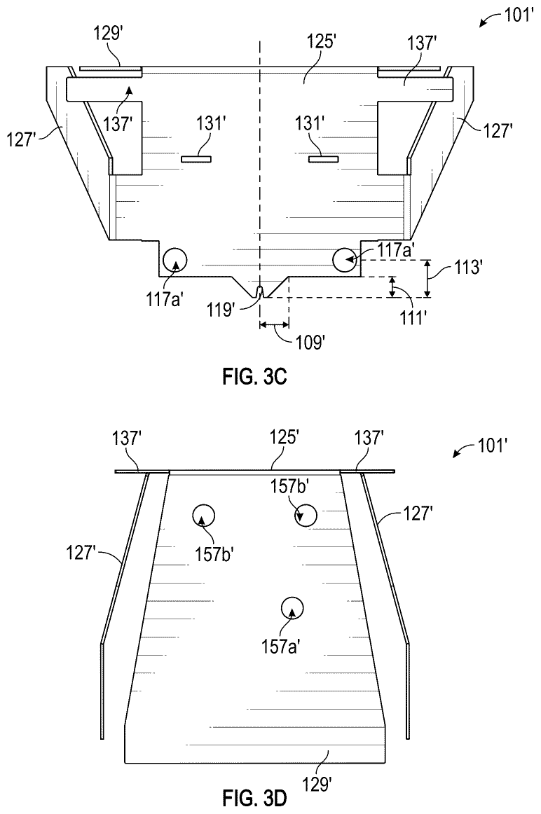

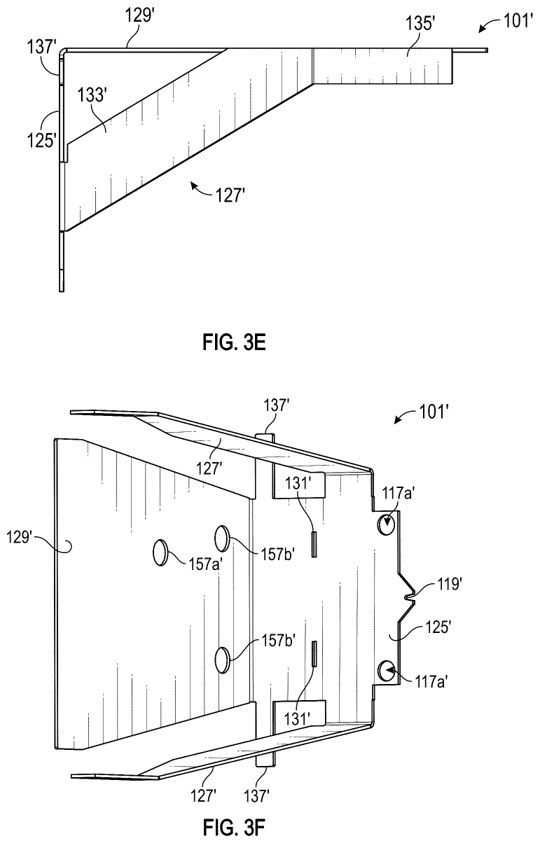

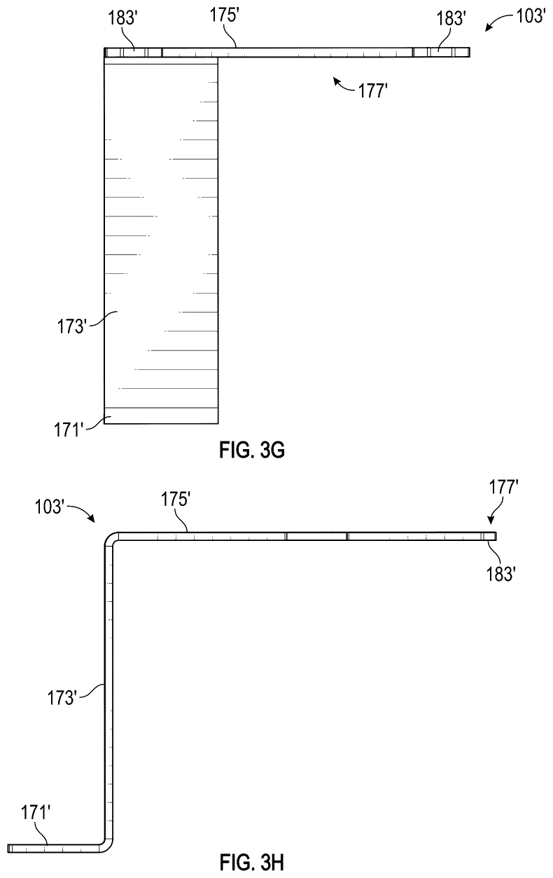

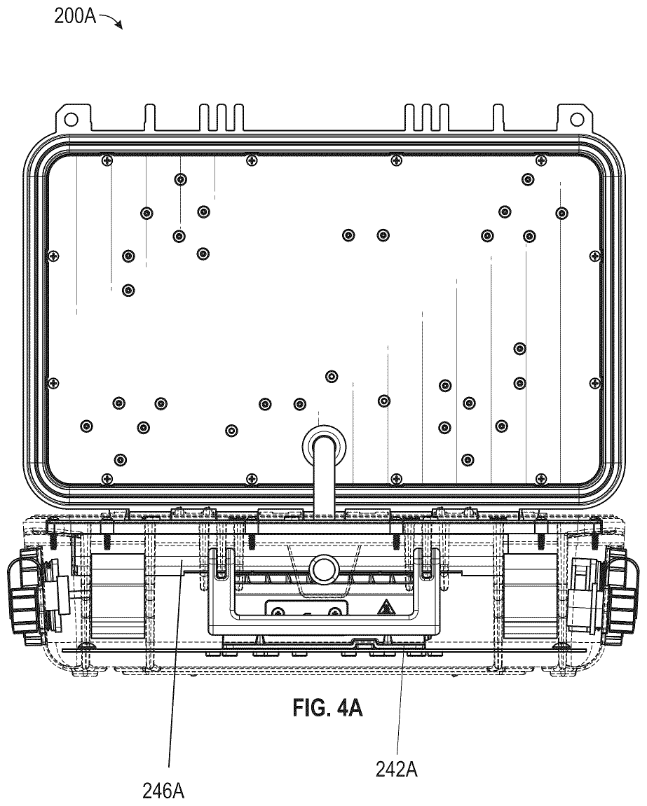

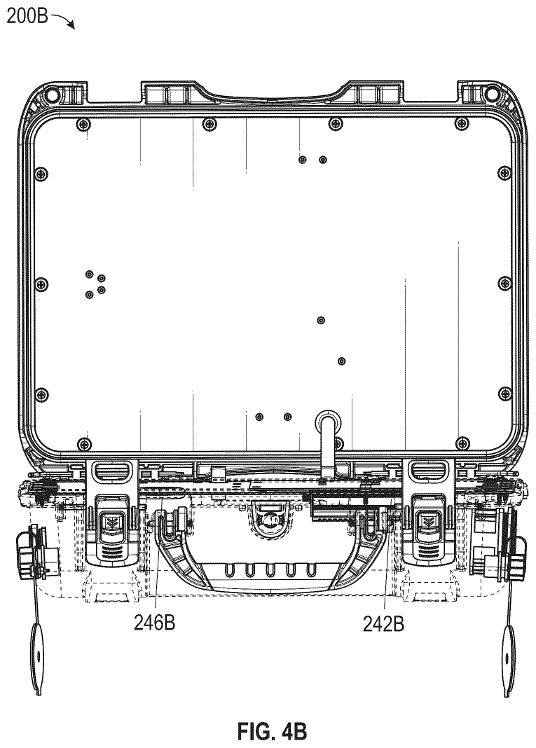

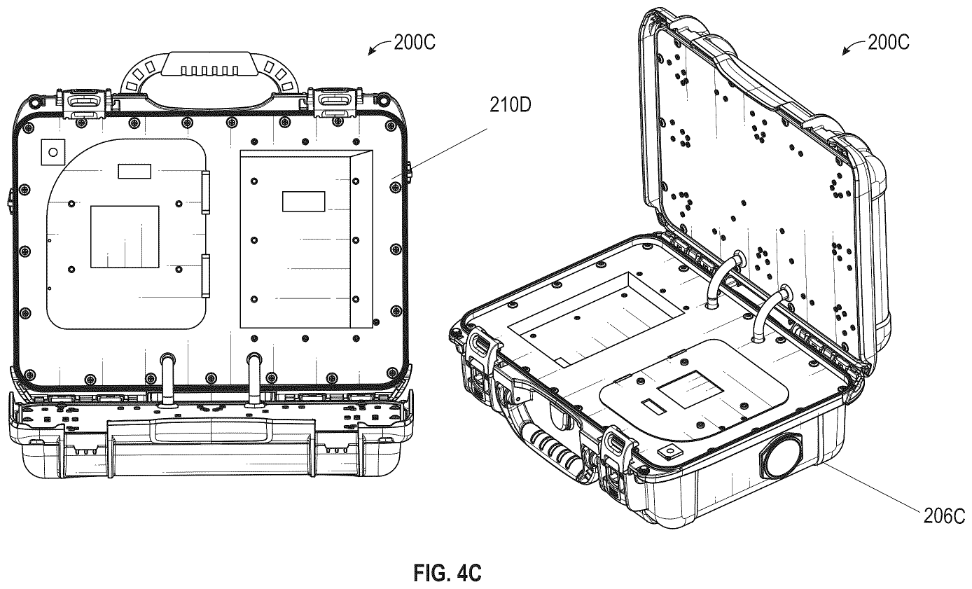

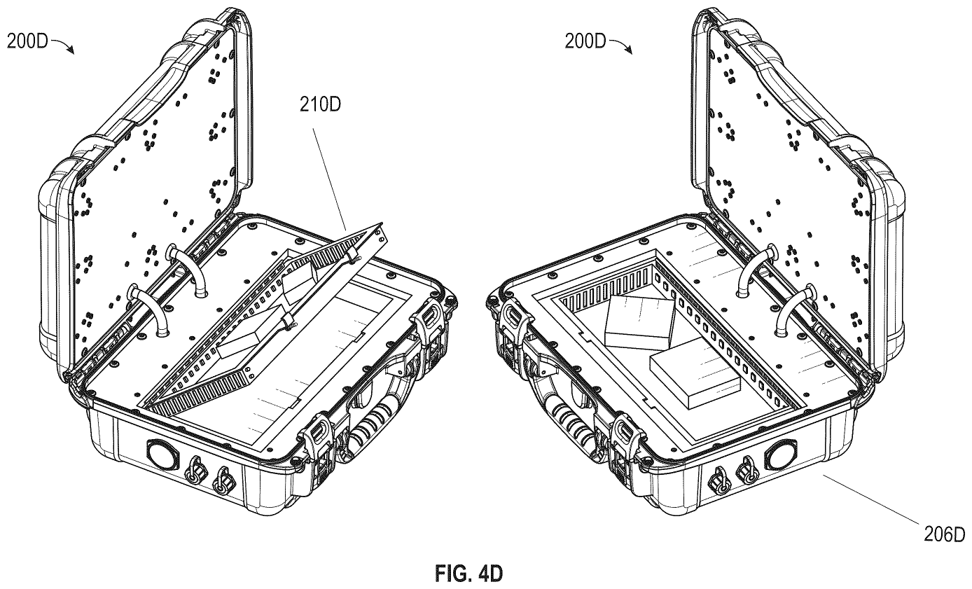

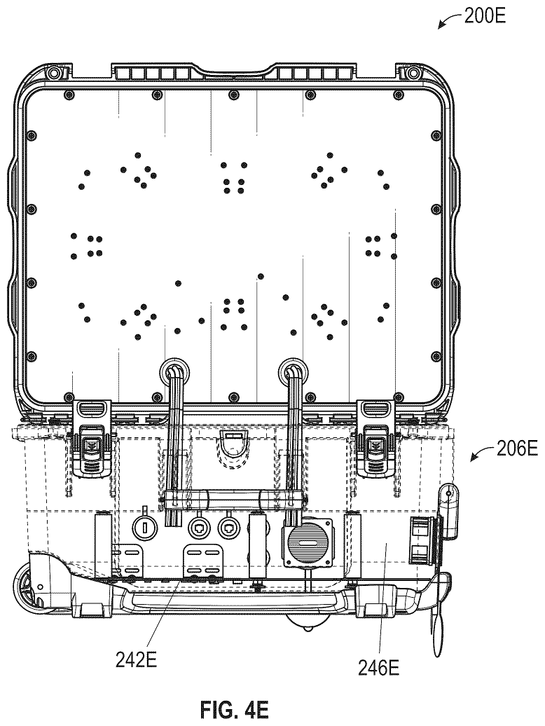

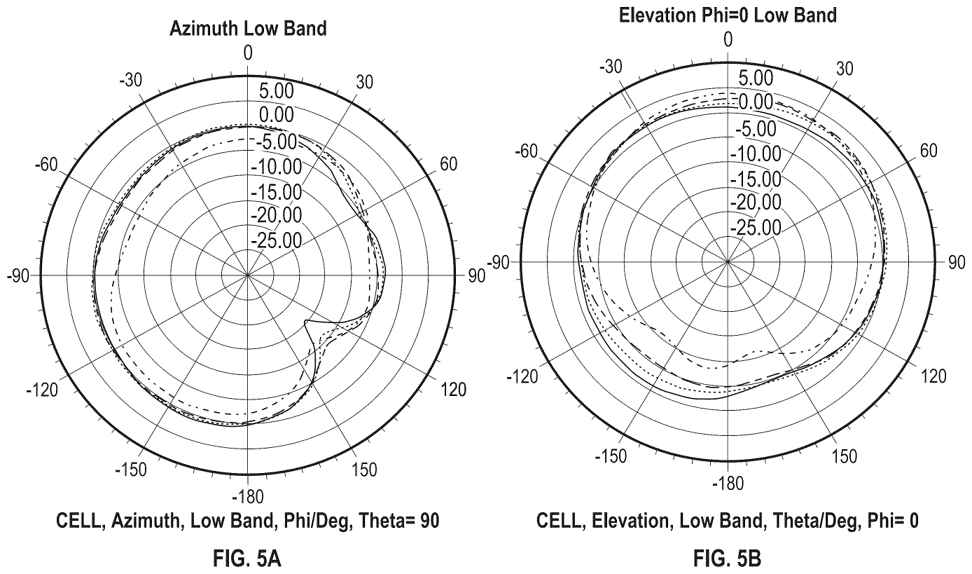

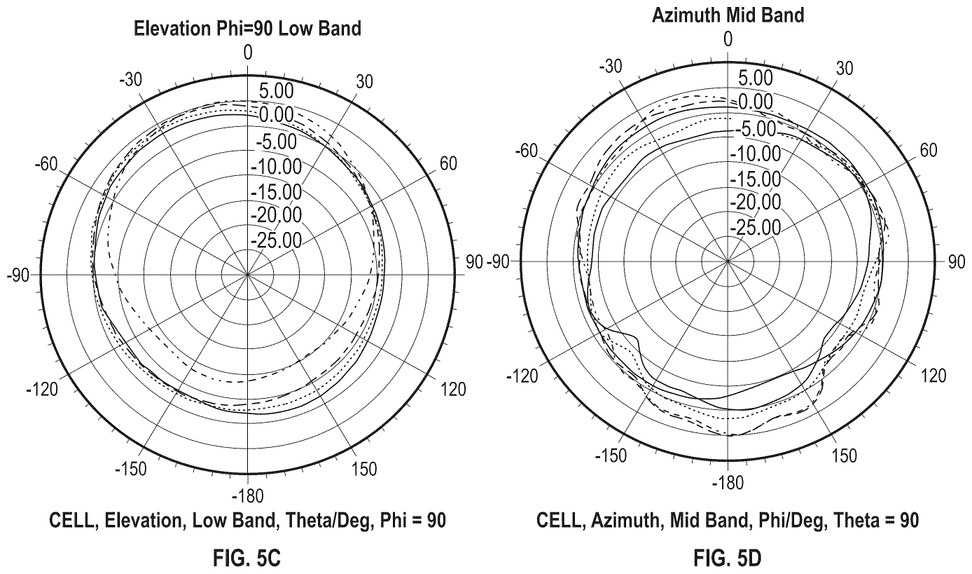

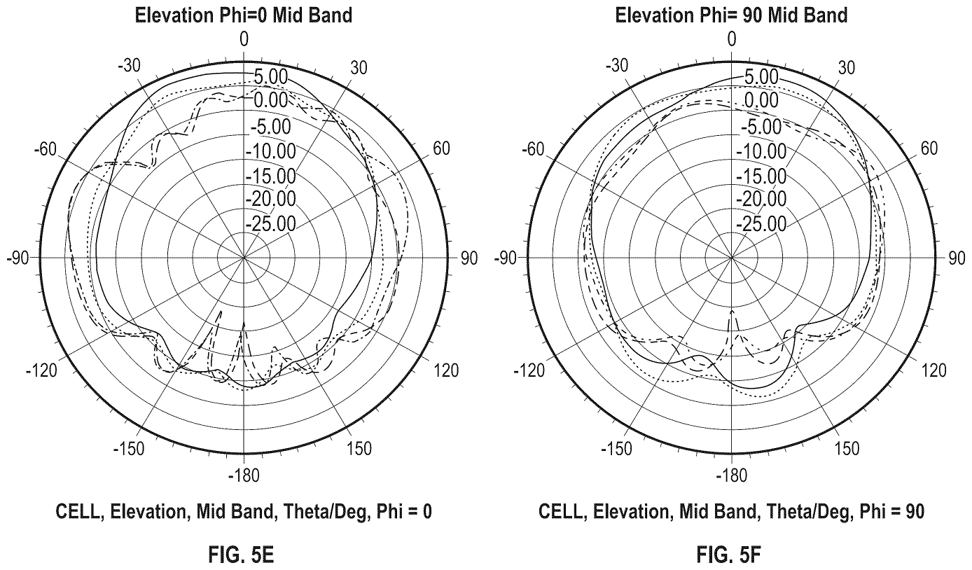

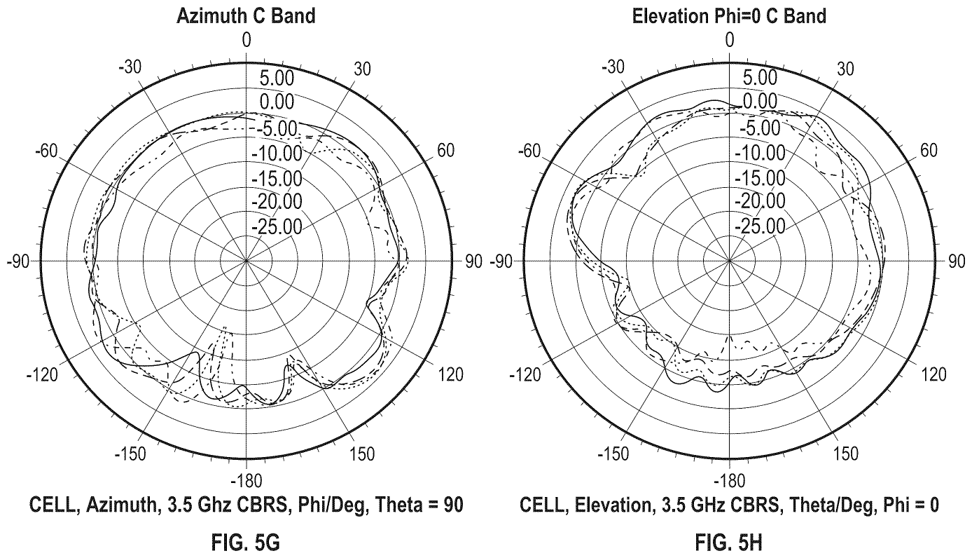

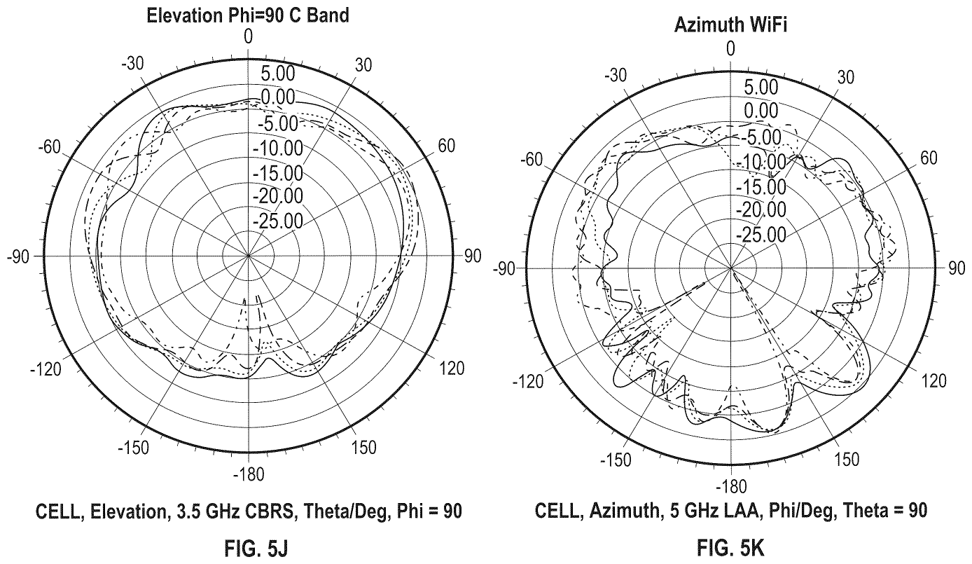

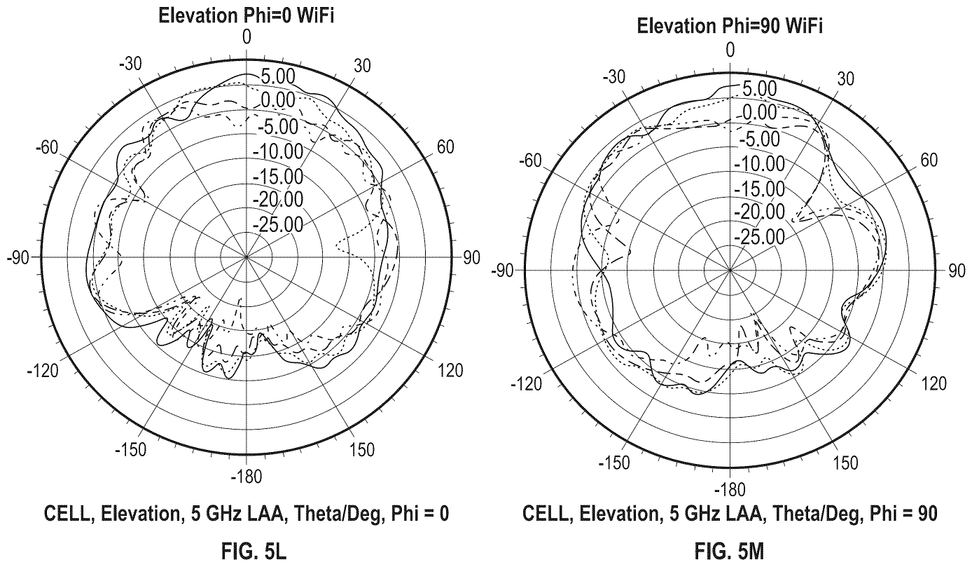

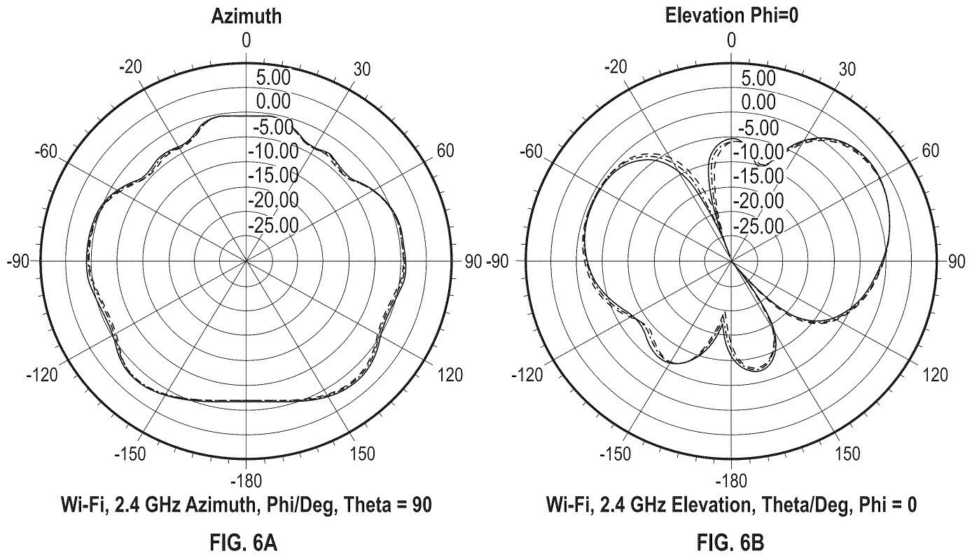

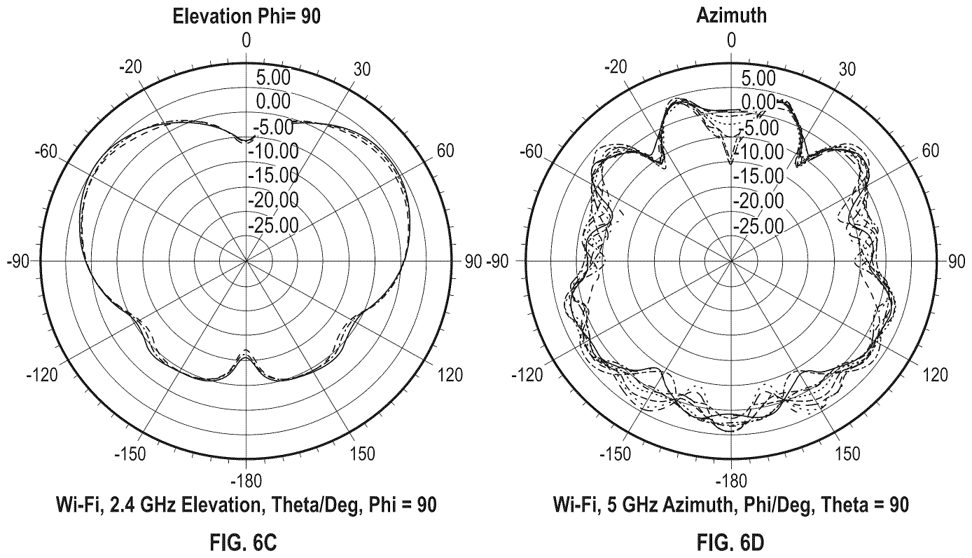

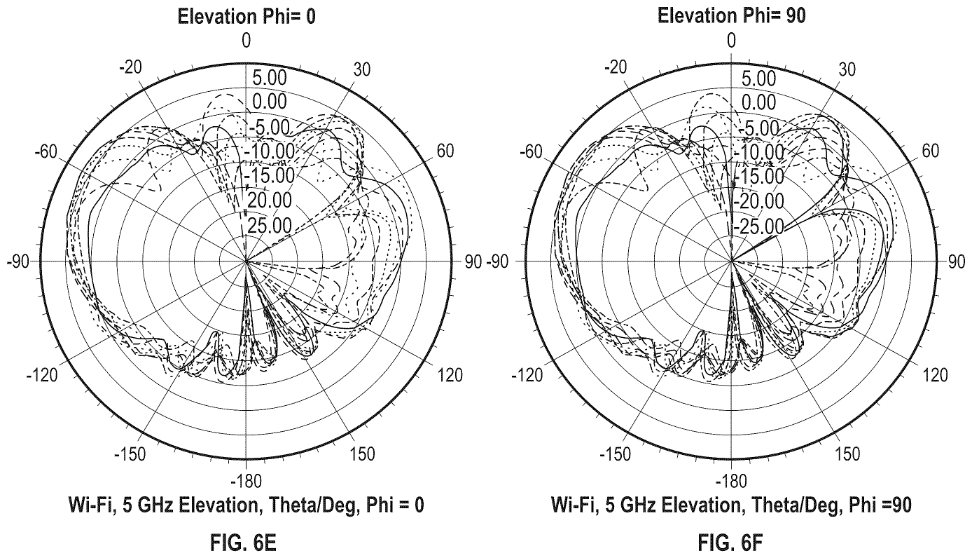

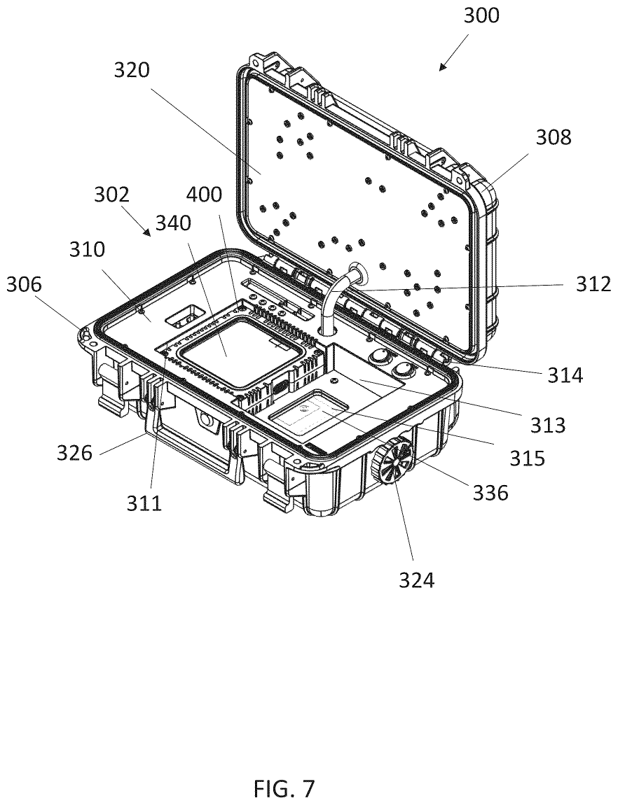

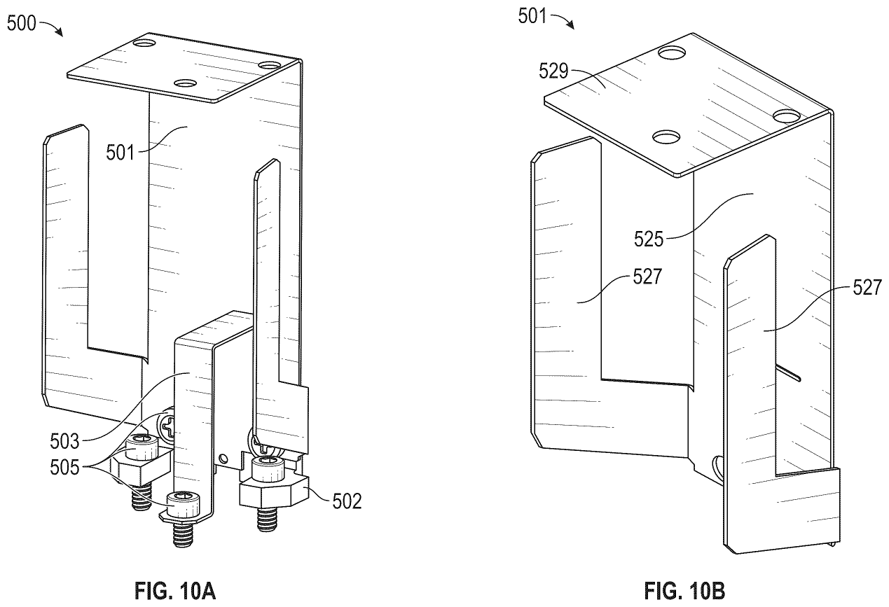

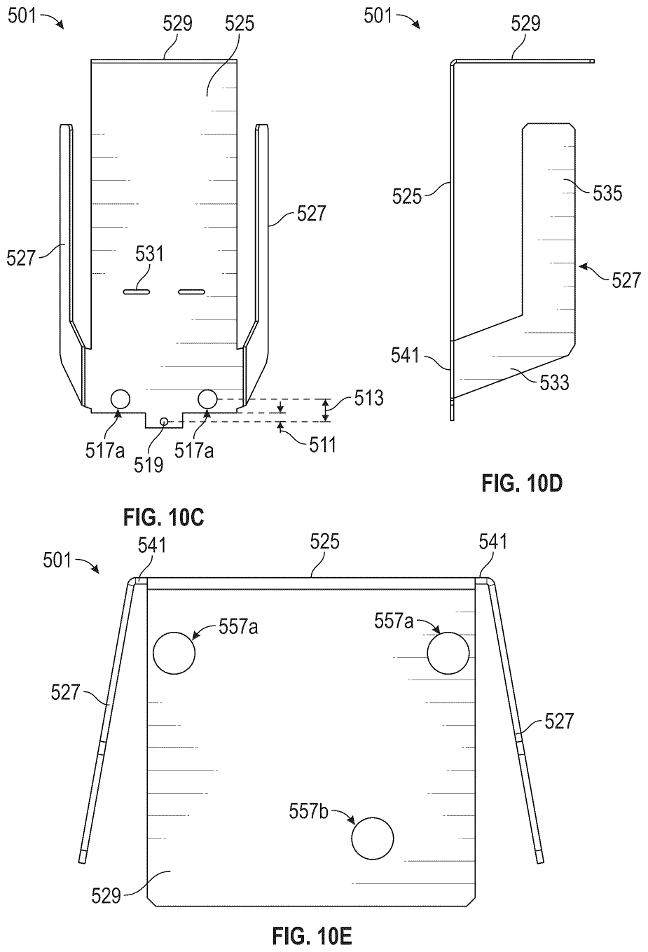

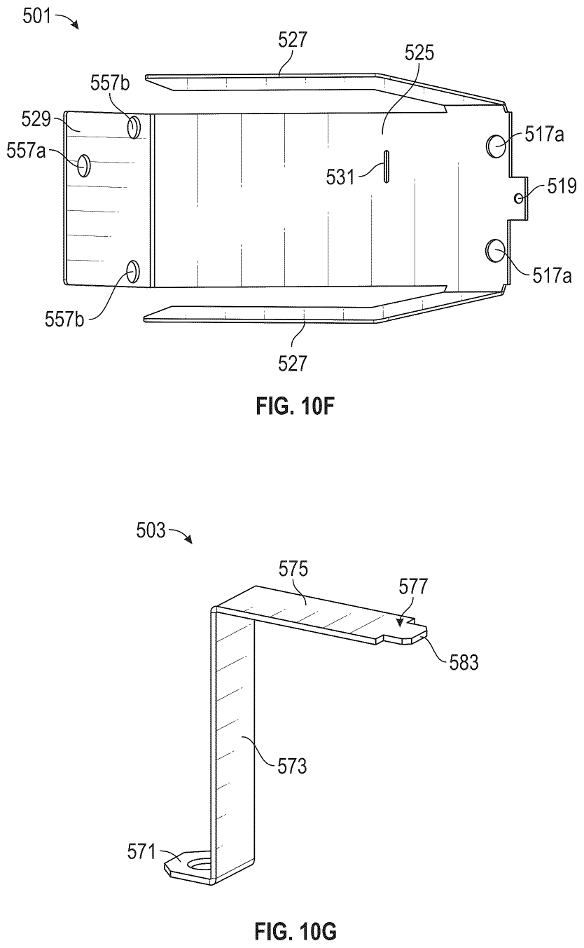

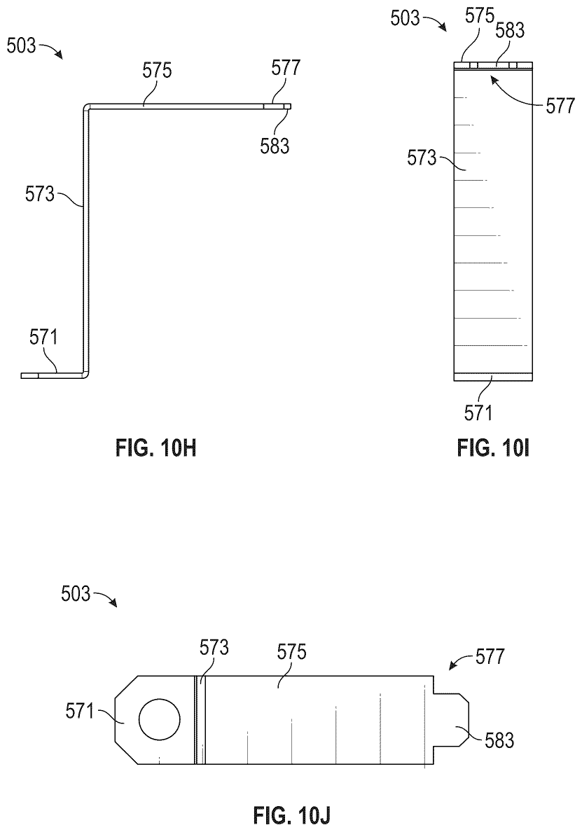

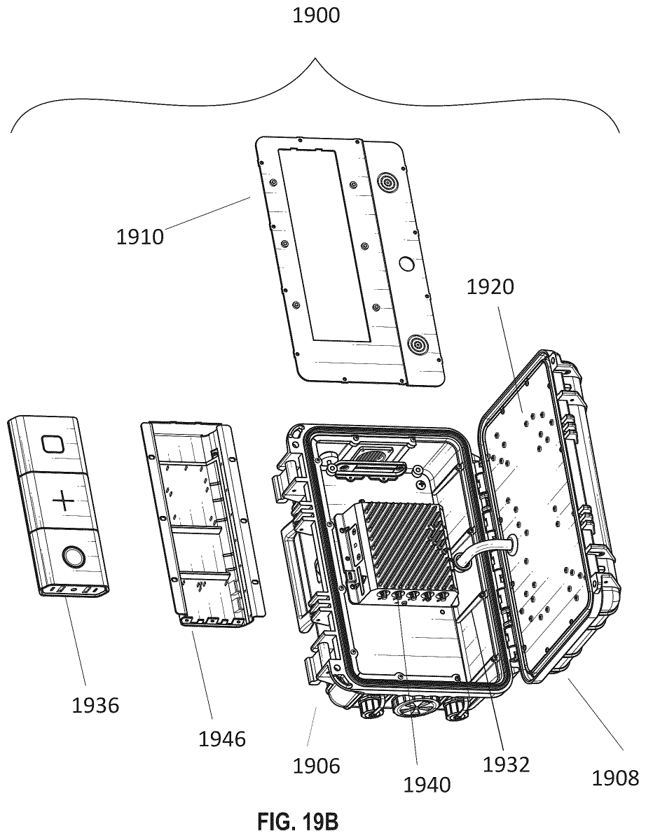

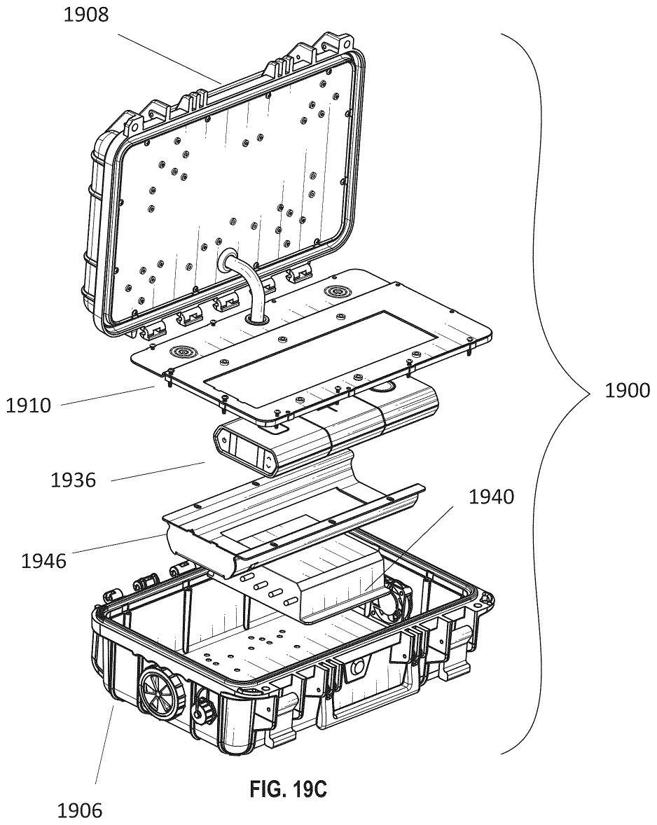

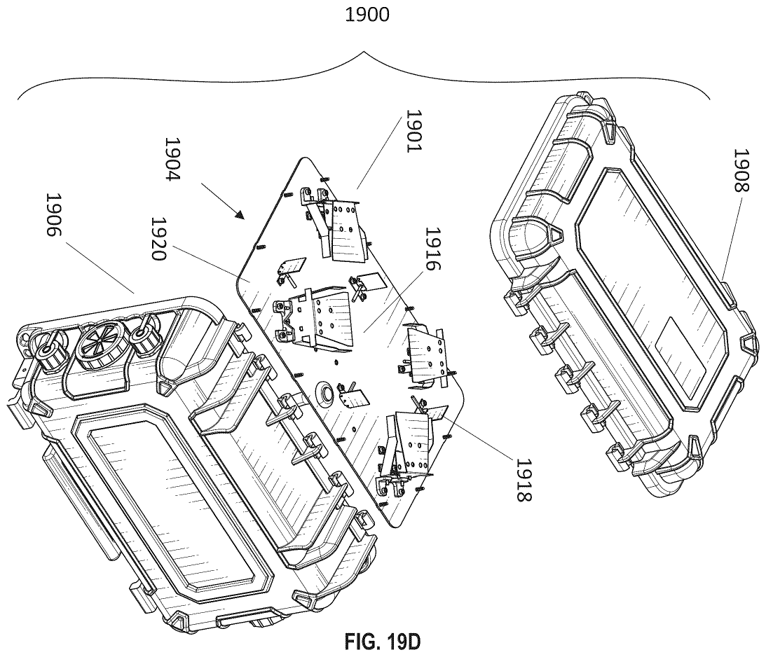

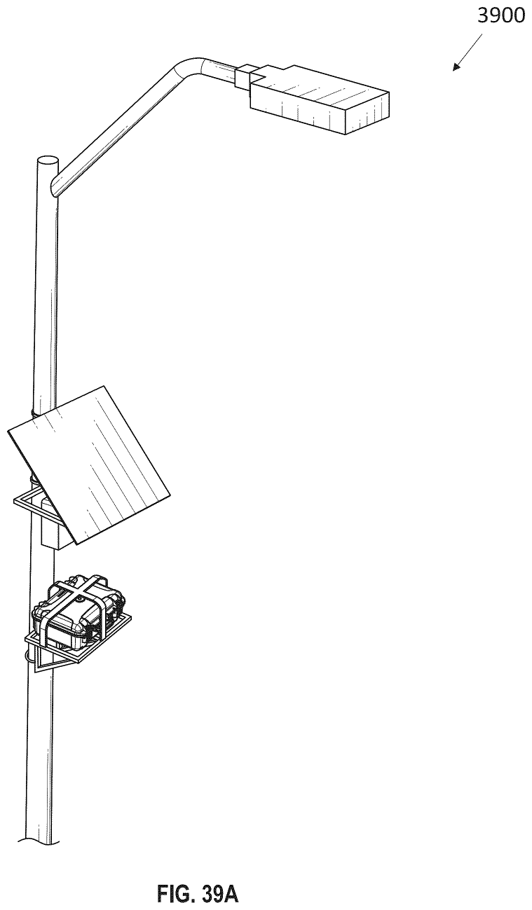

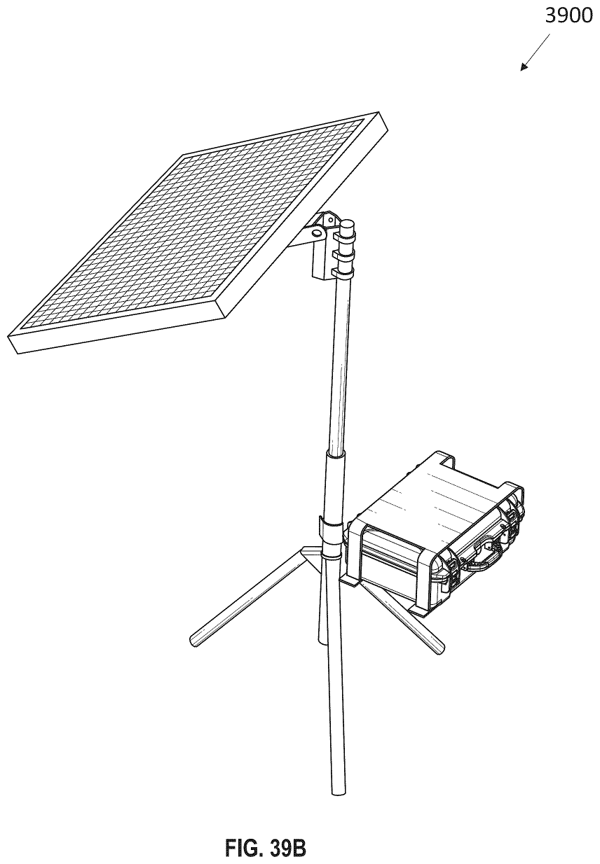

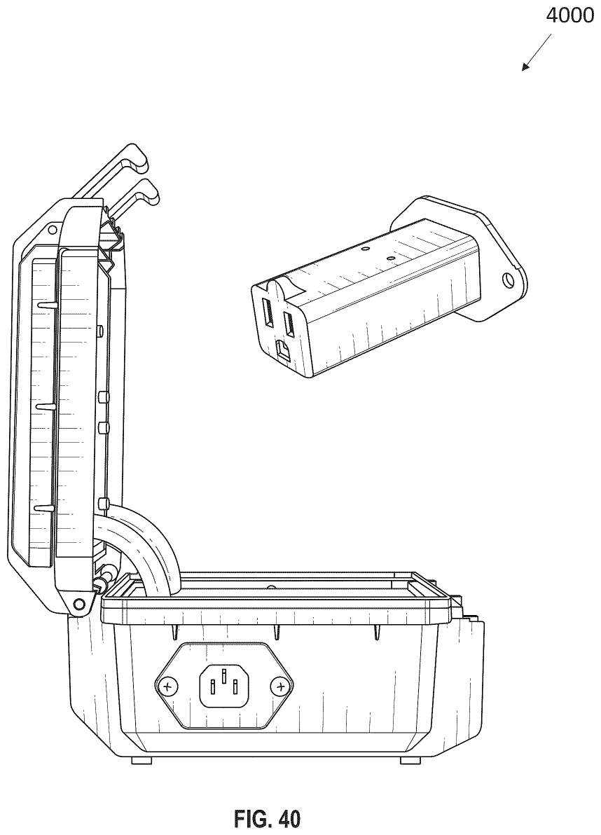

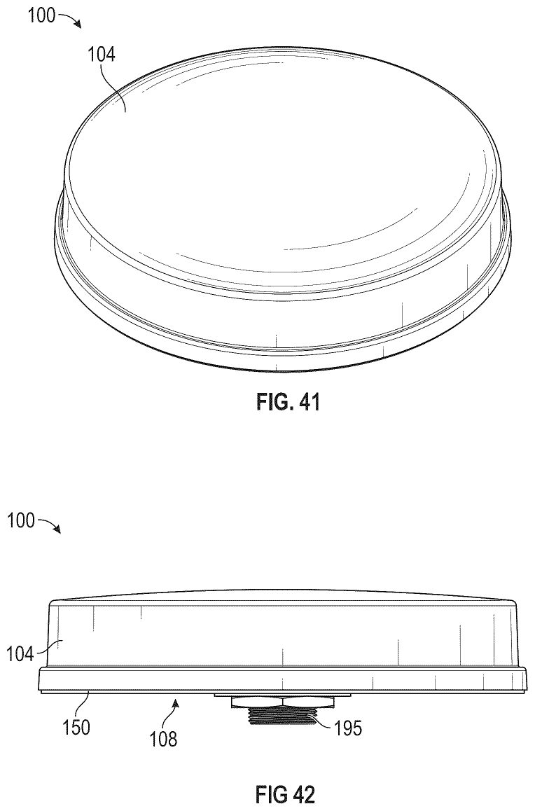

Referring now to the drawings wherein like reference characters identify corresponding or similar elements in form and function throughout the several views. FIGS. 1A to 1J illustrate various views of an antenna unit and components of the antenna unit. FIGS. 2A and 2B illustrate various views of an antenna assembly of the antenna unit of FIG. 1A. FIGS. 3A-3H illustrate various views of components of an implementation of a multi-band radiator portion that can be included in one or more of the an antenna units and/or antenna assemblies described herein, such as, for example, the antenna unit of FIG. 1A and the antenna assembly of FIGS. 2A and 2B in accordance with some aspects of this disclosure. FIGS. 4A-4E illustrate various views of additional implementations of antenna units and/or antenna assemblies in accordance with some aspects of this disclosure. FIGS. 5A-5M and 6A-6F are example graphs of the antenna unit of FIG. 1A-2B operating in different cellular and WiFi band frequencies. FIGS. 7-9H illustrate various views of additional implementations of antenna units and/or antenna assemblies in accordance with some aspects of this disclosure. FIGS. 10A-18D illustrate various views of additional components that can be included in any of the antenna assemblies described herein. FIGS. 19A to 38 show various views of additional implementations of antenna systems, antenna cases, antenna units, antenna assemblies, and components of multi-band antennas that can be included in any case system and/or antenna assembly described herein, in accordance with some aspects of this disclosure. FIGS. 39A to 40 show power management components and systems for an antenna system and/or assembly described herein, in accordance with some aspects of this disclosure. FIGS. 41 to 49D show additional antenna systems and/or antenna assemblies, in accordance with some aspects of this disclosure.

The following detailed description of certain implementations presents various descriptions of specific implementations. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain implementations can include more elements than illustrated in a drawing and/or a subset of the elements illustrated in a drawing. Further, some implementations can incorporate any suitable combination of features from two or more drawings.

Objects that are coupled together can be permanently connected together or releasably connected together. Objects that are permanently connected together can be formed out of one sheet of material or multiple sheets of material. The type of connection can provide different means for the realization of particular advantages and/or convenience consistent with the suitable function and performance of the device.

### Antenna Units

With reference to FIG. 1A, a perspective view of an antenna unit 200 is illustrated in accordance with an implementation of the present disclosure. The antenna unit 200 can also be referred to as an antenna system, an antenna case, an antenna assembly, and/or other reference to some or all of its components, etc. The antenna unit 200 is shown in an open configuration in FIG. 1A. The antenna unit 200 may include a case 202 and an antenna assembly 204, as described further herein. The antenna unit 200 be configured as a portable high performance 5G antenna. The antenna unit 200 can be used to provide an on-the-go network as a mobile hotspot (e.g., for emergency use cases). In some implementations, the antenna unit 200 can provide wireless internet connectivity for a plurality of uses (e.g., data, voice communication, video, and/or the like). The antenna unit 200 may be used in a wide range of applications. For example, the antenna unit 200 may be used by first responders, for critical communications, surveillance, covert operations, pop up medical clinics, construction sites, and/or the like. The antenna unit 200 can be a 4×4 MIMO cellular antenna. The antenna unit 200 can be a 4×4 MIMO WIFI antenna. In some implementations, the antenna unit 200 can include a GPS. In some implementations, the antenna unit 200 can include one or more router(s)/modem(s). In some implementations, the antenna unit 200 can be omni-directional. In some implementations, the antenna unit 200 can be configured to be directional as discussed further herein. In some implementations, the antenna unit 200 can have a compact volume.

The antenna unit 200 can have a smaller case 202 when compared to conventional router antenna cases. The antenna unit 200 can include the antenna assembly 204, which can have a 9:1 antenna configuration. In some implementations, the antenna assembly 204 can include an antenna configuration with high efficiency (e.g., approximately 90%). As explained herein, the antenna assembly 204 can include one or more antennas configured for cellular use, one or more antennas configured for WiFi (e.g., WiFi, Bluetooth, a combination, etc.), and/or one or more antennas configured for GPS. In some implementations, the antenna unit 200 may include two cell antennas (e.g., two multi-band radiator portions 100) and two WiFi antennas (e.g., two dual-band WiFi radiator portions 218). In some implementations, the antenna unit 200 may include four cell antennas (e.g., four multi-band radiator portions 100) and four WiFi antennas (e.g., four dual-band WiFi radiator portions 218). Other combinations are also possible.

The antenna unit 200 can be used to house one or more routers and/or modems. The antenna unit 200 can provide protection for the router and can be configured to facilitate connection between the router and the antenna assembly 204. Because routers are usually the most expensive devices when it comes to network systems (e.g., ranging in price between $250 and $15,000 or greater), it can be desirable to protect the router from regular wear and tear to increase the lifetime of the router. Additionally, routers can be ill-suited for some applications, particularly for use in the field and outside of buildings. Additionally, the antenna unit 200 can provide expanded drop protection for routers. The antenna unit 200 can be configured to provide shock isolation for the router. For example, the case 202 can be designed for ruggedness, strength, dielectric loading, and/or the like. In some implementations, the antenna unit 200 can be configured to provide cable management and/or cable protection. The antenna unit 200 can facilitate the use of the router and the antenna assembly 204 while providing an arrangement for the components of the antenna unit 200 and the cables in a compact efficient manner. In some implementations the antenna unit 200 can include adaptors located within or on the case 202 so the router ports are protected from environmental exposure and/or damage. In some implementations, the antenna unit 200 can include external ports that extend through the case 202 to improve accessibility for the user, without requiring the router to be removed from the protective case 202. In some implementations, the case 202 can be configured to house a power source (e.g., a battery). The power source can be configured to power the router. In some implementations, the power source can selectively power the router. In some implementations, the case 202 can include internal structures to separate the router from the power source to promote heat flow through the case 202. In some implementations, the case 202 can include one or more vents and/or one or more fans to facilitate fluid flow through the case 202. The fluid flow can promote heat exchange between internal volume(s) of the case 202 and the outside environment.

FIGS. 1B-1F illustrate various view of the antenna unit 200. The case 202 can include a base 206 and a cover or lid 208. The lid 208 can be coupled to the base 206. The lid 208 can be pivotably connected to the base 206. The lid 208 can move between an open configuration, as shown in FIG. 1A, and a closed configuration (not shown), where the edges of the lid 208 contact the edges of the base 206. In the closed configuration, one or more locking components of the case 202 can be used to lock the lid 208 to the base 206. FIG. 1J shows an isolation view of the lid 208.

The base 206 and the lid 208 can be used to optionally separate components of the antenna unit 200 from each other. The base 206 can have a first internal volume. The lid 208 can have a second internal volume. Components of the antenna unit 200, such as a router (not shown), power supply (not shown), cables (not shown), and/or the like can be housed within the first internal volume of the base 206. Similarly, components of the antenna unit 200, such as the antenna assembly 204 (see e.g., FIGS. 2A and 2B), can be housed within the second internal volume of the lid 208. As such, the antenna assembly 204 is separated from the modem and power supply. In some implementations, the antenna unit 200 can be configured to minimize interference to enable increased performance of one or more antennas of the antenna assembly 204 therein, all while the lid 208 is in the closed configuration. In some implementations, the antenna unit 200 can operate in both the open and closed configurations.

The lid 208 can protect and/or provide mechanical support for the internal components of the antenna unit 200 (e.g., the antenna assembly 204). For example, as discussed herein, the antennas 100 (as well as other radiator portions) can be secured within the second internal volume of the lid 208. In some implementations, the lid 208 may be transparent to radiation from the antenna portions and may serve as an environmental shield for the antenna assembly 204. One or both of the base 206 and the lid 208 can be made of non-conductive materials. For example, the base 206 and/or lid 208 may not be made of metal. In some examples, the base 206 and/or lid 208 can be made of plastic, fiberglass, carbon fiber, and/or the like materials that allow RF signals to pass through. In some implementations, second internal volume of the lid 208 can have a height of less than 2 inches (e.g., less than 1.75 inches, less than 1.5 inches, less than 1.33 inches, etc.).

In some implementations, the base 206 can have a larger internal volume than the lid 208. In some implementations, the case 202 can be designed to separate the locations of the antenna assembly 204 from the other antenna components in a manner to remove interference. In some implementations, the antenna unit 200 can include a barrier 210. The barrier 210 can be laid or located within the interior of the base 206 to act as a divider and/or separator form the lid 208. In some implementations, the antenna unit 200 can include a cable routing component 212. The cable routing component can extend from the first internal volume of the base 206 to the second internal volume of the lid 208. In some implementations, the cable routing component 212 can be waterproof. The cable routing component 212 can be used to route cables (e.g., coaxial cables) from the first internal volume of the base 206 to the second internal volume of the lid 208 (e.g., from the modem to the antenna assembly 204). In some implementations, the power source can be positioned below barrier 210 (e.g., on an internal frame positioned in or formed in the base 206. In some implementations, the barrier 210 can include a window or cutout 228. The cutout 228 can be positioned above the power source such that a charge indicator of the power source can be seen through the cutout 228.

In some implementations, the case 202 can be configured to be IP67 compliant/rated, meaning that the case 202 is waterproof. The case 202 may be made from any known materials and is typically hardened and durable to act as a protection to the antenna assembly 204 and other components therein. As noted herein, the lid 208 can be configured to pivot in an operable manner to act between an open and closed position. The antenna unit 200 can include hinges 214 or other suitable components to enable the lid 208 to pivot. It is understood that all that is necessary is that lid 208 is at least partially separable from base 206 to allow selective access internally. In some implementations, the antenna unit 200 can include a handle 226. The handle 226 can be coupled to the case 202.

In the closed configuration, the antenna unit 200 may have a smaller volume and profile when compared to other antenna units. For example, the antenna unit 200 may have a cubic volume between 400 and 800 cubic inches (e.g., between 400 and 800 cubic inches, 450 and 750 cubic inches, 500 and 700 cubic inches, 550 and 650 cubic inches, values between the foregoing, etc.). As such, in some implementations, the antenna unit 200 can be configured to fit within a backpack or carry-on luggage. In some implementations, the case 202 can be configured to be shock absorbent and/or impact resistant. For example, the case 202 may comprise shock absorption and impact resistant resin to reduce damage and loss of performance due to hard use.

With reference to FIGS. 1B and 1C, which illustrates side-views of the antenna unit 200, in some implementations, the antenna unit 200 can include one or more vents, fans, and/or the like to promote heat flow from the internal components of the antenna unit 200 to an external environment. For example, the case 202 can include one or more fans 222 and/or one or more vents 224. The fan 222 can extend though the side wall of the base 206. Similarly, the vent 224 can extend through a side wall of the base 206. In some cases, the fan 222 may be positioned in one side wall and the vent 224 may be positioned in an opposite side wall. The fan 222 can be configured to blow or drive fluid (e.g., air) from the first internal volume of the base 206 to the outside environment. The vent 224 can be configured to allow air to enter the first internal volume of the base 206 from the outside environment. In some cases, the fan 222 and/or vent 224 can include a filter configured to filter debris in the fluid entering the base 206. In some implementations, the fan 222 and/or vent 224 can be configured to move between a first/open configuration and a second/closed configuration. For example, the fan 222 and/or vent 224 can include a twist lock component 230 that can be rotated to move between the open configuration and the closed configuration. In the open configuration, air and other fluid can pass through the fan 222 and/or vent 224. In the closed configuration, the fan 222 and/or vent 224 can prevent liquid from entering the base 206. In some implementations, the vent 224 can be configured to equalize the pressure in the first internal volume of the base 206 when in the closed configuration, while still preventing liquid from entering the base 206. In some implementations, the twist lock component 230 can be configured to select the amount of airflow entering the base 206 based on the position of the twist lock component 230 between the open and closed configuration.

With continue reference to FIGS. 1B and 1C, in some implementations, the case 202 can include one or more external ports 238. For example, the external ports 238 can be formed in one or more side walls of the base 206. The external ports 238 can be configured as ethernet ports, sim ports, USB ports, USB C ports, and/or the like. The external ports 238 can provide access to cables that extend to the router and/or battery. In some implementations, the external ports 238 can be customizable or interchangeable. In some implementation, an external port 238 can be configured to receive a sim card. As such, the user can easily access the sim card via the external port 238, without opening the antenna unit 200 or removing the barrier 210. In some implementations, the external ports 238 can include covers to prevent damage to the external ports 238 when not in use.

FIG. 1G illustrates a section view of the antenna unit 200 along the line 1G-1G shown in FIG. 1F. FIG. 1G shows the first internal volume of the base 206. As shown, the antenna unit base 206 can include an internal frame 232. The internal frame 232 can be coupled to/formed in the base 206. The internal frame 232 can include a shelf 234. The shelf 234 can be configured to support the power source (e.g., a battery 236 is schematically illustrated in FIG. 1G) of the antenna unit 200. The shelf 234 can be configured to secure the battery 236 to the internal frame 232, to prevent motion of the power source. The shelf 234 can promote separation between the battery 236 and the router. In the illustrated example, the router is secured to the bottom of the base 206, as explained further with reference to FIG. 1H. As such, there is a gap between the router and the battery 236. The gap can allow fluid flow (e.g., from the vent 224 to the fan 222) to pass between the battery and the router, for improved heat flow. In some implementations, the internal frame 232 can be made of a conductive material (e.g., aluminum). As such, the internal frame 232 can promote heat transfer from the battery 236 and/or router to the internal frame 232 for improve heat dissipation.

FIG. 1H illustrates an example internal view of the first internal volume of the base 206. In FIG. 1H, an example router 240 is shown, with cables extending between the router 240, battery 236, case 202, and external ports 238. In some implementations, the antenna unit 200 may include a router plate 242. The router plate 242 can be configured to secure the router to the base 206. The router plate 242 can be configured to prevent the router 240 from moving when the case 202 is moved or dropped. Preventing relative motion of the router 240 can provide a benefit of protecting the router 240 from damage and preventing movement or damage to the cables connected to the router 240. The router plate 242 can provide shock isolation for the router 240. In some implementations, the router plate 242 can be made of a conductive material (e.g., aluminum). As such, the router plate 242 can promote heat transfer from the router 240 to the router plate 242 for improve heat dissipation.

### Antenna Assemblies

FIGS. 2A and 2B illustrate various views of the antenna assembly 204 that is housed in the lid 208. The antenna assembly 204 can also be referred to as an antenna system, antenna components, antenna module, radiating systems, radiating elements, and/or other reference to some or all of its components, etc. The antenna assembly 204 can include one or more antennas and/or antenna systems. The antennas may be of different shapes, operational ranges or frequencies, and sizes. As shown in FIGS. 2A and 2B, the antenna assembly 204 can include one or more GPS antenna elements 216, one or more dual-band WiFi radiator antennas 218, and/or one or more multi-band radiator portions/antennas 100. The antenna assembly 204 can be secured to a baseplate 220. The baseplate 220 can be coupled to the lid 208 (e.g., with fasteners). When the baseplate 220 is coupled to the lid 208, the second internal volume housing the antenna assembly 204 is enclosed. The baseplate 220 can be a ground plane 220. The baseplate 220 can be configured as a heatsink and/or reflector for the antenna assembly 204. The antenna assembly 204 can be designed and optimized to work on the baseplate 220 and can be designed to operate within lid 208 so as to transmit and receive data. An added benefit is that the antenna assembly 204 is out of harm's way and can operate without any other objects in the RF path. All other accessories, routers and batteries can be stored below, under barrier 210, out of the RF path of the antenna assembly 204. In some implementations, the baseplate 220 can have a smaller size compared to conventional ground planes used with router antennas. A ground plane 220 for example as in as in an antenna assembly 204 can also serve as a ground plane and/or ground reference for any additional antennas or antenna components included in any of the antenna assemblies and/or antenna units or systems disclosed herein that can be used in additional and/or alternative configurations for antenna systems.

The GPS antenna element(s) 216 can be used to collect one or more signal(s) from geosynchronous satellites so that the GPS function of a radio including the antenna assembly 204 can determine where the antenna unit 200 is positioned relative to a global coordinate system. Depending on the particular use, the number of GPS antenna element(s) 216 can vary. In the illustrated example the antenna unit 200 includes one GPS antenna element 216; however, more or fewer GPS antenna element(s) 216 are possible. The GPS antenna element 216 may be positioned on the baseplate 220 and within the lid 208. In this arrangement, the GPS antenna element 216 is supported by the baseplate 220 in the assembled antenna unit 200.

The dual-band WiFi radiator antennas 218 can be used for un-licensed band wireless telecommunication purposes. In some implementations, the antennas 218 can be configured operation at frequencies above approximately 1 GHz. For example, the antennas 218 can be configured as multi-band Wi-Fi radios, 3GPP radios, cellular radios, and/or the like. In some advantageous implementations, the antennas 218 can be multi-band WiFi antenna devices. As such, the antennas 218 can be configured for mid-band operation, CBRS-band operation, and Wi-Fi-band operation, depending on the specific radio or transceiver attached. In some cases, the antennas 218 can have an operating range of approximately 1.6 GHz to 8 GHz or higher. In some implementations, the antennas 218 can include one or more PCB portions. The PCB portions may be made of flexible substrate materials (e.g., polyimide). As such, the PCB portions may be a flex circuit. In some cases, the PCB portions may be fiberglass reinforced with epoxy (e.g., FR4). The PCB portions may provide structure for the radiating portions of the antennas 218. The various conductive portions of the antennas 218 may be etched into the structure of the PCB portions. While the antennas 218 are referred to herein as “dual-band WiFi radiator antennas,” the antennas 218 may be configured for operation on less than two or more than two bands, in some implementations.

Depending on the particular use, the number of dual-band WiFi radiator portions 218 can vary. In the illustrated example, the antenna unit 200 includes four dual-band WiFi radiator portions 218. However, more or fewer dual-band WiFi radiator portions 218 are possible. In some cases, one or more of the dual-band WiFi radiator portions 218 can be configured for Bluetooth communication. For example, one or more of the dual-band WiFi radiator portions 218 can be a Bluetooth radiator portion 218. In some implementations, each dual-band WiFi radiator portions 218 can be coupled to an individual RF cable (not shown), for example, coaxial cables. The one or more dual-band WiFi radiator antennas 218 may be positioned on the baseplate 220 and within the lid 208. In this arrangement, the one or more dual-band WiFi radiator antennas 218 are supported by the baseplate 220 in the assembled antenna unit 200.

The multi-band radiator portions 100 and/or multi-band antennas 100 can be used for wireless telecommunication purposes (e.g., cellular telecommunication). The multi-band antennas 100 can also be referred to as an antenna system, antenna components, antenna module, radiating systems, radiating elements, and/or other reference to some or all of its components, etc. The multi-band antennas 100 can include one or more radiator portions, antennas, and/or antenna systems that may be of different shapes, operational ranges or frequencies, and sizes. The multi-band radiator portions 100 may be a dual band monopole antenna that has a configuration that, when used in conjunction with high order electromagnetic modes generated or received by a transceiver and/or receiver (as is typically performed for PIFA antennae), permit the antenna to have an operating frequency range of 600 MHz to 6.0 GHz. Depending on the particular use, the number of multi-band radiator portions 100 can vary. In the illustrated example, the antenna assembly 204 includes four multi-band radiator portions 100; however, more or fewer multi-band radiator portions 100 are possible. The multi-band radiator portions 100 and/or 101′ are described further herein with reference to FIGS. 3A-3H. In some implementations, the multi-band radiator portions 100 and/or 101′ can have a radiated efficiency between 70% and 90% when operating between 600 MHz and 6000 MHz. In some implementations, the multi-band radiator portions 100 and/or 101′ can have a peak gain between 2.5 and 6 when operating between 600 MHz and 6000 MHz.

The RF cabling (not shown) to connect the internal modem to the multi-band radiator portions 100 and/or 101′ and the dual-band WiFi radiator portions 218 can extend through the cable routing component 212 and through the baseplate 220 and into the second internal volume of the lid 208.

The orientation and the arrangement of the multi-band radiator portions 100 and/or 101′ and the dual-band WiFi radiator portions 218 on the baseplate 220 relative to each other can be selected to optimize the performance of the antenna assembly 204 for the particular use case. In the illustrated example, the dual-band WiFi radiator portions 218 are positioned on opposite sides of the baseplate 220. Similarly, in the illustrated example, the multi-band radiator portions 100 and/or 101′ are positioned on opposite corners of the baseplate 220. The relationship between the multi-band radiator portions 100 can be important for the performance of the antenna assembly 204. In some implementations, the arrangement of the multi-band radiator portions 100 can be selected to have complementary overlapping azimuth patterns. Additionally, the arrangement can be selected to reduce the multi-band antenna 100 to multi-band antenna 100 isolation, without the use of divider walls or RF absorbing material.

The antenna unit 200 can be configured advantageously to act as an emergency portable hot spot and serve as a complete portable network in a singular box/case. The antenna unit 200 can be used for emergency situations where a portable network is required. In some implementations, a principal function of the antenna unit 200 can be to route local Wi-Fi 5 or 6 (LAN) signals to WAN signals, which is typically 4G/5G LTE based. In some implementations, the antenna unit 200 can be configured for CAT 4 to CAT 18 LTE and may also include 5G NR (New Radio) which goes from 600 MHz to 6.0 GHz for wide area cellular networks backhaul and 5G millimeter wave which uses 24, 28 and 39 GHz bands. In some implementations, the antenna unit 200 can be used for Local cellular short haul (150 ft ultra-high speed to LTE). The antenna unit 200 may imbeds GPS, LTE and Wi-Fi antennas in the lid 208 of the case 202. The antenna unit 200 can also include GPS, LTE, Wi-Fi and both version of 5G all in one case 202, working at the same time for maximum throughput, upload and download speeds for portable internet access.

### Multi-band Antenna Elements

FIGS. 3A-3H illustrate various views of components of the multi-band radiator portions 100′, in accordance with some aspects of this disclosure. Each multi-band radiator portion 100′ and/or multi-band antenna 100′ can include a multi-band radiating element 101′ and a ground connection 103′ (also referred to herein as a “grounding portion” or a “tuner”). The ground connection 103′ is configured to couple multi-band radiating element 101′ to the ground plane 220. FIGS. 3A and 3C-3F illustrate assorted views of the multi-band radiating element 101′. FIGS. 3B and 3G-3H illustrate the ground connection 103′. In some implementations, a different ground connection can be used with the radiating element 101′ to form the multi-band radiator portions 100′. The multi-band antennas 100, 100′, and the multi-band radiating element 101′ and ground connection 103′, can also be referred to as an antenna system, antenna components, antenna module, radiating systems, multi-band elements, and/or other reference to some or all of its components, etc. The multi-band elements can include one or more antenna elements and/or antenna components or systems. The multi-band elements may be of different shapes, operational ranges or frequencies, and sizes. When other antennas and/or multi-band elements (e.g., the antennas of any of FIGS. 10A-18D, etc.) are included in the antenna assembly 204, such antennas can be arranged on the ground plane 220 in a similar or different manner, depending on the particular application.

It is recognized that the multi-band radiator portions 100′ and/or multi-band antennas 100′ described herein are just one example of multi-band radiator portions that can be included in the antenna assembly or system 200 and/or antenna assembly 204. In other implementations, different multi-band radiator portions can be included. For example, the antenna assembly 200 can include multi-band radiator portions that are similar or identical to the multi-band radiator portions 100 described herein. In the illustrated implementation, the radiating element 101′ and the ground connection 103′ are constructed of metal (e.g., a conductive sheet). In some cases, the conductive sheet can have a thickness between 0.01 inches and 0.03 inches. In other implementations, the radiating element 101′ and/or ground connection 103′ could be constructed out of several rigid PCB portions or a single flex circuit PCB (e.g., supported by the radome 204 or another RF-transparent supporting structure). Additional disclosure regarding antenna systems and assemblies including the multi-band radiator portions 100′ of FIGS. 3A-3H is further described in U.S. application Ser. No. 18/894,607, filed Sep. 24, 2024, entitled “Antenna Systems,” the entire contents of which is hereby incorporated by reference herein in its entirety. The disclosure and Figures in U.S. application Ser. No. 18/894,607 can be used in connection with the disclosure and Figures described and shown herein.

As shown in FIG. 3A, a radiating element 101′ can be one element or component of the multi-band radiator portion 100′. An upright low-band radiation portion 125′ (also referred to herein as the “body portion 125′”) can be a body portion of the radiating element 101′. The upright low-band radiation portion 125′ can be coupled to a feeding portion at a feed point 119′ (see e.g., FIG. 3C) to electrically excite the radiating element 101′. As shown in FIG. 3A, a second low-band radiation portion 129′ (also referred to herein as the “head portion 129′”) can be positioned at an angle relative to the body portion 125′ (e.g., the upright low-band radiation portion 125′) and extend such that the second low-band radiation portion 129′ is not coplanar with the upright low-band radiation portion 125′. In some other implementations, the second low-band radiation portion 129′ can be configured without a bend such that it is coplanar with the upright low-band radiation portion 125′. In some implementations, advantages of a bend can include having two distinct low-band radiating portions, reducing the total height of the system to be more compact and conserve space, and configuring the system to be able to easily cover and provide protection for the system in a compact configuration with multi-band coverage (e.g., in the antenna assembly 200). Having a compact radiating element 101′ (e.g., in part due to the bend between the upright low-band radiation portion 125′ and the second low-band radiation portion 129′) can allow the multi-band radiator portions 100′ to be utilized in antenna assemblies where a low profile is required or desired. For example, it can be desirable for the antenna assembly 200 to have as low a profile as possible, to allow the antenna assembly 200 to be used in high wind operating conditions or applications that require low visual impact. Accordingly, as the multi-band radiator portions 100′ represent the limiting factor in terms of total height of the antenna assembly 200, the low-profile multi-band radiator portions 100′ are particularly advantageous. In some implementations, the multi-band radiator portions 100′ can have a total height (e.g., from the bottom of the feed point 119′ to the top of the second low-band radiation portion 129′) of between 0.75 inch and 3 inches. For example, the multi-band radiator portions 100′ may have a total height of less than 3 inches, less than 2.5 inches, less than 2 inches, less than 1.5 inches, less than 1 inches, and/or the like.

In some other implementations, the second low-band radiation portion 129′ can be coupled to a third low-band radiation portion, a fourth low-band radiation portion, and/or other radiation portions. In some implementations, material forming the second low-band radiation portion 129′ can extend in a direction further away from the upright low-band radiation portion 125′ and comprise a slit between the material such that portion of material on each side of the slit may form a third low-band radiation portion and a fourth low-band radiation portion respectively, that may be coplanar with and extend beyond the second low-band radiation portion 129′. In some implementations the third and fourth low-band radiation portions can be the same length and width. In some implementations, the length and/or width of the third low-band radiation portion may be different from the length and/or width of the fourth low-band radiation portion. In some implementations, one or more of the third low-band radiation portion and the fourth low-band radiation portion may be angled or bent or attached such that it is not coplanar with the second low-band radiation portion 129′. Adding variations in radiation portions can provide advantageous coverage in different areas of bandwidth in some implementations.

In some cases, the radiating element 101′ is a modified printed inverted-F antenna (PIFA) modified to have three bent arm members that make the radiating element 101′ a three-dimensional antenna as opposed to a two-dimensional antenna generally practiced in the art for printed inverted-F antennas. Furthermore, the radiating element 101′ can be a dual-band monopole antenna, a multi-band 3D inverted F antenna, or a version of a 2D inverted F antenna similar to a PIFA that has a configuration that, when used in conjunction with high order electromagnetic modes generated or received by a transceiver and/or receiver (as is typically performed for PIFA antennas), permit the radiating element 101′ to have an operating frequency range of 500 MHz to 8 GHz.

The low-band portions (e.g., upright low-band radiation portion 125′, the second low-band radiation portion 129′, and any additional low-band radiation portions) can be configured for radiation in the low-band (e.g., approximately 600 MHz to 900 MHz), including low-band odd multiples. The radiating element 101′ can also include additional portions configured for radiation above the low-band. For example, the radiating element 101′ can include one or more primary arms 127′ and/or one or more secondary arms 137′. The primary arms 127′ and the secondary arms 137′ may be configured for operation on different bands or the same bands. For example, the primary arms 127′ can be configured for radiation in the mid-band (e.g., approximately 1.7 GHz to 2.7 GHz) and the secondary arms 137′ can be configured for radiation in the C-band (e.g., approximately 3.4 GHz to 4.2 GHz). In the illustrated example, the radiating element 101′ includes two primary arms 127′ and two secondary arms 137′. However, more or fewer arms 127′, 137′ are possible. Further, in other implementations, the arms 127′, 137′ or additional/alternative arms can be included in the radiating element 101′ and configured for radiation in the high band Wi-Fi band (e.g., approximately 4.8 GHz to 7.25 GHz).

The arms 127′ can be coupled to a lower portion of the upright low-band radiation portion 125′. In some implementations, the arms 127′ can be coupled to an upper portion of the upright low-band radiation portion 125′. In some other implementations, one or more additional arms 127′ can be coupled to an upper portion of a low-band radiation portion (e.g., upright low-band radiation portion 125′, the second low-band radiation portion 129′, etc.). In some implementations the arms 127′ can have the same length. In some implementations arms 127′ can have different lengths. In some implementations, one or more of the arms 127′ can be positioned at an angle relative to the upright low-band radiation portion 125′ and/or relative to a ground plane (e.g., the ground plane 220). The arms 127′ can be positioned at the same angle or at different angles. The arms 127′ can be configured for radiation in the mid-band, including higher even order resonances. In some implementations, additional arm portions can be added or formed at selected locations to add coverage for additional high frequency bandwidth areas (e.g., the high band Wi-Fi band). For example, in some implementations, portions of the arms 127′ (and/or the arms 137′) may be slit, extended, angled, bent, modified, and/or otherwise connected to provide improved coverage areas.

As shown in FIG. 3E, in some implementations, each arm 127′ can include a first arm portion 133′ and a second arm portion 135′. The first arm portions 133′ can be coupled to or extend from the upright low-band radiation portion 125′, and the second arm portions 135′ can be coupled to or extend from the first arm portions 133′. The second arm portions 135′ can be at a different angle relative to the upright low-band radiation portion 125′ and the ground plane 220 compared to the first arm portions 133′. The second arm portions 135′ can have a different width, thickness, length, and/or bend angle compared to the first arm portions 133′. These variations can improve return loss and radiation pattern performance in some cases. In the illustrated example, the first arm portions 133′ extend from a lower portion of the upright low-band radiation portion 125′ in a direction towards the second low-band radiation portion 129′. The first arm portions 133′ and the second low-band radiation portion 129′ can both extend away from the upright low-band radiation portion 125′. In some implementations, the arms 127′ can have a maximum height (relative to the ground plane 220) that is substantially the same as the maximum height of the second low-band radiation portion 129′ (relative to the ground plane 220).

The arms 137′ can extend from or be coupled to the upright low-band radiation portion 125′. For example, the arms 137′ can be coupled to an upper portion of the upright low-band radiation portion 125′. In some implementations, the arms 137′ can be positioned above the arms 127′, relative to the ground plane 220. In some implementations, the arms 137′ can be coupled to a lower portion of the upright low-band radiation portion 125′. For example, the arms 137′ may be positioned below the arms 127′. In some other implementations, one or more additional arms 137′ can be coupled to a low-band radiation portion of the radiating element 101′ (e.g., the upright low-band radiation portion 125′, the second low-band radiation portion 129′, etc.). In some implementations the arms 137′ can have the same length. In some implementations arms 137′ can have different lengths. In some implementations, one or more of the arms 137′ can be positioned at an angle relative to the upright low-band radiation portion 125′ and/or relative to a ground plane (e.g., the ground plane 220). The arms 137′ can be positioned at the same angle or at different angles. As described herein, the arms 137′ can be configured for radiation in the C-band (e.g., approximately 3.4 GHz to 4.2 GHz), including high even order resonances. In some implementations, additional arm portions can be added or formed at selected locations to add coverage for additional high frequency bandwidth areas (e.g., the C-band or higher). For example, in some implementations portions of the arms may be slit, extended, angled, bent, modified, and/or otherwise connected to provide improved coverage areas. In some implementations, the arms 137′ can be coplanar to the upright low-band radiation portion 125′, as shown in FIG. 3E. In some implementations, the arms 137′ can improve return loss at the upper end of the mobile telecommunications spectrum relative to the radiating element 101′, which may not include the additional arms similar to the arms 137′.

As shown in FIG. 3B, a ground connection 103′ (also referred to herein as the “tuner 103′”) can be adapted and configured to couple the radiating element 101′ with the ground plane 220. The tuner 103′ can include a face plate 171′ that is configured to be coupled to a ground plane (e.g., the ground plane 220). The tuner 103′ can include an arm portion 173′, which can be an arm portion coupled to the face plate 171′. The width of arm portion 173′ can be adjusted to accommodate clearance for transmission lines, such as coaxial cables (not shown) of antenna assembly 200, which can be used to excite the radiating element 101′. For example, the illustrated width of the arm portion 173′ allows the coaxial cables to extend past the arm portion 173′, under the body 175′, and to be positioned adjacent the arm portion 173′ when coupled to the radiating element 101′. Low-band operation of the multi-band radiator portion 100′ is enhanced and can be adjusted by the length and width of body portion 125′ and head portion 129′ as well as the location, placement, and configuration of an opening (not shown) in body portion 125′. The tuner 103′ can include a body 175′ that includes an engagement portion 177′. The engagement portion 177′ can be adapted and configured to be positioned against the body portion 125′ of the radiating element 101′. For example, the engagement portion 177′ can be positioned against the upright low-band radiation portion 125′ such that the body 175′ is substantially orthogonal to the upright low-band radiation portion 125′. The engagement portion 177′ can include one or more tabs 183′. The tabs one or more tabs 183′ can be twist tabs. The one or more tabs 183′ can be received within one or more slots 131′ of the upright low-band radiation portion 125′. As such, the extension of the tabs 183′ through the slots 131′ can be a point of coupling, creating a ground connection for the multi-band radiator portion 100′. Use of the tabs 183′ and the slot 131′ for the ground connection can improve grounding, reduce the part count, and/or reduce assembly time, compared to other coupling means such as a nut and threaded fastener. For example, to couple the ground connection 103′ to the radiating element 101′, the tabs 183′ can be inserted in the slots 131′ and twisted (e.g., with pliers) to create the connection. This type of connection can be completed more quickly than other connections (such as soldering, nut and fastener, etc.) and can provide a secured connection. In some cases, solder can optionally be used to improve the electrical connection between the ground connection 103′ and the radiating element 101′; however, the solder is generally not required for the mechanical or electrical connection to be established. The lateral position of the arm portion 173′ relative to body 175′ can also be selected to accommodate clearance for transmission lines. For example, while the arm portion 173′ is shown as positioned on one side of the body 175′, this position is not required and the arm portion 173′ could be centrally positioned on the body 175′ in other implementations. The position and width of the arm portion 173′ can also impact the performance of the multi-band radiator portion 100′ across the various bands.

The ground connection 103′ can be elevated relative to the feed location 119′ of the radiating element 101′ in the assembled antenna assembly 200. For example, the face plate 171′ can be coupled to a portion of the ground plane 220 that is higher than the feed point 119′ in the assembled antenna assembly 200. Such a raised connection provides advantages to achieve the multi-band coverage. Dimensions can be selected to provide harmonic resonance at higher odd orders in some implementations. The grounding portion 103′ provides advantages for achieving multiple advantageous resonances. Also, the selection of the dimensions for radiating portion 100′ may also be adjusted to impact the radiation patterns of the fundamental mode as well as the higher order modes. For example, in some implementations, the height, width, and clearance provided for by the size of arm portion 173′ can be advantageously selected. Additionally, the length and width of body portion 175′ can also be advantageously selected. For example, the width and length of the arm portion 173′ and the body 175′ can be adjusted for impedance matching as well as to achieve a desired radiation pattern for the multi-band radiator portion 100′. The locations of the one or more slots 131′ and one or more tabs 183′, when coupled together for the grounding connection create a symbiotic connection to provide a resonance of desired impedance to match a desired frequency and bandwidth and radiation pattern for a low-band frequency configuration in some implementations. In the illustrated example, the slots 131′ are near the vertical center of the upright low-band radiation portion 125′. The vertical position of the slots 131′ on the upright low-band radiation portion 125′ is related to the height or length of the arm portion 173′. In other implementations, the slots 131′ can be located higher or lower on upright low-band radiation portion 125′ relative to the vertical axis. The location of the slots 131′ (e.g., where the ground connection 103′ attaches) relative to the height of the upright low-band radiation portion 125′ is selected for impedance matching and the desired behavior of the higher order modes (e.g., where the higher order modes occur). The relative dimensions are also selected so that the radiation patterns come off of the radiating element 101′ in the desired shape and/or direction. The width between the slots 131′ can also be variable. In the illustrated example, each slot 131′ is located approximately centrally between the central vertical axis of the upright low-band radiation portion 125′ and an outside edge of the upright low-band radiation portion 125′. In other examples, the slots 131′ can be closer or further apart from each other. In some cases, decreasing the width between the slots 131′ can require the height of the slots 131′ to also be reduced relative to the upright low-band radiation portion 125′ for optimal performance of the multi-band radiator portion 100′. In some cases, it can be desirable for the slots 131′ to be located as high on the upright low-band radiation portion 125′ as possible for improved structural benefits. However, the height of the slots 131′ is selected generally selected for a balance of good structural support and performance of the multi-band radiator portion 100′ across all desired bands.

FIG. 3C shows coupling points 117a′ of the radiating element 101′. The twin coupling points 117a′ can be used to attach the multi-band radiator portion 100′ to a non-conductive structural stand coupled to the ground plane 220. For example, the non-conductive structural stand can be secured to the ground plane 220. More isolation can be created from the ground plane 220 by expanding the space 113′ and/or the space 111′ between the twin coupling points 117a′ and a feed point location 119′. The feed point location 119′ is configured to receive an electrical connection to excite the radiating element 101′. For example, the center conductor of the coaxial cable can be electrically and mechanically coupled to the feed point 119′ with the outer conductor being electrically and mechanically coupled to the ground plane 220. The space 111′ can be selected primarily for impedance matching purposes and may vary depending on the particular implementation of the multi-band radiator portion 100′ and the antenna assembly 200. For example, changing the dimensions or structure of the ground plane 220 can result in a variation in the size of the space 111′. In some implementations, the feed point 119′ can be twice the height (e.g., space 111′ can be doubled) or greater and/or the feed point 119′ can be twice the width (e.g., the narrow width tab 109′ can be doubled) or greater. In other implementations, a feed point 119′ with different structural features can be used. For example, the radiating element 101′ may include a feed point that is a tab. The tab feed point may extend substantially perpendicular to the upright low-band radiation portion 125′. In one example, the radiating element 101′ can include a feed point that includes a spacer with a push rivet or established via a heat stake operation. In some implementations, the feed point of the radiating element 101′ can be configured to be snap fit into a slot or configured as a push pass connection.

In some other implementations, features and aspects of the multi-band radiator portions 100′ can be further described as follows. FIG. 3C illustrates the radiating element 101′ that can be coupled to the ground plane 220 of the antenna assembly 204 shown in at least FIGS. 2A-2B, and electrically excited at the feed point 119′. For example, as described above, the center conductor of the coaxial cable can be coupled to the feed point 119′ with the outer conductor being coupled to the ground plane 220. The feed point 119′ can extend from or be coupled to the upright low-band radiation portion 125′ with what can be a narrow width tab 109′. Additional isolation between the upright low-band radiation portion 125′ and the ground plane 220 can be obtained by adjusting 111′ and consequently the coupling location reference 113′. For additional mechanical support, the upright low-band radiation portion 125′ can have a non-conductive coupling mechanism (not shown) to the ground plane 220. The upright low-band radiation portion 125′ can have a coupling point (e.g., one or more slots 131′) for attaching the grounding portion 103′ with via the one or more tabs 183′. As noted above, also extending from/coupled to the upright low-band radiation portion 125′ can be one or more primary arms 127′ and/or one or more secondary arms 137′. The arms 127′, 137′ can assist with the dominate radiation in the mid-band and C-band for the multi-band radiator portion 100′. One or more portions similar to the arms 127′, 137′ may be used for assisting in the high band portion of the radiation are realizable in the implementation of this approach. Higher even order resonances may radiate from portions similar to the arms 127′, 137′ of the radiating element 101′ to assist in the multi-band properties of the device. Furthermore, there can be the additional head portion 129′ coupled to the upright low-band radiation portion 125′ that may be perpendicular in nature for its orientation. Though it is not necessary for it to be bent near 90-degrees as depicted in this illustration and can be shown to be perceptibly straight in other implementations. By bending the low-band radiation portion of the radiating element 101′ to realize two distinct portions (e.g., the upright low-band radiation portion 125′ and the second low-band radiation portion 129′), the total height of the radiating element 101′ is reduced and as such the total volume of the antenna assembly 200 to most likely provide environmental protection is consequently reduced. The low-band operation of the radiating element 101′ is determined by several factors. Some of the factors are the length and width of the upright low-band radiation portion 125′ and of the second low-band radiation portion 129′, the location of opening one or more slots 131′, and/or the grounding portion 103′.

FIG. 3B illustrates the grounding portion of the device 103′. The face plate 171′ can extend from or be coupled to the arm 173′. The width of the arm 173′ can be adjusted to accommodate clearance for assembly purposes for a transmission line of the antenna assembly 200 that may be used for excitation of the multi-band radiator portion 100′. The body 175′ can extend from or be coupled to arm 173′. The engagement portion 177′ can be coupled to or form a portion of the body 175′. The engagement portion177′ can also have one or more coupling points (e.g., one or more tabs 183′) that are configured to couple to the opening one or more slots 131′ of the radiating element 101′ in the assembled multi-band radiator portion 100′. The height of the arm 173′, the width of the arm 173′, the clearance provided for in the arm 173′, the length of body 175′, and the symbiotic location of slots 131′ and/or tabs 183′ can provide for a reactance that counterbalances the reactance of the low-band impedance to provide a resonance of desired impedance match for the desired frequency and bandwidth for the low-band radiation. The location of the coupling points (e.g., one or more tabs 183′) and the length and width of the grounding portion 103′ are also chosen to provide higher odd order resonant harmonics at the desired locations to cover a portion of the frequency band of the multi-band performance of the antenna assembly 200. Further, the relative dimensions described above also influence the radiation pattern generated by the radio frequency excitation of the multi-band radiator portion 100′.

FIG. 3C illustrates a back side view of the radiating element 101′. Twin coupling points 117a′ in the radiating element 101′ may be coupled to a non-conductive object (not shown), which can be coupled to the ground plane 220 of the antenna assembly 200. This coupling may provide mechanical stability for the multi-band radiator portions 100′ while not disturbing or inhibiting the ground connection provided by the ground connection 103′.

FIGS. 3D-3F provide additional views of the radiating element 101′. As shown in FIGS. 3D and 3F, the second low-band radiation portion 129′ can include one or more clearances. For example, the second low-band radiation portion 129′ can include one or more first clearances 157a′ and/or one or more second clearances 157b'. The clearances 157a', 157b′ can be holes or openings formed in the second low-band radiation portion 129′. The clearances 157a', 157b′ may allow for ease of assembly of the completed multi-band radiator portions 100′. FIG. 3G-3H provide additional views of the ground connection 103′ of the multi-band radiator portions 100′.

Another example of a multi-band radiator portion 101′ that can be used in addition to or alternatively to the multi-band radiator portions 101′ in the multi-band multi-element antenna 100 is described further herein with reference to at least FIG. 19D. It is recognized that any discussion of the features or arrangements of the multi-band radiator portions 101′ in the multi-band multi-element antenna 100 of the multi-band antenna assembly 1904 can apply to the multi-band radiator portions 1901 and the multi-band multi-element antenna assembly 1904. Similarly, such discussion can also apply to any alternative antennas and/or radiator portions included in an implementation of the multi-band multi-element antenna systems of antenna units 200, 300, 1900, and/or those of other multi-band antenna systems disclosed herein (e.g., antenna systems of any of FIGS. 10A-18D, 25-28, and 31-34, etc.), any of which can be are included in alternative antenna configurations, such as for example, the antenna assembly 1904 and/or for the other antenna units disclosed herein.

### Antenna Unit Components

FIGS. 4A-4E illustrate additional implementations of antenna units 200A-200E respectively. Some features of the antenna units 200A-200E are similar or identical to features of the antenna unit 200 in at least FIGS. 1A-3H. Thus, reference numerals used to designate the various features or components of the antenna unit 200 are identical to those used for identifying the corresponding features of the components of the antenna units 200A-200E in FIGS. 4A-4E, except that the numerical identifiers for the antenna units 200A-200E include a letter (e.g., “A” through “E” respectively). Therefore, the structure and description for the various features of the antenna unit 200 and the operation thereof as described in at least FIGS. 1A-3H are understood to also apply to the corresponding features of the antenna units 200A-200E in FIG. 4A-4E, except as shown differently and/or described differently herein.

FIG. 4A illustrates an antenna unit 200A. The antenna unit 200A is shown with the base 206A as transparent. The base 206A can include a battery tray 246A for housing the power sources of the antenna unit 200A. The base 206A can include a router plate 242A for the router or modem. The battery tray and router plate can be within the first internal volume of the base 206A.

FIG. 4B illustrates an antenna unit 200B. The antenna unit 200B is shown with the base 206B as transparent. The base 206B can include a battery tray 246B for housing the power sources of the antenna unit 200B. The base 206B can include a router mount 242B for the router or modem. The battery tray and router plate can be within the first internal volume of the base 206B. The battery tray and router plate can be suspended above the bottom of the base 206B.

FIG. 4C illustrates an antenna unit 200C. The barrier 210C can include one or more additional features. For example, the barrier 210C can include window that can be positioned above the router so that the user can see the router label. The barrier 210C can include a hinge router mount plate such that a user can have easy access to the router without removing the barrier 210C from the base 206C. A user may wish to access the router to change the SIMS or to replace the router. The barrier 210C can include an internal RJ45 port, which can provide added security.

FIG. 4D illustrates an antenna unit 200D. The barrier 210D can include one or more additional features. For example, the barrier 210D can be pivotably connected to the base 206D. As such, a user can pivot the 210D to access the first internal volume of the base 206D. The barrier 210D can also include one or more recessed portions for storing multiple routers or other antenna accessories.

FIG. 4E illustrates an antenna unit 200E. The antenna unit 200E is shown with the base 206E as transparent. The base 206E can have a larger first internal volume compared to the antenna unit 200. The base 206E can include a battery placement portion 246E for housing the power sources of the antenna unit 200E. The base 206E can include a router plate 242E for the router or modem. The battery placement portion and router plate can be within the first internal volume of the base 206E.

### Antenna Patterns

Referring now also to FIGS. 5A-5M in the drawings, assorted graphs of various frequencies are shown for Ports 5 and 8 within LTE Elevation Low Band, Mid Band, and High Band ranges. In particular, FIGS. 5A-5C illustrate Port 5 within the LTE. FIGS. 5D-5F illustrate Port 5 in the Mid Band. FIGS. 5G-5J illustrate Port 5 in the High Band. Figures and 6A-6F illustrate additional WiFi graphs. These are representative only but act to illustrate a level of performance possible as the antenna unit 200. It is understood that other performance data is possible for Ports 10, 21, and/or others.

### Antenna Units and Router Cases

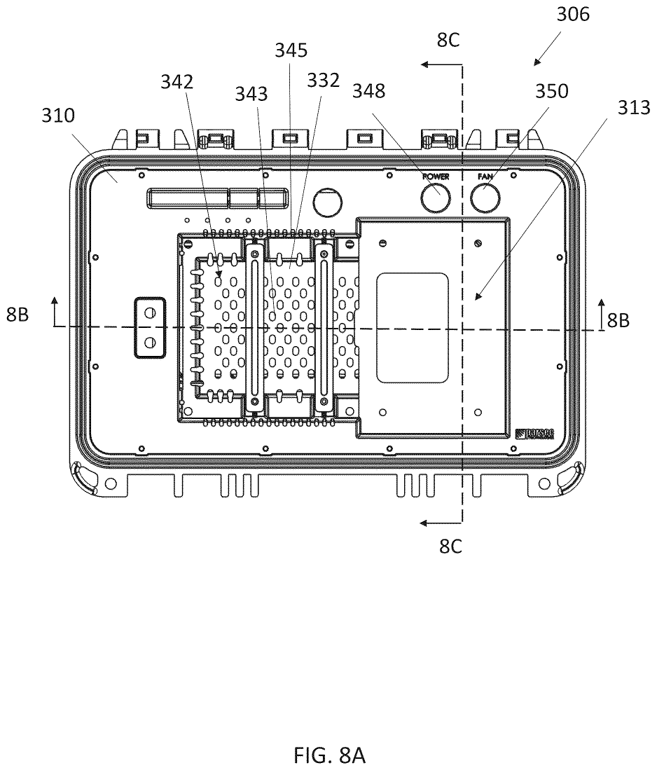

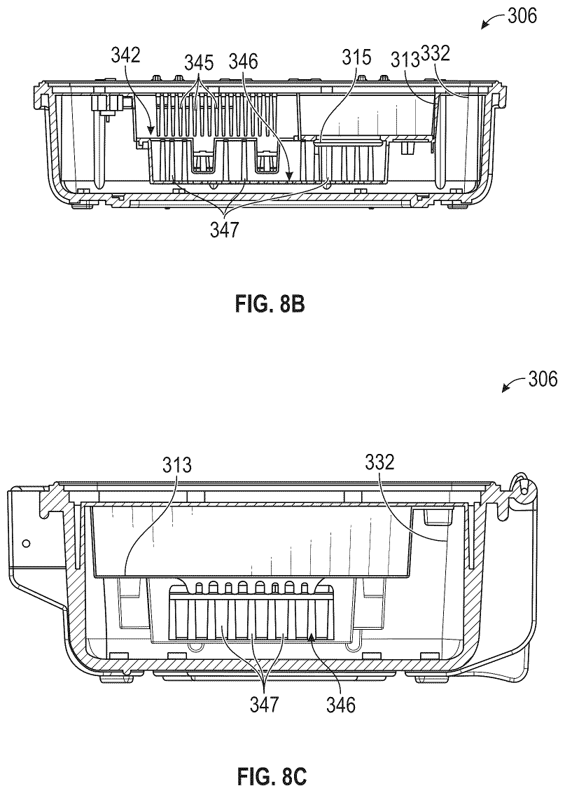

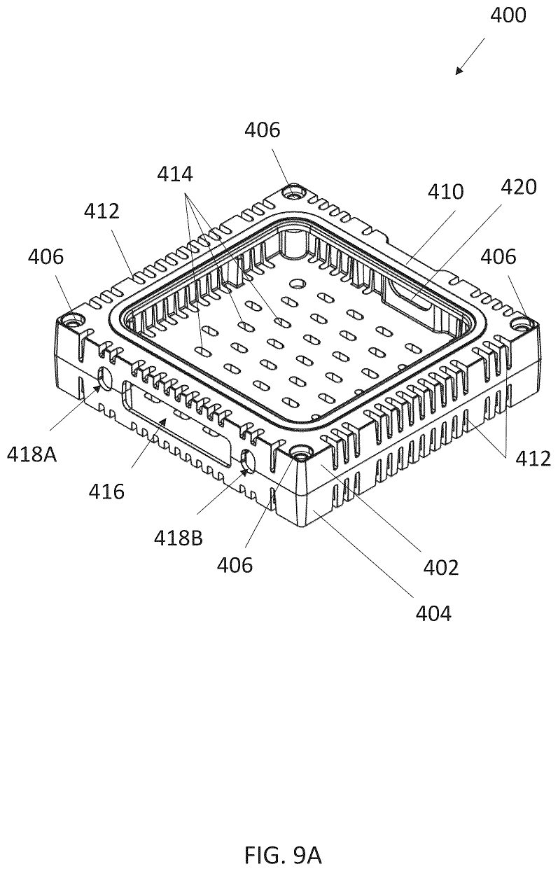

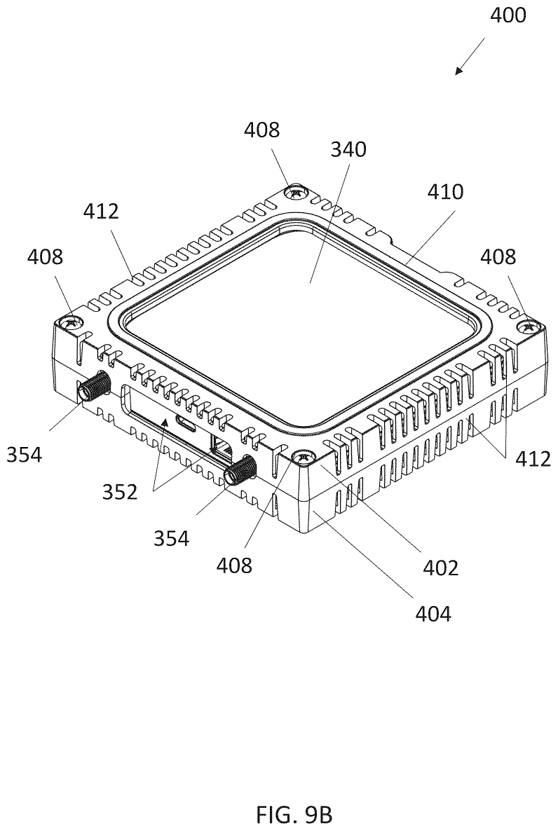

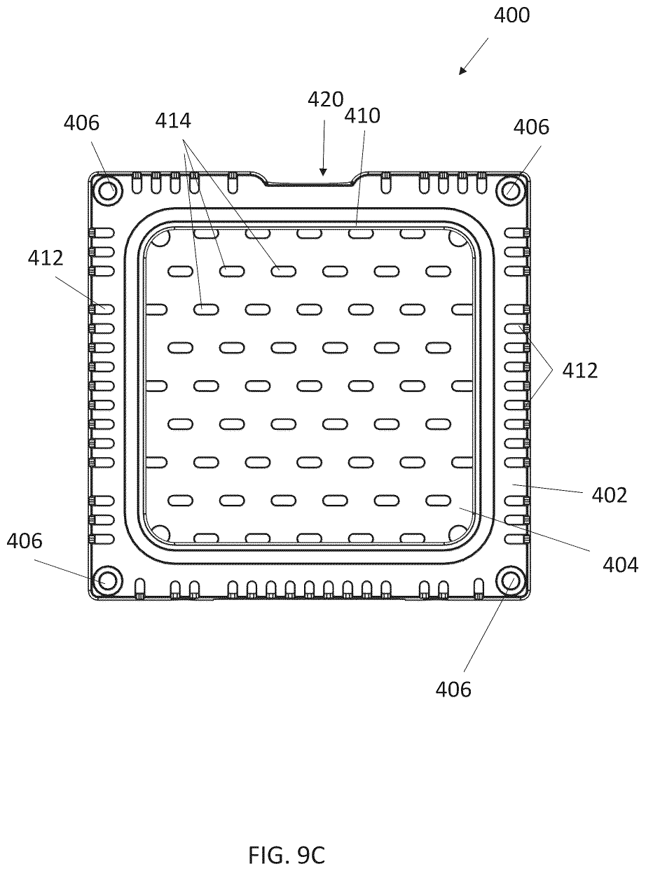

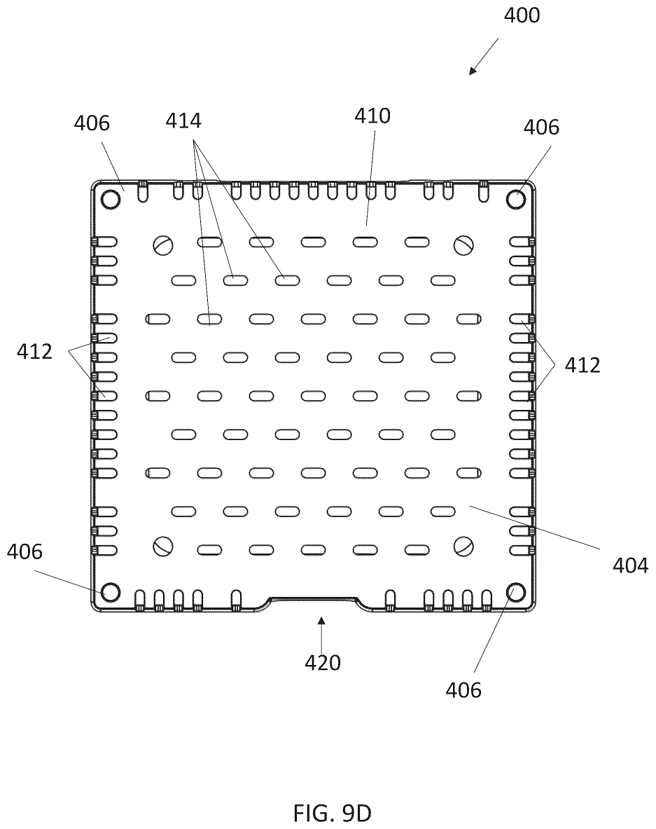

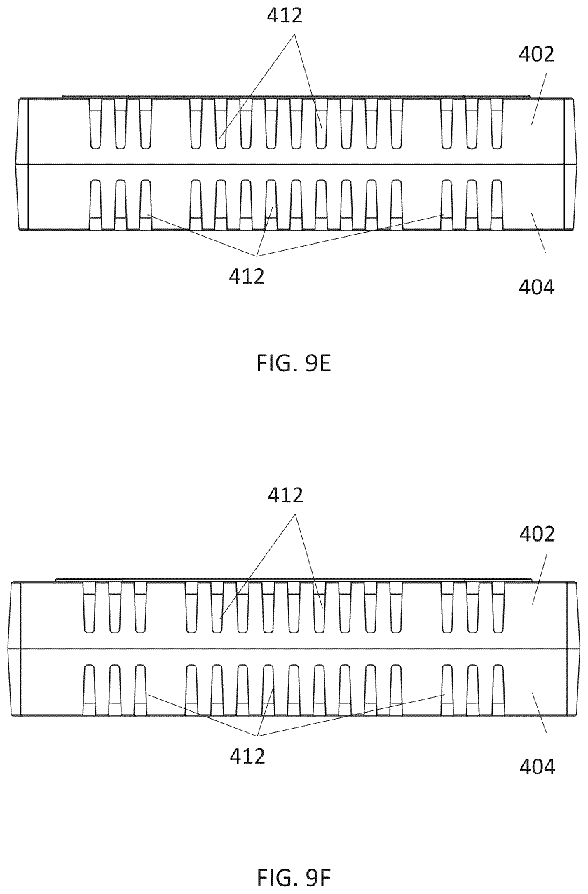

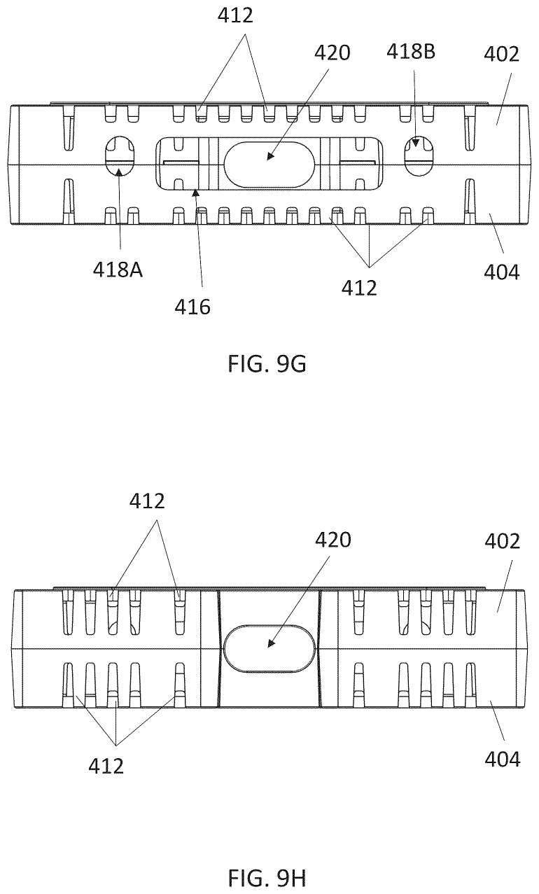

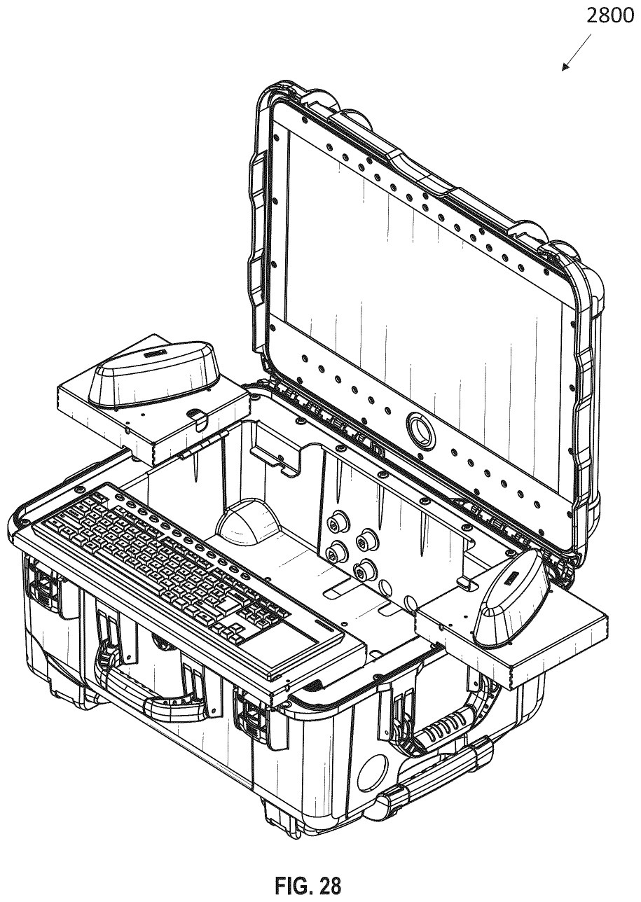

FIG. 7 illustrates a perspective view of an antenna unit 300. FIGS. 28A-9H illustrate additional view of the antenna unit 300 or components of the antenna unit 300. Some features of the antenna unit 300 are similar or identical to features of the antenna unit 200 in at least FIGS. 1A-3H. Thus, reference numerals used to designate the various features or components of the antenna unit 200 are identical to those used for identifying the corresponding features of the components of the antenna unit 300 in FIGS. 7-8C, except that the numerical identifiers for the antenna unit 300 include begin with a “3” instead of a “2”. Therefore, the structure and description for the various features of the antenna unit 200 and the operation thereof as described in at least FIGS. 1A-3H are understood to also apply to the corresponding features of the antenna unit 300 in FIGS. 7-8C, except as shown differently and/or described differently herein.

The antenna unit 300 differs from the antenna unit 200 primarily in the components of the base 306. For example, the antenna unit 300 may include an internal frame 332 and a barrier 310 with different features than the antenna unit 200. However, it is recognized that the components of the base 306 can be used in the antenna unit 200 and vice-versa. Additionally, the antenna unit 300 can be configured for use with a router shell 400. The router shell 400 is described herein with reference to FIGS. 9A-9H. In some implementations, the antenna unit 300 can be configured for use with a mobile hot spot. Throughout the description, the use of “router” is understood to apply to a mobile hot spot.

FIG. 8A illustrates a top isolation view of the base 306 and associated components. In FIG. 8A, the router shell 400, router 340, and battery 336 are removed (these components are shown in FIG. 7). FIG. 8B illustrates a section view of the base 306 and associated components along the line 8B-8B of FIG. 8A. FIG. 8C illustrates a section view of the base 306 and associated components along the line 8C-8C of FIG. 8A.

With reference to FIGS. 7-8C, the barrier 310 can include cutout portion 311. The cutout portion 311 can be configured to allow the router shell 400 to engage the internal frame 332. The cutout portion 311 can include a shelf 313. The shelf 313 can be a recessed portion of the barrier 310. The shelf 313 can be used to store further components in the case 302 (e.g., tool, chargers, etc.). In some implementations, the shelf 313 can include a window 315. The window 315 can be positioned above the battery 336 such that a user can view indicators on the battery 336.

The internal frame 332 can be configured to support one or both of the router 340 and the battery 336. The internal frame 332 can be configured to provide separation between the router 340 and the battery 336. For example, the internal frame 332 can provide spacing for the battery 336 and router 340 to avoid heat flow between the two devices via direct contact, as well as provide space for air flow for heat dissipation. In some implementations, the internal frame 332 can comprise a plastic. The internal frame 332 can be configured to protect the router 340 and the battery 336 and provide shock isolation for the router 340 and the battery 336. For example, in some implementations, the internal frame 332 can move relative to the base 306 when the antenna unit 300 is moved or dropped, while preventing motion of the battery 336 and router 340 relative to the internal frame 332. In some implementations, the internal frame 332 can be removably coupled to the base 306 within the first internal volume.

The internal frame 332 can include a router compartment or shelf 342. The router shelf 342 can be aligned with the cutout portion 311 of the barrier 310 in the assembled antenna unit 300. The router shelf 342 can be configured to support the router 340 and/or the router shell 400. The router shelf 342 can be sized to prevent movement of the router shell 400 relative to the internal frame 332. For example, the router shell 400 can have a transition fit with the router shelf 342. As such, the router shell 400 can be easily removed by the user, from a top, but fixed when the antenna unit 300 is in the closed configuration. The router shelf 342 can include a plurality of holes 343 located in a bottom portion of the router shelf 342. The holes 343 can be configured to allow the router 340 and/or the router shell 400 to be exposed to airflow. Similarly, the router shelf 342 can include a plurality of slots 345 located in the side walls of the router shelf 342. The slots 345 can be configured to allow the router 340 and/or the router shell 400 to be exposed to airflow.

With reference to FIGS. 8B and 8C, the internal frame 332 can include a battery compartment or shelf 346. The battery shelf 346 can be configured to support battery 336. The battery shelf 346 can be sized to prevent movement of the battery 336 relative to the internal frame 332. For example, the battery 336 can have a transition fit with the battery shelf 346. As such, the battery 336 can be easily remove by the user, from a top, but fixed when the antenna unit 300 is in the closed configuration. The battery shelf 346 can include a plurality of holes (not shown) located in a bottom portion of the battery shelf 346. The holes can be configured to allow the battery 336 to be exposed to airflow. Similarly, the battery shelf 346 can include a plurality of slots 347 located in the side walls of the battery shelf 346. The slots 347 can be configured to allow the battery 336 to be exposed to airflow. While not illustrated, the internal frame 332 can further include a plurality of slots or cutouts in the side walls and bottom portion of the internal frame 332. The plurality of slots can be configured to promote airflow through the internal frame 332.

Referring back to FIG. 8A, in some implementations, the antenna unit 300 can include a power button 348 and/or a fan button 350. The power button 348 can be configured to turn the battery 336 on an off. The fan button 350 can be used to turn the fan 322 on and off.

FIGS. 9A and 9C-9H illustrate various view of the router shell 400. FIG. 9B illustrates the router shell 400 engaged with the router 340. The router shell 400 can be configured to support and protect the router 340. The router shell 400 can be configured to support a number of different router types. The router shell 400 can increase the height from which the router 340 can be safely dropped from without damage occurring to the router 340. For example, in some implementations, the router shell 400 can be configured for a 3-meter drop test. The router shell 400 can be configured for use with the antenna unit 300. The router shell 400 can also be used without the antenna unit 300. For example, a user may use the router shell 400 for added protection for the router 340 without the antenna unit 300.

The router shell 400 can include a top cover 402 and a bottom cover 404. The top cover 402 can be configured to be removably coupled to the bottom cover 404. For example, in one implementation, one or more fastener holes 406 can extend through the top cover 402 and bottom cover 404. The fastener holes 406 can be configured to receive fasteners 408 (see e.g., FIG. 9B). In other implementations, other methods can be used to removably couple the top cover 402 to the bottom cover 404.

The top cover 402 can include a router window 410. The router window 410 can be a cutout extending through a top side of the top cover 402. The router window 410 can allow a portion of the router 340 to be exposed to airflow and visible through the router shell 400. The covers 402, 404 can include a plurality of cutouts or slots 412. The slots 412 can be configured to promote airflow to the router 340. For example, the slots 412 can be vents. The slots 412 can extend along the side walls of the covers 402, 404. In some implementations, the slots 412 in the top cover 402 can extend along the top side of the top cover 402 and the bottom side of the bottom cover 404. The bottom cover 404 can include a plurality of cutouts or holes 414. The holes 414 can be formed in a bottom side of the bottom cover 404. The holes 414 can be configured to promote airflow to the router 340 in the router shell 400.

The router shell 400 can include one or more additional cutouts for access to the router 340. The cutouts can be formed in the side walls of the covers 402, 404. For example, the router shell 400 can include a router port cutout 416. The router port 416 can provide access through the router shell 400 to various ports 352 of the router 340 (e.g., USB port(s), USB-C port(s), ethernet port(s), etc.). In another example, the router shell 400 can include one or more adaptor cutouts 418. For example, the router shell 400 can include a first adaptor cutout 418A and a second adaptor cutout 418B. The adaptor cutouts 418 can be configured to allow cable adaptors 354 for the router 340 to pass through the router shell 400. In yet another example, the router shell 400 can include a power button cutout 420. The power button cutout 420 can be configured to provide access through the router shell 400 to a power button of the router.

### Multi-band Antenna Variations and Components

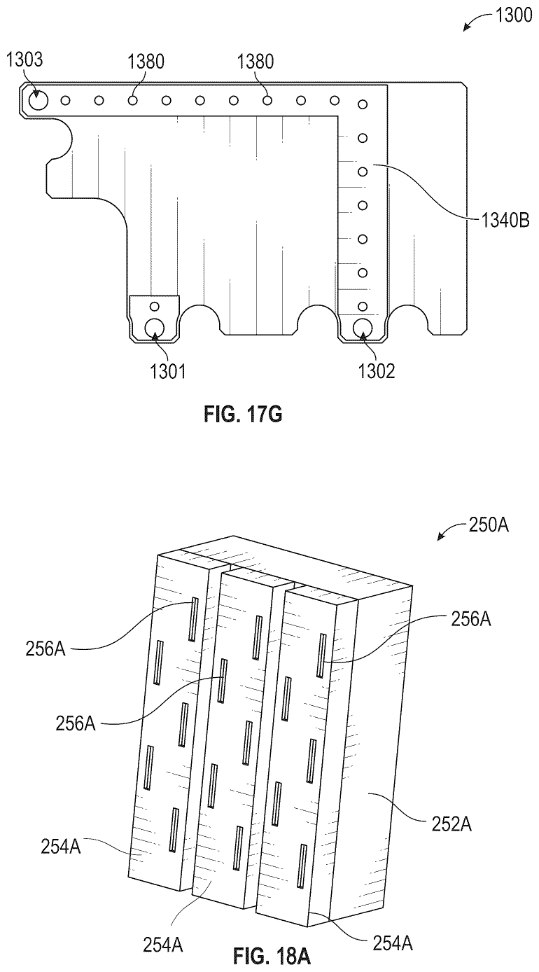

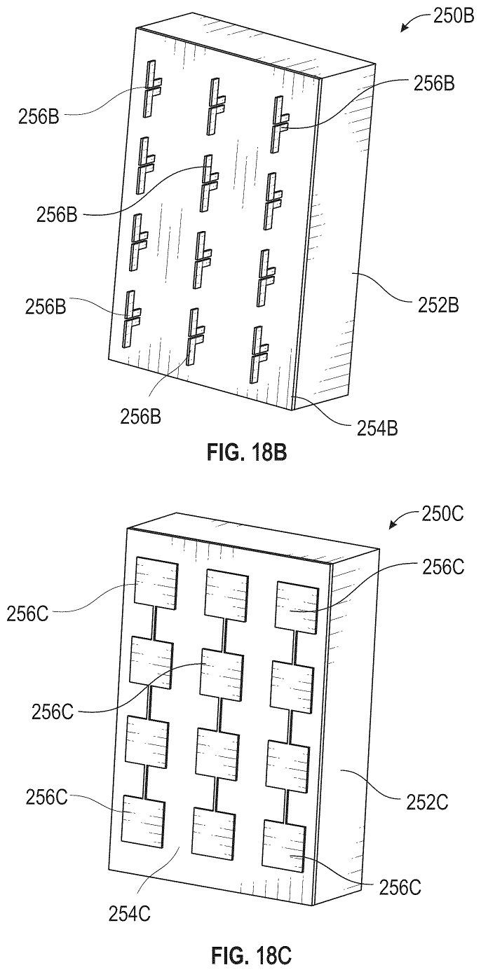

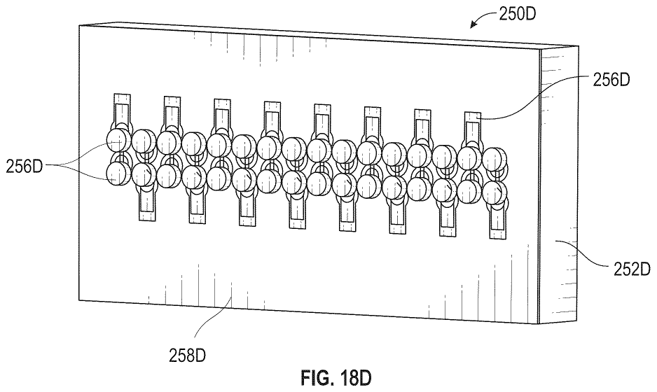

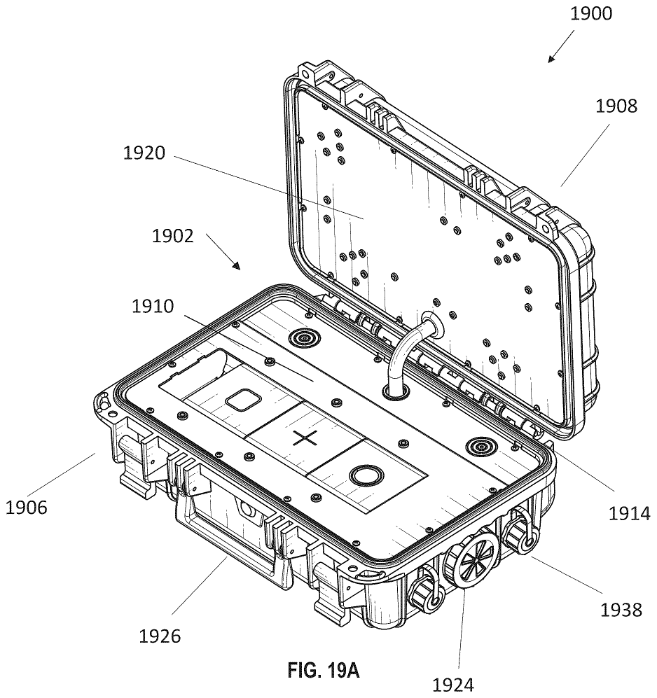

As described further herein, various alternative antenna elements can be incorporated into the multi-band multi-element antenna 100, in some implementations. For example, any of the multi-band radiator multi-band radiator portions 100, multi-band radiator portions 101′, dual-band WiFi radiator portions 218, GPS antenna elements 216, multi-band radiator portion 500, multi-band antenna 600, multi-band antenna 700, multi-band antenna 800, multi-band antenna 900, multi-band antenna 1000, stacked patch antenna 1100, and/or multi-band radiator portion 1200 can form part of the multi-band multi-element antenna 100 of the antenna assembly 204. Additionally, in some implementations, any of the millimeter wave radios 250 described with reference to at least FIGS. 18A-18D can be incorporated into the antenna assembly 204 and/or other antenna assemblies or antenna units and systems disclosed herein.

FIGS. 10A-10J illustrate various views of components of a multi-band radiator portion 500, in accordance with some aspects of this disclosure. Some features of the multi-band radiator portion 500 are similar or identical to features of the multi-band radiator portion 100′ in at least FIGS. 3A-3H. Thus, reference numerals used to designate the various features or components of the multi-band radiator portion 100′ are identical to those used for identifying the corresponding features of the components of the multi-band radiator portion 500 in FIGS. 10A-10J, except that the numerical identifiers for the multi-band radiator portion 500 begin with a “5” instead of a “1” and do not end with a “prime”. Therefore, the structure and description for the various features of the multi-band radiator portion 100′ and the operation thereof as described in at least FIGS. 3A-3H are understood to also apply to the corresponding features of the multi-band radiator portion 500 in FIGS. 10A-10J, except as shown and described differently. Additional disclosure regarding antenna systems and assemblies including the multi-band radiator portions 500 of FIGS. 10A-10H is further described in U.S. Provisional Application No. 63/637,247, filed Apr. 22, 2024, entitled “Antenna Systems,” the entire contents of which is hereby incorporated by reference herein in its entirety. The disclosure and Figures in U.S. Provisional Application No. 63/637,247 can be used in connection with the disclosure and Figures described and shown herein.

One or more multi-band radiator portions 500 can form part of any of the multi-band multi-element antennas described herein (e.g., the multi-band multi-element antenna 100 of the antenna assembly 204, the multi-band radiator portion 101′, etc.). In FIGS. 10A-10H, particular reference is made to various components of the antenna assembly 204 and how those components interact with the multi-band radiator portion 500. However, it is recognized that one or more multi-band radiator portions 500 may be integrated into any of the antenna assemblies described herein above and/or below. In particular, one or more of the multi-band radiator portions 100′ and/or multi-band radiator portions 100 of the antenna assemblies 204, or in any of the other antenna assemblies discloses herein, may be replaced with one or more of the multi-band radiator portions 500.

Each multi-band radiator portion 500 can include a multi-band radiating element 501 and a ground connection 503 (also referred to herein as a “grounding portion”). The ground connection 503 is configured to couple multi-band radiating element 501 a ground plane, such as the ground plane 220 of the antenna assembly 204. FIG. 10A shows a perspective view of the multi-band radiating element 501 and the ground connection 503 coupled together and secured to a mounting portion 502. As shown in FIG. 10A, fasteners 505 can be used to secure the multi-band radiating element 501 to the mounting portion 502. The fasteners 505 can also be used to secure the mounting portion 502 and the ground connection 503 to the ground plane 220. FIG. 10B0-10F illustrate assorted views of the multi-band radiating element 501. FIGS. 10G-10J illustrate assorted views of the ground connection 503. It is recognized that the multi-band radiator portion 500 described herein is just one example of multi-band radiator portions that can be included in the antenna assemblies described herein. In other implementations, different multi-band radiator portions can be included. In the illustrated implementation, the radiating element 501 and the ground connection 503 are constructed of metal (e.g., a conductive sheet). In some cases, the conductive sheet can have a thickness between 0.01 inches and 0.03 inches. In other implementations, the radiating element 501 and/or ground connection 503 could be constructed out of several rigid PCB portions or a single flex circuit PCB (e.g., supported by the radome 404 or another RF-transparent supporting structure). For example, the formed three-dimensional multi-band radiator portions 500 described with reference to FIGS. 10A-10J can be supported by PCB structures, sheet metal, or other conductive surfaces that hold their three-dimensional shape, configured and adapted to be housed within the radome 404 along with other multi-band radiator portions (e.g., other multi-band radiator portions 500). The three-dimensional multi-band radiator portions can be paired with one or more formed ground plane(s), such as the ground plane 220, that can permit a frequency range of 450 MHz to 8 GHz, which can provide a wider range of frequencies than antenna systems currently known in the art, with improved cost effectiveness and simplicity of manufacture. The multi-band radiator portion 500 allow for the antenna to be compact, making it ideal for compact 3GPP or other telecommunication transmitters, in some implementations.

According to some implementations, when the multi-band radiator portion 500 are configured as PCB portions, a tab and slot configuration in the PCB material is used to mechanically locate the individual PCB portions. When appropriate, in some implementations the tab and slot arrangements are then soldered. The soldering process can be used to provide a mechanical and/or electrical connection between the individual PCB portions or one or more sheet metal portions. In some implementations, there are electrically conducting features on one surface of the PCB support material. In other implementations, both sides of the PCB support material are used to for supporting the electrically conducting features. The same surface of any one particular surface of the PCB support material can have separate electrically conducting features that perform different functions for the multi-band antenna system or for an individual multi-band radiating element. In other implementations, one or more sheet metal portions can be configured with optional portions of electrically non-conductive material to provide a similar form and function to that of a PCB portion. The use of mechanical threaded fasteners, heat stakes, keyhole slots, pressure sensitive adhesive, soldering, interlocking, and other coupling techniques may be exploited to couple portions of the multi-element multi-band antenna. These coupling techniques are used to firmly hold structures and components in place and/or in contact with one another. In some implementations, the coupling techniques provide an important role in establishing and maintaining a direct electrical connection between two components. In other implementations, the coupling techniques are used to establish firm contact between two surfaces that are electrically conductive. In some implementations, the coupling techniques provide structural integrity between one or more components where one or more portions is electrically non-conductive. In some implementations, one or more of the radiating elements are electromagnetically excited by an individual coaxial transmission line (e.g., one coaxial transmission line for each of the radiating elements). In other implementations, the one or more of the radiating elements are electromagnetically excited by a microstrip, stripline, conductor backed coplanar waveguide, parallel plate, twin lead, wire above a groundplane, or other suitable microwave or telecommunication transmission line.

Referring first to FIGS. 10B-10F, various views of the multi-band radiating element 501 are shown. The multi-band radiating element 501 can define a three-dimensional radiating portion that includes several unique portions. The geometry of these unique portions are configured in a way that the radio frequency energy that is radiated by the multi-band radiator portion 500 has an intended direction that is nearly parallel to a groundplane that the multi-band radiator portion 500 is coupled to (e.g., the ground plane 220). When one or more multi-band radiator portions 500 are incorporated into the multi-band multi-element antenna, a radiation intensity that is somewhat stable around its circumference is a typical requirement for the radiation profile for antennas servicing customer premises equipment. This is radiation that is in the same plane or only slightly above the plane of the first groundplane and of somewhat equal intensity at a fixed radial distance away from multi-element multi-band antenna 100 of FIG. 2A in the plane of the first groundplane 220. This type of radiation pattern is known as omni-directional for those familiar with wireless telecommunication technology.

With continued reference to FIGS. 10B-10F, the geometry of the multi-band radiator portion 500 can allow for close proximity spacing of other radiating elements of the multi-band multi-element antenna on the ground plane. To accommodate this close spacing, the height of the multi-band radiating element 501 can be greater than other three-dimensional inverted F antennas. For example, the multi-band radiating element 501 may have a greater height than the radiating element 101′ of at least FIG. 3A. To obtain close proximity spacing between the radiating elements of the multi-band multi-element antenna 100 on the ground plane 220, the geometry of the multi-band radiating element 501 has several unique features. As shown in FIG. 10C, the multi-band radiating element 501 of the multi-band radiator portion 500 can include a feed portion 519, a first low-band radiating portion 525 and/or a second low-band radiating portion 529. The multi-band radiating element 501 can also include one or more arms 527. The one or more arms 527 can be configured to radiate above the low-band. Accordingly, the arms 527 may be referred to as “high-band radiating portions.” For example, the one or more arms 527 can be configured for radiation in the mid-band and/or in the C-band. In the illustrated example, the multi-band radiating element 501 includes two arms 527. In other implementations, more or fewer arms 527 are possible. Further, in other implementations, the arms 527 or additional/alternative arms can be included in the radiating element 501 and configured for radiation in the high band Wi-Fi band. The illustrated example of the multi-band radiating element 501 does not include secondary arms. However, in some implementations, the multi-band radiating element 501 may include additional arms that are similar or identical to the secondary arms 137′ of the radiating element 101′ of at least FIG. 3A. The feed portion 519 can extend from the bottom of the first low band radiating portion 525. The first low band radiating portion 525 can include one or more mounting features 517a (e.g., holes) to facilitate mounting the multi-band radiating element 501 to the ground plane 220. For example, as shown in FIG. 10A, the holes 517a can receive fasteners 505 to couple the multi-band radiating element 501 to the mounting portion 502. The mounting portion 502 can then be coupled to the ground plane (e.g., using additional fasteners). The first low band radiating portion 525 can extend substantially vertically from the ground plane. Accordingly, in some implementations, the first low band radiating portion 525 can be an upright portion of the radiating element 501. The upright portion 525 can have a smaller width than other antennas. For example, the upright portion 525 may have a smaller width than the upright low band radiation portion 125′ of the radiating element 101′ of FIG. 3A. The upright portion 525 can have a larger height than width. In some implementations, the upright portion 525 can have a height to width ratio that is 2:1 or greater. The upright portion 525 can include a coupling point 531. The coupling point 531 can be used to couple the radiating element 501 to the ground portion 503 (e.g., in a similar or identical manner as the slots 131′ of the multi-band radiator portion 100′). The upright portion 525 can be used for all portions of the desired frequency band of operation to support the radio frequency requirements for the desired frequency band of operation.

The radiating element 501 can include one or more connecting portions 541 for connecting the upright portion 525 to the arms 527. For example, the radiating element 501 can include a first connecting portion 541 for connecting a left arm 527 to the upright portion 525 and a second connecting portion 541 for connecting a right arm 527 to the upright portion 525. With reference to FIG. 10E, the connecting portions 541 can extend a short distance from the upright portion 525 to reduce the overall width of the radiating element 501. In the illustrated example, the arms 527 extend away from the upright portion 525. For example, a greater than 90-degree angle is defined between each arm 527 and the upright portion 525. The arms 527 can extend in substantially the same direction that the upright portion 525 faces. In some implementations, the arms 527 can extend at an angle away from the upright portion 525. The arms 527 can initially extend substantially horizontally from the upright portion 525. The arms 527 can include one or more bend portions. For example, as shown in FIG. 10D, each arm 527 can include a first arm portion 533 that extends from the connecting portion 541 and a second arm portion 535 that extends from the first arm portion 533. The second arm portion 535 can extend approximately vertically from the first arm portion 533. When multiple arms 527 are included, as in the illustrated example, the arms 527 can be similar or identical except that the left arm 527 extends from the left side of the upright portion 525 and the right arm 525 extends from the right side of the upright portion 525. The arms 527 may have a shorter height than the upright portion 525. The second arm portion 535 of the arms 527 can be used to collectively support radiation in the 1.6 GHz to 8 GHz frequency band for the arms 527.

The radiating element 501 can optionally include the second low band radiator portion 529 to aid in accomplishing radiation in the low-band (e.g., approximately 600 MHz to 900 MHz). The second low band radiating portion 529 can extend from the top of the upright portion 525. In some implementations, the second low band radiating portion 529 can be a head radiating element and can extend at a substantially perpendicular angle from the upright portion 525. The length of low band radiator portion 529 is significantly shorter than other radiating structures to accommodate the closer spacing of neighboring antenna elements. For example, the second low band radiating portion 529 may have a shorter length than the second low band radiation portion 129′ of the radiating element 101′ of FIG. 3A. The additional height of upright portion 525 allows for a shorter than typical second low band radiating portion 529. The ratio and orientation of all portions of radiating element 501 allow for both dominate and higher order modes to support a somewhat omni-directional radiation characteristic for the multi-band radiator portion 500.

Referring now to FIGS. 10G-10J, various views of the ground connection 503 of the multi-band radiator portion 500 are shown. In the illustrated examples, the grounding portion 503 is made of sheet metal. In other implementations, one or more PCB portions with electrically conducting surfaces on one or more sides or layers may be used for the ground connection 503. In this implementation, coupling points 571 and 583 are present to electrically couple to the ground plane (e.g., the ground plane 220) and radiating element 501, respectively. The width, thickness and height of portions 573 and 575 are selected so that the desired radiation pattern characteristics are maintained while providing an impedance match between the multi-band radiating element 501 and the characteristic impedance of the radio frequency transmission lines that connect the radio that is part of the 5G wireless communication link to the multi-element multi-band antenna. The ground connection 503 can function in a similar manner as the ground connection 103′ of the multi-band radiator portion 100′ of FIG. 3B.

In some implementations, different antennas may be incorporated into any of the antenna assemblies described herein. For example, an off-the-shelf antenna in its full package (e.g., with a radome and secured to a base and/or ground plane) can replace the multi-band multi-element antenna (e.g., the multi-band multi-element antenna 100) of the antenna assemblies described herein, typically resulting in reduced performance. Such an off-the-shelf antenna could be positioned or secured to a ground plane (e.g., the ground plane 220) and positioned beneath a radome and/or within a lid compartment and/or a base compartment of an antenna case unit of the respective antenna assembly.

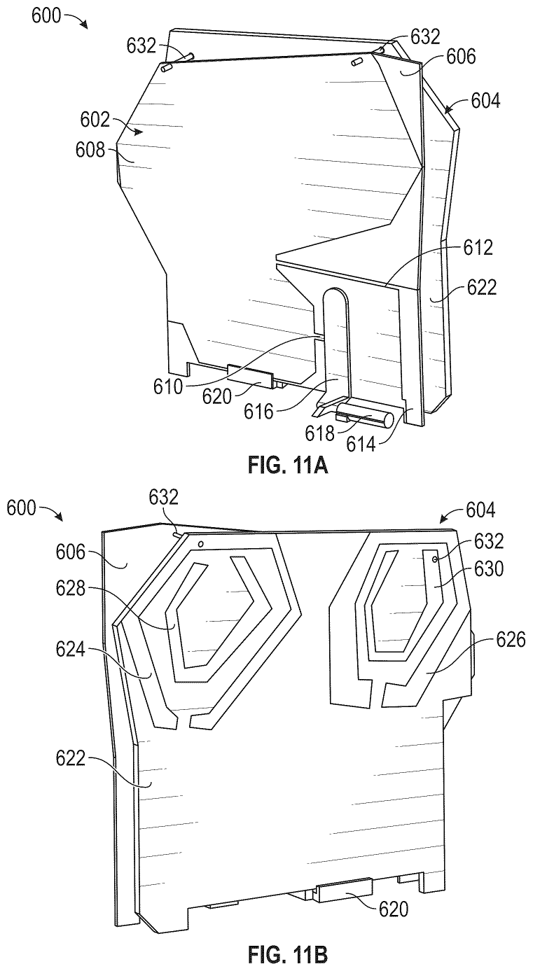

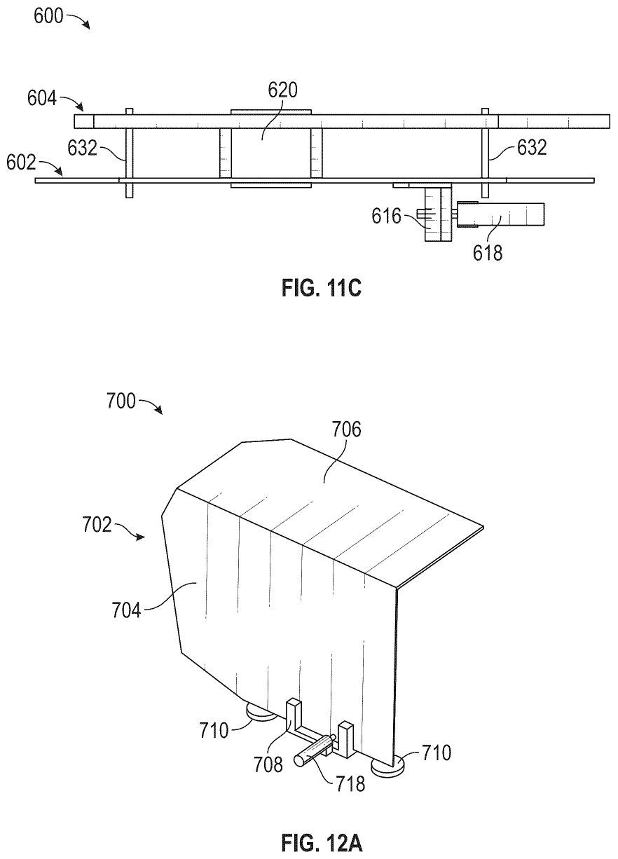

FIGS. 11A-15B illustrate various views of different multi-band antennas that can form part of any of the multi-band multi-element antennas described herein (e.g., the multi-band multi-element antenna 100 of the antenna assembly 204, the multi-band multi-element antenna portion 101′, etc.). In FIGS. 11A-15B, particular reference is made to various components of the antenna assembly 204 and how those components interact with the various multi-band antennas. However, it is recognized that multi-band antennas of FIGS. 11A-15B may be integrated into any of the antenna assemblies disclosed herein. In particular, one or more of the multi-band radiator portions 101′ and/or multi-band radiator portions 100 of the antenna assemblies may be replaced with one or more of multi-band antennas of FIGS. 11A-15B.

FIGS. 11A-11C illustrate various views of a multi-band antenna 600 that can be included in any of the antenna assemblies described herein, in accordance with some aspects of this disclosure. The multi-band antenna 600 can be mounted to the ground plane. The multi-band antenna 600 can be a 3D or 2.5D inverted F antenna configured to be utilized with a ground reference, such as the ground plane. The multi-band antenna 600 can include a first radiating portion 602 and a second radiating portion 604. In the illustrated example, the first radiating portion 602 is in the form of a first conductive portion 608 etched onto a first PCB portion 606. In other implementations, the first radiating portion 602 and/or the second radiating portion 604 can be sheet metal (e.g., with plastic supports). The multi-band antenna 600 can include a grounding portion configured to connect the first radiating portion 602 to the ground plane. The grounding portion can be defined by a first grounding portion 612 that extends from the first conductive portion 608 in the horizontal direction and a second grounding portion 614 that extends from the first grounding portion 612 in the vertical direction along the first PCB portion 606 to the ground plane. As such, the grounding portions 612, 614 can electrically connect the first conductive portion 608 to the groundplane, e.g. groundplane 220.

As shown in at least FIG. 11B, the second radiating portion 604 can be in the form of a plurality of conductive portions 624, 626, 628, and 630 etched onto a second PCB portion 622. The conductive portions 624 and 630 of the second radiating portion 604 can be electrically connected to the first conductive portion 608 of the first radiating portion 602. For example, shorting pins 632 can be used to establish the electrical connection from the first PCB portion 606 to the second PCB portion 622 (see e.g., FIG. 11C). The shorting pins 632 can be in the form of electrically conductive cylinders. The additional conductive portions 626 and 628 can be electromagnetically coupled to their neighboring conductive portions, for example, the conductive portion 630 and the conductive portions 624 respectively. The conductive portions 626, 628 can provide additional radiation that may not always be required.

Referring back to FIG. 11A, the multi-band antenna 600 can include a feed arm 616. The feed arm 616 can be in the form of an electrically conductive sheet metal portion, which forms the initial portion of the radiating portion of the multi-band antenna 600. The feed arm 616 can be electrically connected to the first conductive portion 608 of the first radiating portion 602 via feed line 610. The multi-band antenna 600 can be configured to connect to a coaxial cable 618. For example, the center conductor of the coaxial cable 618 can be electrically coupled to the multi-band antenna 600 via the feed arm 616. The outer conductor of the coaxial cable 618 can be electrically connected to a coax feed point of the ground plane. In the illustrated example, the multi-band antenna 600 is supported by a non-conductive support portion 620, which can be mechanically coupled to the ground plane.

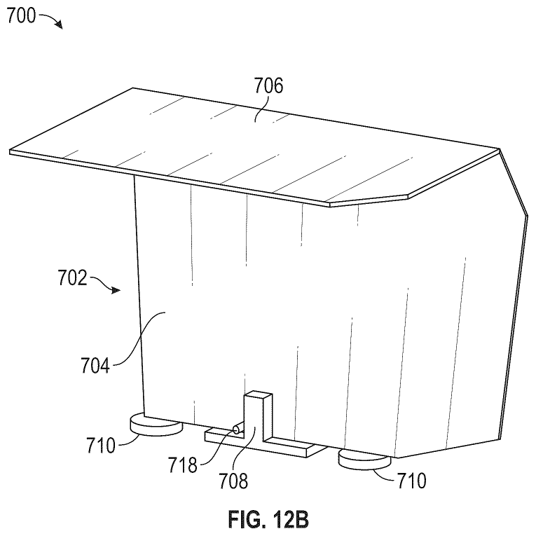

FIGS. 12A-12B illustrate various views of a multi-band antenna 700 that can be included in any of the antenna assemblies described herein, in accordance with some aspects of this disclosure. The multi-band antenna 700 can be a bent monopole antenna configured to be mounted to a ground plane (e.g., the ground plane 220). The multi-band antenna 700 includes a radiating element 702. The radiating element 702 can be bent to define an upright portion 704 and a head portion 706. The bend in the radiating element 702 can allow the multi-band antenna 700 to fit under a fixed radome height and/or within the lid of a case system. When the multi-band antenna 700 is incorporated into a multi-band multi-element antenna system, the ground plane may be modified to accommodate the multi-band antenna 700. For example, the ground plane 220 may include openings configured to receive mechanical supports 710. As such, the openings in the ground plane 220 can have a similar shape to the mechanical supports 710 (e.g., circular). The mechanical supports 710 can be non-conductive. The mechanical supports 710 can be coupled to a lower edge of the upright portion 704 of the radiating element 702 to electrically insulate the radiating element 702 from the ground plane. The multi-band antenna 700 can be configured to connect to a coaxial cable 718. For example, the center conductor of the coaxial cable 718 can be electrically coupled to the radiating element 702. The outer conductor of the coaxial cable 718 can be electrically connected to a coax feed point of the ground plane 220. In the illustrated example, the multi-band antenna 700 is further supported by a non-conductive support portion 708, which can be mechanically coupled to the ground plane.

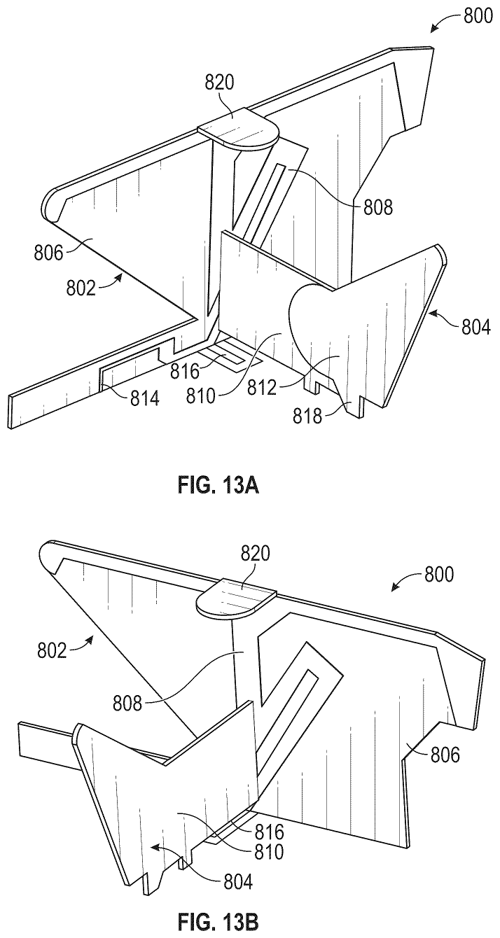

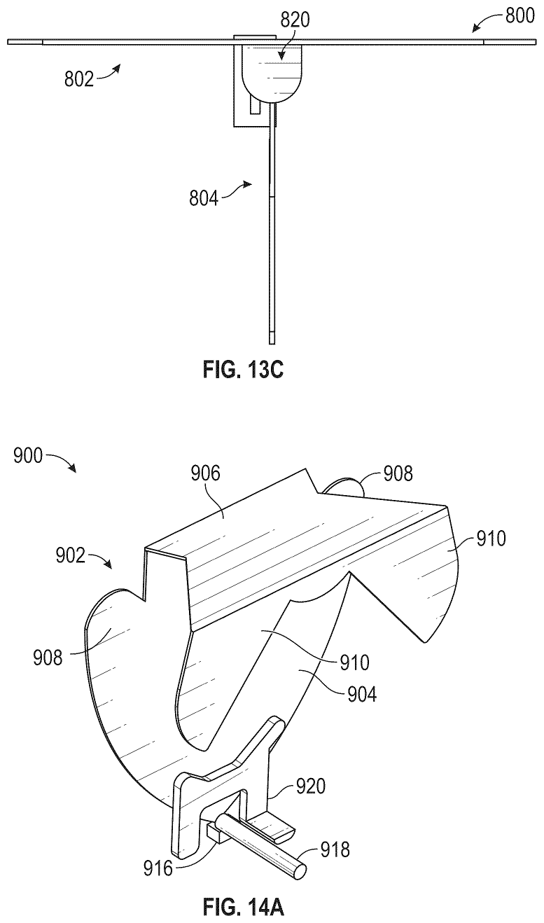

FIGS. 13A-13C illustrate various views of a multi-band antenna 800 that can be included in any of the antenna assemblies described herein, in accordance with some aspects of this disclosure. The multi-band antenna 800 can be mounted to the ground plane 220. The multi-band antenna 800 can be a printed inverted F antenna (“PIFA”). The multi-band antenna 800 can include a first radiating portion 802 and a second radiating portion 804. In the illustrated example, the first radiating portion 802 is in the form of a first conductive portion 808 etched onto a first PCB portion 806. In other implementations, the first radiating portion 802 and/or the second radiating portion 804 can be sheet metal (e.g., with plastic supports). The first radiating portion 802 can be the directly fed portion of the PIFA. For example, a grounding portion 814 can extend from the first conductive portion 808 to electrically connect the first conductive portion 808 to the ground plane 220. A microstrip line 816 can extend from the radio attaching the grounding portion 814 to the multi-band antenna 800. The first radiating portion 802 can include a top portion 820. The top portion 820 can extend orthogonally to the first PCB portion 806. A lower surface (not shown) of the top portion 820 can include a conductive portion that, along with the unequal length arms of the first conductive portion 808 along the first PCB portion 806, can allow for increased impedance bandwidth by having complementary higher order mode performance due to the unequal length arms of the first conductive portion 808.

The second radiating portion 804 can be electromagnetically coupled to the first radiating portion 802. In the illustrated example, the second radiating portion 804 is in the form of a second conductive portion 812 etched onto a second PCB portion 810. The second conductive portion 812 can be electrically coupled to the ground plane 220 at the ground connection 818. The second conductive portion 812 of the second radiating portion 804 can be orthogonal to both the first conductive portion 808 and the top portion 820 of the first radiating portion 802. The second conductive portion 812 can assist with the high-band performance of the multi-band antenna 800.

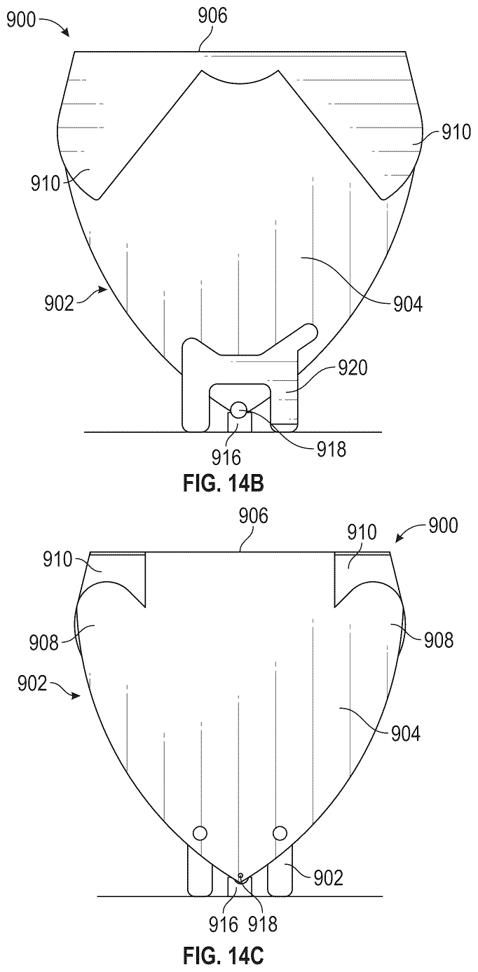

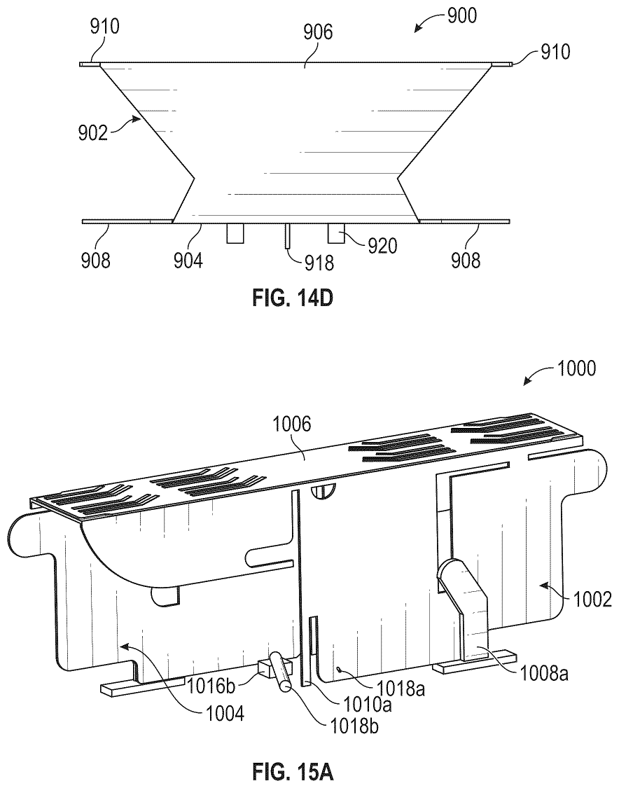

FIGS. 14A-14D illustrate various views of a multi-band antenna 900 that can be included in any of the antenna assemblies described herein, in accordance with some aspects of this disclosure. The multi-band antenna 900 can be a bent monopole antenna configured to be mounted to a ground plane (e.g., the ground plane 220). The multi-band antenna 900 includes a radiating element 902. The radiating element 902 can be bent to define an upright portion 904 and a head portion 906. The bend in the radiating element 902 can allow the multi-band antenna 900 to fit under a fixed radome height and/or within a compartment and/or lid of an antenna case unit. The bend can still allow the radiating element 902 to resonate down to 600 MHz. The radiating element 902 can include one or more first arms 908. The first arms 908 can extend from or form part of the upright portion 904. In some implementations, the first arms 908 can be co-planar to the upright portion 904. The radiating element 902 can include one or more second arms 910. The second arms 910 can extend from or form part of the head portion 906. As shown in FIG. 14D, in the illustrated example, the one or more second arms 910 can extend parallel to the upright portion 904 and may be at an angle and/or orthogonal to the head portion 906. The first arm 908 and the second arms 910 can assist with the input impedance at higher portions of the frequency band. The multi-band antenna 900 can be configured to connect to a coaxial cable 918. For example, the center conductor of the coaxial cable 918 can be electrically coupled to the radiating element 902 at its feed point. The outer conductor of the coaxial cable 918 can be electrically connected to a coax feed point of the ground plane. In the illustrated example, the multi-band antenna 900 is supported by a non-conductive support portion 920, which can be mechanically coupled to the ground plane. The support portion 920 can include heat stake posts that extend into corresponding openings in the upright portion 904.

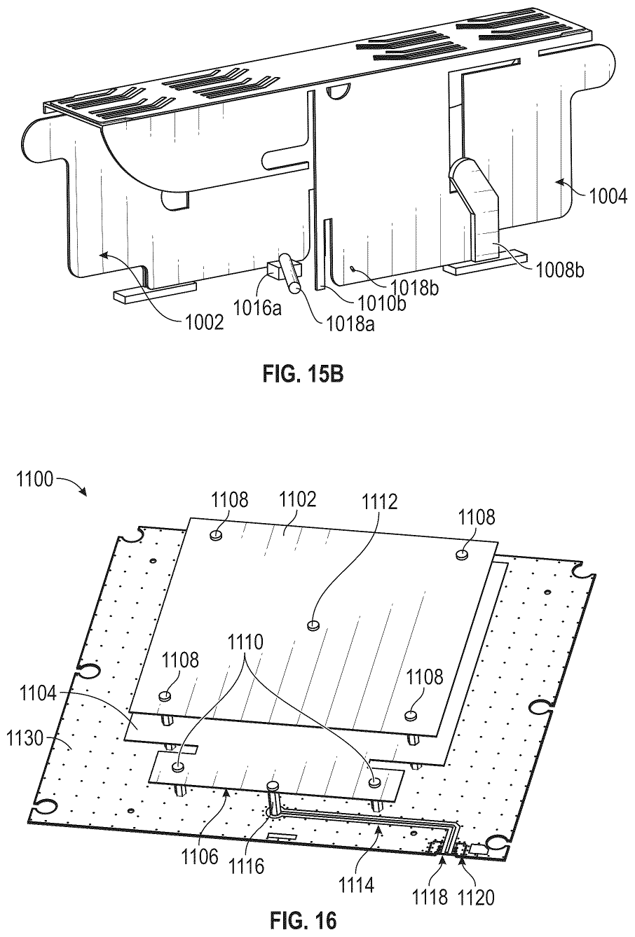

FIGS. 15A-15B illustrate various views of a multi-band antenna 1000 that can be included in any of the antenna assemblies described herein, in accordance with some aspects of this disclosure. The multi-band antenna 1000 can be mounted to the ground plane 220. The multi-band antenna 1000 can comprise two 3D inverted F antennas. For example, the multi-band antenna 1000 can include a first inverted F antenna 1002 and a second inverted F antenna 1004. The first inverted F antenna 1002 and the second inverted F antenna 1004 can be similar or substantially identical to each other. The multi-band antenna 1000 can include a PCB support 1006 that can be coupled to the tops of and provide mechanical support for both inverted F antennas 1002, 1004. The first inverted F antenna 1002 can be further supported by a non-conductive support 1008a. Similarly, the second inverted F antenna 1004 can be further supported by a non-conductive support 1008b. The multi-band antenna 1000 can be configured to connect to coaxial cables 1018. For example, the center conductor of a first coaxial cable 1018a can be electrically coupled to the first inverted F antenna 1002 at its feed point and the center conductor of a second coaxial cable 1018b can be electrically coupled to the second inverted F antenna 1004 at its feed point. The outer conductors of the coaxial cables 1018a, 1018b can be electrically connected to coax feed points of the ground plane 220. Each of the inverted F antennas 1002, 1004 can include a grounding point 1010a, 1010b respectively that can be electrically connected to the ground plane.

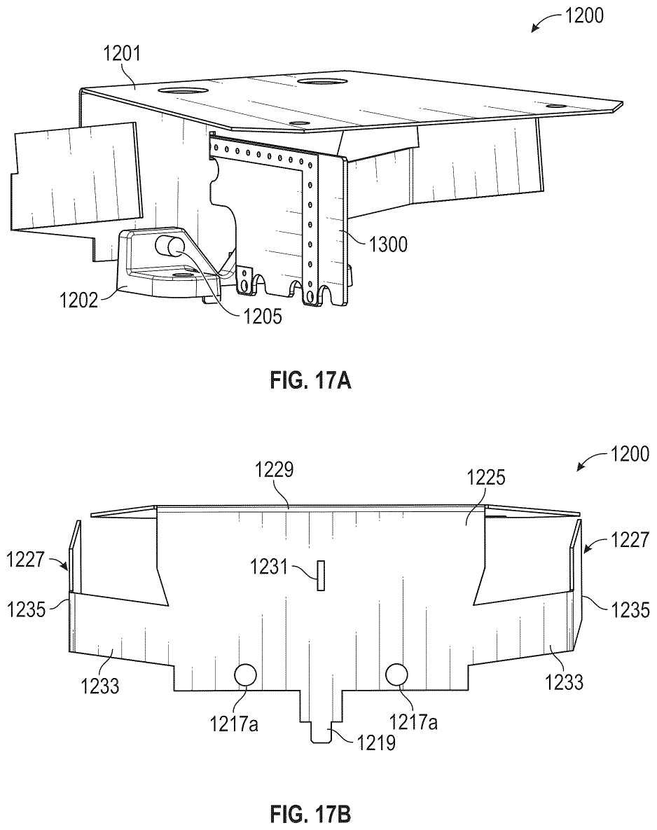

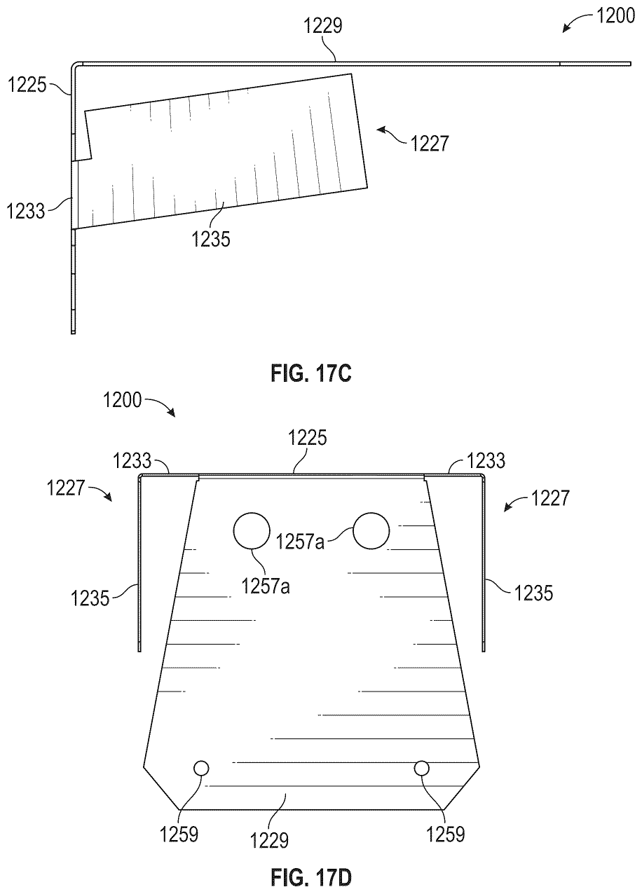

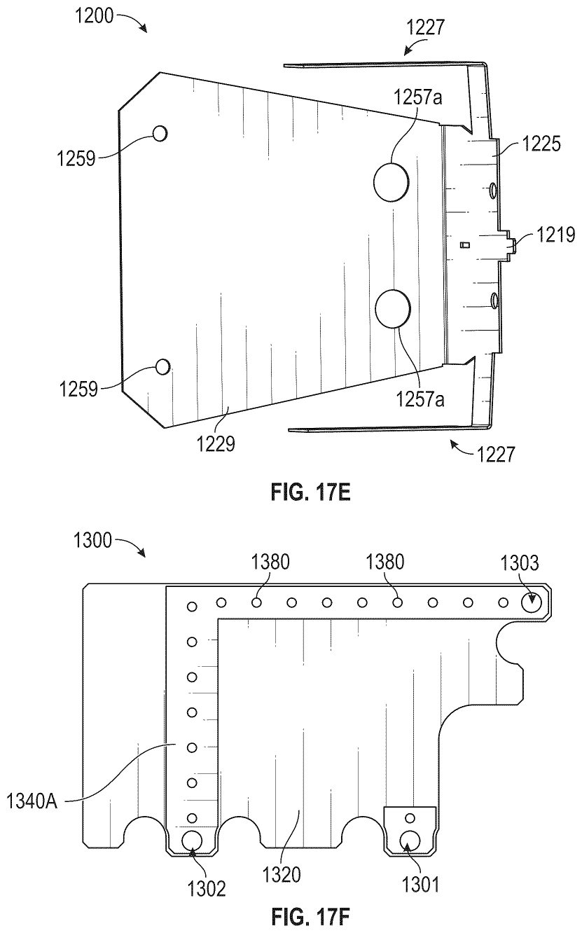

FIGS. 17A-17G illustrate various views of components of a multi-band radiator portion 1200, in accordance with some aspects of this disclosure. Some features of the multi-band radiator portion 1200 are similar or identical to features of the multi-band radiator portion 100′ in at least FIGS. 3A-3H. Thus, reference numerals used to designate the various features or components of the multi-band radiator portion 100′ are identical to those used for identifying the corresponding features of the components of the multi-band radiator portion 1200 in FIGS. 17A-17G, except that the numerical identifiers for the multi-band radiator portion 1200 begin with a “12” instead of a “1” and do not end with a “prime”. Therefore, the structure and description for the various features of the multi-band radiator portion 100 and the operation thereof as described in at least FIGS. 3A-3H are understood to also apply to the corresponding features of the multi-band radiator portion 1200 in FIGS. 17A-17G, except as shown and described differently. Additional disclosure regarding antenna systems and assemblies including the multi-band radiator portions 1200 of FIGS. 17A-17G is further described in U.S. Provisional Application No. 63/638,330, filed Apr. 24, 2024, entitled “Antenna Systems,” and U.S. Provisional Application No. 63/676,268, filed Jul. 26, 2024, entitled “Antenna Systems.” The entire contents of both are hereby incorporated by reference herein in their entireties. The disclosure and Figures in U.S. Provisional Application No. 63/638,330 and in U.S. Provisional Application No. 63/676,268 can be used in connection with the disclosure and Figures described and shown herein.

One or more multi-band radiator portions 1200 can form part of any of the multi-band multi-element antennas described herein (e.g., the multi-band multi-element antenna 100 of the antenna assembly 204, the multi-band multi-element antenna portion 101′, etc.). In FIGS. 17A-17G, particular reference is made to various components of the antenna assembly 204 and how those components interact with the multi-band radiator portion 1200. However, it is recognized that one or more multi-band radiator portions 1200 may be integrated into any of the antenna assemblies disclosed herein. In particular, one or more of the multi-band radiator portions 100′ and/or multi-band radiator portions 100 of the antenna assemblies 204, etc., may be replaced with one or more of the multi-band radiator portions 1200. In some implementations, the multi-band radiator portion 1200 may be incorporated into a different portion of the antenna assembly 204 than the multi-band radiator portions 100, 100′. For example, one or more multi-band radiator portions 1200 may be mounted to a vertical ground plane that is supported on a wall and/or side of a compartment and/or lid within an antenna unit.

Each multi-band radiator portion 1200 can include a multi-band radiating element 1201 and a ground connection 1300 (also referred to herein as a “grounding portion”). The ground connection 1300 is configured to couple the multi-band radiating element 1301 to a ground plane, such as the ground plane 220 or another ground plane of an antenna assembly. The multi-band radiator portion 1200 differs from the illustrated example of the multi-band radiator portion 100′ in that the ground connection 1300 is formed on a PCB 1320, as described further below. FIG. 17A shows a perspective view of the multi-band radiating element 1201 and the ground connection 1300 coupled together and secured to a mounting portion 1202. As shown in FIG. 17A, fasteners 1205 can be used to secure the multi-band radiating element 1201 to the mounting portion 1202. The fasteners 1205 can also be used to secure the mounting portion 1202 to the associated ground plane. FIGS. 17B-17E illustrate assorted views of the multi-band radiating element 1201. FIGS. 17F and 17G illustrate a first side view and a second side view the ground connection 1300. It is recognized that the multi-band radiator portion 1200 described herein is just one example of multi-band radiator portions that can be included in the antenna assemblies described herein. In other implementations, different multi-band radiator portions can be included. In the illustrated implementation, the radiating element 1201 is constructed of metal (e.g., a conductive sheet). In some cases, the conductive sheet can have a thickness between 0.01 inches and 0.03 inches. In other implementations, the radiating element 1201 could be constructed out of several rigid PCB portions or a single flex circuit PCB (e.g., supported by a radome, a lid, a base, a case, and/or another RF-transparent supporting structure). For example, the multi-band radiator portion 1200 may be constructed of PCB material, sheet metal, metalized plastic, or other such materials that can be configured and adapted to be used for communication between about 450 MHz to about 8 GHz.

As noted above, the multi-band radiator portion 1200 can be configured for use with a ground plane, such as the ground plane 220 or another ground plane. In some implementations, the associated ground plane can be constructed from one or more types of PCB material, sheet metal with non-conductive spacers of plastic, foam, ceramic, and metalized plastic. Transmission lines utilized with the multi-band radiator portion 1200 can be microstrip, stripline, conductor back co-planar waveguide, parallel plate waveguide, wire above a groundplane, coaxial cables or other such materials of construction that can be configured and adapted to be used for communication between about 450 MHz to about 8 GHz. According to some implementations, the non-conductive support portions and/or PCB portions of the groundplanes and/or radiating elements can be made of FR4, fiberglass reinforced epoxy, polyester reinforced epoxy, or other similar PCB support material that may have high performance radio frequency properties and that can support electrically conductive features of one or more radiating portions for one or more elements on its structure on one or both side of the support material.

According to some implementations, a tab and slot configuration in the PCB material can be used to mechanically locate the individual PCB portions, sheet metal portions, and/or other electromagnetic structures of the multi-band radiator portion 1200. When appropriate, in some implementations, the tab and slot arrangements are then soldered. The soldering process is used to provide a mechanical and electrical connection between the individual PCB portions. Any sheet metal portion(s) of the multi-band radiator portion 1200 may be supported with non-conductive material for the spacing and mechanical support between the sheet metal and the groundplane. In some implementations, the etched electrically conducting features can be on one surface of the PCB support material. In other implementations, both sides of the PCB support material are used for supporting the electrically conducting features. In other implementations, sheet metal or other construction material that is electrically conductive that is supported by non-conductive material to support the electrically conducting features is used in the multi-band radiator portion 1200.

In some implementations, mechanical threaded fasteners can be used with the multi-band radiator portion 1200 or to couple the multi-band radiator portion 1200 to another structure (e.g., the ground plane 220 and/or another ground plane, base, and/or support structure). The fasteners can be used to firmly hold structures and components in place and in contact with one another. Some of the mechanical features of the antenna assemblies described herein can be formed with a heat staking process to couple different portions together. In some implementations, the mechanical fasteners provide an important role in establishing and maintaining a direct electrical connection between two components. In other implementations, the mechanical fasteners are used to establish firm contact between two surfaces that are electrically conductive. In some implementations, the mechanical fasteners provide structural fastening between one or more components that have wholly non-conductive components. The use of mechanical threaded fasteners, heat stakes, keyhole slots, pressure sensitive adhesive, soldering, interlocking, and other coupling techniques may be utilized to couple portions of the multi-element multi-band antennas described herein. These coupling techniques are used to firmly hold structures and components in place and in contact with one another.

When multiple multi-band radiator portions 1200 are included in the antenna assembly 204, the various multi-band radiator portions 1200 may be rotated in orientation to provide radiation in different polarizations with reference to the direction normal to the groundplane (e.g., the ground plane 220 and/or another ground plane). For example, the orientation of the multi-band radiator portions 1200 may correspond with a 45-degree polarization with respect to vertical (or other types of polarizations as applicable).

In some implementations, the multi-band radiator portion 1200 can be configured to be utilized with one or more ground planes that can be rigid PCBs with independent conductor back co-planar waveguide transmission lines that are electrically coupled to individual multi-band radiator portions 1200. In some implementations, the multi-band radiator portions 1200 can be mechanically coupled to an associated ground plane through a plurality of electrically non-conductive connector portions (not shown). For example, as shown in FIG. 17D, the multi-band radiating element 1201 can include one or more openings 1259 in the second low-band radiation portion 1229 configured to receive the non-conductive connector portions. The connector portions can be secured to the multi-band radiating element 1201 with a heat staking process, in one example. The coupling of the connector portions may be accomplished with other manufacturing processes such as a snapping process, threaded fastener process, a key-hole process, an interference staking process, or other suitable mechanical coupling process. The coupling of multi-band radiating element 1201 to the groundplane (e.g., via the connector portions) provides a secure connection that enables a reliable mechanical connection to facilitate a stable electrical connection between the multi-band radiator portions 1200 and their associated transmission line excitations.

In the illustrated example, the multi-band radiator portion 1200 includes a multi-band radiating element 1201 comprised of a sheet metal portion as well as ground connection 1300 comprising a PCB with electrically conductive features on both surfaces. For example, FIGS. 17F and 17G illustrate both sides of the ground connection 1300. The ground connection 1300 may function as an impedance matching component and assist with the radiation characteristics of the fundamental resonance as well as higher order modes. The ground connection 1300 may be made of one or more rigid substrate materials (e.g., FR4) that act as the non-conductive support material and may include an electrically conductive portion on one or more sides or other suitable electrically conductive material for the electrically conductive features on the desired sides or surfaces. As such, the ground connection 1300 may be a one layer or a two layer or a multi-layer PCB of standard processing for the PCB industry. The ground connection 1300 may provide one portion of a multi-portion structure for the multi-band radiator portion 1200. In some implementations, a sheet metal portion may be used to realize the ground connection 1300 (e.g., similar to the ground connection 103, the ground connection 103′, and/or the like).

Referring back to FIGS. 17B-17E, the multi-band radiating element 1201 is comprised of several unique portions. The geometry of these unique portions is configured in a way that the radio frequency energy that is radiated by the multi-element multi-band antenna including the multi-band radiator portion 1200 (e.g., the multi-band multi-element antenna 100) has an intended direction that is normal/perpendicular to groundplane the multi-band radiating element 1201 is coupled to. Accordingly, it may be desirable to mount one or more of the multi-band radiator portions 1200 to a ground plane of a door, lid, and/or a base. Having this predominate radiation direction or orientation for the multi-band radiator portions 1200 may provide certain benefits and differs from traditional multi-band multi-element antennas. The typical radiation direction is in a directional that is the same as, co-planar, or only slightly above the plane of the groundplane. To obtain the radio frequency radiation direction that is normal to the groundplane or otherwise, known as a directional radiation pattern, the geometry of the radiator portion multi-band radiating element 1201 has been adjusted compared to the other multi-band radiating elements described herein (e.g., the radiating element 101′, and/or the like). In the illustrated implementation, the feed portion 1219 has been adjusted (e.g., compared to the feed points 119′ of the radiating elements 101′) to accommodate the transmission line feed from a conductor backed co-planar waveguide. The feed portion 1219 can be adjusted to accommodate the feed from a microstrip, coax, stripline, parallel plate, a waveguide of various cross sections, twin lead, wire above a groundplane, and/or other transmission line structures in the telecommunications and microwave industries. In FIG. 17B, upright portion 1225 can be used for all portions of the desired frequency band of operation to support the radio frequency radiation. In some examples, the upright portion 1225 has a greater width than height. For example, the upright portion 1225 can have a width to height ratio of 2:1 or greater and may be a compact radiating structure when compared to other implementations of three-dimensional inverted F antennas. Such a compact radiating structure can provide numerous advantages, including reducing the overall height of an antenna assembly incorporating the multi-band radiator portion 1200, as the height of the multi-band radiator portions can be a limiting factor in terms of total assembly height particularly within a lid and/or other compartment of a case antenna unit. Reduced height can be desirable for visual appearance, operations in high wind loads, etc. The upright portion 1225 may include one or more mounting features. The one or more mounting features can be configured to allow the upright portion 1225 to be coupled to the desired ground plane. The upright portion 1225 may include a slot 1231 that can be configured to receive the grounding portion 1300. Upright portion 1225 also supports mounting features 1217a for support portion 1202. As shown in FIGS. 17B and 17C, the multi-band radiating element 1201 can include two arms 1227. The arms can include main arm portions 1235 and connecting portions 1233. The connecting portions 1233 provide coupling between upright portion 1225 and main arm portions 1235 to assist in radiation in the 1 GHz to 8 GHz frequency band. As shown in at least FIG. 17C, main arm portions 1235 can have a significantly shorter length and can be positioned closer to the groundplane than the other antennas. For example, the arms 1227 can have a shorter length than arms 127 of the radiating element 101 and/or a shorter length than the arms 127′ of the radiating element 101′. Additionally, the second low-band radiation portion 1229 of the multi-band radiating element 1201 can be significantly longer in the length and closer to the groundplane than the other antennas. For example, compared to second low band radiation portion 129′ of the radiating element 101′. Grounding portion 1300 is thinner, rotated in orientation, and further away from the groundplane than the ground connection in other antennas (e.g., the ground connection 103′ of FIG. 3B, etc.). These arrangements can contribute to accomplishing the change in predominate radiation direction. This change in the ratio of lengths between the high band and low band portions impacts the higher order mode radiation from the portions of the three-dimensional radiating element 1200 and allows for the dramatic change in the direction of predominate radio frequency radiation. In this manner, when one or more multi-band radiator portions 1200 are incorporated into an antenna assembly (e.g., mounted to a ground plane 220 and/or on another ground plane, base, and or support portion, including vertical and/or horizontal portions, for example, within a lid or compartment of an antenna case), the antenna assembly may be configured to produce a radiation pattern perpendicular to the ground plane. In some examples, such an implementation of the antenna assembly may produce a radiation pattern that is either omni-directional or directional when the antenna assembly is configured in accordance with a desired radiation performance criterion based on the geometry considerations of the multi-band radiating element 1201 and ground connection 1300. As shown in FIG. 17D, the second low-band radiation portion 1229 includes two openings 1259 for receiving the aforementioned connectors and clearance features 1257a.

Referring now to FIGS. 17F and 17G, side views of the ground connection 1300 are shown. In this implementation, the grounding portion 1300 is a PCB 1320 with electrically conducting surfaces 1340 on both sides. For example, the first side shown in FIG. 17F includes conducting surface 1340A and the second side shown in FIG. 17G includes conducting surface 1340B (collectively referred to as conducting surfaces 1340). In other implementations, only one side of the PCB 1320 might have an electrically conducting surface 1340 or the PCB 1320 could be a multi-layer PCB with three or more conducting surfaces 1340 or conducting surface 1340 could be a sheet metal portion that may or may not be supported by a non-conducting portion. For example, depending on the particular ground plane, it may be desirable for the ground connection 1300 to be constructed wholly of sheet metal, similar to the ground connection 103′ of FIG. 3B. In this implementation, several plated through holes 1380 are present to electrically connect the two conducting surfaces 1340A, 1340B of the ground portion 1300. The ground connection 1300 can also include coupling points 1301 and 1302 that can be used to establish electrical connection between ground portion 1300 and the associated ground plane. In some implementations, the coupling points 1301, 1302 may extend through the associated groundplane (e.g., ground plane 220 or another ground plane) and an electrical connection may be established between one or both sides of the ground plane and the coupling points 1301, 1302. The ground connection 1300 can include a coupling point 1303 that establishes an electrical connection between ground portion 1300 and multi-band radiating element 1201 (e.g., coupling point 1303 can be received within slot 1231 of the multi-band radiating element 1201). In some examples, the coupling points 1301 and 1302 and/or the coupling point 1303 may be of a size and shape to pass buss wire through. In this manner, the buss wire may pass through one or more of the coupling points 1301, 1302, 1303 to provide electrical connection and/or structural support.

The width, length and height of conductive surfaces 1340 are selected to provide an impedance match and also assist with the radiation characteristics of the fundamental resonance as well as the higher order modes for the radiating element multi-band radiating element 1201 and the characteristic impedance of the radio frequency transmission lines that connect the radio that is part of the 5G wireless communication link to the multi-element multi-band antenna including the multi-band radiator portion 1200 (e.g., the multi-band multi-element antenna 100) as well as the individual radiation elements. In some implementations, the width of the conductive surfaces 1340 may include a first width and a second width. The first width may be positioned along a length portion of the conductive surfaces 1340. The second width may be positioned along the height portion of the conductive surfaces 1340. Each of the first width and the second width may be between about 0.01 centimeters (cm) and about 10.0 cm. The first width and the second width each may be equal to or smaller than about 10 cm. In some implementations, the first width and the second width may be between approximately 0.0 cm and approximately 10.0 cm, for example, between approximately 0.5 cm and approximately 9.5 cm, between approximately 1.0 cm and approximately 9.0 cm, between approximately 1.5 cm and approximately 8.5 cm, between approximately 2.0 cm and approximately 8.0 cm, between approximately 2.5 cm and approximately 7.5 cm, between approximately 3.0 cm and approximately 7.0 cm, between approximately 3.5 cm and approximately 6.5 cm, between approximately 4.0 cm and approximately 6.0 cm, between approximately 4.5 cm and approximately 5.5 cm, between approximately 5.0 cm and approximately 5.0 cm, or any value or range between any of these values or ranges or any value or range bounded by any combination of these values, although values or ranges outside these values or ranges can be used in some cases. In some examples, the first width may be a different value than the second width. For example, the first width may be wider than the second width.

A ratio of the first width to the second width (or of the second width to the first width) can be between approximately 1 and approximately 5, for example, between approximately 1.5 and approximately 4.5, between approximately 2 and approximately 4, between approximately 2.5 and approximately 3.5, between approximately 2 and approximately 2.5, or between approximately 3.5 and approximately 4, or any value or range between any of these values or ranges or any value or range bounded by any combination of these values, although values or ranges outside these values or ranges can be used in some cases.

In some implementations, the height and the length of the conductive surfaces 1340 may be between about 0.0 cm and about 10.0 cm. The height and the length may be equal to or smaller than about 10 cm. In some implementations, the height and the length of the conductive surfaces 1340 may be between approximately 0.0 cm and approximately 10.0 cm, for example, between approximately 0.5 cm and approximately 9.5 cm, between approximately 1.0 cm and approximately 9.0 cm, between approximately 1.5 cm and approximately 8.5 cm, between approximately 2.0 cm and approximately 8.0 cm, between approximately 2.5 cm and approximately 7.5 cm, between approximately 3.0 cm and approximately 7.0 cm, between approximately 3.5 cm and approximately 6.5 cm, between approximately 4.0 cm and approximately 6.0 cm, between approximately 4.5 cm and approximately 5.5 cm, between approximately 5.0 cm and approximately 5.0 cm, or any value or range between any of these values or ranges or any value or range bounded by any combination of these values, although values or ranges outside these values or ranges can be used in some cases. In some examples, the length and the height of the conductive surfaces 1340 may be different values. For example, the height may be greater than the length.

A ratio of the height to the length (or of the length to the height) of the conductive surfaces 1340 can be between approximately 1 and approximately 5, for example, between approximately 1.5 and approximately 4.5, between approximately 2 and approximately 4, between approximately 2.5 and approximately 3.5, between approximately 2 and approximately 2.5, or between approximately 3.5 and approximately 4, or any value or range between any of these values or ranges or any value or range bounded by any combination of these values, although values or ranges outside these values or ranges can be used in some cases.

In some instances, the plated through holes 1380 may be configured to equalize electrical potential across both sides of the ground connection 1300. For example, the grounding portion 1300 may include conductive material on both sides (e.g., conducting surface 1340A on the first side shown in FIG. 17F and conducting surface 1340B on the second side shown in FIG. 17G). In this manner, the conductive material forming the conducting surfaces 1340 may direct a current. When the current flows along the conductive material of the conducting surfaces 1340 of the ground connection 1300, there may be potential difference between both sides of the ground connection 1300. The plated through holes 1380 may allow for the current to pass through for any potential difference to equalize.

In some implementations, when multiple multi-band radiator portions 1200 are included in an antenna assembly, one or more of multi-band radiator portions 1200 can be arrayed together. In such a configuration, fewer RF ports may be required, and this allows for the possibility of a higher antenna gain for the remaining ports. For example, if eight multi-band radiator portions 1200 were included in an antenna assembly and are arrayed in pairs, the antenna assembly can include four RF ports, instead of eight, for the paired multi-band radiator portions 1200. Such a configuration can also result in enhanced performance in a desired direction.

FIG. 16 illustrates a perspective view of a stacked patch antenna 1100 on a ground plane 1130 that can be included in any antenna assembly described herein, in accordance with some aspects of this disclosure. For example, stacked patch antenna 1100 can form part of any of the multi-band multi-element antennas described herein (e.g., the multi-band multi-element antenna 100 of the antenna assembly 204, the multi-band multi-element antenna portion 101′, etc.). In other examples, the stacked patch antenna 1100 may be incorporated into an antenna assembly described herein but may operate separately from the corresponding stacked patch antenna 1100. In FIG. 16, particular reference is made to various components of an antenna assembly and how those components interact with the stacked patch antenna 1100. However, it is recognized that one or more stacked patch antenna 1100 may be integrated into any of the antenna assemblies, antenna systems, and/or antenna units disclosed herein. In some implementations, the stacked patch antenna 1100 may be incorporated into a different portion of the antenna assembly, antenna system, and/or antenna unit. For example, stacked patch antenna 1100 may be configured to be supported by a door, a base, a lid, and/or a case. A ground plane of the antenna assembly can be in the form of the ground plane 1130 of FIG. 16. Additional disclosure regarding antenna systems and assemblies including the stacked patch antenna 1100 of FIGS. 17A-17G is further described in U.S. Provisional Application No. 63/638,330, filed Apr. 24, 2024, entitled “Antenna Systems,” and U.S. Provisional Application No. 63/676,268, filed Jul. 26, 2024, entitled “Antenna Systems.” The entire contents of both are hereby incorporated by reference herein in their entireties. The disclosure and Figures in U.S. Provisional Application No. 63/638,330 and is U.S. Provisional Application No. 63/676,268 can be used in connection with the disclosure and Figures described and shown herein.

With continued reference to FIG. 16, the stacked patch antenna 1100 can be formed on and/or supported by the ground plane 1130. Including the stacked patch antenna 1100 in an antenna assembly, such as an antenna assembly can provide certain advantages. For example, the stacked patch antenna 1100 may enhance the performance of the antenna assembly in terms of beamwidth, gain, spatial filtering, and/or efficiency. The stacked patch antenna 1100 can be configured as a highly directional antenna.

The stacked patch antenna 1100 can include a first or top patch element 1102 and a second or bottom patch element 1104. The patch elements 1102, 1104 may also be referred to herein as “patch antenna radiators”, “patch antenna elements”, and/or “patch radiating elements.” Including a stacked patch antenna 1100 in an antenna assembly can provide more impedance bandwidth than a single layer patch antenna of comparable thickness.

The top patch element 1102 and the bottom patch element 1104 can each be considered an electrically conductive structure. In some implementations, the top patch element 1102 and the bottom patch element 1104 can comprise sheet metal, PCBs with an electrically conductive coating, and/or the like. The top patch element 1102 can be positioned above the ground plane 1130 with the bottom patch element 1104 positioned therebetween in the orientation of the stacked patch antenna 1100 relative to the ground plane 1130 shown in FIG. 16. A first gap or physical space can be maintained between the top patch element 1102 and the bottom patch element 1104 and a second gap can be maintained between the bottom patch element 1104 and the ground plane 1130. The antenna assembly 100B can include one or more support posts 1108 that extend between the ground plane 1130 and the bottom patch element 1104 and/or between the bottom patch element 1104 and the top patch element 1102. The support posts 1108 can be configured to support the top patch element 1102 and the bottom patch element 1104 and maintain the first and second gaps. The support posts 1108 can extend through the bottom patch element 1104 in some configurations. The support posts 1108 can be non-conductive. For example, the support posts 1108 are configured such that there is not a conductive path between the ground plane 1130 and either to the top patch element 1102 or the bottom patch element 1104 or between the top patch element 1102 and the bottom patch element 1104.

In some implementations, the stacked patch antenna 1100 can include a conductive post 1112. The conductive post 1112 can provide mechanical support for the top patch element 1102 and/or the bottom patch element 1104. The conductive post 1112 can also be electrically connected to the ground plane 1130 and the patch elements 1102, 1104. The gain and bandwidth performance of the stacked patch antenna 1100 will not change in a significant fashion if post 1112 is constructed of non-conductive material.

In the illustrated configuration, the bottom patch element 1104 includes a matching circuit 1106. The matching circuit 1106 can allow for a transmission line 1114 (e.g., a 50 ohm microstrip transmission line) to be matched to the input impedance of the stacked patch antenna 1100. The matching circuit 1106 can be T-shaped. The matching circuit 1106 can extend from the bottom patch element 1104. While a majority of the bottom patch element 1104 may be positioned directly below the top patch element 1102, the matching circuit 1106 may extend outwardly from the bottom patch element 1104 such that the matching circuit 1106 is not positioned directly below the top patch element 1102. The matching circuit 1106 can be mechanically supported by one or more support posts 1110. The one or more support posts 1110 can be configured in a similar manner as the support posts 1108 (e.g., to provide non-conductive mechanical support).

The matching circuit 1106 can be electrically connected to the transmission line 1114 via a feed post 1116. The feed post 1116 provides the electrical connection between the transmission line 1114 and the bottom patch element 1104. In some configurations, the feed post 1116 serves an additional function of providing mechanical support for the matching circuit 1106 in addition to or alternatively to the one or more support posts 1110. The transmission line 1114 can include a junction or attachment point 1118. The attachment point 1118 is where a coaxial cable could attach to the ground plane 1130 to connect the stacked patch antenna 1100 to a radio. The ground plane 1130 can include heat relief sections 1120 in the ground plane 1130 (e.g., in the PCB structure when formed as such) at the attachment point 1118. The transmission line 1114 can extend along the non-conductive side of the ground plane 1130 between the attachment point 1118 and the feed post 1116. In some configurations, the transmission line 1114 could include an impedance transformer or reactive matching components along the transmission line 1114.

In some implementations, any of antenna assemblies, antenna systems, and/or antenna units described herein can include one or more millimeter wave radios. For example, the one or more millimeter wave radios can form part of the associated multi-element multi-band antenna, the antenna system, and/or the antenna unit. FIGS. 18A-18D illustrate four example millimeter wave radios 250A, 250B, 250C, 250D respectively (collectively millimeter wave radios 250), any of which can be included in any antenna assembly described herein (e.g., the antenna assembly 204). While particular reference is made to the antenna assembly 204 and its components, it is recognized that the millimeter wave radios 250 of FIGS. 18A-18D can form part of any of the other antennas assemblies, antenna systems, and/or antenna units described herein. While four example millimeter wave radios 250 are provided, in other implementations, different or modified millimeter wave radios 250 can be included in the antenna assemblies, antenna systems, and/or antenna units described herein. The millimeter wave radios 250 can be included in addition to or alternatively to the other antennas included in the antenna assembly 204. The millimeter wave radios 250 can operated in the millimeter wave frequency spectrum (approximately between 30 GHz and 300 GHz), with wavelengths ranging from 1 to 10 millimeters approximately. The millimeter wave radios 250 can be used for high-frequency communication. Including one or more millimeter wave radios 250 can improve or support high data transfer rates of the antenna assembly over short distances. For example, the millimeter wave radios 250 can be configured to transmit large amounts of data, which can be ideal for 5G network applications and high-speed wireless communication for the antenna assembly. In some implementations, the millimeter wave radios 250 can be mounted to a ground plane. When one or more of the stacked patch antennas 1100 and/or the multi-band radiator portion 1200 are included in the antenna assembly and coupled to a ground plane, it may be desirable to include one or more millimeter wave radios 250 coupled to a ground plane as well.

FIG. 18A illustrates a first example of a millimeter wave radio 250A that can be included in an antenna assembly (e.g., antenna assembly 204, etc.). The millimeter wave radio 250A can be a slotted waveguide array millimeter wave radio. The millimeter wave radio 250A can include a millimeter wave radio 252A and one or more waveguides 254A. In the illustrated example, three waveguides 254A are included. The waveguides 254A can be hollow metallic structures that direct electromagnetic waves. Each waveguide 254A can include slots 256A cut into its surface to allow for controlled radiation. For ease of illustration, not all slots 256A in FIG. 18A are labeled. The waveguides 254A can serve as a conduit for the millimeter-wave signals, efficiently transmitting them along its length with minimal loss. The slots 256A can act as the radiating elements for the millimeter wave radio 250A, emitting the millimeter wave signals. The position and size of the slots 256A can be selected to achieve a highly directional beam. In some implementations, the waveguides 254A can be configured to create an array of slots 256A. Such an array can be used to form a high-gain, highly directional antenna, which can be ideal for focusing energy in a specific direction or scanned along a portion of the horizon, which may be desirable.

FIG. 18B illustrates a second example of a millimeter wave radio 250B that can be included in an antenna assembly, an antenna system, and/or an antenna unit. The millimeter wave radio 250B can be a dipole array millimeter wave radio. The millimeter wave radio 250B can include a millimeter wave radio 252B, a microwave grade PCB portion 254B, and a plurality of dipole antennas 256B. The dipole antennas 256B can be arranged in an array on the PCB portion 254B. The PCB portion 254B can include a ground plane (not shown) on its back side (e.g., the side closest to the millimeter wave radio 252B). For ease of illustration, not all of the dipole antennas 256B in FIG. 18B are labeled. The dipole antennas 256B can be substantially smaller compared to other antennas of an antenna assembly (e.g., antenna assembly 204, etc.) because of the short wavelength of the millimeter wave radio 250B. Arranging the dipole antennas 256B in an array can enhance the gain, directivity, and/or beamforming capabilities of the millimeter wave radio 250B. The phase and amplitude of signals fed to each dipole antenna 256B can be selected to focus the energy in a specific direction. For example, highly directional and scannable radiation patterns can be generated by the millimeter wave radio 250B.

FIG. 18C illustrates a third example of a millimeter wave radio 250C that can be included in an antenna assembly, an antenna system, and/or an antenna unit. The millimeter wave radio 250C can be a microstrip patch array millimeter wave radio. The millimeter wave radio 250C can include a millimeter wave radio 252C, a microwave grade PCB portion 254C, and a plurality of microstrip patch antennas 256C. The microstrip patch antennas 256C can be flat rectangular antennas comprising a conductive material (e.g., a metal). The microstrip patch antennas 256C can be arranged in an array on the PCB portion 254C. The PCB portion 254C can include a ground plane (not shown) on its back side (e.g., the side closest to the millimeter wave radio 252C). For ease of illustration, not all of the microstrip patch antennas 256C in FIG. 18C are labeled. The microstrip patch antennas 256C can be substantially smaller compared to other antennas of an antenna assembly because of the short wavelength of the millimeter wave radio 250C. Arranging the microstrip patch antennas 256C in an array can enhance the gain, directivity, and/or beamforming capabilities of the millimeter wave radio 250C. The feed network of the microstrip patch antenna array can be controlled to allow for precise beamforming and higher directional accuracy. Alternatively, elements can be individually fed as opposed to serially fed to form a highly scannable array in both azimuth and elevation.

FIG. 18D illustrates a fourth example of a millimeter wave radio 250D that can be included in an antenna assembly, an antenna system, and/or an antenna unit (e.g., antenna assembly 204). The millimeter wave radio 250D can be a coplanar waveguide feed cylindrical dielectric resonator array millimeter wave radio. The millimeter wave radio 250D can include a millimeter wave radio 252D, a microwave grade PCB portion 254D, a plurality of dielectric resonator antennas 256D, and a ground plane 258D. The dielectric resonator antennas 256D can be constructed of a non-metallic materials (e.g., dielectrics) and can be the radiating elements of the millimeter wave radio 250D. The dielectric resonator antennas 256D can be cylindrically shaped, which can help confine and radiate electromagnetic energy effectively at millimeter-wave frequencies. The dielectric resonator antennas 256D can be arranged in an array on the PCB portion 254D. For ease of illustration, not all of the dielectric resonator antennas 256D in FIG. 18D are labeled. The dielectric resonator antennas 256D can be substantially smaller compared to other antennas of the antenna assembly 204 because of the short wavelength of the millimeter wave radio 250D. Arranging the dielectric resonator antennas 256D in an array can enhance the gain, directivity, and/or beamforming capabilities of the millimeter wave radio 250D.

The particular implementations disclosed above are illustrative only, as the application may be modified and practiced in different but equivalent manners apparent to those skilled in the art having the benefit of the teachings herein. It is therefore evident that the particular implementations disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

### Antenna Unit Configurations and Features

FIGS. 19A-19C show various views of an implementation of an antenna case system, in accordance with some aspects of this disclosure. FIG. 19D shows a case system, an antenna assembly, and an implementation of a multi-band antenna that can be included in any case system and/or antenna assembly described herein, in accordance with some aspects of this disclosure.

FIG. 19A illustrates a perspective view of an antenna unit 1900. FIGS. 19B-19D illustrate additional views of the antenna unit 1900 or components of the antenna unit 1900. Some features of the antenna unit 1900 are similar or identical to features of the antenna unit 200 in at least FIGS. 1A-3H and/or antenna unit 300 in at least FIGS. 7 and 8A-8C. Thus, reference numerals used to designate the various features or components of the antenna units 200 and/or 300 are identical to those used for identifying the corresponding features of the components of the antenna unit 1900 in FIGS. 19A-19D, except that the numerical identifiers for the antenna unit 1900 can begin with a “19” instead of a “2” and/or a “3”. Therefore, the structure and description for the various features of antenna unit 200 and/or antenna unit 300, and the operations thereof as described in at least FIGS. 1A-3H and/or FIGS. 7 and 8A-8C are understood to also apply to the corresponding features of the antenna unit 1900 in FIGS. 19A-19D, except as shown differently and/or described differently herein.

With reference to FIG. 19A, a perspective view of an antenna unit 1900 is illustrated in accordance with an implementation of the present disclosure. The antenna unit 1900 can also be referred to as an antenna system, an antenna case, an antenna assembly, and/or other reference to some or all of its components, etc. The antenna unit 1900 is shown in an open configuration in FIG. 19A. The antenna unit 1900 may include a case 1902 and an antenna assembly 1904, as described further herein. The antenna unit 1900 be configured as a portable high performance 5G antenna and/or remote internet connectivity device. As shown here, the case system can have a DC power source, for 5G radio and 5G antenna applications to provide remote internet connectivity. The antenna unit 1900 can be used to provide an on-the-go network as a mobile hotspot (e.g., for emergency use cases). In some implementations, the antenna unit 1900 can provide wireless internet connectivity for a plurality of uses (e.g., data, voice communication, video, and/or the like). The antenna unit 1900 may be used in a wide range of applications. For example, the antenna unit 1900 may be used by first responders, for critical communications, surveillance, covert operations, pop up medical clinics, construction sites, and/or the like. The antenna unit 1900 can be a 4×4 MIMO cellular antenna. The antenna unit 1900 can be a 4×4 MIMO WIFI antenna. In some implementations, the antenna unit 1900 can include a GPS. In some implementations, the antenna unit 1900 can include one or more router(s)/modem(s). In some implementations, the antenna unit 1900 can include one or DC power sources. In some implementations, the antenna unit 1900 can be omni-directional. In some implementations, the antenna unit 1900 can be configured to be directional as discussed further herein. In some implementations, the antenna unit 1900 can have a compact volume.

The antenna unit 1900 can have a smaller case 1902 when compared to conventional router antenna cases. The antenna unit 1900 can include the antenna assembly 1904, which can have nine or more antennas. In some implementations, the antenna assembly 1904 can include an antenna configuration with high efficiency (e.g., approximately 90%). As explained herein, the antenna assembly 1904 can include one or more antennas configured for cellular use, one or more antennas configured for WiFi (e.g., WiFi, Bluetooth, a combination, etc.), and/or one or more antennas configured for GPS. In some implementations, the antenna unit 1900 may include two cell antennas (e.g., two multi-band radiator portions 100) and two WiFi antennas (e.g., two dual-band WiFi radiator portions 1918) and may include a GPS radiator portion 1916. In some implementations, the antenna unit 1900 may include four cell antennas (e.g., four multi-band radiator portions 100) and four WiFi antennas (e.g., four dual-band WiFi radiator portions 1918) and one or more GPS radiator portions 1916. Other combinations are also possible.

The antenna unit 1900 can be used to house one or more routers and/or modems. The antenna unit 1900 can provide protection for the router and can be configured to facilitate connection between the router and the antenna assembly 1904. Because routers are usually the most expensive devices when it comes to network systems (e.g., ranging in price between $250 and $15,000 or greater), it can be desirable to protect the router from regular wear and tear to increase the lifetime of the router. Additionally, routers can be ill-suited for some applications, particularly for use in the field and outside of buildings. Additionally, the antenna unit 1900 can provide expanded drop protection for routers. The antenna unit 1900 can be configured to provide shock isolation for the router. For example, the case 1902 can be designed for ruggedness, strength, dielectric loading, and/or the like. In some implementations, the antenna unit 1900 can be configured to provide cable management and/or cable protection. The antenna unit 1900 can facilitate the use of the router and the antenna assembly 1904 while providing an arrangement for the components of the antenna unit 1900 and the cables in a compact efficient manner. In some implementations the antenna unit 1900 can include adaptors located within or on the case 1902 so the router ports are protected from environmental exposure and/or damage. In some implementations, the antenna unit 1900 can include external ports that extend through the case 1902 to improve accessibility for the user, without requiring the router to be removed from the protective case 1902. In some implementations, the case 1902 can be configured to house a power source (e.g., a battery). The power source can be configured to power the router. In some implementations, the power source can selectively power the router. In some implementations, the case 1902 can include internal structures to separate the router from the power source to promote heat flow through the case 1902. In some implementations, the case 1902 can include one or more vents and/or one or more fans to facilitate fluid flow through the case 1902. The fluid flow can promote heat exchange between internal volume(s) of the case 1902 and the outside environment.

FIGS. 19B-19D illustrate various view of the antenna unit 1900. The case 1902 can include a base 1906 and a cover or lid 1908. The lid 1908 can be coupled to the base 1906. The lid 1908 can be pivotably connected to the base 1906. The lid 1908 can move between an open configuration, as shown in FIG. 19A, and a closed configuration (not shown), where the edges of the lid 1908 contact the edges of the base 1906. In the closed configuration, one or more locking components of the case 1902 can be used to lock the lid 1908 to the base 1906. FIG. 19D shows an exploded perspective and/or isolation view of the antenna assembly 1904, the base 1906, and the lid 1908 of the antenna unit 1900.

The base 1906 and the lid 1908 can be used to optionally separate components of the antenna unit 1900 from each other. The base 1906 can have a first internal volume. The lid 1908 can have a second internal volume. Components of the antenna unit 1900, such as a router (not shown), power supply (not shown), cables (not shown), and/or the like can be housed within the first internal volume of the base 1906. A battery 1936 is shown and can be provided as described in more detail herein. The battery 1936 can comprise one or more charging portions.

Similarly, components of the antenna unit 1900, such as the antenna assembly 1904 (see e.g., FIGS. 2A and 2B), can be housed within the second internal volume of the lid 1908. As such, the antenna assembly 1904 is separated from the modem and power supply. In some implementations, the antenna unit 1900 can be configured to minimize interference to enable increased performance of one or more antennas of the antenna assembly 1904 therein, all while the lid 1908 is in the closed configuration. In some implementations, the antenna unit 1900 can operate in both the open and closed configurations.

The lid 1908 can protect and/or provide mechanical support for the internal components of the antenna unit 1900 (e.g., the antenna assembly 1904). For example, as discussed herein, the antennas 100 (as well as other radiator portions) can be secured within the second internal volume of the lid 1908. In some implementations, the lid 1908 may be transparent to radiation from the antenna portions and may serve as an environmental shield for the antenna assembly 1904. One or both of the base 1906 and the lid 1908 can be made of non-conductive materials. For example, the base 1906 and/or lid 1908 may not be made of metal. In some examples, the base 1906 and/or lid 1908 can be made of plastic, fiberglass, carbon fiber, and/or the like materials that allow RF signals to pass through. In some implementations, second internal volume of the lid 1908 can have a height of less than 2 inches (e.g., less than 1.75 inches, less than 1.5 inches, less than 1.33 inches, etc.). According to some implementations, where the base is holding the router and/or battery, it can be metal or plastic. The lid is RF transparent. If the configuration is using antennas internal to the modem, then it will be helpful for the case to be RF transparent as well. This can depend on the engineering of the modem and the antenna configuration in the lid.

In some implementations, the base 1906 can have a larger internal volume than the lid 1908. In some implementations, the case 1902 can be designed to separate the locations of the antenna assembly 1904 from the other antenna components in a manner to remove interference. In some implementations, the antenna unit 1900 can include a barrier 1910. The barrier 1910 can be laid or located within the interior of the base 1906 to act as a divider and/or separator form the lid 1908. In some implementations, the antenna unit 1900 can include a cable routing component 1912. The cable routing component can extend from the first internal volume of the base 1906 to the second internal volume of the lid 1908. In some implementations, the cable routing component 1912 can be waterproof. The cable routing component 1912 can be used to route cables (e.g., coaxial cables) from the first internal volume of the base 1906 to the second internal volume of the lid 1908 (e.g., from the modem to the antenna assembly 1904). In some implementations, the power source can be positioned below barrier 1910 (e.g., on an internal frame positioned in or formed in the base 1906. In some implementations, the barrier 1910 can include a window or cutout 1928. The cutout 1928 can be positioned above the power source such that a charge indicator of the power source can be seen through the cutout 1928.

In some implementations, the case 1902 can be configured to be IP67 compliant/rated, meaning that the case 1902 is waterproof. The case 1902 may be made from any known materials and is typically hardened and durable to act as a protection to the antenna assembly 1904 and other components therein. As noted herein, the lid 1908 can be configured to pivot in an operable manner to act between an open and closed position. The antenna unit 1900 can include hinges 1914 or other suitable components to enable the lid 1908 to pivot. It is understood that all that is necessary is that lid 1908 is at least partially separable from base 1906 to allow selective access internally. In some implementations, the antenna unit 1900 can include a handle 1926. The handle 1926 can be coupled to the case 1902.

In the closed configuration, the antenna unit 1900 may have a smaller volume and profile when compared to other antenna units. For example, the antenna unit 1900 may have a cubic volume between 400 and 800 cubic inches (e.g., between 400 and 800 cubic inches, 450 and 750 cubic inches, 500 and 700 cubic inches, 550 and 650 cubic inches, values between the foregoing, etc.). As such, in some implementations, the antenna unit 1900 can be configured to fit within a backpack or carry-on luggage. In some implementations, the case 1902 can be configured to be shock absorbent and/or impact resistant. For example, the case 1902 may comprise shock absorption and impact resistant resin to reduce damage and loss of performance due to hard use.

With reference to FIGS. 1B, 1C, and 1D which also illustrate perspective s side-views of the antenna unit 1900, in some implementations, the antenna unit 1900 can include one or more vents, fans, and/or the like to promote heat flow from the internal components of the antenna unit 1900 to an external environment. For example, the case 1902 can include one or more fans 1922 and/or one or more vents 1924. The fan 1922 can extend though the side wall of the base 1906. Similarly, the vent 1924 can extend through a side wall of the base 1906. In some cases, the fan 1922 may be positioned in one side wall and the vent 1924 may be positioned in an opposite side wall. The fan 1922 can be configured to blow or drive fluid (e.g., air) from the first internal volume of the base 1906 to the outside environment. The vent 1924 can be configured to allow air to enter the first internal volume of the base 1906 from the outside environment. In some cases, the fan 1922 and/or vent 1924 can include a filter configured to filter debris in the fluid entering the base 1906. In some implementations, the fan 1922 and/or vent 1924 can be configured to move between a first/open configuration and a second/closed configuration. For example, the fan 1922 and/or vent 1924 can include a twist lock component 1930 that can be rotated to move between the open configuration and the closed configuration. In the open configuration, air and other fluid can pass through the fan 1922 and/or vent 1924. In the closed configuration, the fan 1922 and/or vent 1924 can prevent liquid from entering the base 1906. In some implementations, the vent 1924 can be configured to equalize the pressure in the first internal volume of the base 1906 when in the closed configuration, while still preventing liquid from entering the base 1906. In some implementations, the twist lock component 1930 can be configured to select the amount of airflow entering the base 1906 based on the position of the twist lock component 1930 between the open and closed configuration.

With continued reference to FIGS. 1B and 1C, in some implementations, the case 1902 can include one or more external ports 1938. For example, the external ports 1938 can be formed in one or more side walls of the base 1906. The external ports 1938 can be configured as ethernet ports, sim ports, USB ports, USB C ports, and/or the like. The external ports 1938 can provide access to cables that extend to the router and/or battery. In some implementations, the external ports 1938 can be customizable or interchangeable. In some implementation, an external port 1938 can be configured to receive a sim card. As such, the user can easily access the sim card via the external port 1938, without opening the antenna unit 1900 or removing the barrier 1910. In some implementations, the external ports 1938 can include covers to prevent damage to the external ports 1938 when not in use.

FIGS. 1B and 1C show the first internal volume of the base 1906. As shown, the antenna unit base 1906 can include an internal frame 1932. The internal frame 1932 can be coupled to/formed in the base 1906. The internal frame 1932 can include a shelf 1934. The shelf 1934 can be configured to support the power source (e.g., a battery 1936) of the antenna unit 1900. The shelf 1934 can be configured to secure the battery 1936 to the internal frame 1932, to prevent motion of the power source. The shelf 1934 can promote separation between the battery 1936 and the router. In the illustrated example, the router is secured to the bottom of the base 1906. As such, there is a gap between the router and the battery 1936. The gap can allow fluid flow (e.g., from the vent 1924 to the fan 1922) to pass between the battery and the router, for improved heat flow. In some implementations, the internal frame 1932 can be made of a conductive material (e.g., aluminum). As such, the internal frame 1932 can promote heat transfer from the battery 1936 and/or router to the internal frame 1932 for improve heat dissipation.

FIGS. 1B and 1C illustrate an example internal view of the first internal volume of the base 1906. An example router 1940 is shown. Cables, not shown here, but similar to those shown, for example, in FIG. 1H, can be extending between the router 1940, battery 1936, case 1902, and external ports 1938. In some implementations, the antenna unit 1900 may include a router plate 1942. The router plate 1942 can be configured to secure the router to the base 1906. The router plate 1942 can be configured to prevent the router 1940 from moving when the case 1902 is moved or dropped. Preventing relative motion of the router 1940 can provide a benefit of protecting the router 1940 from damage and preventing movement or damage to the cables connected to the router 1940. The router plate 1942 can provide shock isolation for the router 1940. In some implementations, the router plate 1942 can be made of a conductive material (e.g., aluminum). As such, the router plate 1942 can promote heat transfer from the router 1940 to the router plate 1942 for improve heat dissipation.

FIG. 19D illustrates various views of the antenna assembly 1904 that is housed in the lid 1908 (see also, similar FIGS. 2A and 2B). The antenna assembly 1904 can also be referred to as an antenna system, antenna components, antenna module, radiating systems, radiating elements, and/or other reference to some or all of its components, etc. The antenna assembly 1904 can include one or more antennas and/or antenna systems. The antennas may be of different shapes, operational ranges or frequencies, and sizes. As shown in FIG. 19D, the antenna assembly 1904 can include one or more GPS antenna elements 1916, one or more dual-band WiFi radiator antennas 1918, and/or one or more multi-band radiator portions/antennas 100. The antenna assembly 1904 can be secured to a baseplate 1920. The baseplate 1920 can be coupled to the lid 1908 (e.g., with fasteners). When the baseplate 1920 is coupled to the lid 1908, the second internal volume housing the antenna assembly 1904 is enclosed. The baseplate 1920 can be a ground plane 1920. The baseplate 1920 can be configured as a heatsink and/or reflector for the antenna assembly 1904. The antenna assembly 1904 can be designed and optimized to work on the baseplate 1920 and can be designed to operate within lid 1908 so as to transmit and receive data. An added benefit is that the antenna assembly 1904 is out of harm's way and can operate without any other objects in the RF path. All other accessories, routers and batteries can be stored below, under barrier 1910, out of the RF path of the antenna assembly 1904. In some implementations, the baseplate 1920 can have a smaller size compared to conventional ground planes used with router antennas. A ground plane 1920 for example as in as in an antenna assembly 1904 can also serve as a ground plane and/or ground reference for any additional antennas or antenna components included in any of the antenna assemblies and/or antenna units or systems disclosed herein that can be used in additional and/or alternative configurations for antenna systems.

The GPS antenna element(s) 1916 can be used to collect one or more signal(s) from geosynchronous satellites so that the GPS function of a radio including the antenna assembly 1904 can determine where the antenna unit 1900 is positioned relative to a global coordinate system. Depending on the particular use, the number of GPS antenna element(s) 1916 can vary. In the illustrated example the antenna unit 1900 includes one GPS antenna element 1916; however, more or fewer GPS antenna element(s) 1916 are possible. The GPS antenna element 1916 may be positioned on the baseplate 1920 and within the lid 1908. In this arrangement, the GPS antenna element 1916 is supported by the baseplate 1920 in the assembled antenna unit 1900.

The dual-band WiFi radiator antennas 1918 can be used for un-licensed band wireless telecommunication purposes. In some implementations, the antennas 1918 can be configured operation at frequencies above approximately 1 GHz. For example, the antennas 1918 can be configured as multi-band Wi-Fi radios, 3GPP radios, cellular radios, and/or the like. In some advantageous implementations, the antennas 1918 can be multi-band WiFi antenna devices. As such, the antennas 1918 can be configured for mid-band operation, CBRS-band operation, and Wi-Fi-band operation, depending on the specific radio or transceiver attached. In some cases, the antennas 1918 can have an operating range of approximately 1.6 GHz to 8 GHz or higher. In some implementations, the antennas 1918 can include one or more PCB portions. The PCB portions may be made of flexible substrate materials (e.g., polyimide). As such, the PCB portions may be a flex circuit. In some cases, the PCB portions may be fiberglass reinforced with epoxy (e.g., FR4). The PCB portions may provide structure for the radiating portions of the antennas 1918. The various conductive portions of the antennas 1918 may be etched into the structure of the PCB portions. While the antennas 1918 are referred to herein as “dual-band WiFi radiator antennas,” the antennas 1918 may be configured for operation on less than two or more than two bands, in some implementations.

Depending on the particular use, the number of dual-band WiFi radiator portions 1918 can vary. In the illustrated example, the antenna unit 1900 includes four dual-band WiFi radiator portions 1918. However, more or fewer dual-band WiFi radiator portions 1918 are possible. In some cases, one or more of the dual-band WiFi radiator portions 1918 can be configured for Bluetooth communication. For example, one or more of the dual-band WiFi radiator portions 1918 can be a Bluetooth radiator portion 1918. In some implementations, each dual-band WiFi radiator portions 1918 can be coupled to an individual RF cable (not shown), for example, coaxial cables. The one or more dual-band WiFi radiator antennas 1918 may be positioned on the baseplate 1920 and within the lid 1908. In this arrangement, the one or more dual-band WiFi radiator antennas 1918 are supported by the baseplate 1920 in the assembled antenna unit 1900.

The multi-band radiator portions 1901 and/or multi-band antennas 1901 can be used for wireless telecommunication purposes (e.g., cellular telecommunication). The multi-band antennas 1901 can also be referred to as an antenna system, antenna components, antenna module, radiating systems, radiating elements, and/or other reference to some or all of its components, etc., and can have the same or similar features to, and/or correspond to, the multi-band antennas 100 as described herein. The multi-band antennas 1901 can include one or more radiator portions, antennas, and/or antenna systems that may be of different shapes, operational ranges or frequencies, and sizes. The multi-band radiator portions 1901 may be a dual band monopole antenna that has a configuration that, when used in conjunction with high order electromagnetic modes generated or received by a transceiver and/or receiver (as is typically performed for PIFA antennas), permit the antenna to have an operating frequency range of 600 MHz to 7.25 GHz. Depending on the particular use, the number of multi-band radiator portions 1901 can vary. In the illustrated example, the antenna assembly 1904 includes four multi-band radiator portions 1901; however, more or fewer multi-band radiator portions 1901 are possible. The multi-band radiator portions 1901 and/or 1901′ are described further herein with reference to FIGS. 3A-3H. The multi-band radiator portions 1901 and/or 1901′ are the same as and/or similar to, or corresponds to, multi-band radiator portions 100 and/or 101′ as shown and described with reference to FIGS. 3A-3H. In some implementations, the multi-band radiator portions 1901 and/or 1901′ can have a radiated efficiency between 70% and 90% when operating between 600 MHz and 7250 MHz. In some implementations, the multi-band radiator portions 1901 and/or 1901′ can have a peak gain between 2.5 and 7.25 when operating between 600 MHz and 7250 MHz.

The RF cabling (not shown) to connect the internal modem to the multi-band radiator portions 1901 and/or 1901′ and the dual-band WiFi radiator portions 1918 can extend through the cable routing component 1912 and through the baseplate 1920 and into the second internal volume of the lid 1908.

The orientation and the arrangement of the multi-band radiator portions 1901 and/or 1901′ and the dual-band WiFi radiator portions 1918 on the baseplate 1920 relative to each other can be selected to optimize the performance of the antenna assembly 1904 for the particular use case. In the illustrated example, the dual-band WiFi radiator portions 1918 are positioned on opposite sides of the baseplate 1920. Similarly, in the illustrated example, the multi-band radiator portions 1901 are positioned on opposite corners of the baseplate 1920. The relationship between the multi-band radiator portions 1901 can be important for the performance of the antenna assembly 1904. In some implementations, the arrangement of the multi-band radiator portions 1901 can be selected to have complementary overlapping azimuth patterns. Additionally, the arrangement can be selected to reduce the multi-band antenna 1901 to multi-band antenna 1901 isolation, without the use of divider walls or RF absorbing material.

The antenna unit 1900 can be configured advantageously to act as an emergency portable hot spot and serve as a complete portable network in a singular box/case. The antenna unit 1900 can be used for emergency situations where a portable network is required. In some implementations, a principal function of the antenna unit 1900 can be to route local Wi-Fi 5 or 6 (LAN) signals to WAN signals, which is typically 4G/5G LTE based. In some implementations, the antenna unit 1900 can be configured for CAT 4 to CAT 18 LTE and may also include 5G NR (New Radio) which goes from 600 MHz to 7.25 GHz for wide area cellular networks backhaul and 5G millimeter wave which uses 24, 28 and 39 GHz bands. In some implementations, the antenna unit 1900 can be used for Local cellular short haul (150 ft ultra-high speed to LTE). The antenna unit 1900 may imbeds GPS, LTE and Wi-Fi antennas in the lid 1908 of the case 1902. The antenna unit 1900 can also include GPS, LTE, Wi-Fi and both version of 5G all in one case 1902, working at the same time for maximum throughput, upload and download speeds for portable internet access.

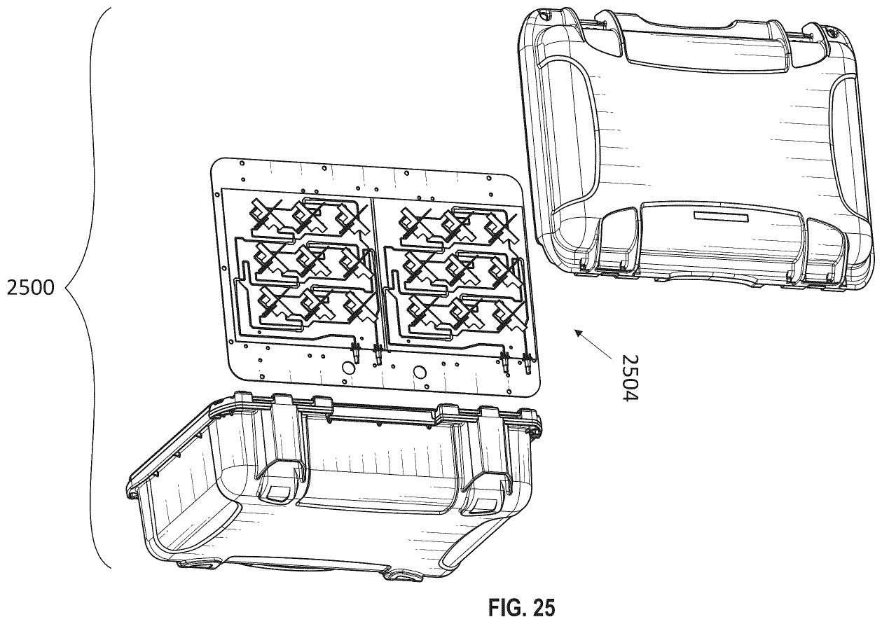

FIG. 19D shows the antenna unit 1900 in an exploded view of the antenna case 1902 with an antenna assembly 1904, a base 1906, and a lid 1908. The antenna assembly 1904 includes multiband antennas and/or multi-band radiator portions 1901 and/or 1901′. As discussed herein, in accordance with some aspects of this disclosure, the multiband antennas and/or multi-band radiator portions 1901 and/or 1901′ are the same as or similar to, and correspond to, the multi-band radiator portions 100 and/or 101′ as shown and described in connection with FIGS. 3A-3H. It is recognized that the multi-band radiator portions 1901 described herein are just one example of multi-band radiator portions that can be included in the antenna system 1900 and/or antenna assembly 1904. In other implementations, different multi-band radiator portions can be included. For example, the antenna assembly 1904 is not limited to include multi-band radiator portions that are similar or identical to the multi-band radiator portions 100 described herein. The multi-band elements 1901 can include one or more antenna elements and/or antenna components or systems. The multi-band elements 1901 may be of different shapes, operational ranges or frequencies, and sizes. In other implementations, more or fewer antennas and/or different antennas (e.g., one or more of any of the antennas of FIGS. 10A-18D, etc.) may be included in the antenna assembly 1904 as described herein. Additional implementations of other antennas and/or multi-band elements are shown and disclosed further in connection with at least FIGS. 25, 26, 27, 28, 31, 32, 33, and 34. When other antennas and/or multi-band elements (e.g., the antennas of any of FIGS. 10A-18D, 25-28, and 31-34, etc.) are included in the antenna assembly 1904, such antennas can be arranged on the ground plane 1920, or on another ground plane or connection, in a similar or different manner, depending on the particular application.

According to some implementations, it can be desirable for the antenna assembly 1904 to have as low a profile as possible, to allow the antenna assembly 1904 to be positioned within a compartment within a case, such as a lid and/or a base. Additionally, a low profile can allow for high wind operating conditions or applications that require low visual impact. Accordingly, as the multi-band radiator portions 1901 can represent a limiting factor in terms of total height of the antenna assembly 1900, the low-profile multi-band radiator portions 1901 are particularly advantageous. In some implementations, the multi-band radiator portions 1901 can have a total height (e.g., from the bottom of the feed point to the top of the second low-band radiation portion) of between 0.75 inch and 3 inches. For example, the multi-band radiator portions 1901 may have a total height of less than 3 inches, less than 2.5 inches, less than 2 inches, less than 1.5 inches, less than 1 inches, and/or the like.

The antenna unit 1900 can differ from the antenna units 200 and/or 300 with respect to some components of the base 1906. For example, the antenna unit 1900 may include an internal frame 1932 and a barrier 1910 with different features than the antenna units 200 and/or 300. However, it is recognized that the components of the base 1906 can be used in the antenna units 200, 300, and vice-versa. Additionally, the antenna unit 1900 can be configured for use with a charging port battery system 1936. The charging port battery system 1936 is described herein with reference to FIGS. 19A-C. In some implementations, the antenna unit 1900 can be configured for use with a mobile hot spot. Throughout the description, the use of “router” is understood to apply to a mobile hot spot.

FIG. 19B illustrates a top isolation view of the base 1906 and associated components. In FIG. 19B, the router 1940 is shown in the base 1906, and battery 1936 is removed and spaced from the base 1906. FIG. 19C illustrates a perspective exploded view of the antenna unit 1900 and associated components. FIG. 19D illustrates a perspective exploded view of the antenna assembly 1904 and associated components.

With reference to FIGS. 19B and 19C, the barrier 1910 can include cutout portion 1911. The cutout portion 1911 can be configured to allow the battery holder and/or battery support 1946 to engage the internal frame 1932 and/or another support portion of the antenna case 1902. The cutout portion 1911 can include a shelf 1913. The shelf 1913 can be a recessed portion of the barrier 1910. The shelf 1913 can be a separate component configured to be coupled to and/or supported by the barrier 1910. In some implementations, the barrier 1910 can have a first horizontal surface in a first plane, and a second horizontal surface in a second plane, wherein there is a transition portion between the first and second horizontal surfaces. The first surface can be positioned relatively above the second surface. The higher surface and/or portion of the barrier 1910 can allow for more space between the battery that is suspended from below the barrier 1910, and the router 1940, which is shown resting on the router support coupled to the lower surface within the base 1906. In some implementations, the shelf 1913 can be used to store further components in the case 1902 (e.g., tool, chargers, etc.). As shown, the barrier 1910 can comprise vent portions and/or punch out holes 1980 for customized configurations. In some implementations, the shelf 1913 form an enclosure and can include a window 1915. The window 1915 can be positioned above the battery 1936 such that a user can view indicators on the battery 1936. In some implementations, the batter 1936 sits on the shelf 1913 and fills and/or aligns with an opening formed in the barrier 1910 so as to provide easy access to the battery and/or charging functions. The charging functions can include the ability to wirelessly charge a phone, earphones, and/or other electronic devices.

The internal frame 1932 can be configured to support one or both of the router 1940 and the battery 1936. The internal frame 1932 can be configured to provide separation between the router 1940 and the battery 1936. For example, the internal frame 1932 can provide spacing for the battery 1936 and router 1940 to avoid heat flow between the two devices via direct contact, as well as provide space for air flow for heat dissipation. In some implementations, the internal frame 1932 can comprise a plastic. The internal frame 1932 can be configured to protect the router 1940 and the battery 1936 and provide shock isolation for the router 1940 and the battery 1936. For example, in some implementations, the internal frame 1932 can move relative to the base 1906 when the antenna unit 1900 is moved or dropped, while preventing motion of the battery 1936 and router 1940 relative to the internal frame 1932. In some implementations, the internal frame 1932 can be removably coupled to the base 1906 within the first internal volume.

With reference to FIGS. 19B and 19C, the internal frame 1932 can include a battery compartment and/or shelf 1946. The battery shelf 1946 can be configured to support battery 1936. The battery shelf 1946 can be sized to prevent movement of the battery 1936 relative to the internal frame 1932. For example, the battery 1936 can have a transition fit with the battery shelf 1946. As such, the battery 1936 can be easily removed by the user, from a top, but fixed when the antenna unit 1900 is in the closed configuration. The battery shelf 1946 can include one or more holes located in a bottom portion of the battery shelf 1946. The one or more holes can be configured to allow the battery 1936 to be exposed to airflow. Similarly, the battery shelf 1946 can include a plurality of slots 1947 located in the side walls of the battery shelf 1946. The slots 1947 can be configured to allow the battery 1936 to be exposed to airflow. While not illustrated, the internal frame 1932 can further include a plurality of slots and/or cutouts in the side walls and bottom portion of the internal frame 1932. The plurality of slots can be configured to promote airflow through the internal frame 1932.

Referring back to FIGS. 19B and 19C, in some implementations, the antenna unit 1900 can include a power button 1948 and/or a fan button 1950. The power button 1948 can be configured to turn the battery 1936 on and off. The fan button 1950 can be used to turn the fan on and off.

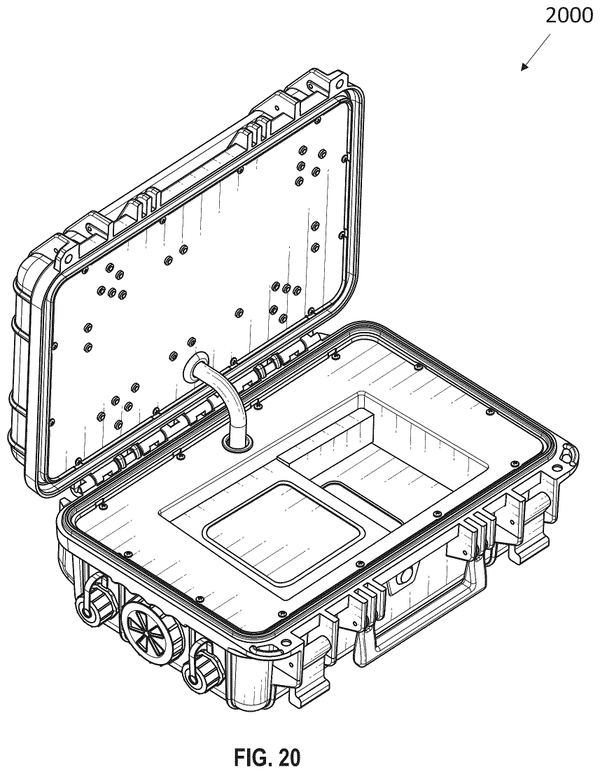

FIG. 20 shows an antenna case system, in accordance with some aspects of this disclosure. FIG. 20 illustrates a perspective view of an antenna unit 2000. Some features of the antenna unit 2000 are similar or identical to features of the antenna units 200, 300, 1900, etc. Thus, reference numerals for various features or components of the antenna units are identical or similar to those used for corresponding features of the other antenna units except for leading digits. Therefore, the structure and description for the various features and operations of the other antenna units are understood to also apply to the corresponding features of the antenna unit 2000, except as shown differently and/or described differently herein.

The configuration in FIG. 20 demonstrates accessible compartments below the internal frame for easy access to batteries or modems or other equipment. The recessed compartments allow for some equipment to be installed or serviced without removing the internal frame from the case. In some implementations, the internal frame 2032 can include a router compartment or shelf 2042. The router shelf 2042 can be aligned with the cutout portion 2011 of the barrier 2010 in the assembled antenna unit 2000. The router shelf 2042 can be configured to support the router 2040 and/or a router shell. The router shelf 2042 can be sized to prevent movement of the router shell relative to the internal frame 2032. For example, the router shell can have a transition fit with the router shelf 2042. As such, the router shell can be easily removed by the user, from a top, but fixed when the antenna unit 2000 is in the closed configuration. The router shelf 2042 can include one or more holes 2043 located in a bottom portion of the router shelf 2042. The holes 2043 can be configured to allow the router 2040 and/or the router shell to be exposed to airflow. Similarly, the router shelf 2042 can include a plurality of slots 2045 located in the side walls of the router shelf 2042. The slots 2045 can be configured to allow the router 2040 and/or the router shell to be exposed to airflow.

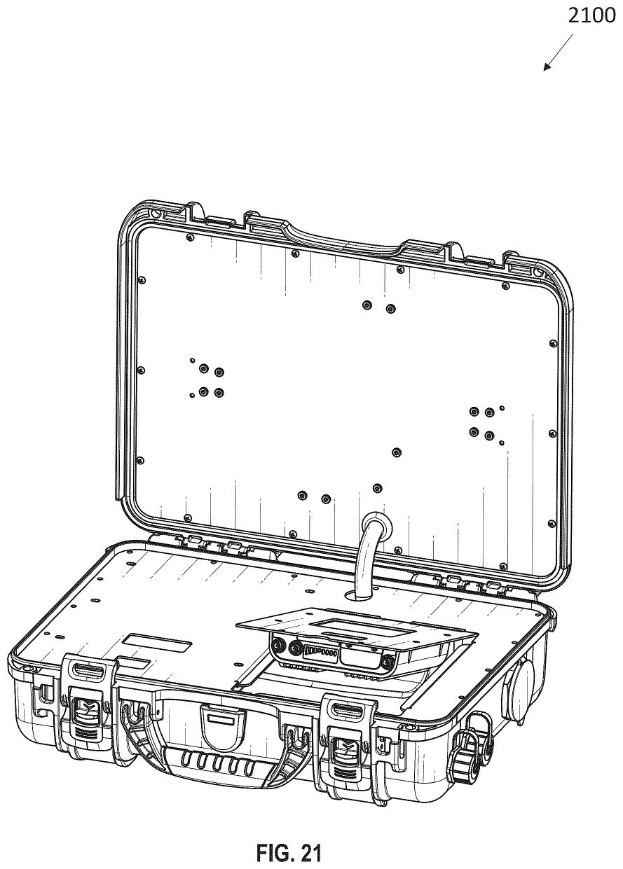

FIG. 21 shows an antenna case system, in accordance with some aspects of this disclosure. FIG. 21 illustrates a perspective view of an antenna unit 2100. Some features of the antenna unit 2100 are similar or identical to features of the antenna units 200, 300, 1900, etc. Thus, reference numerals for various features or components of the antenna units are identical or similar to those used for corresponding features of the other antenna units except for leading digits. Therefore, the structure and description for the various features and operations of the other antenna units are understood to also apply to the corresponding features of the antenna unit 2100, except as shown differently and/or described differently herein.

The configuration in FIG. 21 demonstrates accessible compartments via a hinging door that allow for easy access to batteries or modems or other equipment. The hinging door pivots off the internal frame which allows for some equipment to be installed without removing the internal frame from the case. The hinging door allows for additional equipment to be accessed compared to the configuration in FIG. 19 without removing the internal frame from the case. The hinging door is secured by a minimal number of fasteners that are easily accessible. The hinging door allows for equipment that either slides into place or is secured by a minimal number of fasteners.

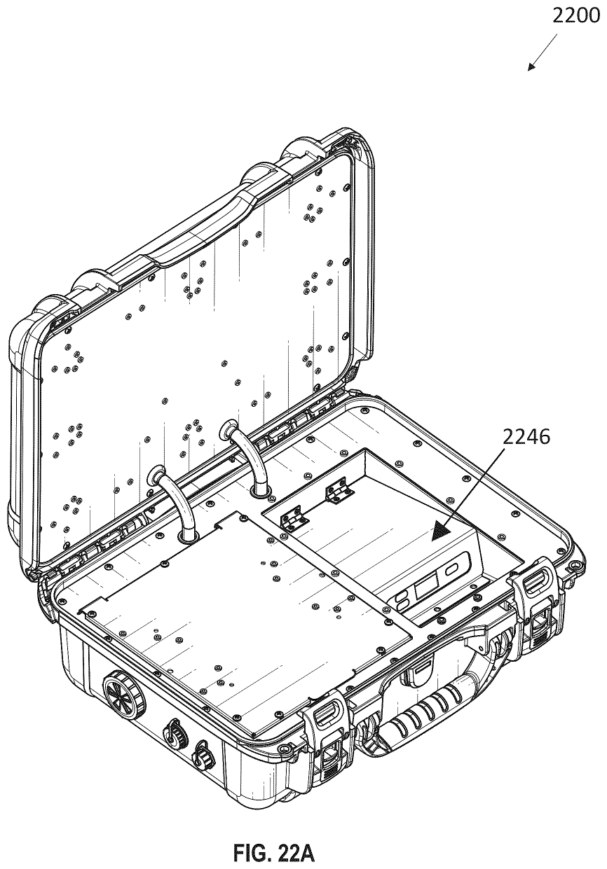

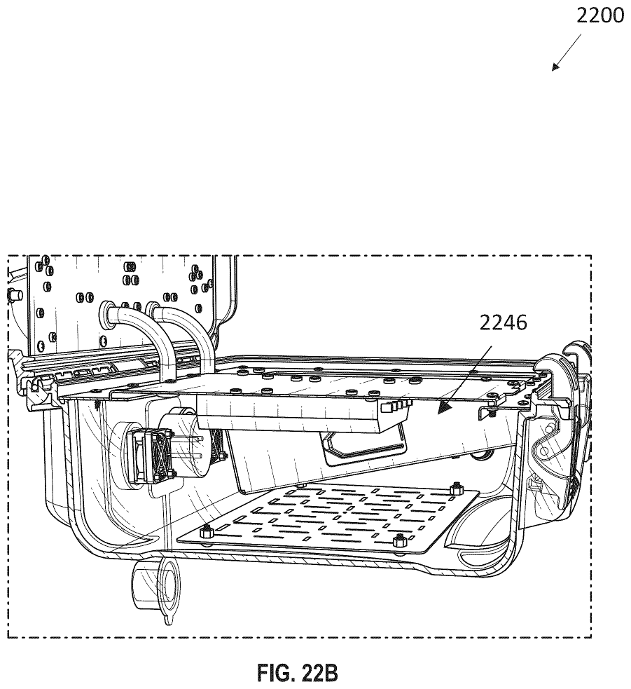

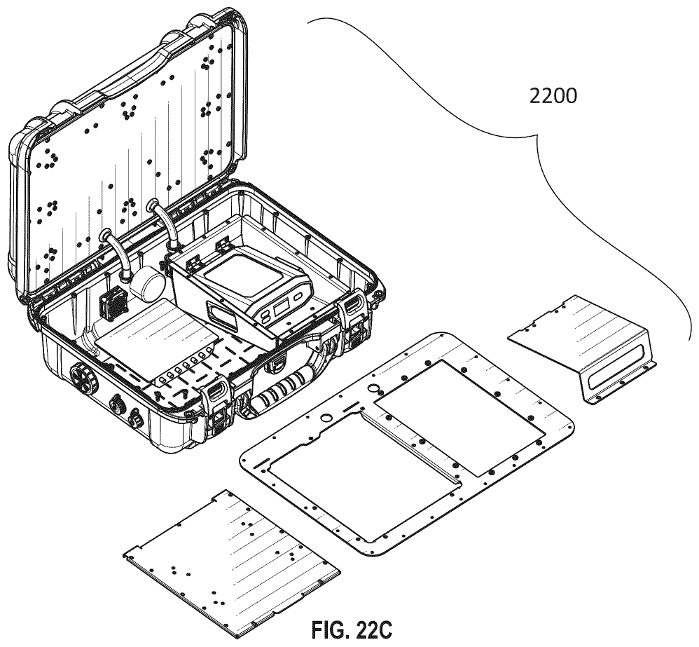

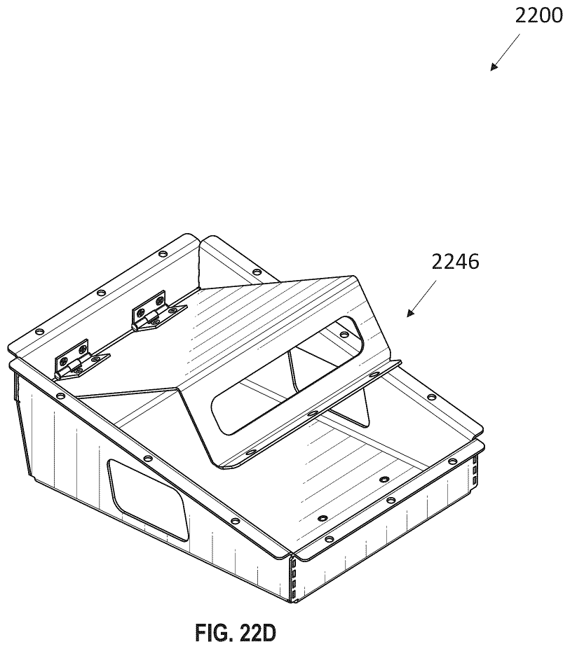

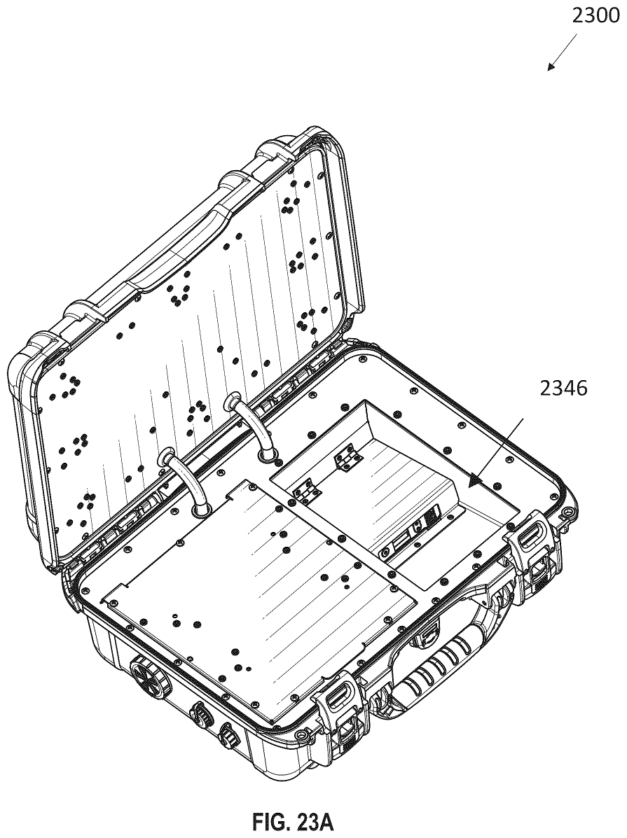

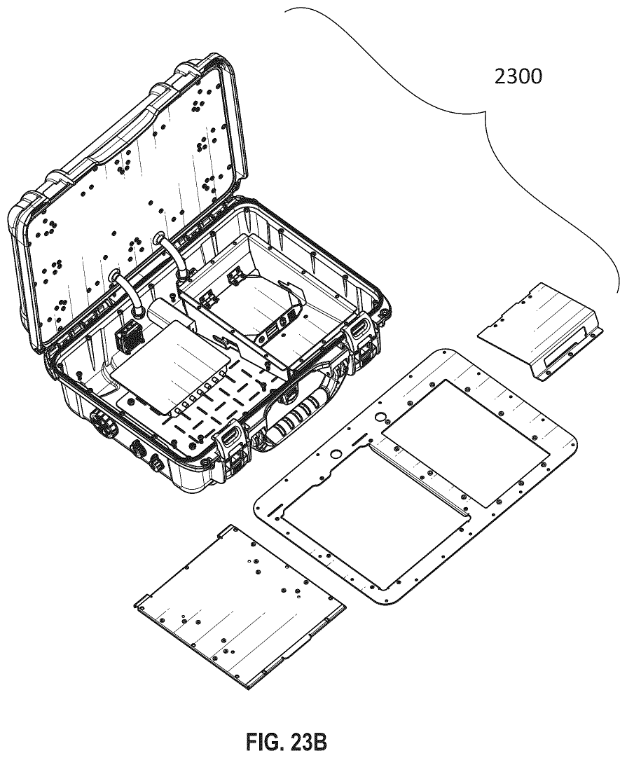

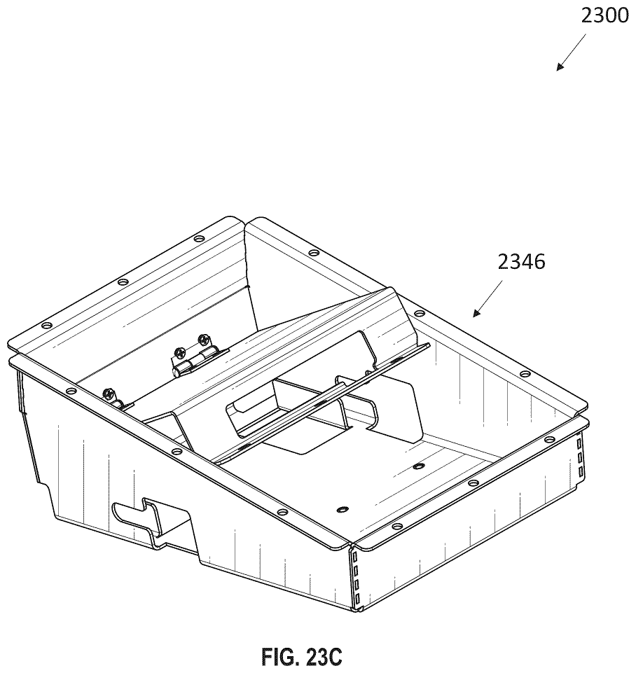

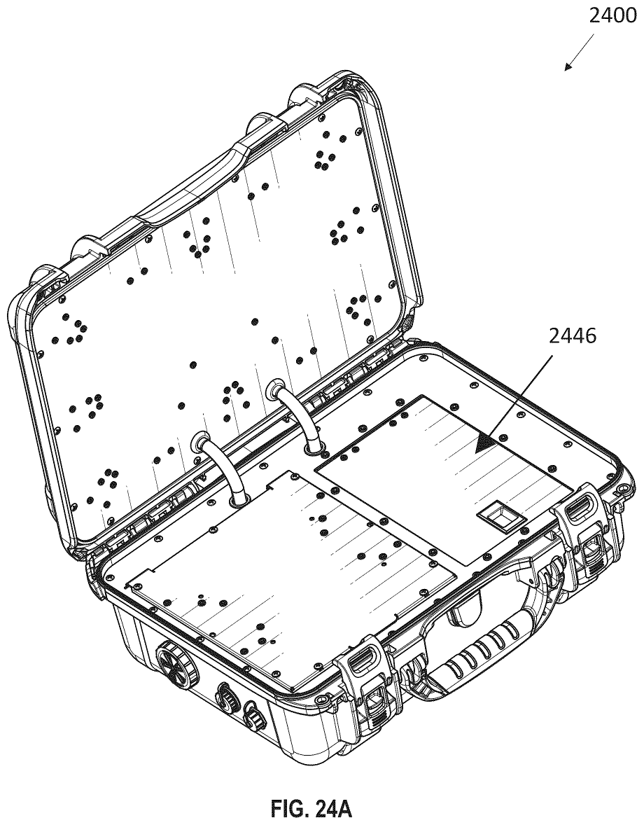

FIGS. 22A-22D and FIGS. 23A-23C show various views of an implementation of an antenna case system, in accordance with some aspects of this disclosure. FIGS. 22A-22D and FIGS. 23A-23C illustrate various views of an antenna unit 2200 and 2300. Some features of the antenna unit 2200 and 2300 are similar or identical to features of the antenna units 200, 300, 1900, etc. Thus, reference numerals for various features or components of the antenna units are identical or similar to those used for corresponding features of the other antenna units except for leading digits. Therefore, the structure and description for the various features and operations of the other antenna units are understood to also apply to the corresponding features of the antenna unit 2200 and 2300, except as shown differently and/or described differently herein. The battery compartments are different in 2200 and 2300, otherwise they have a similar configuration that can have modular changing of battery compartments.

The configuration in FIG. 22 demonstrates accessible compartments via hinging doors that allow for easy access to batteries or modems or other equipment. The hinging doors pivot off the internal frame which allows for some equipment to be installed without removing the internal frame from the case. The hinging doors allow for additional equipment to be accessed compared to the configuration in FIG. 19 without removing the internal frame from the case. The hinging doors are secured by a minimal number of fasteners that are easily accessible. The hinging door on the right hand side allows for equipment that slides into place. The hinging door on the left allows for the mounting of equipment that is secured to the hinging plate for its required thermal and mechanical performance specifications.

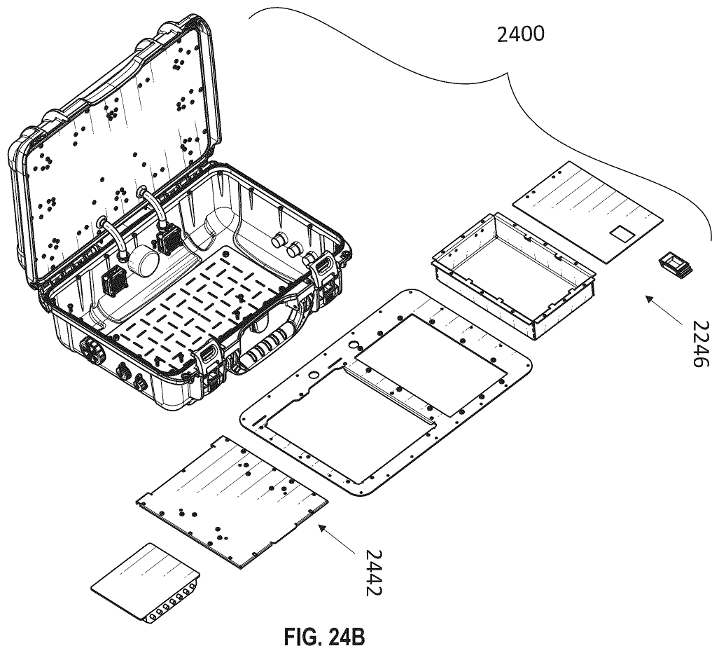

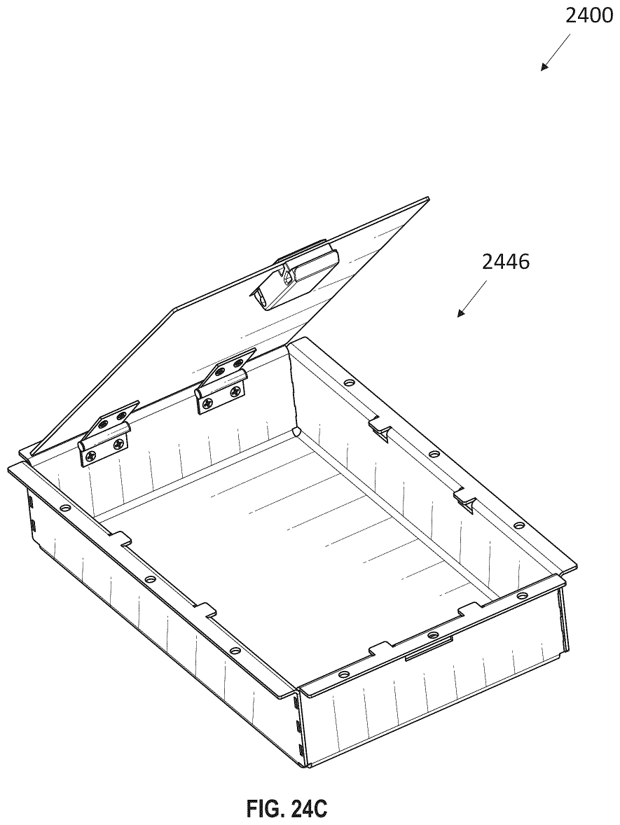

FIGS. 22A-22D show various views of an implementation of an antenna case system. One or more of a router shell, a router plate, a router shelf and/or router enclosure 2242, a battery shelf and/or battery enclosure 2246 can be configured to support, enclose, and/or protect one or more of the router 2240, the battery 2236, and/or other components. These support components 2242, 2246 can be configured and adapted to receive and support a number of different sizes and/or types of routers and/or batteries. These support components 2242, 2246 can be sized and configured to be interchangeable and/or swappable within the base 2206. For example, the support components 2242, 2246 of FIGS. 22A-22D are arranged such that they can be interchanged with the support components 2342, 2346 of FIGS. 23A-23C, and/or with the support components 2442, 2446 of FIGS. 24A-24C as described in more detail herein with reference to those Figures. Providing support components 2242, 2246 in with modular configurations facilitates alternating components or features depending on the use or application of the antenna unit, and also provides manufacturing and assembly benefits to significantly reduce costs based on implementation of assembly procedures for incorporating modular components and facilitating improved manufacturing time and limiting expense during the assembly process.

In some implementations, one or more support components 2242, 2246 can increase the height from which the router 2240 and/or the battery 2236 can be safely dropped from without damage occurring to the router 2240 and/or the battery 2236. For example, in some implementations, the support components 2242, 2246 can be configured for a 3-meter drop test. The support components 2242, 2246 can be configured for use with the antenna unit 2200.

In some implementations, one or more of the support components 2242, 2246 can include a router window and/or a battery window. The router window and/or battery window can be a cutout extending through a top and/or a side of the support components 2242, 2246. The windows can allow for at least a portion of the router and/or battery to be exposed to airflow and visible or accessible to the user.

In some implementations, the support components 2242, 2246 can include a plurality of cutouts or slots. The slots can be configured to promote airflow to the router and/or battery. For example, the slots can be vents. The slots can extend along the one or more walls and/or sides of the support components 2242, 2246. In some implementations, the support components 2242, 2246 can include a plurality of cutouts or holes. The holes can be formed in a top, bottom, and/or side portion of the support components 2242, 2246 and be configured to promote airflow to the router and/or battery. For example, the holes can be vents. The holes can extend through one or more walls and/or sides of the support components 2242, 2246.

The support components 2242, 2246 can include one or more additional cutouts for access to the router and/or the battery. The cutouts can be formed in the top, bottom, and/or side walls of the support components 2242, 2246. For example, the support components 2242, 2246 can include one or more router port cutouts and/or one or more battery port cutouts. The router port cutouts and/or battery port cutouts can provide access through the support components 2242, 2246 to various ports 2252 of the router 2240 (e.g., USB port(s), USB-C port(s), ethernet port(s), etc.) and/or components of the battery 2236. For example, the support components 2242, 2246 can include one or more adaptor cutouts. For example, the support components 2242, 2246 can respectively include a first adaptor cutout and a second adaptor cutout. The adaptor cutouts can be configured to allow cable adaptors and/or power cords for the router and/or battery to pass through one or more of the support components 2242, 2246. The support components 2242, 2246 can also include a power button cutout. The power button cutout can be configured to provide access through the support components 2242, 2246, and/or through the barrier 2210, to a power button of the router, battery, power supply, and/or other components within the base 2206 and/or the lid 2208.

FIGS. 24A-24C show various views of an implementation of an antenna case system, in accordance with some aspects of this disclosure. FIGS. 24A-24C illustrate various views of an antenna unit 2400. Some features of the antenna unit 2400 are similar or identical to features of the antenna units 200, 300, 1900, etc. Thus, reference numerals for various features or components of the antenna units are identical or similar to those used for corresponding features of the other antenna units except for leading digits. Therefore, the structure and description for the various features and operations of the other antenna units are understood to also apply to the corresponding features of the antenna unit 2400, except as shown differently and/or described differently herein.

The configuration in FIG. 24 demonstrates accessible compartments via hinging doors that allow for easy access to batteries or modems or other equipment. The hinging doors pivot off the internal frame which allows for some equipment to be installed without removing the internal frame from the case. The hinging doors allows for additional equipment to be accessed compared to the configuration in FIG. 19 without removing the internal frame from the case. The hinging door on the left is secured by a minimal number of fasteners that are easily accessible. The hinging door on the left allows for the mounting of equipment that is secured to the hinging plate for its required thermal and mechanical performance specifications. The hinging door on the right hand side allows for equipment that fits into a confined space and is secured by a releasable latch.

FIG. 25 shows a case system, an antenna assembly, and another implementation of a multi-band antenna that can be included in any case system and/or antenna assembly described herein, in accordance with some aspects of this disclosure. FIG. 25 illustrates a perspective view of an antenna unit 2500. Some features of the antenna unit 2500 are similar or identical to features of the antenna units 200, 300, 1900, etc. Thus, reference numerals for various features or components of the antenna units are identical or similar to those used for corresponding features of the other antenna units except for leading digits. Therefore, the structure and description for the various features and operations of the other antenna units are understood to also apply to the corresponding features of the antenna unit 2500, except as shown differently and/or described differently herein.

FIG. 25 defines a case system that utilizes a multi-port directional antenna compared to the omni directional antennas installed into the case system defined in FIG. 19. The directional antenna system may also utilize polarization diversity to improve data rates and signal to noise ratio. The directional antenna allows for an increased signal to noise ratio for the radio link when pointed toward the direction of the incoming signal. The higher signal to noise ratio most often allows for higher data rates and extended battery life. When used at the edges of the communication coverage area, the directional antenna most often will establish a usable radio link while the omnidirectional antennas may not be able to establish a useable radio link. The omni directional antenna most often is used with the lid closed or close to being closed for terrestrial communication while the directional antenna presented in this configuration would most likely be used with the lid open for typical terrestrial communication. The reversed configurations are true when establishing satellite telecommunication links.

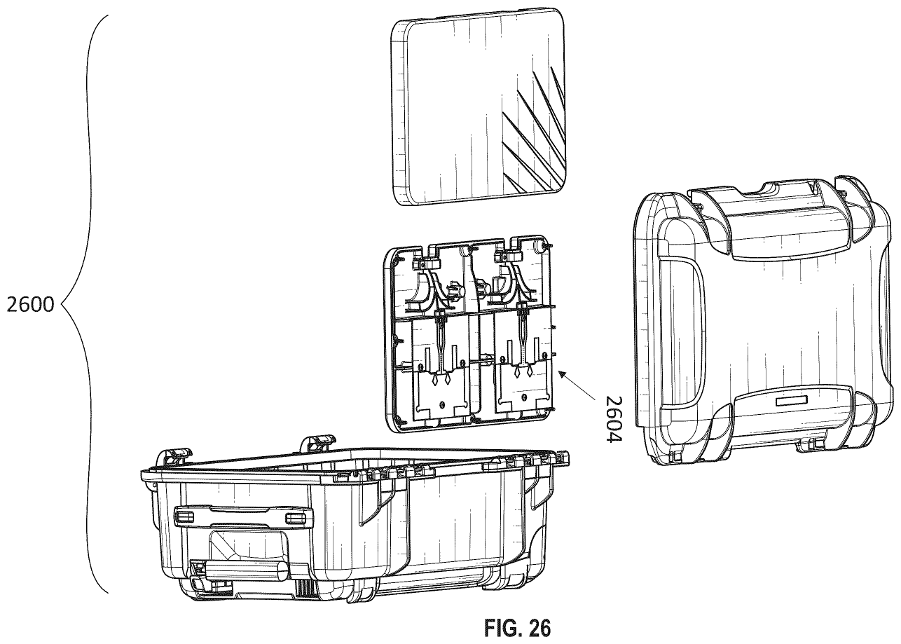

FIG. 26 shows a case system, an antenna assembly, and another implementation of a multi-band antenna that can be included in any case system and/or antenna assembly described herein, in accordance with some aspects of this disclosure. FIG. 26 illustrates a perspective view of an antenna unit 2600. Some features of the antenna unit 2600 are similar or identical to features of the antenna units 200, 300, 1900, etc. Thus, reference numerals for various features or components of the antenna units are identical or similar to those used for corresponding features of the other antenna units except for leading digits. Therefore, the structure and description for the various features and operations of the other antenna units are understood to also apply to the corresponding features of the antenna unit 2600, except as shown differently and/or described differently herein.

FIG. 26 defines a case system that utilizes an omni directional antenna that will work best in a terrestrial communication setting with the lid open when compared to the omni directional antennas installed into the case system defined in FIG. 19 that will typically work best with the lid closed or mostly closed for terrestrial communication.

FIG. 26 illustrates an antenna unit 2600. The antenna unit 2600 is configured and adapted to provide for an omni antenna assembly 2604 in the lid. According to some implementations, the antenna unit 2600 is configured and adapted to provide a combination antenna that can have WiFi and/or GPS.

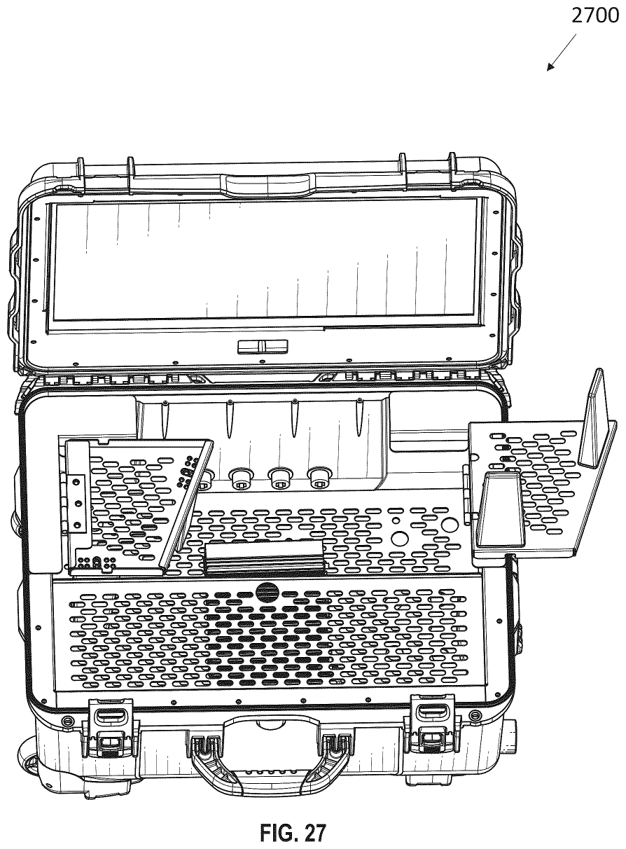

FIG. 27 shows a case system and an antenna assembly that can be included in any case system and/or antenna assembly described herein, in accordance with some aspects of this disclosure. FIG. 27 illustrates a perspective view of an antenna unit 2700. Some features of the antenna unit 2700 are similar or identical to features of the antenna units 200, 300, 1900, etc. Thus, reference numerals for various features or components of the antenna units are identical or similar to those used for corresponding features of the other antenna units except for leading digits. Therefore, the structure and description for the various features and operations of the other antenna units are understood to also apply to the corresponding features of the antenna unit 2700, except as shown differently and/or described differently herein.

The case configuration in FIG. 27 demonstrates the outboarding of the antennas components when the lid is open. This configuration allows for spatial separation of the antennas from the work area when the lid is used to house a monitor, and the case holds the components for a terminal or computer station. Placing the antennas on groundplanes away from the user work area allows for better antenna performance which allows for better connectivity and data rates and provides a comfortable work area for the user.

FIG. 27 illustrates an antenna unit 2700. The antenna unit 2700 is shown with wheels coupled to the base 2706 configured and adapted to provide for easy transportation of the case system. The base 2706 can have a larger first internal volume compared to the antenna unit 2700. The first internal volume can be configured and adapted to be spacious to store equipment and can be provided with a robust design to protect the internal equipment. FIG. 2700 can be configured and adapted for storing other devices, batteries, and/or routers. The antenna unit 2700 can include one or more additional antennas. The one or more additional antennas can be one or more swivel antennas 2770. The swivel antennas 2770 can be positioned in a packed configuration when the lid 2708 is closed and can be repositioned to a deployed configuration when the lid 2708 is open, as shown in FIG. 27. The antenna unit 2700 can include a mini desk and/or vented supports.

FIG. 28 shows a case system, an antenna assembly, and an implementation of a command center module having a multi-band antenna system, in accordance with some aspects of this disclosure. FIG. 28 illustrates a perspective view of an antenna unit 2800. Some features of the antenna unit 2800 are similar or identical to features of the antenna units 200, 300, 1900, etc. Thus, reference numerals for various features or components of the antenna units are identical or similar to those used for corresponding features of the other antenna units except for leading digits. Therefore, the structure and description for the various features and operations of the other antenna units are understood to also apply to the corresponding features of the antenna unit 2800, except as shown differently and/or described differently herein.

The case configuration in FIG. 28 demonstrates the outboarding of the antennas components when the lid is open. This configuration allows for spatial separation of the antennas from the work area when the lid is used to house a monitor, and the case holds the components for a terminal or computer station. Placing the antennas on groundplanes away from the user work area allows for better antenna performance which allows for better connectivity and data rates and provides a comfortable work area for the user. There are many different antenna types that are suitable for use on the hinged grounplanes.

FIG. 28 illustrates an antenna unit 2800. The antenna unit 2800 has wheels coupled to the base 2806 configured and adapted to provide for easy transportation of the case system. The base 2806 can have a larger first internal volume compared to the antenna unit 2800. The first internal volume can be configured and adapted to be spacious to store equipment and can be provided with a robust design to protect the internal equipment. FIG. 2800 can be configured and adapted for storing other devices, batteries, and/or routers. The antenna unit 2800 can include one or more additional antennas. The one or more additional antennas can be one or more swivel antennas 2870. The swivel antennas 2870 can be positioned in a packed configuration when the lid 2808 is closed and can be repositioned to a deployed configuration when the lid 2808 is open, as shown in FIG. 28. The antenna unit 2800 can include a screen 2872. The antenna unit 2800 can include a mini desk. The antenna unit 2800 can include a keyboard 2874.

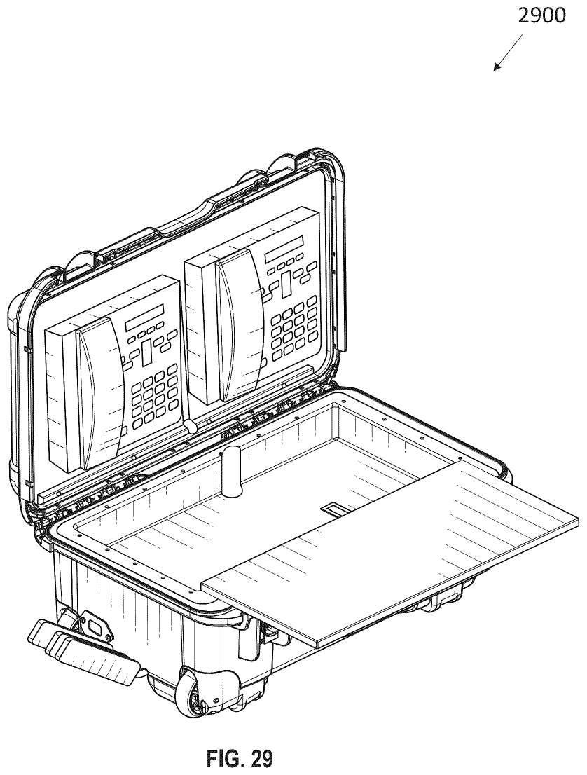

FIG. 29 shows a case system, an antenna assembly, and an implementation of a command center module having one or more phone systems, in accordance with some aspects of this disclosure. FIG. 29 illustrates a perspective view of an antenna unit 2900. Some features of the antenna unit 2900 are similar or identical to features of the antenna units 200, 300, 1900, etc. Thus, reference numerals for various features or components of the antenna units are identical or similar to those used for corresponding features of the other antenna units except for leading digits. Therefore, the structure and description for the various features and operations of the other antenna units are understood to also apply to the corresponding features of the antenna unit 2900, except as shown differently and/or described differently herein.

The case system in FIG. 29 demonstrates the extensive nature of the equipment that can be installed in a case system.

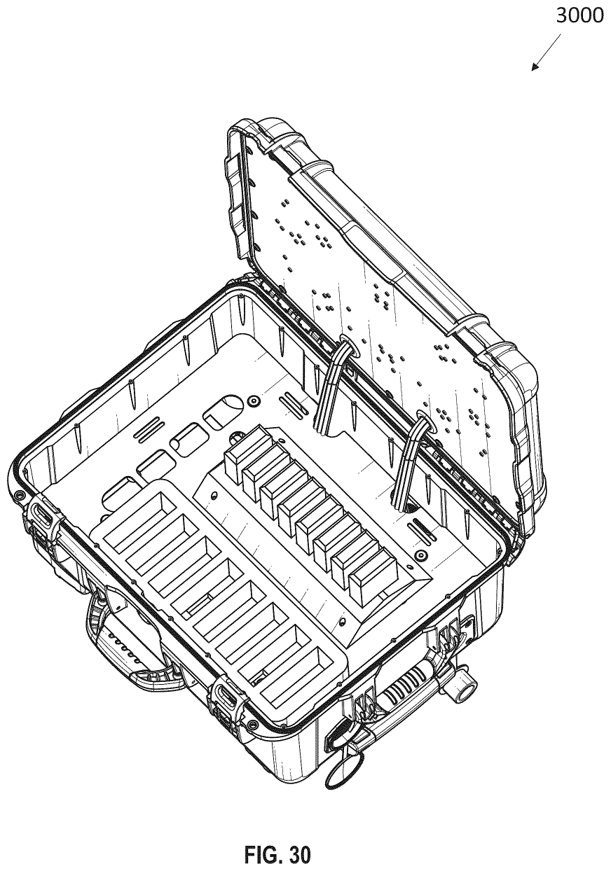

FIG. 30 shows a case system configured and adapted for body camera systems, including an antenna assembly, and cushioned storage features that can be included in any case system and/or antenna assembly described herein, in accordance with some aspects of this disclosure. FIG. 30 illustrates a perspective view of an antenna unit 3000. Some features of the antenna unit 3000 are similar or identical to features of the antenna units 200, 300, 1900, etc. Thus, reference numerals for various features or components of the antenna units are identical or similar to those used for corresponding features of the other antenna units except for leading digits. Therefore, the structure and description for the various features and operations of the other antenna units are understood to also apply to the corresponding features of the antenna unit 3000, except as shown differently and/or described differently herein.

The case system in FIG. 30 demonstrates the extensive nature of the equipment that can be installed in a case system. The case system allows for the wireless uploading of the content in the body cameras as well as the charging of the body cameras for use at a later date. The antenna unit 3000 can also include one or more foam inserts within the base 3006 configured and adapted for storing other devices, such as, for example, cameras, body cameras, communication systems, batteries, and/or routers.

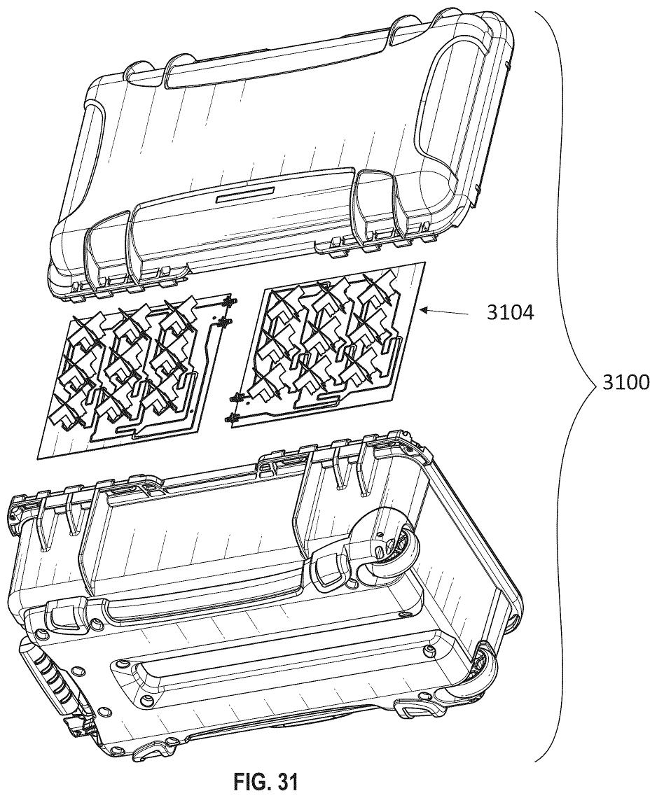

FIG. 31 shows a case system, an antenna assembly, and another implementation of a directional multi-band antenna that can be included in any case system and/or antenna assembly described herein, in accordance with some aspects of this disclosure. FIG. 31 illustrates a perspective view of an antenna unit 3100. Some features of the antenna unit 3100 are similar or identical to features of the antenna units 200, 300, 1900, etc. Thus, reference numerals for various features or components of the antenna units are identical or similar to those used for corresponding features of the other antenna units except for leading digits. Therefore, the structure and description for the various features and operations of the other antenna units are understood to also apply to the corresponding features of the antenna unit 3100, except as shown differently and/or described differently herein. FIG. 31 is a similar system to FIG. 25 using a directional antenna system in an advantageous case configuration.

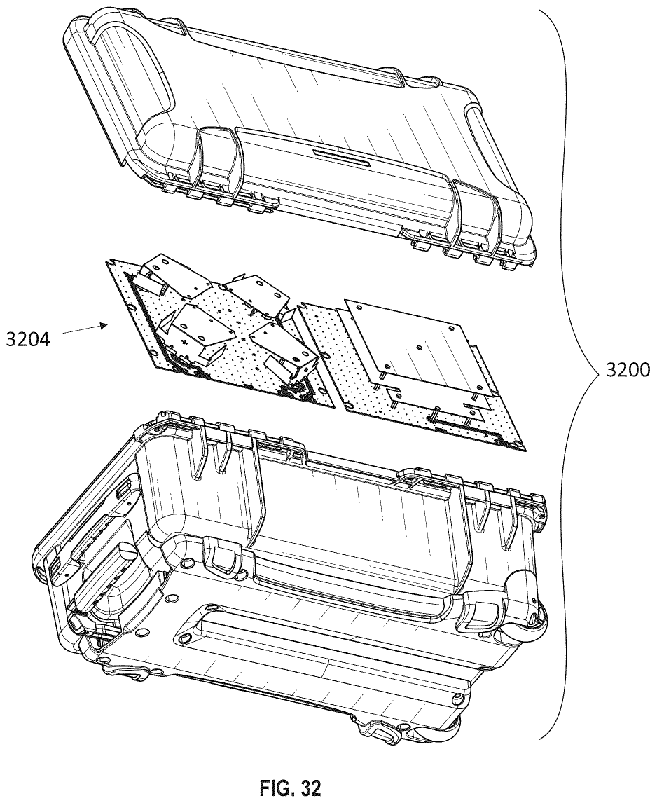

FIG. 32 shows a case system, an antenna assembly, and an implementation of a directional multi-band antenna that can be included in any case system and/or antenna assembly described herein, in accordance with some aspects of this disclosure. FIG. 32 illustrates a perspective view of an antenna unit 3200. Some features of the antenna unit 3200 are similar or identical to features of the antenna units 200, 300, 1900, etc. Thus, reference numerals for various features or components of the antenna units are identical or similar to those used for corresponding features of the other antenna units except for leading digits. Therefore, the structure and description for the various features and operations of the other antenna units are understood to also apply to the corresponding features of the antenna unit 3200, except as shown differently and/or described differently herein.

FIG. 32 demonstrates the use of multiport directional antennas as well as narrow band directional antennas that can be used with high power user equipment (HPUE). FIG. 32 defines a case system that utilizes a multi-port directional antenna compared to the omni directional antennas installed into the case system defined in FIG. 19. The directional antenna system may also utilize polarization diversity to improve data rates and signal to noise ratio. The directional antenna allows for an increased signal to noise ratio for the radio link when pointed toward to direction of the incoming signal. The higher signal to noise ratio most often allows for higher data rates and extended battery life. When used at the edges of the communication coverage area, the directional antenna most often will establish a usable radio link while the omnidirectional antennas may not be able to establish a useable radio link. The omni directional antenna most often is used with the lid closed or close to being closed for terrestrial communication while the directional antenna presented in this configuration would most likely be used with the lid open for typical terrestrial communication. The reversed configurations are true when establishing satellite telecommunication links.

In some implementations, an antenna unit 3200 has an antenna assembly 3204 that can be configured to be supported by one or more ground planes 3220 in an arrangement with the one or more ground planes 3220 positioned below the lid 3208, (e.g., on a horizontal surface during use). In some implementations, the ground planes 3220 and/or antenna case unit 3200 can be configured to be mounted vertically, and/or coupled to a vertical surface (e.g., a wall, a side of a compartment, a pole, etc.). Mounting the antenna assembly vertically (e.g., directly and/or by an additional component) can provide certain advantages, particularly when the antenna is configured as a directional antenna, as described herein. In some cases, the antenna assembly 3204 can be configured as a directional antenna, such as when one or more multi-band radiator portions 1200 of FIGS. 17A-17G and/or one or more stacked patch antennas 1100 of FIG. 16 are included in the antenna assembly 3200. When the antenna assembly 3200 is configured as a directional antenna, mounting the antenna assembly 3200 on the wall can provide certain advantages. For example, a wall-mounted antenna assembly 3200 can allow for an elevated position, which can provide a clearer line of sight to the device or networks the antenna assembly 3200 is intending to communicate with (e.g., by reducing obstructions such as furniture, people, other objects) compared to if the antenna assembly 3200 was positioned on a table. The wall-mounting of the antenna assembly 3200 can also reduce potential interferences from other electronic devices positioned near the antenna assembly 3200, which can improve signal quality and consistency in some cases. A wall-mounted antenna assembly 3200 configured as a directional antenna can be aimed in a specific direction. For example, by wall-mounting, the antenna assembly 3200 can be strategically pointed towards an area or device.

In some implementations, when the antenna assembly 3200 is configured as a directional antenna (e.g., including one or more stacked patch antennas 1100 and/or multi-band radiator portions 1200) it can be advantageous to position the base 3202 on a horizontal surface in some cases (e.g., to point vertically). For example, such an arrangement can be desirable when the antenna assembly 3200 is configured to communicate with a satellite. In this example, the vertical direction of the antenna assembly 3200 can provide improved line of sight to the satellite(s). For example, pointing the antenna assembly 3200 vertically toward the satellite ensures the strongest possible signal is directed at the target. Misalignment could result in signal loss or weak reception. In some cases, satellite communication systems often require precise alignment in both azimuth (horizontal) and elevation (vertical) to maintain an optimal connection. A vertically oriented antenna assembly 3200 configured as a directional antenna can be aimed at a specific elevation angle that matches the satellite's position relative to the ground station. An additional advantage of pointing the antenna assembly 3200 vertically can include minimizing interference from terrestrial signals and reflections from the ground or nearby objects, which can be especially important when communicating with high-altitude satellites.

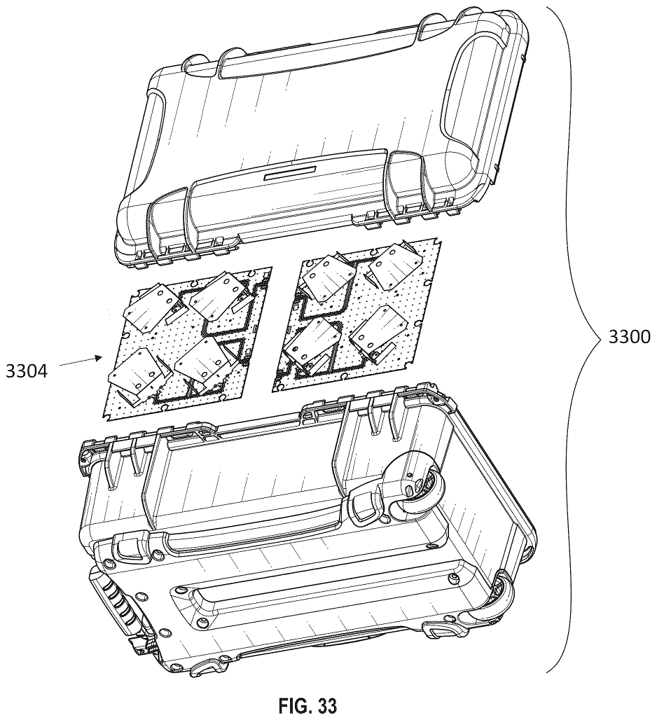

FIG. 33 shows a case system, an antenna assembly, and an implementation of a directional multi-band antenna that can be included in any case system and/or antenna assembly described herein, in accordance with some aspects of this disclosure. FIG. 33 illustrates a perspective view of an antenna unit 3300. Some features of the antenna unit 3300 are similar or identical to features of the antenna units 200, 300, 1900, etc. Thus, reference numerals for various features or components of the antenna units are identical or similar to those used for corresponding features of the other antenna units except for leading digits. Therefore, the structure and description for the various features and operations of the other antenna units are understood to also apply to the corresponding features of the antenna unit 3300, except as shown differently and/or described differently herein.

FIG. 33 demonstrates the use of multiport directional antennas. FIG. 33 defines a case system that utilizes a multi-port directional antenna compared to the omni directional antennas installed into the case system defined in FIG. 19. The directional antenna system may also utilize polarization diversity to improve data rates and signal to noise ratio. The directional antenna allows for an increased signal to noise ratio for the radio link when pointed toward to direction of the incoming signal. The higher signal to noise ratio most often allows for higher data rates and extended battery life. When used at the edges of the communication coverage area, the directional antenna most often will establish a usable radio link while the omnidirectional antennas may not be able to establish a useable radio link. The omni directional antenna most often is used with the lid closed or close to being closed for terrestrial communication while the directional antenna presented in this configuration would most likely be used with the lid open for typical terrestrial communication. The reversed configurations are true when establishing satellite telecommunication links. In other implementations, the antenna PCB portion assemblies can be rotated 90 degrees so that the connectors point towards the case and not towards the neighboring PCB antenna assembly portion for advantageous benefits.

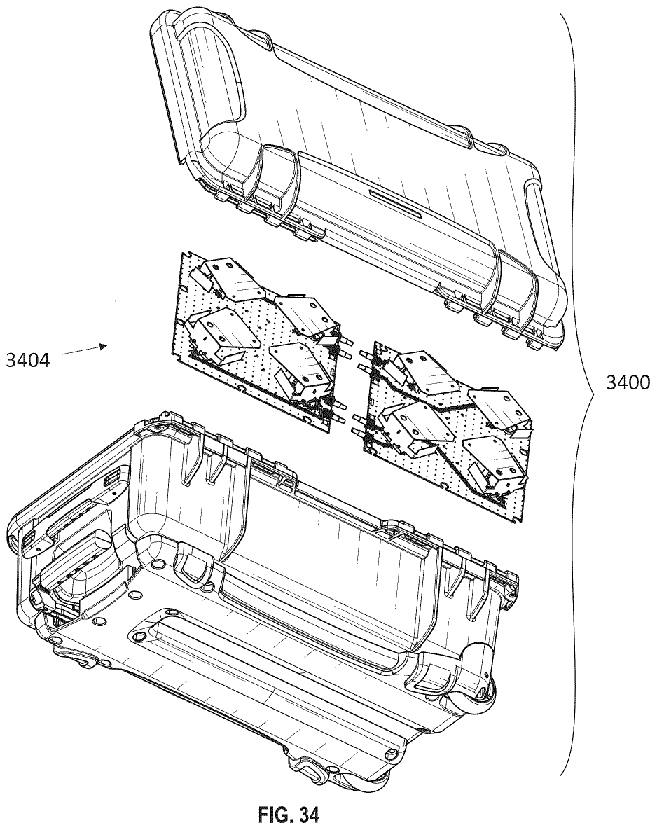

FIG. 34 shows a case system, an antenna assembly, and an implementation of a directional multi-band antenna that can be included in any case system and/or antenna assembly described herein, in accordance with some aspects of this disclosure. FIG. 34 illustrates a perspective view of an antenna unit 3400. Some features of the antenna unit 3400 are similar or identical to features of the antenna units 200, 300, 1900, etc. Thus, reference numerals for various features or components of the antenna units are identical or similar to those used for corresponding features of the other antenna units except for leading digits. Therefore, the structure and description for the various features and operations of the other antenna units are understood to also apply to the corresponding features of the antenna unit 3400, except as shown differently and/or described differently herein.

FIG. 34 demonstrates the use of multiport directional antennas for high port count systems. FIG. 34 defines a case system that utilizes a multi-port directional antenna compared to the omni directional antennas installed into the case system defined in FIG. 19. The directional antenna system may also utilize polarization diversity to improve data rates and signal to noise ratio. The directional antenna allows for an increased signal to noise ratio for the radio link when pointed toward to direction of the incoming signal. The higher signal to noise ratio most often allows for higher data rates and extended battery life. When used at the edges of the communication coverage area, the directional antenna most often will establish a usable radio link while the omnidirectional antennas may not be able to establish a useable radio link. The omni directional antenna most often is used with the lid closed or close to being closed for terrestrial communication while the directional antenna presented in this configuration would most likely be used with the lid open for typical terrestrial communication. The reversed configurations are true when establishing satellite telecommunication links.

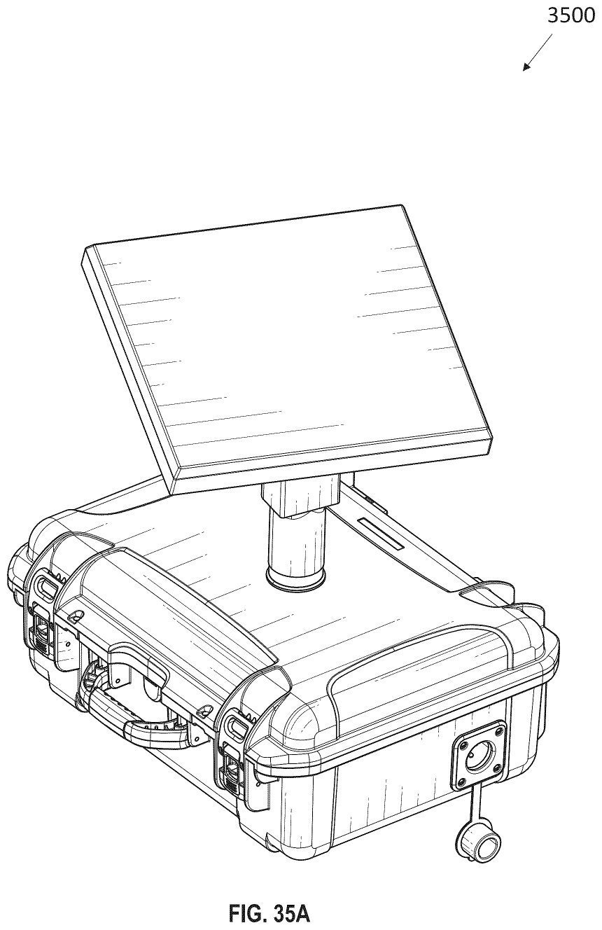

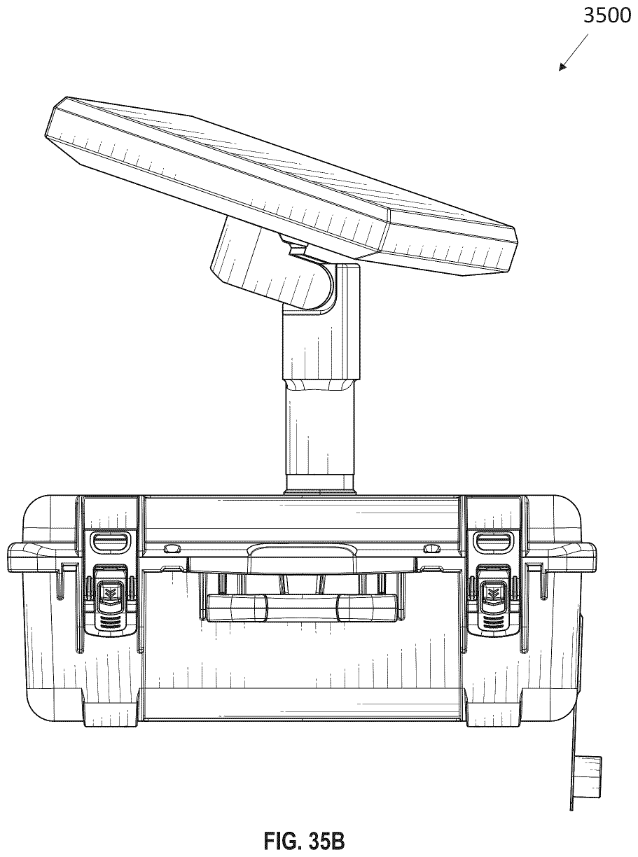

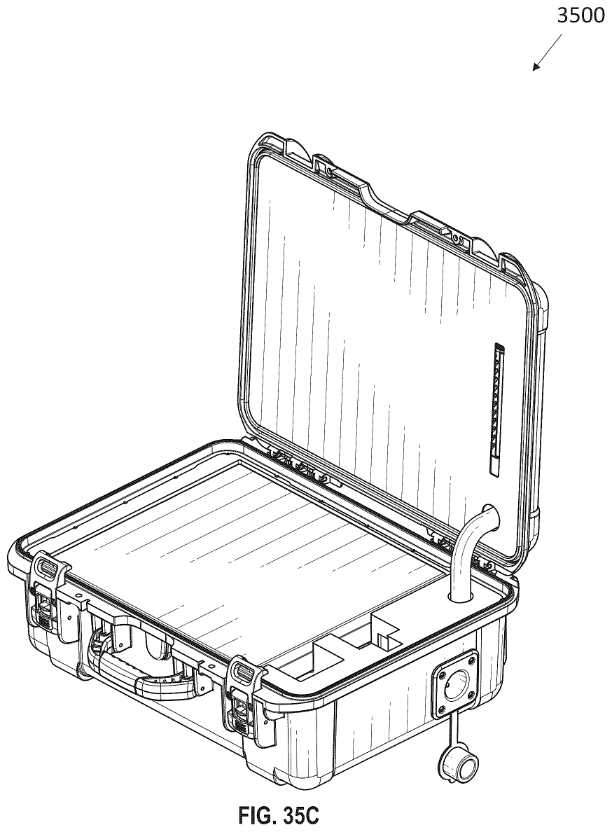

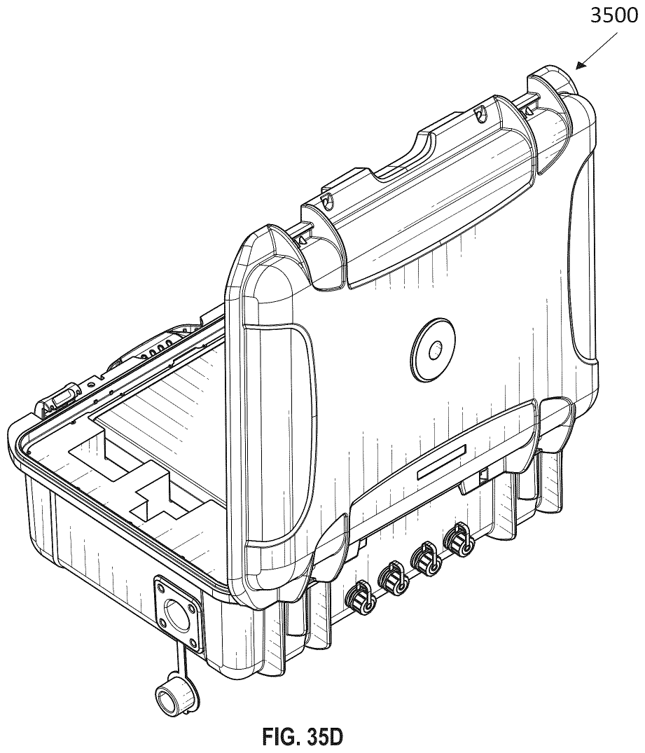

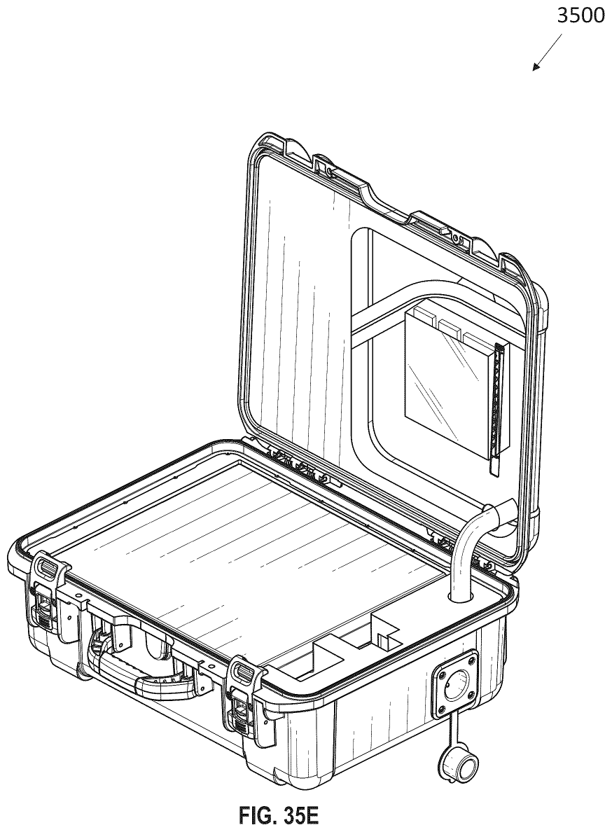

FIGS. 35A-35E show various views of an antenna case configured to support and connect to a satellite terminal, in accordance with some aspects of this disclosure. FIGS. 35A-35E illustrate various views of an antenna unit 3500. Some features of the antenna unit 3500 are similar or identical to features of the antenna units 200, 300, 1900, etc. Thus, reference numerals for various features or components of the antenna units are identical or similar to those used for corresponding features of the other antenna units except for leading digits. Therefore, the structure and description for the various features and operations of the other antenna units are understood to also apply to the corresponding features of the antenna unit 3500, except as shown differently and/or described differently herein.

FIG. 35 demonstrates one implementation of a satellite communication antenna and radio system that is mounted external to the case once it is deployed and is used to provide a wireless internet communications backhaul. The case system will hold the modem for the satellite communication antenna as well as the modem for the terrestrial based communication system. The lid of the case will hold antenna portions similar in nature to those of FIG. 19. When in a transport and non-operational configuration, the satellite communication equipment and antenna portions are housed internal to the case system.

Various examples of devices, systems, and methods relating to antenna systems having satellite antenna capabilities and case configurations are described herein. Many of the disclosed components and configurations can be implemented in combination with other features and aspects of antenna and case systems disclosed herein.

FIGS. 35A-35E illustrate an example implementation of a satellite terminal antenna case. The antenna case can be configured to support and connect to a satellite terminal. In some implementations, the antenna case can be configured to be mobile and/or for portable use. In some implementations, the antenna case can be configured for satellite and/or cellular network operations. In some implementations, the antenna case can be configured to provide superfast data transmission speeds. In some implementations, the antenna case can comprise a rugged housing. The rugged housing can be configured to be tamper resistant. In some implementations, the antenna case can be configured for operations in the 600 MHZ to 6 GHz range. In some implementations, the antenna case can operate on the Citizens Broadband Radio Service (CBRS) bands. In some implementations, the antenna case can operate on the Private LTE (PLTE) bands. In some implementations, the antenna case can be IP67 rated. In some implementations, the antenna case can be sized for airplane travel. For example, the antenna case can be as small as or smaller than a traditional carry-on bag and/or personal item. In some implementations, the antenna case can have an internal volume of less than 3250 cubic inches.

In some implementations of a satellite terminal antenna case, the length of the antenna unit 3500 can be between about 20 inches to about 23 inches, or any value or range between any of these values or ranges or any value or range bounded by any combination of these values, although values or ranges outside these values or ranges can be used in some cases. In some implementations, the width of the antenna unit 3500 can be between about 16 inches to about 18 inches, or any value or range between any of these values or ranges or any value or range bounded by any combination of these values, although values or ranges outside these values or ranges can be used in some cases. In some implementations, the height of the antenna unit 3500 can be between about 7 inches to about 10 inches, or any value or range between any of these values or ranges or any value or range bounded by any combination of these values, although values or ranges outside these values or ranges can be used in some cases. In some implementations, the height of the base 3506 can be between about 5 inches to about 7 inches, or any value or range between any of these values or ranges or any value or range bounded by any combination of these values, although values or ranges outside these values or ranges can be used in some cases. In some implementations, the height of the lid 3508 can be between about 1 inch to about 3 inches, or any value or range between any of these values or ranges or any value or range bounded by any combination of these values, although values or ranges outside these values or ranges can be used in some cases.

In some implementations, the antenna case can have LTE frequency ranges of 617-894 MHz, 1710-2700 MHz, 3300-4000 MHz (CBRS), and/or 5150-5925 MHz (LTE LAA). In some implementations, the antenna case can have WiFi frequency ranges of 2400-2483.5 MHz and/or 4900-5900 MHz. In some implementations, an antenna assembly 3504 can be provided within the case. The antenna assembly 3504 can be positioned within the lid in some implementations. The antenna assembly 3504 can comprise a multi-band antenna system including one or more of cellular antennas, WiFi antennas, and GPS within the lid. Other locations for the antenna systems are also possible and contemplated. A router can be positioned in the base. A battery can be positioned within the base and/or the lid. In some implementations, the antenna unit can comprise wheels to facilitate transportation.

As shown in FIGS. 35A-35E, the antenna case can be configured to support a satellite terminal. The satellite terminal may be mountable to the lid of the antenna case. The antenna case has a lid that can be positioned in a closed configuration or an open configuration, in accordance with some implementations. In some implementations, the satellite terminal can be removable from the lid and can be stored within the housing of the antenna case. Storing the satellite terminal within the housing can allow the antenna case to be easily transportable (e.g., for air travel).

In some implementations, the antenna case can store one or more antennas within the lid. For example, one or more MIMO LTE antennas, one or more MIMO WiFi antennas, one or more Bluetooth antennas, one or more GPS/GNSS antennas, and/or the like. For example, in one implementation, the antenna case may include 4×4 MIMO LTE antennas and/or 4×4 MIMO WiFi antennas. In some implementations, the antenna case can be configured to be AC powered and/or DC powered. The antenna case may also house a router. In some cases, the router may be removably housed within the case. In some implementations, the antenna case may house the router in the lid of the case.

A power port can extend through the side of the case housing. In some implementations, the antenna case can include one or more ethernet ports that can extend through the side of the housing. While some Figures may suggest and/or reference a particular type or brand of satellite and/or satellite terminal (e.g., Intelsat), it is recognized that the antenna case can be used with any suitable satellite and/or satellite terminal (e.g., including Starlink satellites and/or satellite terminals, etc.). In some cases, the type of satellite and/or satellite terminal may dictate the size of the antenna case.

The antenna case can also include an antenna mount that may extend into the lid of the case. The antenna mount can be used to electrically and/or mechanically connect the satellite terminal to the antenna case. In some implementations, the antenna case can include one or more ethernet ports. The satellite terminal can be positioned within the antenna case in some implementations. In some implementations, the antenna case may include a foam insert which can be stored within the case. The insert can secure the satellite terminal and may include one or more holes or cutouts for cable management.

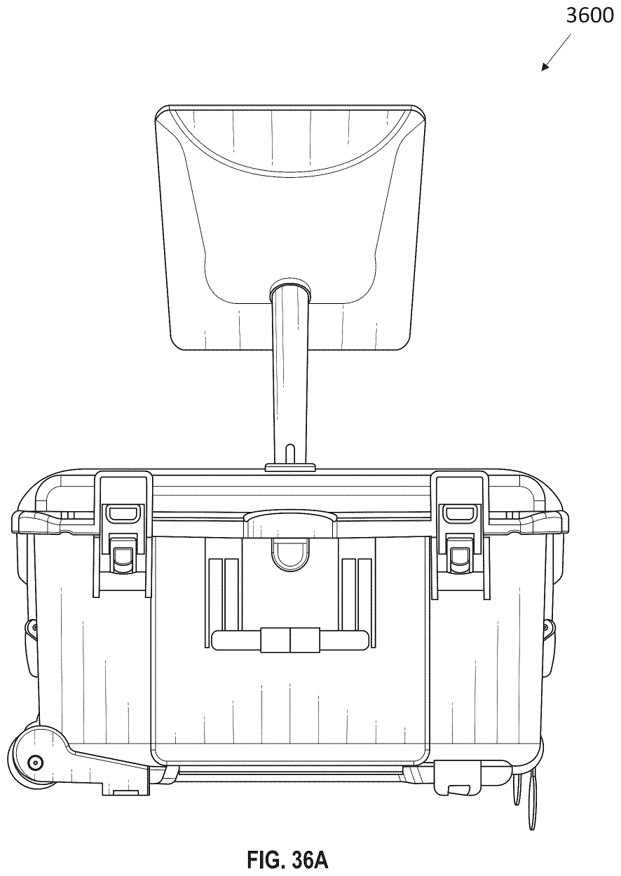

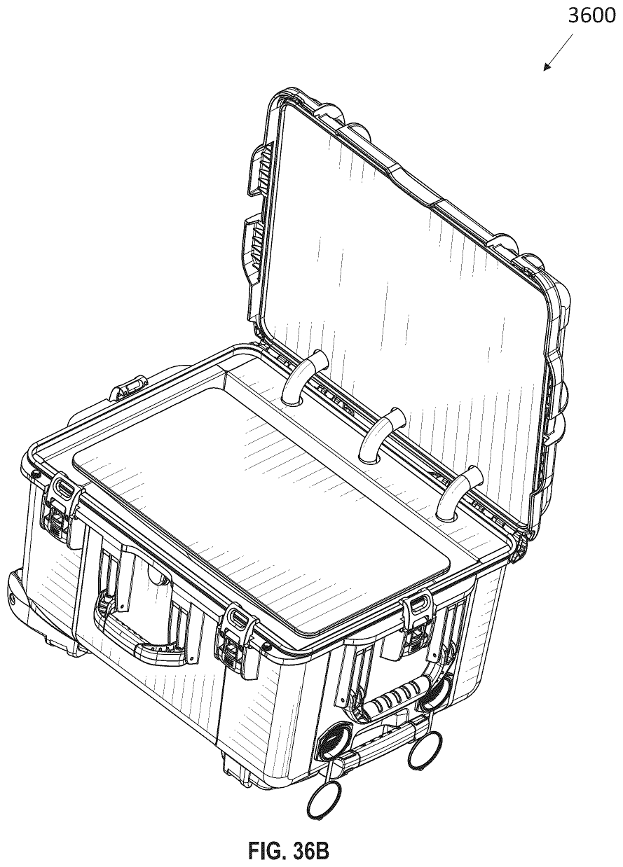

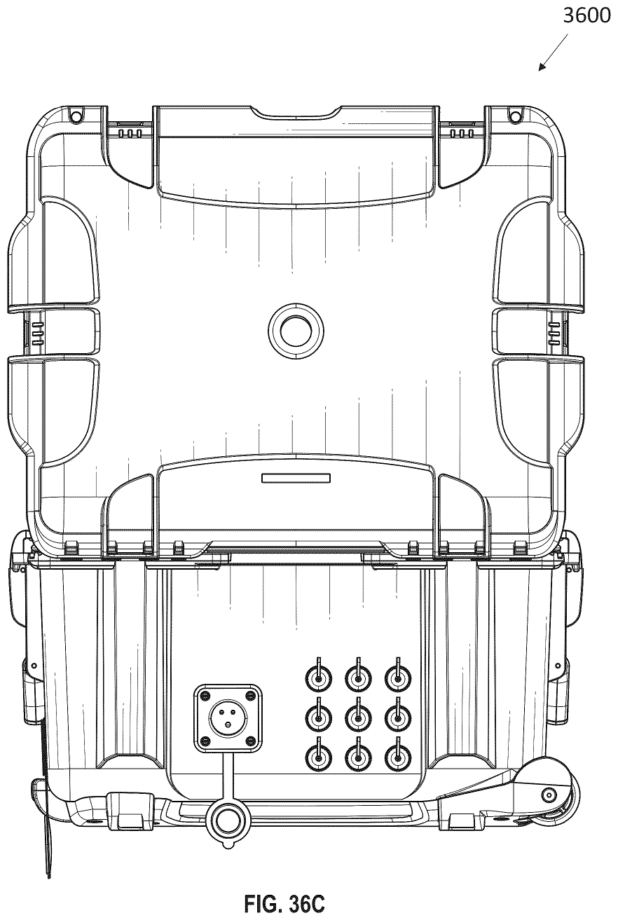

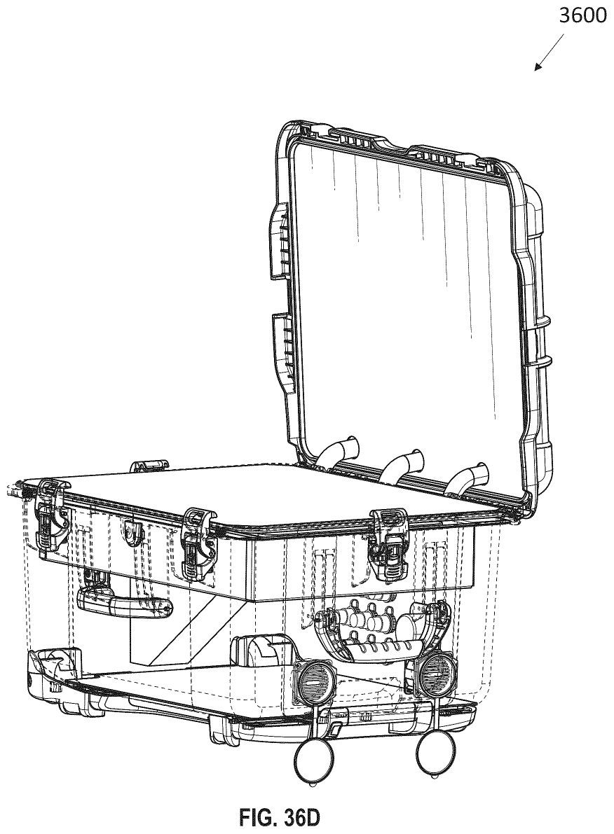

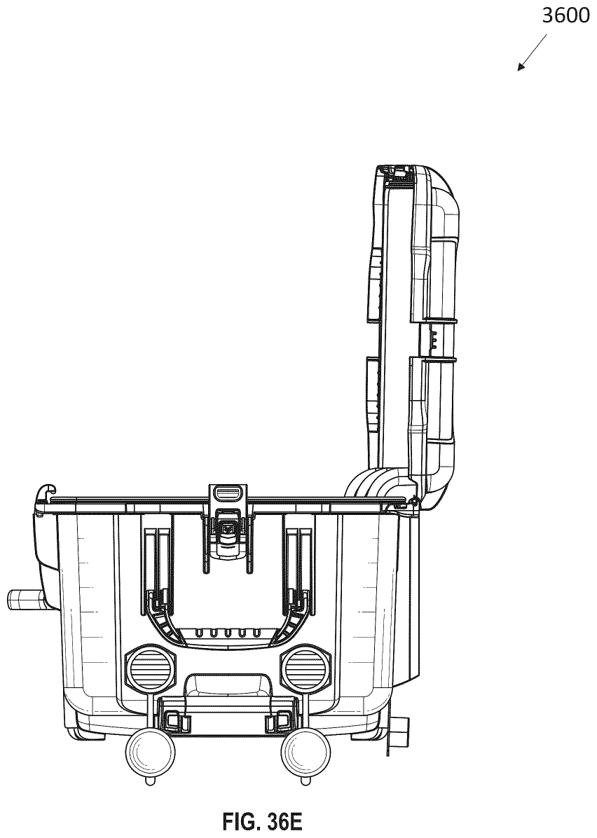

FIGS. 36A-36E, and 37, and 38 show various views of another implementation of an antenna case configured to support and connect to a satellite terminal, in accordance with some aspects of this disclosure. FIGS. 36A-36E, 37, and 38 illustrate various views of an antenna unit 3600. Some features of the antenna unit 3600 are similar or identical to features of the antenna units 200, 300, 1900, etc. Thus, reference numerals for various features or components of the antenna units are identical or similar to those used for corresponding features of the other antenna units except for leading digits. Therefore, the structure and description for the various features and operations of the other antenna units are understood to also apply to the corresponding features of the antenna unit 3600, except as shown differently and/or described differently herein.

FIGS. 36A to 38 demonstrate one implementation of a satellite communication antenna and radio system that is stored and/or mounted for external and/or internal use within the case. In some configurations, the satellite terminal can be mounted to the lid in an exterior arrangement and be stored inside the case when not in use. In other configurations the satellite terminal can be configured and adapted for use while mounted interior to the case. It can be configured to be functional where its deployed configuration is similar to its stored configuration in some implementations. The satellite communication antenna is used to provide a wireless internet communications backhaul. The case system will hold the modem for the satellite communication antenna as well as the modem for the terrestrial based communication system. The lid of the case will also hold antenna portions similar in nature to those of FIG. 19.

Various examples of devices, systems, and methods relating to antenna systems having satellite antenna capabilities and case configurations are described herein. Many of the disclosed components and configurations can be implemented in combination with other features and aspects of antenna and case systems disclosed herein.

FIGS. 36A-36E, 37, and 38 illustrate an example implementation of a satellite terminal antenna unit 3600. The antenna case can be configured to support and connect to a satellite terminal. In some implementations, the antenna case can be configured to be mobile and/or for portable use. In some implementations, the antenna case can be configured for satellite and/or cellular network operations. In some implementations, the antenna case can be configured to provide superfast data transmission speeds. In some implementations, the antenna case can comprise a rugged housing. The rugged housing can be configured to be tamper resistant. In some implementations, the antenna case can be configured for operations in the 600 MHZ to 6 GHz range. In some implementations, the antenna case can operate on the Citizens Broadband Radio Service (CBRS) bands. In some implementations, the antenna case can operate on the Private LTE (PLTE) bands. In some implementations, the antenna case can be IP67 rated. In some implementations, the antenna case can be sized for airplane travel. For example, the antenna case can be as small as or smaller than a traditional carry-on bag and/or personal item. In some implementations, the antenna case can have an internal volume of less than 3250 cubic inches.

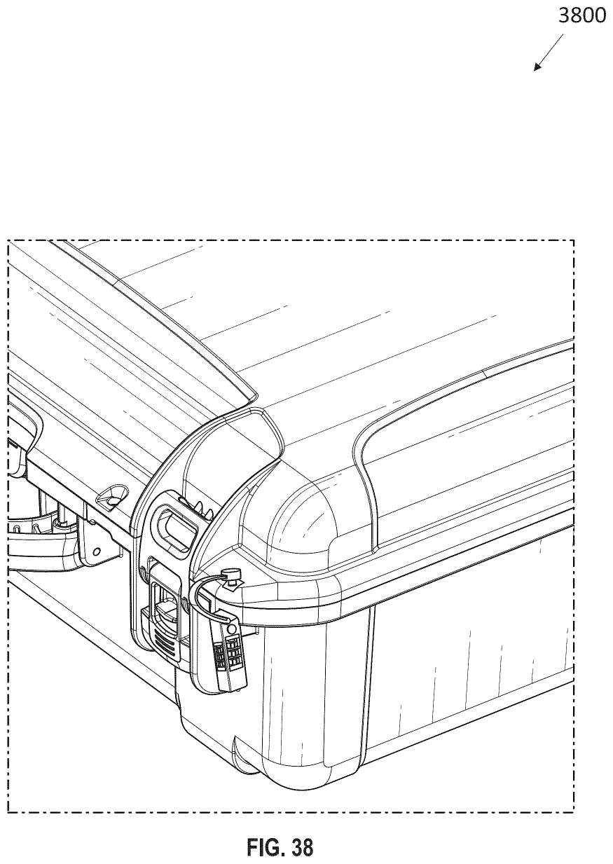

The antenna case can be configured to support a satellite terminal. For example, the lid of the antenna case can include an antenna mount. The antenna mount can be used to support and connect to a satellite terminal. While an example Starlink satellite terminal is illustrated, it is recognized that the antenna case can be used with any suitable satellite terminal. In some implementations, when the satellite terminal is not in use, the satellite terminal can be stored within the body of the antenna case. Storing the satellite terminal within the case can provide protection for the satellite terminal, while also allowing the antenna case to be easily transportable. In some configurations, the antenna case can be fully-functional, and the body of the antenna case may be configured to be tamperproof. For example, the antenna case may include one or more locking systems to prevent unauthorized access to the antenna case, as described further with reference to FIG. 38.

As shown in FIG. 36C, the antenna case can include an AC adapter and one or more ports for RJ45, USB-A, USB-C, and/or the like for connection to the internal components of the antenna case (e.g., the router(s)). In the illustrated example, the antenna case includes nine ports, however, in other implementations, more or fewer ports are possible. In some implementations, the antenna case can be waterproof, and the ports can include covers to prevent the ingress of fluid into the antenna case.

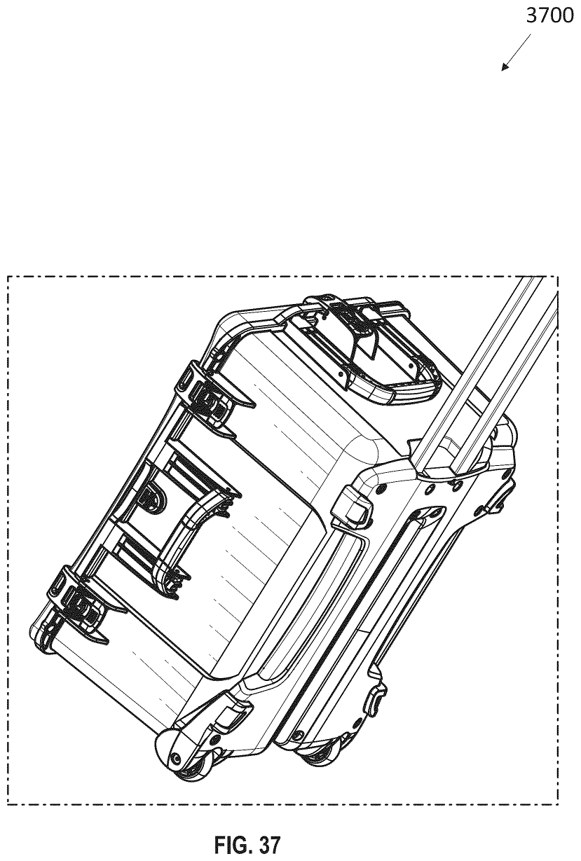

In some implementations, the antenna case can be sized for airplane travel. For example, the antenna case can be as small or smaller than a traditional carry-on bag and/or personal item as shown for example, in FIG. 37, configured for roller travel. In some implementations, the antenna case can have an internal volume of less than 4825 cubic inches.

In some implementations of a satellite terminal antenna case, the length of the antenna unit 3600 can be between about 20 inches to about 30 inches, or any value or range between any of these values or ranges or any value or range bounded by any combination of these values, although values or ranges outside these values or ranges can be used in some cases. In some implementations, the width of the antenna unit 3600 can be between about 16 inches to about 24 inches, or any value or range between any of these values or ranges or any value or range bounded by any combination of these values, although values or ranges outside these values or ranges can be used in some cases. In some implementations, the height of the antenna unit 3500 can be between about 10 inches to about 18 inches, or any value or range between any of these values or ranges or any value or range bounded by any combination of these values, although values or ranges outside these values or ranges can be used in some cases. In some implementations, the height of the base 3606 can be between about 8 inches to about 16 inches, or any value or range between any of these values or ranges or any value or range bounded by any combination of these values, although values or ranges outside these values or ranges can be used in some cases. In some implementations, the height of the lid 3608 can be between about 2 inches to about 7 inches, or any value or range between any of these values or ranges or any value or range bounded by any combination of these values, although values or ranges outside these values or ranges can be used in some cases.

With reference to FIG. 36B, the antenna case can include one or more antennas within the lid of the antenna case. For example, the antenna case may include one or more 4×4 MIMO 5G cellular antennas, one or more 4×4 MIMO WiFi antenna, one or more GPS antennas, and/or the like. Within the main body of the antenna case, a foam insert can be used to provide further protection to the satellite terminal during travel. Additionally, as shown in FIG. 15, when the satellite terminal is positioned within the main body of the antenna case, there can be sufficient room to mount one or more routers.

As shown in FIG. 36D-36E, the main body of the antenna case can include one or more vents and/or one or more fans. The vents/fans can be used to promote air exchange between the internal main body and the outside environment to, for example, cool the internal components of the antenna case, such as the router(s). The antenna case may also include one or more handles. As shown in FIG. 37, in some implementations the handle can extend out of the body of the antenna case. Further, the antenna case can include one or more wheels for improved transportation.

FIG. 38 shows a side perspective view of an implementation of the antenna case. In some cases, the antenna case can include one or more built-in locks and/or lock holes for receiving external locks. The locks can be used to prevent unauthorized access to the antenna case.

FIGS. 39A and 39B show perspective views of other implementations of antenna systems configured and adapted to operate on solar powered and/or other powered systems as well as advantageous mounting features and configurations, in accordance with some aspects of this disclosure.

FIGS. 39A and 39B illustrate perspective views of an antenna unit 3900. Some features of the antenna unit 3900 are similar or identical to features of the antenna units 200, 300, 1900, etc. Thus, reference numerals for various features or components of the antenna units are identical or similar to those used for corresponding features of the other antenna units except for leading digits. Therefore, the structure and description for the various features and operations of the other antenna units are understood to also apply to the corresponding features of the antenna unit 3900, except as shown differently and/or described differently herein. FIGS. 39A and 39B demonstrate how a solar panel system and a case antenna system can be implemented to provide an external charging source for the internal battery and or batteries of the case antenna system.

FIG. 40 shows a perspective side view of other implementations of antenna case systems configured and adapted to provide a power connection and/or a power cord adapter, in accordance with some aspects of this disclosure.

FIG. 40 illustrates a perspective view of an antenna unit 4000. Some features of the antenna unit 4000 are similar or identical to features of the antenna units 200, 300, 1900, etc. Thus, reference numerals for various features or components of the antenna units are identical or similar to those used for corresponding features of the other antenna units except for leading digits. Therefore, the structure and description for the various features and operations of the other antenna units are understood to also apply to the corresponding features of the antenna unit 2000, except as shown differently and/or described differently herein.

FIG. 40 demonstrates how a typical AC power source can be implemented to provide an external charging source for the internal battery and/or batteries of the case system.

Some implementations of the antenna units described herein may include various features, functions, and/or components of any of the antenna systems described and/or illustrated in applications for which this application claims priority, and also from U.S. Pat. No. 11,329,363, filed Nov. 9, 2020, titled “EMERGENCY PORTABLE HOT SPOT WITH ANTENNAS BUILT INTO COVER”, U.S. Pat. No. 11,664,574, filed May 9, 2022, titled “EMERGENCY PORTABLE HOT SPOT WITH ANTENNAS BUILT INTO COVER”, U.S. Pat. No. 12,057,641, filed Apr. 17, 2023, titled “EMERGENCY PORTABLE HOT SPOT WITH ANTENNAS BUILT INTO COVER”, U.S. Provisional Application No. 63/585,186, filed Sep. 25, 2023, entitled “ANTENNA SYSTEMS”, U.S. Provisional Application No. 63/540,335, filed Sep. 25, 2023, entitled “ANTENNA SYSTEMS”, U.S. patent application Ser. No. 18/616,004, filed Mar. 25, 2024, titled “ANTENNA SYSTEMS”, U.S. patent application Ser. No. 18/438,362, filed Feb. 9, 2024, titled “ANTENNA SYSTEMS”, U.S. patent application Ser. No. 18/395,134, filed Dec. 22, 2023, titled “ANTENNA SYSTEMS”, U.S. patent application Ser. No. 18/447,210, filed Aug. 9, 2023, titled “ANTENNA SYSTEMS”, U.S. patent application Ser. No. 18/447,193, filed Aug. 9, 2023, titled “ANTENNA SYSTEMS”, U.S. patent application Ser. No. 18/447,176, filed Aug. 9, 2023, titled “ANTENNA SYSTEMS”, U.S. patent application Ser. No. 18/893,344, filed Sep. 23, 2024, titled “ANTENNA SYSTEMS”, and U.S. patent application Ser. No. 18/893,548, filed Sep. 23, 2024, titled “ANTENNA SYSTEMS”, the entire contents of each of which are hereby incorporated by reference herein in their entirety.

### Example Clauses

Various examples of systems relating to an antenna system are found in the following clauses:

Clause 1. An antenna unit comprising: a case comprising: a base defining a first internal volume; and a lid defining a second internal volume, the lid coupled to the base, the lid configured to move between a closed configuration and an open configuration to selectively permit access to an interior of the case; one or more components located within the first internal volume of the base; a baseplate configured to be removably coupled to the lid; and an antenna assembly comprises a plurality of antennas, the plurality of antennas coupled to the baseplate and located within the second internal volume.

Clause 2. The antenna unit of Clause 1, wherein the case is IP67 compliant.

Clause 3. The antenna unit of Clause 1 or Clause 2, wherein the antenna assembly is configured to operate with the lid in the closed configuration.

Clause 4. The antenna unit of any of Clauses 1-3, wherein the baseplate is configured to act as a heatsink.

Clause 5. The antenna unit of any of Clauses 1-4, wherein the case further comprises a barrier located between the antenna assembly and the one or more components.

Clause 6. The antenna unit of any of Clauses 1-5, wherein the one or more components comprise a modem and a power source.

Clause 7. The antenna unit of any of Clauses 1-6, wherein the plurality of antennas comprises at least one GPS antenna.

Clause 8. The antenna unit of any of Clauses 1-7, wherein the plurality of antennas comprises one or more WiFi antennas.

Clause 9. The antenna unit of any of Clauses 1-8, wherein the plurality of antennas comprises one or more multi-band radiator portions.

Clause 10. The antenna unit of Clause 9, wherein each multi-band radiator portion of the one or more multi-band radiator portions comprises: a feeding portion; a grounding portion; an upright low band radiation portion; a second low band radiation portion; and a high band radiation portion.

Clause 11. The antenna unit of any of Clauses 10, wherein the second low band radiation portion is not-coplanar with the upright low band radiation portion.

Clause 12. The antenna unit of any of Clauses 10, wherein the second low band radiation portion is coplanar with the upright low band radiation portion.

Clause 13. The antenna unit of any of Clauses 10-12, wherein the high band radiation portion comprises two primary arms coupled to a base of the upright low band radiation portion.

Clause 14. The antenna unit of Clause 13, wherein each primary arm comprises a first arm portion and a second arm portion, wherein the first arm portion is coupled to the upright low band radiation portion and the second arm portion extends from the first arm portion.

Clause 15. The antenna unit of Clause 14, wherein the first arm portion has a varying width along a length of the first arm portion.

Clause 16. The antenna unit of Clause 14 or Clause 15, wherein the second arm portion has a consistent width along a length of the second arm portion.

Clause 17. The antenna unit of any of Clauses 10-12, wherein the high band radiation portion comprises a single primary arm coupled to a base of the upright low band radiation portion.

Clause 18. The antenna unit of any of Clauses 10-12, wherein the high band radiation portion comprises a plurality of primary arms coupled to a base of the upright low band radiation portion.

Clause 19. The antenna unit of any of Clauses 10-12, wherein the high band radiation portion comprises a plurality of primary arms of different lengths coupled to a base of the upright low band radiation portion.

Clause 20. The antenna unit of any of Clauses 10-19, wherein each multi-band radiator portion of the one or more multi-band radiator portions further comprises: a third low band radiation portion coupled to the second low band radiation portion; and a fourth low band radiation portion coupled to the second low band radiation portion and not contacting the third low band radiation portion.

Clause 21. The antenna unit of Clause 20, wherein the third low band radiation portion has a first dimension, wherein the fourth low band radiation portion has a second dimension, and wherein the first dimension and the second dimension are substantially the same.

Clause 22. The antenna unit of Clause 20, wherein the third low band radiation portion has a first dimension, wherein the fourth low band radiation portion has a second dimension, and wherein the first dimension and the second dimension are different.

Clause 23. The antenna unit of any of Clauses 10-22, wherein the high band radiation portion further comprises one or more secondary arms coupled to the upright low band radiation portion.

Clause 24. The antenna unit of Clause 23, wherein the one or more secondary arms are coplanar to the upright low band radiation portion.

Clause 25. The antenna unit of Clause 23, wherein the one or more secondary arms are not coplanar to the upright low band radiation portion.

Clause 26. The antenna unit of any of Clauses 23-25, wherein the one or more secondary arms comprise two secondary arms.

Clause 27. The antenna unit of any of Clauses 10-26, wherein the one or more multi-band radiator portions comprises four multi-band radiator portions.

Clause 28. The antenna unit of any of Clauses 9-27, wherein the one or more WiFi antennas comprises two dual-band WiFi radiator portions.

Clause 29. The antenna unit of any of Clauses 1-28, wherein each antenna of the plurality of antennas operates simultaneously during use.

Clause 30. The antenna unit of any of Clauses 1-29, wherein the antenna assembly is configured to at least extend from 600 MHz to 6 GHz bands.

Clause 31. The antenna unit of any of Clauses 1-30, wherein the antenna assembly is configured to at least extend from 28 GHz to 36 GHz bands.

Clause 32. The antenna unit of any of Clauses 1-31, wherein the antenna assembly is configured to at least extend from 24 GHz to 39 GHz bands.

Clause 33. The antenna unit of any of Clauses 1-32, wherein the antenna assembly is configured to at least extend from 600 MHz to 39 GHz bands.

Clause 34. The antenna unit of any of Clauses 1-33, wherein the one or more components located in the base comprise a plurality of batteries and a plurality of routers.

Clause 35. The antenna unit of any of Clauses 1-34, wherein the case is portable.

Clause 36. The antenna unit of any of Clauses 1-34, wherein the lid is coupled to the base by a hinge.

Clause 37. The antenna unit of any of Clauses 1-36, further comprising a base frame, the base frame configured to be coupled to the base and positioned within the first internal volume, the base frame configured to provide separation between a router and a battery.

Clause 38. The antenna unit of Clause 37, wherein the base frame comprises a plurality of slots, the plurality of slots configured to promote airflow to the router and the battery.

Clause 39. The antenna unit of Clause 37 or Clause 38, wherein the base frame comprises a first compartment for the router and a second compartment for the battery, the first compartment spaced apart from the second compartment, the first compartment configured to secure the router to the base frame, the second compartment configured to secure the battery to the base frame.

Clause 40. The antenna unit of Clause 39, wherein the first compartment is configured to receive a router shell, the router shell configured to receive the router.

Clause 41. The antenna unit of Clause 40, wherein the router shell comprises a top cover and a bottom cover, the top cover configured to be removably coupled to the bottom cover with the router therebetween.

Clause 42. The antenna unit of Clause 40 or Clause 41, where the router shell comprises a plurality of slots, the plurality of slots configured to expose portions of the router to air flow.

Clause 43. The antenna unit of any of Clauses 37-42, wherein the base frame is configured to provide shock isolation for one or more of the router and the battery.

Clause 44. The antenna unit of any of Clauses 1-43, further comprising a fan and a vent, the fan extending through a first wall of the base, the vent extending though a second wall of the base, wherein the vent is configured to allow air to enter the first internal volume, wherein the fan is configured to blow air from the first internal volume to an outside environment.

Clause 45. The antenna unit of Clause 44, wherein the fan has an open configuration and a close configuration, wherein in the open configuration, the fan is configured to allow air to exit the first internal volume, wherein in the closed configuration, the fan is configured to prevent fluid from entering the first internal volume.

Clause 46. The antenna unit of Clause 44 or Clause 45, wherein the vent includes a filter, the filter configured to prevent debris from entering the first internal volume through the vent.

Clause 47. The antenna unit of any of Clauses 1-46, further comprising one or more external ports, wherein the one or more external ports extending though one or more side wall of the base, the external ports coupled to cables that extend to the router.

Clause 48. An antenna system comprising: a conductive sheet having a body portion with a front face, a head portion, a first left arm, and a first right arm; wherein the head portion angularly extends from the body portion; wherein the first left arm angularly extends from the body portion and the first right arm angularly extends from the body portion; wherein the front face is configured as a first resonating component, the head portion is configured as a second resonating component, the first left arm is configured as a third resonating component, and the first right arm is configured a fourth resonating component; and wherein at least one of the respective first, second, third, and fourth resonating components is configured to resonate within a low frequency band of between 600 MHz and 700 MHz during use and at least one of the respective first, second, third, and fourth resonating components is configured to resonate within a high frequency band of between 2.7 GHz and 6.0 GHz during use.

Clause 49. The antenna system of Clause 48, furth comprising a second left arm that extends from the body portion and a second right arm that extends from the body portion.

Clause 50. The antenna system of Clause 49, wherein the second left arm and the second right arm are coplanar to the front face.

Clause 51. The antenna system of any of Clauses 48-50, wherein the body portion further comprises one or more slots configured to receive projections of an antenna connection.

Clause 52. The antenna system of any of Clause 48-51, wherein the conductive sheet has a thickness at or within 0.01 to 0.03 inches.

Clause 53. The antenna system of any of Clauses 48-52, wherein the head portion is configured to angularly extend from the body portion at an angle at or within 89-91 degrees.

Clause 54. The antenna system of any of Clauses 48-53, wherein the first left arm angularly extends from a left side of the body portion at an angle at or within 79-81 degrees.

Clause 55. The antenna system of any of Clauses 48-54, wherein the first right arm angularly extends from a left side of the body portion at an angle at or within 79-81 degrees.

Clause 56. The antenna system of any of Clauses 48-55, wherein at least one of the respective first and second resonating components is configured to resonate within a low frequency band of between 600 MHz and 700 MHz during use.

Clause 57. The antenna system of any of Clauses 48-56, wherein at least one of the respective third and fourth resonating components is configured to resonate within a high frequency band of between 2.7 GHz and 6.0 GHz during use.

Clause 58. The antenna system of any of Clauses 48-57, further comprising a ground aperture located along a symmetry line of the body portion and configured to be electrically coupled to a ground reference.

Clause 59. The antenna system of any of Clauses 48-58, further comprising a first set of apertures on the head portion and located proximate to an upper edge of the body portion.

Clause 60. The antenna system of any of Clauses 48-59, wherein the first left arm comprises a first left arm portion and a second left arm portion and the first right arm comprises a first right arm portion and a second right arm portion, wherein the first left arm portion is coupled to the front face and the second left arm portion extends from the first right arm portion, wherein the first right arm portion is coupled to the front face and the second right arm portion extends from the first right arm portion.

Clause 61. The antenna system of Clause 60, wherein the first right arm portion has a varying width along a length of the first right arm portion and the first left arm portion has a varying width along a length of the first left arm portion.

Clause 62. The antenna system of Clauses 60 or Clause 61, wherein the second left arm portion has a consistent width along a length of the second left arm portion and the second right arm portion has a consistent width along a length of the second right arm portion.

Clause 63. An antenna unit comprising: a case comprising: a base defining a first internal volume; and a lid defining a second internal volume, the lid coupled to the base, the lid configured to move between a closed configuration and an open configuration to selectively permit access to an interior of the case; one or more components located within the first internal volume of the base; a baseplate configured to be removably coupled to the lid; and an antenna assembly comprises a plurality of antennas, the plurality of antennas comprising one or more antenna systems of any of Clauses 48-62, the plurality of antennas coupled to the baseplate and located within the second internal volume.

Clause 64. The antenna unit of Clause 63, wherein the case is IP67 compliant.

Clause 65. The antenna unit of Clause 63 or Clause 64, wherein the antenna assembly is configured to operate with the lid in the closed configuration.

Clause 66. The antenna unit of any of Clauses 63-65, wherein the baseplate is configured to act as a heatsink.

Clause 67. The antenna unit of any of Clauses 63-66, wherein the case further comprises a barrier located between the antenna assembly and the one or more components.

Clause 68. The antenna unit of any of Clauses 63-67, wherein the one or more components comprise a modem and a power source, and wherein the case is portable.

Clause 69. The antenna unit of any of Clauses 63-68, wherein the plurality of antennas further comprises at least one GPS antenna.

Clause 70. The antenna unit of any of Clauses 63-69, wherein the plurality of antennas further comprises one or more WiFi antennas.

Clause 71. The antenna unit of any of Clauses 63-70, wherein each antenna of the plurality of antennas operates simultaneously during use.

Clause 72. The antenna unit of any of Clauses 63-71, wherein the antenna assembly is configured to at least extend from 600 MHz to 6 GHz bands.

Clause 73. The antenna unit of any of Clauses 63-72, wherein the antenna assembly is configured to at least extend from 28 GHz to 36 GHz bands.

Clause 74. The antenna unit of any of Clauses 63-73, wherein the antenna assembly is configured to at least extend from 24 GHz to 39 GHz bands.

Clause 75. The antenna unit of any of Clauses 63-74, wherein the antenna assembly is configured to at least extend from 600 MHz to 39 GHz bands.

Clause 76. The antenna unit of any of Clauses 63-75, wherein the one or more components located in the base comprise a plurality of batteries and a plurality of routers.

Clause 77. The antenna unit of any of Clauses 63-76, wherein the case is portable.

Clause 78. The antenna unit of any of Clauses 63-77, wherein the lid is coupled to the base by a hinge.

Clause 79. The antenna unit of any of Clauses 63-78, wherein the case has a compact internal volume of less than 650 cubic inches.

Clause 80. The antenna unit of any of Clauses 63-79, further comprising a base frame, the base frame configured to be coupled to the base and positioned within the first internal volume, the base frame configured to provide separation between a router and a battery.

Clause 81. The antenna unit of Clause 80, wherein the base frame comprises a plurality of slots, the plurality of slots configured to promote airflow to the router and the battery.

Clause 82. The antenna unit of Clause 80 or Clause 81, wherein the base frame comprises a first compartment for the router and a second compartment for the battery, the first compartment spaced apart from the second compartment, the first compartment configured to secure the router to the base frame, the second compartment configured to secure the battery to the base frame.

Clause 83. The antenna unit of Clause 82, wherein the first compartment is configured to receive a router shell, the router shell configured to receive the router.

Clause 84. The antenna unit of Clause 83, wherein the router shell comprises a top cover and a bottom cover, the top cover configured to be removably coupled to the bottom cover with the router therebetween.

Clause 85. The antenna unit of Clause 83 or Clause 84, where the router shell comprises a plurality of slots, the plurality of slots configured to expose portions of the router to air flow.

Clause 86. The antenna unit of any of Clauses 80-85, wherein the base frame is configured to provide shock isolation for one or more of the router and the battery.

Clause 87. The antenna unit of any of Clauses 63-86, further comprising a fan and a vent, the fan extending through a first wall of the base, the vent extending though a second wall of the base, wherein the vent is configured to allow air to enter the first internal volume, wherein the fan is configured to blow air from the first internal volume to an outside environment.

Clause 88. The antenna unit of Clause 87, wherein the fan has an open configuration and a close configuration, wherein in the open configuration, the fan is configured to allow air to exit the first internal volume, wherein in the closed configuration, the fan is configured to prevent fluid from entering the first internal volume.

Clause 89. The antenna unit of Clause 87 or Clause 89, wherein the vent includes a filter, the filter configured to prevent debris from entering the first internal volume through the vent.

Clause 90. The antenna unit of any of Clauses 67-89, further comprising one or more external ports, wherein the one or more external ports extending though one or more side wall of the base, the external ports coupled to cables that extend to the router.

Clause 91. A router shell for a router comprising: a top cover; and a bottom cover, the top cover configured to be removably coupled to the bottom cover with the router therebetween; wherein the top cover and the bottom cover comprise a plurality of slots, the plurality of slots configured to allow portions of the router to be exposed to an external environment.

Clause 92. The router shell of Clause 91, further comprising one or more cutouts, the one or more cutouts configured to provide access to ports of the router.

Clause 93. An antenna system comprising: a base defining a first internal volume and a lid defining a second internal volume, wherein the lid is coupled to the base, wherein the lid is configured to move between a closed configuration and an open configuration to selectively permit access to an interior of the case; one or more components located within the first internal volume of the base; and an antenna assembly comprising a plurality of antennas coupled to a ground plane and located within the second internal volume of the lid, wherein the ground plane is configured to be removably coupled to the lid.

Clause 94. An antenna system according to any of the clauses, further comprising a power source configured and adapted for charging one or more personal items, such as a phone.

Clause 95. An antenna system according to any of the clauses, further comprising a split-level barrier configured to be removably coupled to the base.

Clause 96. An antenna system according to any of the clauses, further comprising a battery support tray configured to be removably coupled to the base.

Clause 97. An antenna system according to any of the clauses, further comprising a modular battery support tray system comprising one or more barriers and/or support structures defining a modular opening configured and adapted to receive at least one of a plurality of modular battery support tray configurations adapted to be removably coupled to the base when positioned within the modular opening.

Clause 98. An antenna system according to any of the clauses, further comprising an angled battery enclosure configured to hold and suspend a battery within the battery enclosure above a bottom surface of the base.

Clause 99. An antenna system according to any of the clauses, further comprising one or more swivel antenna components.

Clause 100. An antenna system according to any of the clauses, further comprising one or more multi-band directional antennas.

### Additional Considerations and Terminology

Features, materials, characteristics, or groups described in conjunction with a particular aspect, implementation, or example are to be understood to be applicable to any other aspect, implementation or example described herein unless incompatible therewith. All of the features disclosed in this specification (including any accompanying claims, abstract and drawings), or all of the steps of any method or process so disclosed, may be combined in any combination, except combinations where at least some of such features or steps are mutually exclusive. The protection is not restricted to the details of any foregoing implementations. The protection extends to any novel one, or any novel combination, of the features disclosed in this specification (including any accompanying claims, abstract and drawings), or to any novel one, or any novel combination, of the steps of any method or process so disclosed.

While certain implementations have been described, these implementations have been presented by way of example only and are not intended to limit the scope of protection. Indeed, the novel methods and systems described herein may be embodied in a variety of other forms. Furthermore, various omissions, substitutions and changes in the form of the methods and systems described herein may be made. Those skilled in the art will appreciate that in some implementations, the actual steps taken in the processes illustrated or disclosed may differ from those shown in the figures. Depending on the implementation, certain of the steps described above may be removed, others may be added. For example, the actual steps or order of steps taken in the disclosed processes may differ from those shown in the figure. Depending on the implementation, certain of the steps described above may be removed, others may be added. Furthermore, the features and attributes of the specific implementations disclosed above may be combined in different ways to form additional implementations, all of which fall within the scope of the present disclosure.

Although the present disclosure includes certain implementations, examples and applications, it will be understood by those skilled in the art that the present disclosure extends beyond the specifically disclosed implementations to other alternative implementations or uses and obvious modifications and equivalents thereof, including implementations which do not provide all of the features and advantages set forth herein. Accordingly, the scope of the present disclosure is not intended to be limited by the described implementations and may be defined by claims as presented herein or as presented in the future.

Conditional language, such as “can,” “could,” “might,” or “may,” unless specifically stated otherwise, or otherwise understood within the context as used, is generally intended to convey that certain implementations include, while other implementations do not include, certain features, elements, or steps. Thus, such conditional language is not generally intended to imply that features, elements, or steps are in any way required for one or more implementations or that one or more implementations necessarily include logic for deciding, with or without user input or prompting, whether these features, elements, or steps are included or are to be performed in any particular implementation. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Likewise, the term “and/or” in reference to a list of two or more items, covers all of the following interpretations of the word: any one of the items in the list, all of the items in the list, and any combination of the items in the list. Further, the term “each,” as used herein, in addition to having its ordinary meaning, can mean any subset of a set of elements to which the term “each” is applied. Additionally, the words “herein,” “above,” “below,” and words of similar import, when used in this application, refer to this application as a whole and not to any particular portions of this application.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain implementations require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain implementations, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

### Additional Antenna Systems

The present application claims priority benefit to U.S. Provisional Application No. 63/585,541, filed Sep. 26, 2023, entitled “ANTENNA SYSTEMS,” and U.S. application Ser. No. 18/894,607, filed Sep. 24, 2024, entitled “ANTENNA SYSTEMS.” All of the above-mentioned applications are hereby incorporated by reference herein in their entireties. Any and all applications for which a foreign or domestic priority claim is identified in the Application Data Sheet as filed with the present application are hereby incorporated by reference under 37 CFR 1.57 and made a part of this specification.

The present disclosure relates to the field of wireless broadband communication, and more particularly to antenna systems and antennas that cover multiple frequency bands used in the telecommunication wireless spectrum.

Over the last few decades, 3GPP as a collaborative organization has developed protocols for mobile telecommunications. The latest operational standard is known as 5G. Wireless communication relies on a variety of radio components including radio antennas that are used for transmitting and receiving information via electromagnetic waves. To communicate to specific devices without interference from other devices, radio transceivers and receivers communicate within a dedicated frequency bandwidth and have associated antennas that are configured to electromagnetically resonate at frequencies within the dedicated bandwidth. As more wireless devices are used on a frequency bandwidth, a communication bottleneck occurs as wireless devices compete for frequency channels within a dedicated bandwidth. 3GPP frequency bands range from 450 MHz to 8 GHz and beyond, however, antennas configured to resonate within this spectrum only resonate below 8 GHz for mobile 3GPP telecommunication standards. To capture a greater portion of the 3GPP or other telecommunication spectrum, either an antenna array of various antenna configurations is used, or a single geometrically complex antenna can be used. An antenna array, in most instances, takes up too much space and is therefore impractical for small devices, but employing a single antenna will have a useable bandwidth that is limited by its geometrical configuration. In one example, a known antenna configuration permits a 700 MHz-2.7 GHz frequency band; however, a single antenna configuration that permits a wider frequency band is desired. Additionally, it can be difficult and expensive to manufacture, assemble, and procure materials for components of antenna array systems. This may result in a system with poor functionality and/or coverage.

This disclosure relates to antennas that cover multiple frequency bands that are prolific in today's telecommunication wireless spectrum. The advances of telecommunications wireless devices have expanded the number of frequency bands that a radio can support for prolific coverage. For example, there are over 30 LTE Bands that a radio may be asked to support if the radio is to provide ubiquitous coverage for a mobile device. While some of the LTE Bands overlap one another, there are numerous gaps between the bands as well. A multi-band approach to the antenna's frequency response provides a unique and novel radiating structure to support the numerous LTE bands.

According to some implementations, a multi-band antenna including a radiating element is disclosed. The radiating element includes an upright portion, a head portion, one or more first arms, and one or more second arms. The upright portion is configured for low-band radiation. The head portion extends from a top edge of the upright portion and is configured for low-band radiation. The one or more first arms extend from the upright portion and configured for mid-band radiation. The one or more second arms extend from the upright portion and are configured for C-band radiation.

According to some implementations, a multi-band antenna is disclosed. The multi-band antenna includes an upright portion, a head portion, a first left arm, a first right arm, a second left arm, and a second right arm. The upright portion is configured as a first resonating component. The head portion extends angularly from the upright portion and is configured as a second resonating component. The first left arm extends from a left edge of the upright portion and is configured as a third resonating component. The first right arm extends from a right edge of the upright portion and is configured as a fourth resonating component. The second left arm extends from the left edge of the upright portion and is configured as a fifth resonating component. The second right arm extends from the right edge of the upright portion and is configured as a sixth resonating component.

According to some implementations, an antenna assembly is disclosed. The antenna assembly includes a base, a radome, and a multi-element multi-band antenna. The base includes a conductive material and is configured as a ground reference for the antenna assembly. The radome is configured to be coupled to the base to define an internal volume. The multi-element multi-band antenna includes one or more multi-band antennas coupled to the base and one or more second radiating elements coupled to the base.

Some advantageous features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one implementation of the present disclosure in detail, it is to be understood that the implementations are not limited in its application to the details of construction and the arrangements of the components set forth in the following description or illustrated in the drawings. The implementations are capable of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. Accordingly, the claims should be regarded as including such equivalent constructions in so far as they do not depart from the spirit and scope of the present application.

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 41 illustrates a perspective view of an antenna system, in accordance with some aspects of this disclosure.

FIG. 42 illustrates a side view of the antenna system of FIG. 41, in accordance with some aspects of this disclosure.

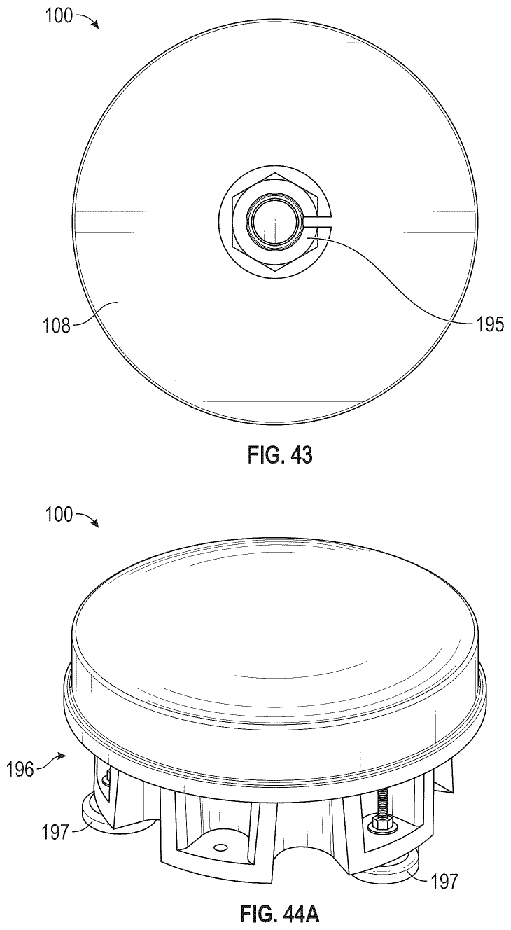

FIG. 43 illustrates a bottom view of the antenna system of FIG. 41, in accordance with some aspects of this disclosure.

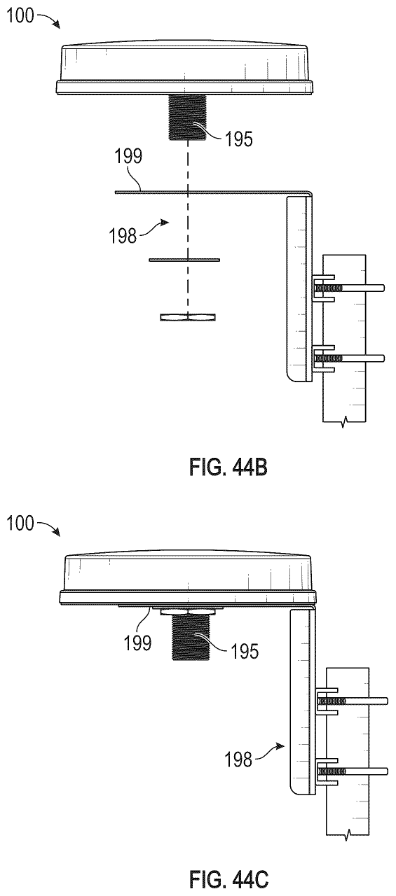

FIG. 44A illustrates a perspective view the antenna system of FIG. 41 with a first mounting assembly, in accordance with some aspects of this disclosure.

FIGS. 44B and 44C illustrates side views of the antenna system of FIG. 41 with a second mounting assembly, in accordance with some aspects of this disclosure.

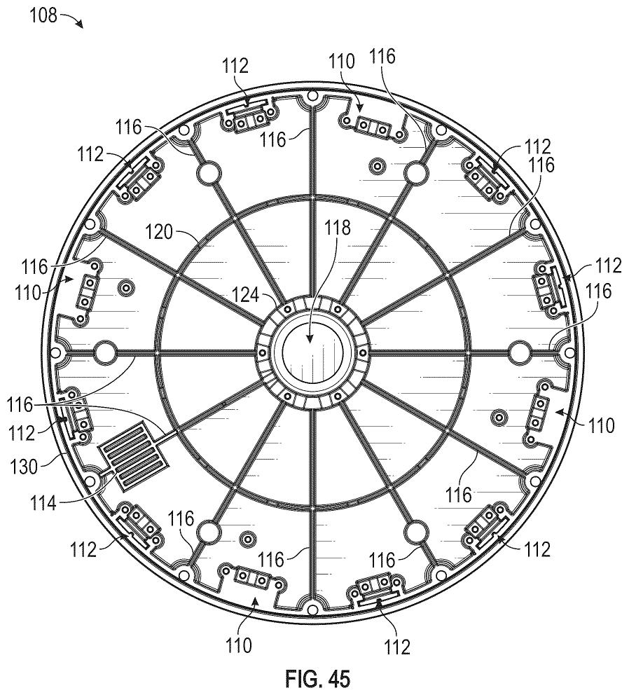

FIG. 45 illustrates a top isolation view of a base of the antenna system of FIG. 41, in accordance with some aspects of this disclosure.

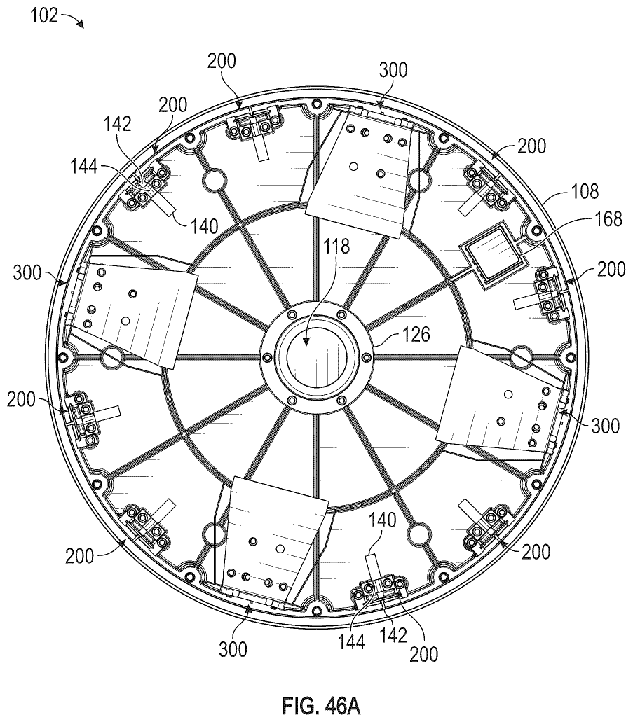

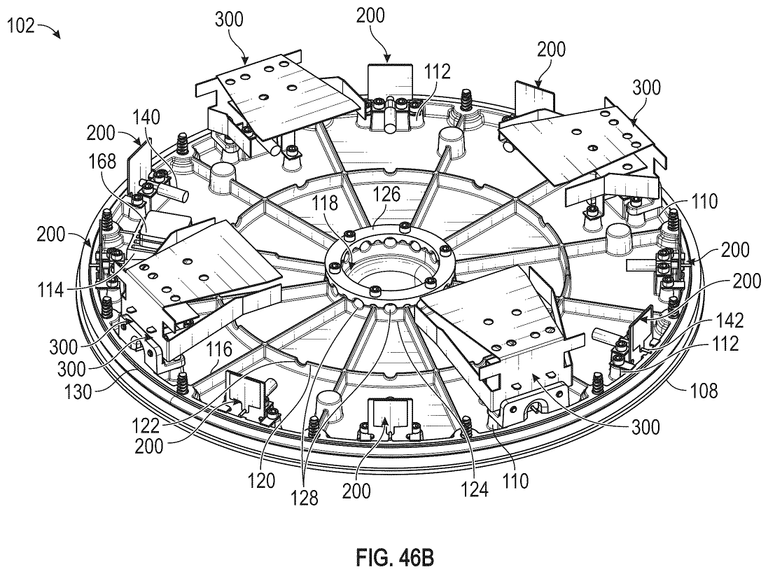

FIGS. 46A and 46B illustrate a top view and a perspective view respectively of the antenna system of FIG. 41 with the radome removed, in accordance with some aspects of this disclosure.

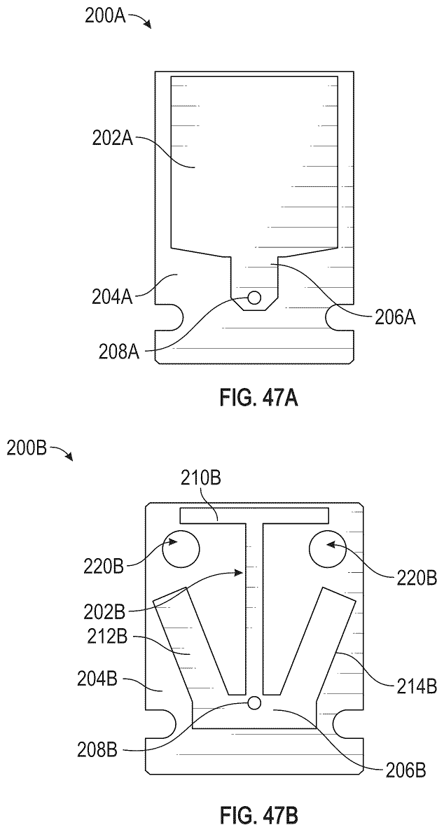

FIG. 47A illustrates a side view of a first implementation of a Wi-Fi radiating element of the antenna system of FIG. 41, in accordance with some aspects of this disclosure.

FIG. 47B illustrates a side view of a second implementation of a Wi-Fi radiating element of the antenna system of FIG. 41, in accordance with some aspects of this disclosure.

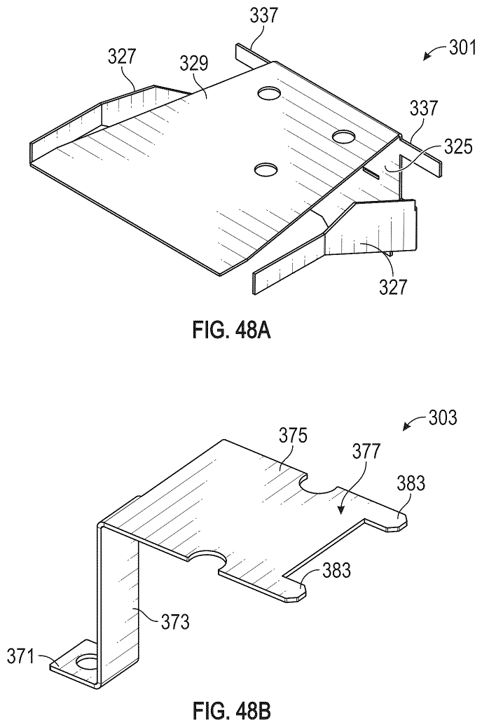

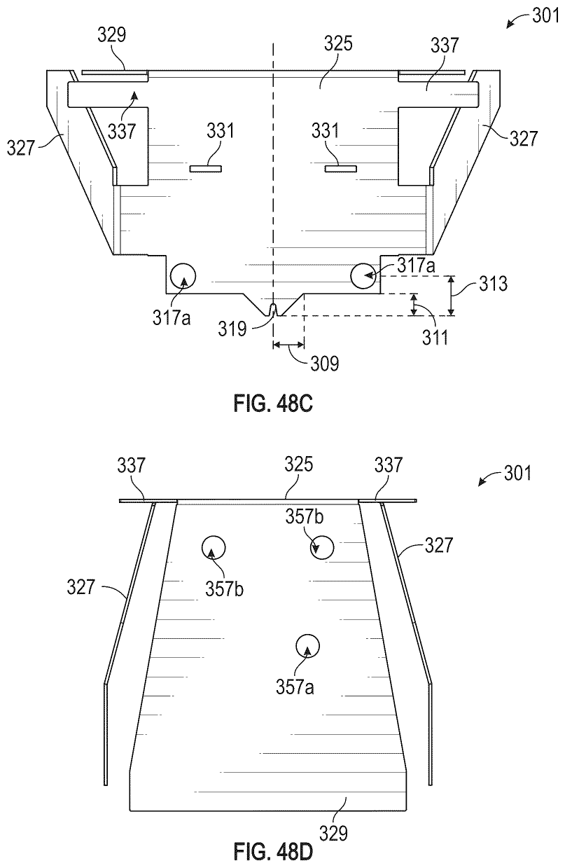

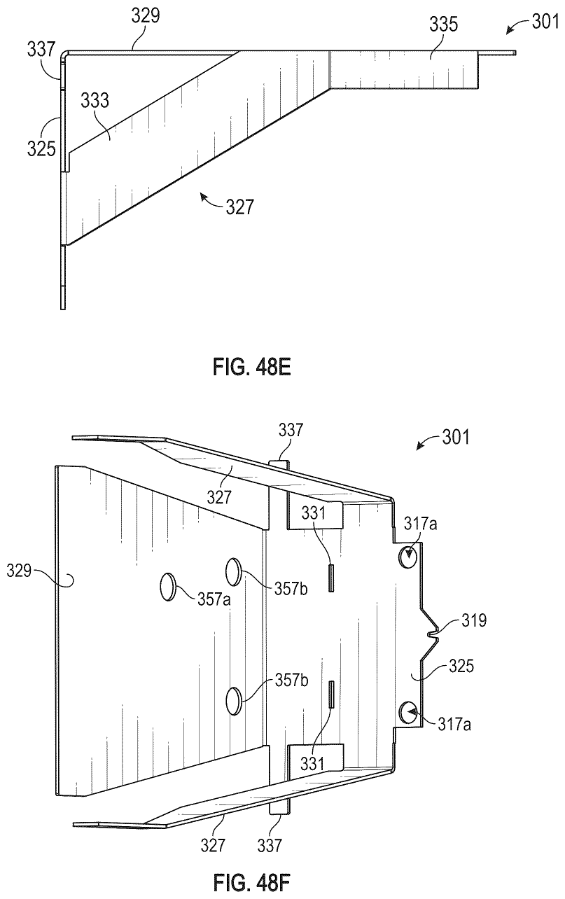

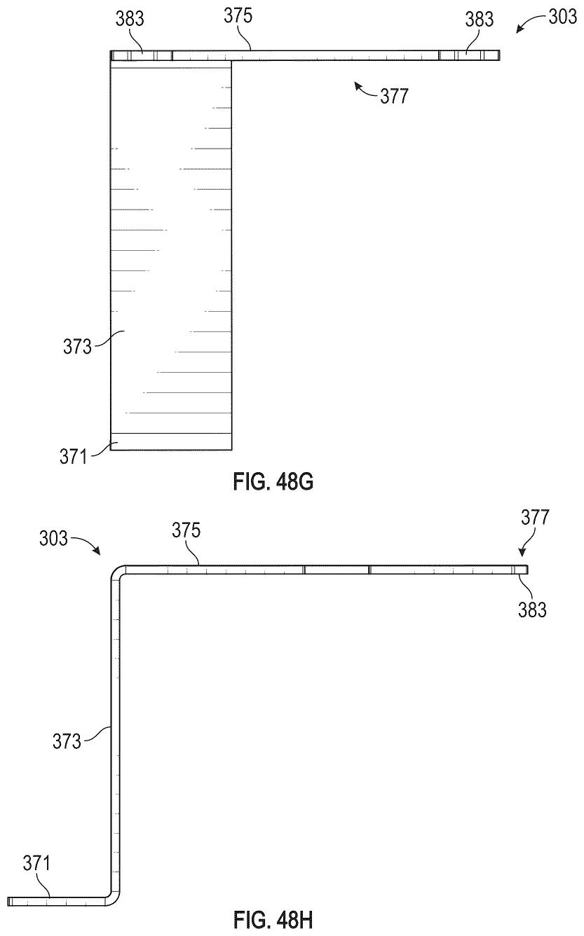

FIGS. 48A-48H illustrate various views of components of a multi-band radiator portion of the antenna assembly of FIG. 41, in accordance with some aspects of this disclosure.

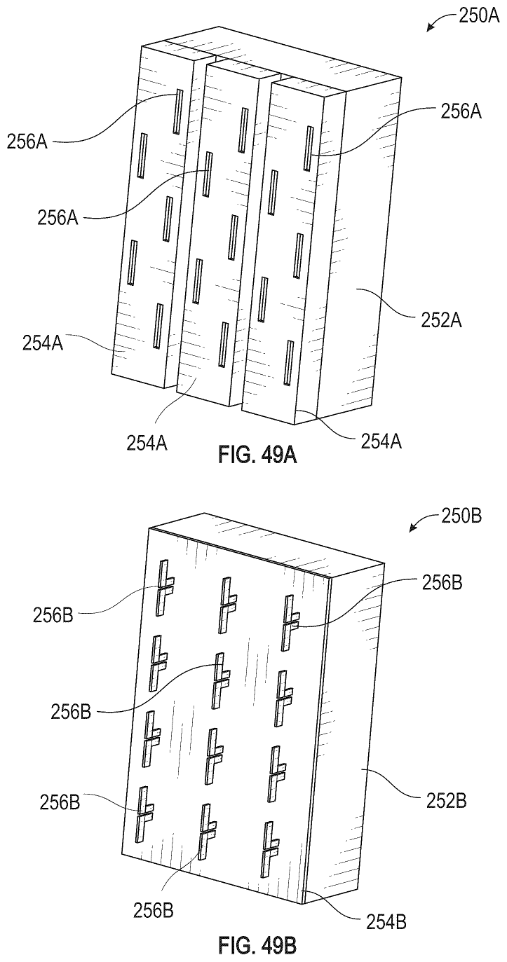

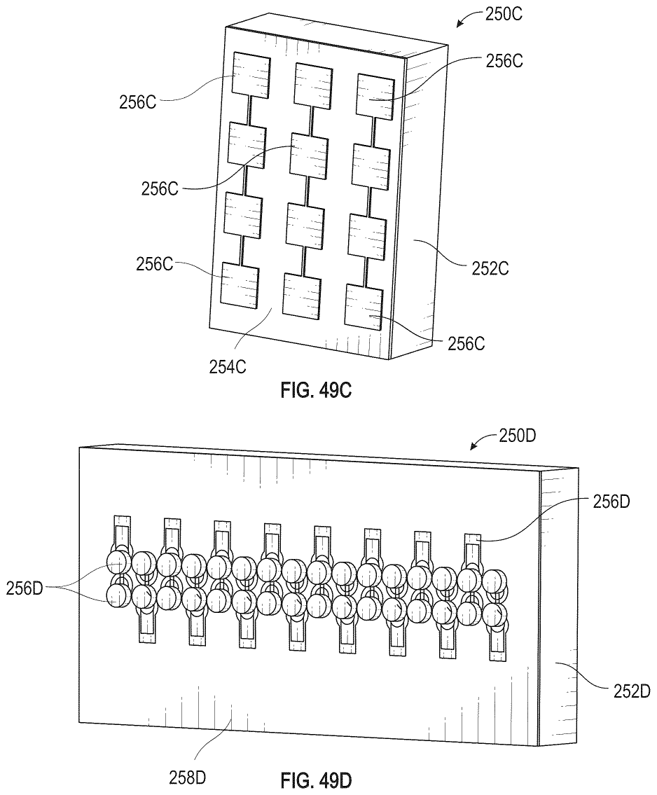

FIGS. 49A-49D illustrate various implementations of millimeter wave radios with their antennas that can be included in the antenna assembly of FIG. 41, in accordance with some aspects of this disclosure.

While the implementations and method of the present application is susceptible to various modifications and alternative forms, specific implementations thereof have been shown by way of example in the drawings and are herein described in detail. It should be understood, however, that the description herein of specific implementations is not intended to limit the application to the particular implementation disclosed, but on the contrary, the intention is to cover all modifications, equivalents, and alternatives falling within the spirit and scope of the process of the present application as defined by the appended claims.

Illustrative implementations of the preferred implementations are described below. In the interest of clarity, not all features of an actual implementation are described in this specification. It will of course be appreciated that in the development of any such actual implementation, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the implementations described herein may be oriented in any desired direction.

The systems and methods will be understood, both as to its structure and operation, from the accompanying drawings, taken in conjunction with the accompanying description. Several implementations of the system may be presented herein. It should be understood that various components, parts, and features of the different implementations may be combined together and/or interchanged with one another, all of which are within the scope of the present application, even though not all variations and particular implementations are shown in the drawings. It should also be understood that the mixing and matching of features, elements, and/or functions between various implementations is expressly contemplated herein so that one of ordinary skill in the art would appreciate from this disclosure that the features, elements, and/or functions of one implementation may be incorporated into another implementation as appropriate, unless otherwise described. As used herein, “system” and “assembly” are used interchangeably. It should be noted that the articles “a”, “an”, and “the”, as used in this specification, include plural referents unless the content clearly dictates otherwise. Dimensions provided herein provide for an exemplary implementation, however, alternate implementations having scaled and proportional dimensions of the presented exemplary implementation are also considered. Additional features and functions are illustrated and discussed below.

Referring now to the drawings wherein like reference characters identify corresponding or similar elements in form and function throughout the several views. FIGS. 41-44C illustrate various views of an exterior of an antenna assembly and mounting assemblies for the antenna assembly, FIGS. 45-46B illustrate various views of components of the antenna assembly in isolation and various internal views of the antenna assembly, FIGS. 47A and 47B illustrate various radiating elements that can be included in the antenna assembly, and FIGS. 48A-48H illustrate various views of components of a multi-band radiator portion that can be included in the antenna assembly.

According to some implementations, features and aspects of this disclosure, a multi-band antenna including a radiating element is disclosed. The radiating element includes an upright portion, a head portion, one or more first arms, and one or more second arms. The upright portion is configured for low-band radiation. The head portion extends from a top edge of the upright portion and is configured for low-band radiation. The one or more first arms extend from the upright portion and configured for mid-band radiation. The one or more second arms extend from the upright portion and are configured for C-band radiation.

According to some implementations, features and aspects of this disclosure, a multi-band antenna is disclosed. The multi-band antenna includes an upright portion, a head portion, a first left arm, a first right arm, a second left arm, and a second right arm. The upright portion is configured as a first resonating component. The head portion extends angularly from the upright portion and is configured as a second resonating component. The first left arm extends from a left edge of the upright portion and is configured as a third resonating component. The first right arm extends from a right edge of the upright portion and is configured as a fourth resonating component. The second left arm extends from the left edge of the upright portion and is configured as a fifth resonating component. The second right arm extends from the right edge of the upright portion and is configured as a sixth resonating component.

According to some implementations, features and aspects of this disclosure, an antenna assembly is disclosed. The antenna assembly includes a base, a radome, and a multi-element multi-band antenna. The base includes a conductive material and is configured as a ground reference for the antenna assembly. The radome is configured to be coupled to the base to define an internal volume. The multi-element multi-band antenna includes one or more multi-band antennas coupled to the base and one or more second radiating elements coupled to the base.

The following detailed description of certain implementations presents various descriptions of specific implementations. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain implementations can include more elements than illustrated in a drawing and/or a subset of the elements illustrated in a drawing. Further, some implementations can incorporate any suitable combination of features from two or more drawings.

Objects that are coupled together can be permanently connected together or releasably connected together. Objects that are permanently connected together can be formed out of one sheet of material or multiple sheets of material. The type of connection can provide different means for the realization of particular advantages and/or convenience consistent with the suitable function and performance of the device.

With reference to FIG. 41, a perspective view of an antenna assembly 100 is illustrated in accordance with an implementation of the present disclosure. The antenna assembly 100 may include a multi-element multi-band antenna 102 (see e.g., FIG. 46B). The multi-element multi-band antenna 102 may be configured to provide wireless internet connectivity for a plurality of uses (e.g., data, voice communication, remote video monitoring, and/or the like). The multi-element multi-band antenna 102 can be configured to provide high performance of 5G frequencies for both mobile and enterprise network applications. The multi-element multi-band antenna 102 may have particular benefits when used with vehicles, however, the multi-element multi-band antenna 102 may be used in a wide range of applications. For example, the antenna assembly 100 can be durable such that the multi-element multi-band antenna 102 can perform at high efficiency on emergency vehicles (e.g., police vehicles, ambulances, firetrucks, etc.), construction fleets, enterprise roof mounts, recreational vehicles, and/or the like. The antenna assembly 100 can protect the multi-element multi-band antenna 102 even when deployed outdoors or in hard use situations. The multi-element multi-band antenna 102 may have a smaller volume and profile when compared to other antenna systems. For example, the antenna assembly 100 may have a cubic volume of less than 210 cubic inches.

The components of the multi-element multi-band antenna 102 may be concealed and/or secured within and/or between a radome 104 (also referred to herein as “cover” 104 and “non-conducive cover” 104) and a base 108. As shown and described further with reference to at least FIGS. 46A-48H, the multi-element multi-band antenna 102 may include one or more of the following: one or more first radiating element(s) 300, one or more second radiating element(s) 200, and/or one or more GPS antenna(s) 168. In some implementations, the multi-element multi-band antenna 102 can include radiating elements 200, 300 configured to radiate at specific frequency bands. For example, the radiating elements 200, 300 can be configured for one or more of: low-band operation (approximately 600 MHz to 900 MHz), mid-band operation (approximately 1.7 GHz to 2.7 GHz), CBRS-band (“C-band”) operation (approximately 3.4 GHz to 4.2 GHz), and/or high-band Wi-Fi-band (“Wi-Fi-band) operation (approximately 4.8 GHz to 7.25 GHz), depending on the desired performance of the antenna assembly. In some implementations, a plurality of fasteners can be used to secure the components of the antenna assembly 100 together and can include fasteners, magnets, and/or the like.

With reference to FIGS. 41-43, the radome 104 may protect and/or provide mechanical support for the multi-element multi-band antenna 102. For example, the multi-element multi-band antenna 102 can be enveloped by the radome 104. The radome 104 may be transparent to radiation from the multi-element multi-band antenna 102 and may serve as an environmental shield for the internal components of the antenna assembly 100, including the multi-element multi-band antenna 102. The radome 104 may be made of a non-conductive material. The radome 104 may be generally cylindrical or circular prism shaped, with an open bottom, in some configurations. Other suitable shapes can be used for the radome 104. The radome 104 can be configured to be removably coupled to the base 108. In some cases, the shape of the radome 104 can be selected based on the expected operating conditions for the antenna assembly 100. For example, the expected wind-load on the antenna assembly 100 when in use (e.g., when mounted to a vehicle) can impact the design of the radome 104. In some cases, the antenna assembly 100 may be deployed on a vehicle, as described above. Accordingly, it can be desirable for the antenna assembly 100, and the radome 104 in particular, to have a low profile design. In some implementations, the antenna assembly 100 may have a total height of less than 3 inches (e.g., less than 3 inches, less than 2.75 inches, less than 2.5 inches, etc.) when measured from the base 108 to the top of the radome 104. In some implementations, the curved side wall(s) of the radome 104 can reduce the drag on the antenna assembly 100 when the antenna assembly 100 is deployed. In some implementations, the base 108 can be received within the radome 104 in the assembled antenna assembly 100, such that the base 108 or only a portion of the base 108 is visible from a side view of the antenna assembly 100. This design can minimize exposed edges and sharp transitions or protrusions between the base 108 and the radome 104. As a result, the antenna assembly 100 can have streamlined contours, which can reduce drag by minimizing turbulent airflow around the antenna assembly 100. Reducing drag can be particularly beneficial when operating in high wind-load conditions, such as on an emergency vehicle.

FIG. 45 shows a top view of the base 108 of the antenna assembly 100 in isolation. FIGS. 46A and 46B show a top view and a top perspective view respectfully of the base 108 and the multi-element multi-band antenna 102 with the radome 104 not shown. As shown in FIG. 45, the base 108 can provide mechanical support for the multi-element multi-band antenna 102. The base 108 can also serve as the ground plane for the antenna assembly 100. For example, the base 108 can be electrically conductive. The base 108 can be made of a conductive material, such as a metal (e.g., aluminum). In some implementations, the base 108 can provide an electrical connection with a client ground plane. In some implementations, the base 108 includes a plurality of small gaps (not shown) in the surface of the base 108, which may facilitate the use of non-conductive weather resistant material. In some implementations, the size and proximity of the base 108 may be selected to provide an electromagnetic connection with the client ground plane. The combination of at least the non-conductive radome 104 and the conductive base 108 provide mechanical and environmental protection for the multi-element multi-band antenna 102 as well as grounding for the electrically active, radiating portions of the multi-element multi-band antenna 102 that are internal to the antenna assembly 100.

As shown in FIGS. 41-43, the radome 104 can be positioned on the base 108 to secure the internal components of the antenna assembly 100, including the multi-element multi-band antenna 102. The radome 104 may include a plurality of fastener holes which may extend up the side walls of the radome 104. In some implementations, the fastener holes may be tapered. In some implementations, the fastener holes may be threaded. These plurality of fastener holes may be aligned with fastener holes of the base 108 in the assembled configuration, and fasteners can be positioned within the holes to secure the radome 104 and the internal components of the multi-element multi-band antenna 102 to the base 108. In some implementations, the assembled antenna assembly 100 may have an approximate diameter of about 10.75 inches and a height of about 2.31 inches. This small profile, particularly the small diameter and height, can significantly improve the aerodynamic properties of the antenna assembly 100 when in operation.

Referring back to FIG. 45, the base 108 (also referred to herein as the “ground reference” or “ground plane”), is shown in isolation. The base 108 may serve as the ground reference for at least one or more of the radiating elements described herein (e.g., the first radiating element(s) 300, the second radiating element(s) 200, and/or the GPS antenna(s) 168). The radiating elements (e.g., the first radiating element(s) 300 and the second radiating element(s) 200) may also be referred to herein as “radiating antenna elements”, “antenna elements”, “radiating portions”, “radiator portions”, or “multi-band antennas”. The base 108 can include one or more mounting portions for supporting the radiating elements of the multi-element multi-band antenna 102. For example, the base 108 can include one or more first mounting portions 110 configured to support the radiating element(s) 300 and one or more second mounting portions 112 configured to support the second radiating element(s) 200. In the illustrated example, the base 108 is configured to support up to four first radiating elements 300 and up to eight second radiating elements 200. Accordingly, the base 108 includes four first mounting portions 110 and eight second mounting portions 112. In other implementations, more or fewer radiating elements 200, 300 can be included in the multi-element multi-band antenna 102 and the base 108 can include a same number of mounting portions 110, 112. Alternatively, the multi-element multi-band antenna 102 can be assembled without including the maximum number of radiating elements 200, 300. As shown in FIG. 45, the base 108 may also include a GPS mounting portion 114. In the assembled antenna assembly 100, the GPS antenna 168 can be positioned on and/or coupled to the GPS mounting portion 114. In some implementations, an adhesive or adhesive pad can be used to secure the GPS antenna 168 to the GPS mounting portion 114.

The mounting portions 110, 112 can be distributed around the perimeter of the base 108. In the illustrated example, each first mounting portion 110 is positioned between two pairs of second mounting portions 112. For example, when the maximum number of radiating elements 200, 300 are included in the multi-element multi-band antenna 102, each first radiating element 300 can have two second radiating elements 200 positioned on each side of the first radiating element 300. Such an arrangement can provide separation between the first radiating elements 300, which can reduce mutual coupling and enhance realized antenna gain.

The base 108 can include a central opening 118. The central opening 118 can extend completely through the base 108 (e.g., from the top side to the bottom side). The central opening 118 can allow coaxial cables of the antenna assembly 100 to be routed from the radiating elements of the multi-element multi-band antenna 102 through the central opening 118 to one or more transmitters/receivers of the antenna assembly 100. As shown in FIG. 45, the base 108 can include a lower cable support portion 124 that surrounds the central opening 118. The lower cable support portion 124 can be configured to be coupled with an upper cable support portion 126 (see e.g., FIGS. 46A and 46B) to secure the coaxial cables to the base 108. For example, the upper cable support portion 126 can be coupled to the lower cable support portion 124 using one or more fasteners. As shown in FIG. 46B, the cable support portions 124, 126 can define a plurality of openings 128. Each opening 128 can receive a coaxial cable of the antenna assembly 100 and can assist in cable management within the antenna assembly 100.

In the illustrated example, the base 108 includes a plurality of ribs 116. The ribs 116 extend outwardly from the lower cable support portion 124 towards a rim 130 of the base 108. The ribs 116 can provide a benefit of increasing the mechanical stiffness of the base 108 while minimizing the additional material required for the base 108. For example, additional material can increase the weight and cost of the of the base 108, which may not be desirable. Accordingly, including the ribs 116 is an efficient way to both reduce the cost and weight of the antenna assembly 100. The rim 130 can provide a barrier between the center of the base 108. The rim 130 can extend upwardly from an inner surface of the base 108. In some implementations, a gasket (e.g., an O-ring) can be secured around an outer periphery of the rim 130 to prevent ingress (e.g., water, dust, etc.) into the internal volume of the antenna assembly 100. For example, when the radome 104 is coupled to the base 108, the gasket (not shown) can create a seal or barrier to fluid ingress. As such, the antenna assembly 100 may be IP67 rated and the antenna assembly 100 may be able to operate in wet conditions (e.g., in the rain).

The base 108 may also include an inner rib 120. The inner rib 120 may be circular and may be positioned between the lower cable support portion 124 and the rim 130. The inner rib 120 can include a plurality of cable grooves 122 (see e.g., FIG. 46B) that can support the coaxial cables. In such an arrangement, the coaxial cables can be suspended above the inner surface of the base 108. For ease of illustration, only on cable groove 122 is labeled in FIG. 46B.

Referring back to FIGS. 46A and 46B, the multi-element multi-band antenna 102 can include one or more first radiating element(s) 300. The first radiating elements can be multi-band radiator portions 300 and can be used for wireless telecommunication purposes (e.g., cellular telecommunication). Each multi-band radiator portion 300 may be a dual-band monopole antenna, a multi-band 3D inverted F antenna, or a version of a 2D inverted F antenna similar to a PIFA, that has a configuration that, when used in conjunction with high order electromagnetic modes generated or received by a transceiver and/or receiver, permit the antenna to have an operating frequency range of 600 MHz to 7.25 GHz. Depending on the particular use, the number of multi-band radiator portions 300 can vary. In the illustrated example, the antenna assembly 100 includes four multi-band radiator portions 300; however, more or fewer multi-band radiator portions 300 are possible. The multi-band radiator portions 300 are described further herein with reference to FIGS. 48A-48H. The circular base 108 can promote isolation between the multi-band radiator portions 300. In some implementations, the diameter of the base 108 can be selected for the desired isolation between the multi-band radiator portions 300.

The multi-element multi-band antenna 102 can optionally include one or more GPS antennas 168. In the illustrated example, the multi-element multi-band antenna 102 includes a single GPS antenna 168 (also referred to herein as a “GPS radiating device”). The GPS radiating portion 168 can be used to collect signal(s) from geosynchronous satellites so that the GPS function of a radio including the multi-element multi-band antenna 102 can determine where the multi-element multi-band antenna 102 is positioned relative to a global coordinate system. The GPS antenna 168 may be positioned within the radome 104 and may be mounted to the GPS mounting portion 114. The GPS antenna 168 may be electrically and/or mechanically coupled to the base 108.

The multi-element multi-band antenna 102 can include one or more second radiating elements 200. The second radiating elements can be configured operation at frequencies above approximately 1 GHz, in some implementations. For example, the second radiating elements 200 can be configured as multi-band Wi-Fi radios, 3GPP radios, cellular radios, and/or the like. In some advantageous implementations, the second radiating elements 200 can be multi-band WiFi antenna devices. As such, the second radiating elements 200 can be configured for mid-band operation, CBRS-band operation, and Wi-Fi-band operation, depending on the specific radio or transceiver attached. In some cases, the radiating portion 121 can have an operating range of approximately 1.6 GHz to 8 GHz or higher. As described further below, second radiating elements can include one or more PCB portions. The PCB portions may be made of flexible substrate materials (e.g., polyimide). As such, the PCB portions may be a flex circuit. In some cases, the PCB portions may be fiberglass reinforced with epoxy (e.g., FR4). The PCB portions may provide structure for the radiating portions of the second radiating elements 200. The various conductive portions of the second radiating elements 200 may be etched into the structure of the PCB portions.

FIG. 47A illustrates a first example of a second radiating element 200A in isolation. FIG. 47B illustrates a second example of a second radiating element 200B in isolation. The antenna assembly 100 can include second radiating elements 200A, second radiating elements 200B, or a combination of both, depending on the configuration. While FIGS. 46A and 46B show the antenna assembly 100 with the second radiating elements 200A, it is recognized that the antenna assembly 100 could include the second radiating elements 200B in addition to or alternatively to the second radiating elements 200A.

Referring to FIG. 47A first, the second radiating element 200A can include a conductive portion 202A formed on a PCB portion 204A. The conductive portion 202A can have a generally rectangular shape. The conductive portion 202A can extend from a feed point 206A. The feed point 206A is the location in the second radiating element 200A where the radio frequency (RF) signal is applied to or extracted from the second radiating element 200A. The conductive portion 202A may taper at its lower end towards the feed point 206A. The feeding portion 206A can include a coaxial input 208A. The coaxial input 208A can be configured to receive the center conductor 142 of coaxial cables of the antenna assembly 100. In some cases, the center conductor 142 can be soldered to the coaxial input 208A, which results in the second radiating element 200A being electrically coupled to the coaxial cable.

The second radiating element 200A can advantageously be configured to work with a multitude of radios configured to operate above approximately 1 GHz. For example, if the operator of the antenna assembly 100 desires additional cellular radios above 1 GHz, the second radiating elements 200A can be utilized. The second radiating element 200A may have optimal electrical properties from approximately 1.6 GHz to 8 GHz when used with the base 108, as in the antenna assembly 100.

Referring now to FIG. 47B, the second radiating element 200B can include a conductive portion 202B formed on PCB portion 204B. The conductive portion 202B can include a central conductive portion 210B and a first arm 212B and a second arm 214B, all etched into the PCB portion 204B. The central conductive portion 210B can be generally T-shaped. In some implementations, the second radiating element 200B can be configured for mid-band and Wi-Fi-band operation. In some cases, the central conductive portion 210B can be used for the 2.4 GHz to 2.5 GHz portion of the mid-band. In some cases, the first arm 212B and the second arm 214B can be used to cover the 4.8 GHz to 7.25 GHz of the Wi-Fi-band. In some cases, the height and width of the central element of the central conductive portion 210B (e.g., between the two arms of the “T”) can be selected for the impedance matching of the two bands. The conductive portion 202B can extend from a feed point 206B. The feeding portion 206B can include a coaxial input 208B. The coaxial input 208A can be configured to receive the center conductor 142 of coaxial cables of the antenna assembly 100. In some implementations, the PCB portion 204B can include one or more holes 220B. The holes 220B can extend through the PCB portion 204B without contacting the conductive portion 202B. The holes 220B can be tooling holes utilized when manufacturing the PCB portion 204B and are not required. For example, the holes 220B do not impact the electrical performance of the second radiating element 200B.

As shown in FIGS. 46A and 46B, each radiating element 200, 300 can be connected to a terminated coaxial cable 140. The coaxial cables are the transmission lines that allow for the radio frequency “RF” signal to travel from the output of the radio used to establish the wireless link from the base station to the mobile radio of the users of the wireless network. The terminated coaxial cables 140 may require proper connection to the particular components of the multi-element multi-band antenna 102 so that it can function properly. The terminated coaxial cables 140 may each include a center conductor 142 positioned within an outer conductor 144. The outer conductors 144 can be mechanically and electrically connected to the base 108. For example, the outer conductor 144 can be positioned in cable grooves in the mounting portions 110, 112 and coupled to the base 108 at the mounting portions 110, 112 using a bracket.

The number of coaxial cables included in the multi-element multi-band antenna 102 can be determined by the number of radiating elements included in the multi-element multi-band antenna 102. In the illustrated example, the multi-element multi-band antenna 102 includes thirteen radiating portions (e.g., four first radiating elements 300, eight second radiating elements 200, and the GPS antenna 168). As such, the multi-element multi-band antenna 102 includes thirteen coaxial cables, with thirteen terminated coaxial cables 140 being shown. For illustrative purposes, not all of the terminated coaxial cables 140 are labeled.

With reference again to FIG. 42, the base 108 can include a coupling portion 195. The coupling portion 195 can include a threading. The coupling portion 195 can be a shaft with an opening extending through the coupling portion 195. The coupling portion 195 can extend from a bottom of the base 108 so that the coupling portion 195 aligns with the central opening 118. In some implementations, the coupling portion 195 and the base 108 may be integrally formed. A waster, a nut (e.g., a hex nut), and/or any other fastener can be coupled to the threading of the coupling portion 195 to secure the antenna assembly 100 to a deployment surface. For example, the coupling portion 195 can be used to attach the antenna assembly 100 to a vehicle, a roof, any other structure, etc. In some implementations, the antenna assembly 100 can be attached to a client ground plane. In some implementations, a gasket 150 (see e.g., FIG. 42) may be coupled to the bottom surface of the base 108 before the antenna assembly 100 is deployed. A gasket 150 can help prevent fluid ingress into the internal volume of the antenna assembly 100 and/or can provide separation between the base 108 and the deployment surface. The gasket 150 on the base 108 can also increase the traction between the base 108 and the deployment surface.

FIG. 44A illustrates the antenna assembly 100 with a magnetic coupling portion 196. The magnetic coupling portion 196 can include magnets 197 positioned at the bottom of the magnetic coupling portion 196. The magnetic coupling portion 196 may be coupled to the base 108 via one or more fasteners. In some implementations, the coupling portion 195 can be used to couple the antenna assembly 100 to the magnetic coupling portion 196. In some implementations, the magnets 197 can be threadedly coupled to the magnetic coupling portion 196. Accordingly, the magnets 197 can be rotated to move the magnets 197 in a direction towards and/or away from the base 108 so one or more of the magnets 197 are positioned a different distance from the base 108 than the rest of the magnets 197 to allow the antenna assembly 100 or the magnetic coupling portion 196 to be coupled to a curved deployment surface.

FIGS. 44B and 44C illustrate the antenna assembly 100 with a mounting bracket 198. The mounting bracket 198 may be removably coupled to a pole and/or any other elongated structure. The mounting bracket 198 may include a mounting plane 199 that includes an opening. The antenna assembly 100 may be coupled to the mounting plane 199 so the coupling portion 195 extends through the opening in the mounting plane 199. A waster, a nut (e.g., a hex nut), and/or any other fastener can be coupled to the threading of the coupling portion 195 to secure the multi-element multi-band antenna 102 to the mounting plane 199.

FIGS. 48A-48H illustrate various views of components of the multi-band radiator portions 300, in accordance with some aspects of this disclosure. Each multi-band radiator portion 300 can include a multi-band radiating element 301 and a ground connection 303 (also referred to herein as a “grounding portion”). The ground connection 303 is configured to couple multi-band radiating element 301 to the base 108. FIGS. 48A and 48C-48F illustrate assorted views of the multi-band radiating element 301. FIGS. 48B and 48G-48H illustrate the ground connection 303. It is recognized that the multi-band radiator portions 300 described herein are just one example of multi-band radiator portions that can be included in the antenna assembly 100. In the illustrated implementation, the radiating element 301 and the ground connection 303 are constructed of metal (e.g., a conductive sheet). In some cases, the conductive sheet can have a thickness between 0.01 inches and 0.03 inches. In other implementations, the radiating element 301 and/or ground connection 303 could be constructed out of several rigid PCB portions or a single flex circuit PCB (e.g., supported by the radome 104 or another RF-transparent supporting structure).

As shown in FIG. 48A, a radiating element 301 can be one element or component of the multi-band radiator portion 300. An upright low-band radiation portion 325 (also referred to herein as the “body portion 325”) can be a body portion of the radiating element 301. The upright low-band radiation portion 325 can be coupled to a feeding portion at a feed point 319 (see e.g., FIG. 48C) to electrically excite the radiating element 301. As shown in FIG. 48A, a second low-band radiation portion 329 (also referred to herein as the “head portion 329”) can be positioned at an angle relative to the body portion 325 (e.g., the upright low-band radiation portion 325) and extend such that the second low-band radiation portion 329 is not coplanar with the upright low-band radiation portion 325. In some other implementations, the second low-band radiation portion 329 can be configured without a bend such that it is coplanar with the upright low-band radiation portion 325. In some implementations, advantages of a bend can include having two distinct low-band radiating portions, reducing the total height of the system to be more compact and conserve space, and configuring the system to be able to easily cover and provide protection for the system in a compact configuration with multi-band coverage (e.g., in the antenna assembly 100). Having a compact radiating element 301 (e.g., in part due to the bend between the upright low-band radiation portion 325 and the second low-band radiation portion 329) can allow the multi-band radiator portions 300 to be utilized in antenna assemblies where a low profile is required or desired. For example, it can be desirable for the antenna assembly 100 to have as low a profile as possible, to allow the antenna assembly 100 to be used in high wind operating conditions or applications that require low visual impact. Accordingly, as the multi-band radiator portions 300 represent the limiting factor in terms of total height of the antenna assembly 100, the low-profile multi-band radiator portions 300 are particularly advantageous. In some implementations, the multi-band radiator portions 300 can have a total height (e.g., from the bottom of the feed point 319 to the top of the second low-band radiation portion 329) of between 0.75 inch and 3 inches. For example, the multi-band radiator portions 300 may have a total height of less than 3 inches, less than 2.5 inches, less than 2 inches, less than 1.5 inches, less than 1 inches, and/or the like.

In some other implementations, the second low-band radiation portion 329 can be coupled to a third low-band radiation portion, a fourth low-band radiation portion, and/or other radiation portions. In some implementations, material forming the second low-band radiation portion 329 can extend in a direction further away from the upright low-band radiation portion 325 and comprise a slit between the material such that portion of material on each side of the slit may form a third low-band radiation portion and a fourth low-band radiation portion respectively, that may be coplanar with and extend beyond the second low-band radiation portion 329. In some implementations the third and fourth low-band radiation portions can be the same length and width. In some implementations, the length and/or width of the third low-band radiation portion may be different from the length and/or width of the fourth low-band radiation portion. In some implementations, one or more of the third low-band radiation portion and the fourth low-band radiation portion may be angled or bent or attached such that it is not coplanar with the second low-band radiation portion 329. Adding variations in radiation portions can provide advantageous coverage in different areas of bandwidth in some implementations.

In some cases, the radiating element 301 is a modified printed inverted-F antenna (PIFA) modified to have three bent arm members that make the radiating element 301 a three-dimensional antenna as opposed to a two-dimensional antenna generally practiced in the art for printed inverted-F antennas. Furthermore, the radiating element 301 can be a dual-band monopole antenna, a multi-band 3D inverted F antenna, or a version of a 2D inverted F antenna similar to a PIFA that has a configuration that, when used in conjunction with high order electromagnetic modes generated or received by a transceiver and/or receiver (as is typically performed for PIFA antennas), permit the radiating element 301 to have an operating frequency range of 500 MHz to 8 GHz.

The low-band portions (e.g., upright low-band radiation portion 325, the second low-band radiation portion 329, and any additional low-band radiation portions) can be configured for radiation in the low-band (e.g., approximately 600 MHz to 900 MHz), including low-band odd multiples. The radiating element 301 can also include additional portions configured for radiation above the low-band. For example, the radiating element 301 can include one or more primary arms 327 and/or one or more secondary arms 337. The primary arms 327 and the secondary arms 337 may be configured for operation on different bands or the same bands. For example, the primary arms 327 can be configured for radiation in the mid-band (e.g., approximately 1.7 GHz to 2.7 GHz) and the secondary arms 337 can be configured for radiation in the C-band (e.g., approximately 3.4 GHz to 4.2 GHz). In the illustrated example, the radiating element 301 includes two primary arms 327 and two secondary arms 337. However, more or fewer arms 327, 337 are possible. Further, in other implementations, the arms 327, 337 or additional/alternative arms can be included in the radiating element 301 and configured for radiation in the high band Wi-Fi band (e.g., approximately 4.8 GHz to 7.25 GHz).

The arms 327 can be coupled to a lower portion of the upright low-band radiation portion 325. In some implementations, the arms 327 can be coupled to an upper portion of the upright low-band radiation portion 325. In some other implementations, one or more additional arms 327 can be coupled to an upper portion of a low-band radiation portion (e.g., upright low-band radiation portion 325, the second low-band radiation portion 329, etc.). In some implementations the arms 327 can have the same length. In some implementations arms 327 can have different lengths. In some implementations, one or more of the arms 327 can be positioned at an angle relative to the upright low-band radiation portion 325 and/or relative to a ground plane (e.g., the base 108). The arms 327 can be positioned at the same angle or at different angles. The arms 327 can be configured for radiation in the mid-band, including higher even order resonances. In some implementations, additional arm portions can be added or formed at selected locations to add coverage for additional high frequency bandwidth areas (e.g., the high band Wi-Fi band). For example, in some implementations, portions of the arms 327 (and/or the arms 337) may be slit, extended, angled, bent, modified, and/or otherwise connected to provide improved coverage areas.

As shown in FIG. 48E, in some implementations, each arm 327 can include a first arm portion 333 and a second arm portion 335. The first arm portions 333 can be coupled to or extend from the upright low-band radiation portion 325, and the second arm portions 335 can be coupled to or extend from the first arm portions 333. The second arm portions 335 can be at a different angle relative to the upright low-band radiation portion 325 and the base 108 compared to the first arm portions 333. The second arm portions 335 can have a different width, thickness, length, and/or bend angle compared to the first arm portions 333. These variations can improve return loss and radiation pattern performance in some cases. In the illustrated example, the first arm portions 333 extend from a lower portion of the upright low-band radiation portion 325 in a direction towards the second low-band radiation portion 329. The first arm portions 333 and the second low-band radiation portion 329 can both extend away from the upright low-band radiation portion 325. In some implementations, the arms 327 can have a maximum height (relative to the base 108) that is substantially the same as the maximum height of the second low-band radiation portion 329 (relative to the base 108).

The arms 337 can extend from or be coupled to the upright low-band radiation portion 325. For example, the arms 337 can be coupled to an upper portion of the upright low-band radiation portion 325. In some implementations, the arms 337 can be positioned above the arms 327, relative to the base 108. In some implementations, the arms 337 can be coupled to a lower portion of the upright low-band radiation portion 325. For example, the arms 337 may be positioned below the arms 327. In some other implementations, one or more additional arms 337 can be coupled to a low-band radiation portion of the radiating element 301 (e.g., the upright low-band radiation portion 325, the second low-band radiation portion 329, etc.). In some implementations the arms 337 can have the same length. In some implementations arms 337 can have different lengths. In some implementations, one or more of the arms 337 can be positioned at an angle relative to the upright low-band radiation portion 325 and/or relative to a ground plane (e.g., the base 108). The arms 337 can be positioned at the same angle or at different angles. As described herein, the arms 337 can be configured for radiation in the C-band (e.g., approximately 3.4 GHz to 4.2 GHz), including high even order resonances. In some implementations, additional arm portions can be added or formed at selected locations to add coverage for additional high frequency bandwidth areas (e.g., the C-band or higher). For example, in some implementations portions of the arms may be slit, extended, angled, bent, modified, and/or otherwise connected to provide improved coverage areas. In some implementations, the arms 337 can be coplanar to the upright low-band radiation portion 325, as shown in FIG. 48E. In some implementations, the arms 337 can improve return loss at the upper end of the mobile telecommunications spectrum relative to the radiating element 301, which may not include the additional arms similar to the arms 337.

As shown in FIG. 48B, a ground connection 303 (also referred to herein as the “tuner 303”) can be adapted and configured to couple the radiating element 301 with the base 108. The tuner 303 can include a face plate 371 that is configured to be coupled to a ground plane (e.g., the base 108). The tuner 303 can include an arm portion 373, which can be an arm portion coupled to the face plate 371. The width of arm portion 373 can be adjusted to accommodate clearance for transmission lines, such as coaxial cables 140 of antenna assembly 100, which can be used to excite the radiating element 301. For example, as shown in FIG. 46B, the illustrated width of the arm portion 373 allows the coaxial cables 140 to extend past the arm portion 373, under the body 375, and to be positioned adjacent the arm portion 373 when coupled to the radiating element 301. Low-band operation of the multi-band radiator portion 300 is enhanced and can be adjusted by the length and width of body portion 325 and head portion 329 as well as the location, placement, and configuration of an opening (not shown) in body portion 325. The tuner 303 can include a body 375 that includes an engagement portion 377. The engagement portion 377 can be adapted and configured to be positioned against the body portion 325 of the radiating element 301. For example, the engagement portion 377 can be positioned against the upright low-band radiation portion 325 such that the body 375 is substantially orthogonal to the upright low-band radiation portion 325. The engagement portion 377 can include one or more tabs 383. The tabs one or more tabs 383 can be twist tabs. The one or more tabs 383 can be received within one or more slots 331 of the upright low-band radiation portion 325. As such, the extension of the tabs 383 through the slots 331 can be a point of coupling, creating a ground connection for the multi-band radiator portion 300. Use of the tabs 383 and the slot 331 for the ground connection can improve grounding, reduce the part count, and/or reduce assembly time, compared to other coupling means such as a nut and threaded fastener. For example, to couple the ground connection 303 to the radiating element 301, the tabs 383 can be inserted in the slots 331 and twisted (e.g., with pliers) to create the connection. This type of connection can be completed more quickly than other connections (such as soldering, nut and fastener, etc.) and can provide a secured connection. In some cases, solder can optionally be used to improve the electrical connection between the ground connection 303 and the radiating element 301; however, the solder is generally not required for the mechanical or electrical connection to be established. The lateral position of the arm portion 373 relative to body 375 can also be selected to accommodate clearance for transmission lines. For example, while the arm portion 373 is shown as positioned on one side of the body 375, this position is not required and the arm portion 373 could be centrally positioned on the body 375 in other implementations. The position and width of the arm portion 373 can also impact the performance of the multi-band radiator portion 300 across the various bands.

As shown in FIG. 46B, the ground connection 303 can be elevated relative to the feed location 319 of the radiating element 301 in the assembled antenna assembly 100. For example, the face plate 371 can be coupled to a portion of the base 108 that is higher than the feed point 319 in the assembled antenna assembly 100. Such a raised connection provides advantages to achieve the multi-band coverage. Dimensions can be selected to provide harmonic resonance at higher odd orders in some implementations. The grounding portion 303 provides advantages for achieving multiple advantageous resonances. Also, the selection of the dimensions for radiating portion 300 may also be adjusted to impact the radiation patterns of the fundamental mode as well as the higher order modes. For example, in some implementations, the height, width, and clearance provided for by the size of arm portion 373 can be advantageously selected. Additionally, the length and width of body portion 375 can also be advantageously selected. For example, the width and length of the arm portion 373 and the body 375 can be adjusted for impedance matching as well as to achieve a desired radiation pattern for the multi-band radiator portion 300. The locations of the one or more slots 331 and one or more tabs 383, when coupled together for the grounding connection create a symbiotic connection to provide a resonance of desired impedance to match a desired frequency and bandwidth and radiation pattern for a low-band frequency configuration in some implementations. In the illustrated example, the slots 331 are near the vertical center of the upright low-band radiation portion 325. The vertical position of the slots 331 on the upright low-band radiation portion 325 is related to the height or length of the arm portion 373. In other implementations, the slots 331 can be located higher or lower on upright low-band radiation portion 325 relative to the vertical axis. The location of the slots 331 (e.g., where the ground connection 303 attaches) relative to the height of the upright low-band radiation portion 325 is selected for impedance matching and the desired behavior of the higher order modes (e.g., where the higher order modes occur). The relative dimensions are also selected so that the radiation patterns comes off of the radiating element 301 in the desired shape and/or direction. The width between the slots 331 can also be variable. In the illustrated example, each slot 331 is located approximately centrally between the central vertical axis of the upright low-band radiation portion 325 and an outside edge of the upright low-band radiation portion 325. In other examples, the slots 331 can be closer or further apart from each other. In some cases, decreasing the width between the slots 331 can require the height of the slots 331 to also be reduced relative to the upright low-band radiation portion 325 for optimal performance of the multi-band radiator portion 300. In some cases, it can be desirable for the slots 331 to be located as high on the upright low-band radiation portion 325 as possible for improved structural benefits. However, the height of the slots 331 is selected generally selected for a balance of good structural support and performance of the multi-band radiator portion 300 across all desired bands.

FIG. 48C shows coupling points 317a of the radiating element 301. The twin coupling points 317a can be used to attach the multi-band radiator portion 300 to a non-conductive structural stand coupled to the base 108. For example, the non-conductive structural stand can be secured to the mounting portion 110 of the base 108. More isolation can be created from the base 108 by expanding the space 313 and/or the space 311 between the twin coupling points 317a and a feed point location 319. The feed point location 319 is configured to receive an electrical connection to excite the radiating element 301. For example, the center conductor 142 of the terminated coaxial cable 140 can be electrically and mechanically coupled to the feed point 319 with the outer conductor 144 being electrically and mechanically coupled to the base 108 via the mounting portion 110. The space 311 can be selected primarily for impedance matching purposes and may vary depending on the particular implementation of the multi-band radiator portion 300 and the antenna assembly 100. For example, changing the dimensions or structure of the base 108 can result in a variation in the size of the space 311. In some implementations, the feed point 319 can be twice the height (e.g., space 311 can be doubled) or greater and/or the feed point 319 can be twice the width (e.g., the narrow width tab 309 can be doubled) or greater. In other implementations, a feed point 319 with different structural features can be used. For example, the radiating element 301 may include a feed point that is a tab. The tab feed point may extend substantially perpendicular to the upright low-band radiation portion 325. In one example, the radiating element 301 can include a feed point that includes a spacer with a push rivet or established via a heat stake operation. In some implementations, the feed point of the radiating element 301 can be configured to be snap fit into a slot or configured as a push pass connection.

In some other implementations, features and aspects of the multi-band radiator portions 300 can be further described as follows. FIG. 48C illustrates the radiating element 301 that can be coupled to the base 108 of the antenna assembly 100 shown in at least FIG. 45, and electrically excited at the feed point 319. For example, as described above, the center conductor 142 of the terminated coaxial cable 140 can be coupled to the feed point 319 with the outer conductor 144 being coupled to the base 108. The feed point 319 can extend from or be coupled to the upright low-band radiation portion 325 with what can be a narrow width tab 309. Additional isolation between the upright low-band radiation portion 325 and the base 108 can be obtained by adjusting 311 and consequently the coupling location reference 313. For additional mechanical support, the upright low-band radiation portion 325 can have a non-conductive coupling mechanism (not shown) to the base 108. For example, the non-conductive coupling mechanism can be secured to the mounting portion 110. The upright low-band radiation portion 325 can have a coupling point (e.g., one or more slots 331) for attaching the grounding portion 303 with via the one or more tabs 383. As noted above, also extending from/coupled to the upright low-band radiation portion 325 can be one or more primary arms 327 and/or one or more secondary arms 337. The arms 327, 337 can assist with the dominate radiation in the mid-band and C-band for the multi-band radiator portion 300. One or more portions similar to the arms 327, 337 may be used for assisting in the high band portion of the radiation are realizable in the implementation of this approach. Higher even order resonances may radiate from portions similar to the arms 327, 337 of the radiating element 301 to assist in the multi-band properties of the device. Furthermore, there can be the additional head portion 329 coupled to the upright low-band radiation portion 325 that may be perpendicular in nature for its orientation. Though it is not necessary for it to be bent near 90-degrees as depicted in this illustration and can be shown to be perceptibly straight in other implementations. By bending the low-band radiation portion of the radiating element 301 to realize two distinct portions (e.g., the upright low-band radiation portion 325 and the second low-band radiation portion 329), the total height of the radiating element 301 is reduced and as such the total volume of the antenna assembly 100 to most likely provide environmental protection is consequently reduced. The low-band operation of the radiating element 301 is determined by several factors. Some of the factors are the length and width of the upright low-band radiation portion 325 and of the second low-band radiation portion 329, the location of opening one or more slots 331, and/or the grounding portion 303.

FIG. 48B illustrates the grounding portion of the device 303. The face plate 371 can extend from or be coupled to the arm 373. The width of the arm 373 can be adjusted to accommodate clearance for assembly purposes for a transmission line of the antenna assembly 100 that may be used for excitation of the multi-band radiator portion 300. The body 375 can extend from or be coupled to arm 373. The engagement portion 377 can be coupled to or form a portion of the body 375. The engagement portion 377 can also have one or more coupling points (e.g., one or more tabs 383) that are configured to couple to the opening one or more slots 331 of the radiating element 301 in the assembled multi-band radiator portion 300. The height of the arm 373, the width of the arm 373, the clearance provided for in the arm 373, the length of body 375, and the symbiotic location of slots 331 and/or tabs 383 can provide for a reactance that counterbalances the reactance of the low-band impedance to provide a resonance of desired impedance match for the desired frequency and bandwidth for the low-band radiation. The location of the coupling points (e.g., one or more tabs 383) and the length and width of the grounding portion 303 are also chosen to provide higher odd order resonant harmonics at the desired locations to cover a portion of the frequency band of the multi-band performance of the antenna assembly 204. Further, the relative dimensions described above also influence the radiation pattern generated by the radio frequency excitation of the multi-band radiator portion 300.

FIG. 48C illustrates a back side view of the radiating element 301. Twin coupling points 317a in the radiating element 301 may be coupled to a non-conductive object (not shown), which can be coupled to the base 108 (e.g., mounting portions 110) of the antenna assembly 100. This coupling may provide mechanical stability for the multi-band radiator portions 300 while not disturbing or inhibiting the ground connection provided by the ground connection 303.

FIGS. 48D-48F provide additional views of the radiating element 301. As shown in FIGS. 48D and 48F, the second low-band radiation portion 329 can include one or more clearances. For example, the second low-band radiation portion 329 can include one or more first clearances 357a and/or one or more second clearances 357b. The clearances 357a, 357b can be holes or openings formed in the second low-band radiation portion 329. The clearances 357a, 357b may allow for ease of assembly of the completed multi-band radiator portions 300. FIG. 48G-48H provide additional views of the ground connection 303 of the multi-band radiator portions 300.

In some implementations, the antenna assembly 100 can include one or more millimeter wave radios. For example, the one or more millimeter wave radios can form part of the multi-element multi-band antenna 102. FIGS. 49A-49D illustrate four example millimeter wave radios 250A, 250B, 250C, 250D respectively (collectively millimeter wave radios 250), any of which can be included in the antenna assembly 100. While four example millimeter wave radios 250 are provided, in other implementations, different or modified millimeter wave radios 250 can be included in the antenna assembly 100. The millimeter wave radios 250 can be included in addition to or alternatively to the multi-band radiator portion 300 and the second radiating elements 200. For example, in some implementations, the antenna assembly 100 may include one or more multi-band radiator portions 300, one or more second radiating elements 200, and one or more millimeter wave radios 250. In some cases, the antenna assembly 100 can include up to four of each of the multi-band radiator portions 300, the second radiating elements 200, and the millimeter wave radios 250. The millimeter wave radios 250 can operated in the millimeter wave frequency spectrum (approximately between 30 GHz and 300 GHz), with wavelengths ranging from 1 to 10 millimeters approximately. The millimeter wave radios 250 can be used for high-frequency communication. Including one or more millimeter wave radios 250 can improve or support high data transfer rates of the antenna assembly 100 over short distances. For example, the millimeter wave radios 250 can be configured to transmit large amounts of data, which can be ideal for 5G network applications and high-speed wireless communication for the antenna assembly 100.

FIG. 49A illustrates a first example of a millimeter wave radio 250A that can be included in the antenna assembly 100. The millimeter wave radio 250A can be a slotted waveguide array millimeter wave radio. The millimeter wave radio 250A can include a millimeter wave radio 252A and one or more waveguides 254A. In the illustrated example, three waveguides 254A are included. The waveguides 254A can be hollow metallic structures that direct electromagnetic waves. Each waveguide 254A can include slots 256A cut into its surface to allow for controlled radiation. For ease of illustration, not all slots 256A in FIG. 49A are labeled. The waveguides 254A can serve as a conduit for the millimeter-wave signals, efficiently transmitting them along its length with minimal loss. The slots 256A can act as the radiating elements for the millimeter wave radio 250A, emitting the millimeter wave signals. The position and size of the slots 256A can be selected to achieve a highly directional beam. In some implementations, the waveguides 254A can be configured to create an array of slots 256A. Such an array can be used to form a high-gain, highly directional antenna, which can be ideal for focusing energy in a specific direction or scanned along a portion of the horizon, which may be desirable.

FIG. 49B illustrates a second example of a millimeter wave radio 250B that can be included in the antenna assembly 100. The millimeter wave radio 250B can be a dipole array millimeter wave radio. The millimeter wave radio 250B can include a millimeter wave radio 252B, a microwave grade PCB portion 254B, and a plurality of dipole antennas 256B. The dipole antennas 256B can be arranged in an array on the PCB portion 254B. The PCB portion 254B can include a ground plane (not shown) on its back side (e.g., the side closest to the millimeter wave radio 252B). For ease of illustration, not all of the dipole antennas 256B in FIG. 49B are labeled. The dipole antennas 256B can be substantially smaller compared to other antennas of the antenna assembly 100 because of the short wavelength of the millimeter wave radio 250B. Arranging the dipole antennas 256B in an array can enhance the gain, directivity, and/or beamforming capabilities of the millimeter wave radio 250B. The phase and amplitude of signals fed to each dipole antenna 256B can be selected to focus the energy in a specific direction. For example, highly directional and scannable radiation patterns can be generated by the millimeter wave radio 250B.

FIG. 49C illustrates a third example of a millimeter wave radio 250C that can be included in the antenna assembly 100. The millimeter wave radio 250C can be a microstrip patch array millimeter wave radio. The millimeter wave radio 250C can include a millimeter wave radio 252C, a microwave grade PCB portion 254C, and a plurality of microstrip patch antennas 256C. The microstrip patch antennas 256C can be flat rectangular antennas comprising a conductive material (e.g., a metal). The microstrip patch antennas 256C can be arranged in an array on the PCB portion 254C. The PCB portion 254C can include a ground plane (not shown) on its back side (e.g., the side closest to the millimeter wave radio 252C). For ease of illustration, not all of the microstrip patch antennas 256C in FIG. 49C are labeled. The microstrip patch antennas 256C can be substantially smaller compared to other antennas of the antenna assembly 100 because of the short wavelength of the millimeter wave radio 250C. Arranging the microstrip patch antennas 256C in an array can enhance the gain, directivity, and/or beamforming capabilities of the millimeter wave radio 250C. The feed network of the microstrip patch antenna array can be controlled to allow for precise beamforming and higher directional accuracy. Alternatively, elements can be individually fed as opposed to serially fed to form a highly scannable array in both azimuth and elevation.

FIG. 49D illustrates a fourth example of a millimeter wave radio 250D that can be included in the antenna assembly 100. The millimeter wave radio 250D can be a coplanar waveguide feed cylindrical dielectric resonator array millimeter wave radio. The millimeter wave radio 250D can include a millimeter wave radio 252D, a microwave grade PCB portion 254D, a plurality of dielectric resonator antennas 256D, and a ground plane 258D. The dielectric resonator antennas 256D can be constructed of a non-metallic materials (e.g., dielectrics) and can be the radiating elements of the millimeter wave radio 250D. The dielectric resonator antennas 256D can be cylindrically shaped, which can help confine and radiate electromagnetic energy effectively at millimeter-wave frequencies. The dielectric resonator antennas 256D can be arranged in an array on the PCB portion 254D. For ease of illustration, not all of the dielectric resonator antennas 256D in FIG. 49D are labeled. The dielectric resonator antennas 256D can be substantially smaller compared to other antennas of the antenna assembly 100 because of the short wavelength of the millimeter wave radio 250D. Arranging the dielectric resonator antennas 256D in an array can enhance the gain, directivity, and/or beamforming capabilities of the millimeter wave radio 250D.

The particular implementations disclosed above are illustrative only, as the application may be modified and practiced in different but equivalent manners apparent to those skilled in the art having the benefit of the teachings herein. It is therefore evident that the particular implementations disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

### Additional Example Clauses for Antenna Systems

Various examples of systems relating to an antenna system are found in the following clauses:

Clause 1. A multi-band antenna, comprising: a plurality of first radiating structures, each first radiating structure of the plurality of first radiating structures comprising a first upright radiation portion and a first top radiation portion extending from the first upright radiation portion; a plurality of second radiating structures, each second radiating structure of the plurality of second radiating structures comprising a second upright radiation portion and a second top radiation portion extending from the second upright radiation portion; a plurality of third radiating structures; and a base PCB, wherein the plurality of first radiating structures, the plurality of second radiating structures, and the plurality of third radiating structures are positioned on the base PCB around a center of the multi-band antenna, wherein the plurality of first radiating structures are positioned adjacent to the plurality of second radiating structures, and wherein the first top radiation portion and the second top radiating portion of adjacent first radiating structures and second radiating structures extend in a opposite directions.

Clause 2. An antenna assembly, comprising: a base; a radome, the radome configured to be removably coupled to the base; at least one GPS antenna coupled to the base; one or more WiFi antennas coupled to the base; and one or more multi-band radiator portions coupled to the base.

Clause 3. The antenna assembly of Clause 2, wherein each multi-band radiator portion of the one or more multi-band radiator portions comprises: a feeding portion; a grounding portion; an upright low band radiation portion; a second low band radiation portion; and a high band radiation portion.

Clause 4. The antenna assembly of any of Clauses 3, wherein the second low band radiation portion is not-coplanar with the upright low band radiation portion.

Clause 5. The antenna assembly of any of Clauses 13, wherein the second low band radiation portion is coplanar with the upright low band radiation portion.

Clause 6. The antenna assembly of any of Clauses 3-5, wherein the high band radiation portion comprises two primary arms coupled to a base of the upright low band radiation portion.

Clause 7. The antenna assembly of Clause 6, wherein each primary arm comprises a first arm portion and a second arm portion, wherein the first arm portion is coupled to the upright low band radiation portion and the second arm portion extends from the first arm portion.

Clause 8. The antenna assembly of Clause 7, wherein the first arm portion has a varying width along a length of the first arm portion.

Clause 9. The antenna assembly of Clause 7 or Clause 8, wherein the second arm portion has a consistent width along a length of the second arm portion.

Clause 10. The antenna assembly of any of Clauses 3-5, wherein the high band radiation portion comprises a single primary arm coupled to a base of the upright low band radiation portion.

Clause 11. The antenna assembly of any of Clauses 3-5, wherein the high band radiation portion comprises a plurality of primary arms coupled to a base of the upright low band radiation portion.

Clause 12. The antenna assembly of any of Clauses 3-5, wherein the high band radiation portion comprises a plurality of primary arms of different lengths coupled to a base of the upright low band radiation portion.

Clause 13. The antenna assembly of any of Clauses 3-12, wherein each multi-band radiator portion of the one or more multi-band radiator portions further comprises: a third low band radiation portion coupled to the second low band radiation portion; and a fourth low band radiation portion coupled to the second low band radiation portion and not contacting the third low band radiation portion.

Clause 14. The antenna assembly of Clause 13, wherein the third low band radiation portion has a first dimension, wherein the fourth low band radiation portion has a second dimension, and wherein the first dimension and the second dimension are substantially the same.

Clause 15. The antenna assembly of Clause 13, wherein the third low band radiation portion has a first dimension, wherein the fourth low band radiation portion has a second dimension, and wherein the first dimension and the second dimension are different.

Clause 16. The antenna assembly of any of Clauses 3-15 wherein the high band radiation portion further comprises one or more secondary arms coupled to the upright low band radiation portion.

Clause 17. The antenna assembly of Clause 16, wherein the one or more secondary arms are coplanar to the upright low band radiation portion.

Clause 18. The antenna assembly of Clause 16, wherein the one or more secondary arms are not coplanar to the upright low band radiation portion.

Clause 19. The antenna assembly of any of Clauses 16-18, wherein the one or more secondary arms comprise two secondary arms.

Clause 20. The antenna assembly of any of Clauses 3-19, wherein the one or more multi-band radiator portions comprises four multi-band radiator portions.

Clause 21. The antenna assembly of any of Clauses 1-20, wherein the one or more WiFi antennas comprises eight dual-band WiFi radiator portions.

Clause 22. A multi-band antenna comprising a radiating element, the radiating element comprising: an upright portion configured for low-band radiation; a head portion extending from a top edge of the upright portion, the head portion configured for low-band radiation; one or more first arms extending from the upright portion, the one or more first arms configured for mid-band radiation; and one or more second arms extending from the upright portion, the one or more second arms configured for C-band radiation.

Clause 23. The multi-band antenna of clause 22, wherein the multi-band antenna is formed from a conductive sheet comprising the upright portion, the head portion, the one or more first arms, and the one or more second arms.

Clause 24. The multi-band antenna of clause 22, wherein the multi-band antenna is formed of one or more PCB portions, the one or more PCB portions comprising the upright portion, the head portion, the one or more first arms, and the one or more second arms.

Clause 25. The multi-band antenna of any of clauses 22 to 24, wherein the head portion extends angularly from the upright portion.

Clause 26. The multi-band antenna of clause 25, wherein the head portion extends from the upright portion at an angle at or within 89-91 degrees.

Clause 27. The multi-band antenna of any of clauses 22 to 26, wherein the one or more first arms extend angularly from the upright portion.

Clause 28. The multi-band antenna of any of clauses 22 to 27, wherein the one or more first arms comprise a first left arm that extends from a left side of the upright portion and a first right arm that extends from a right side of the upright portion.

Clause 29. The multi-band antenna of clause 28, wherein the first left arm comprises a first left arm portion extending from the left side of the upright portion and a second left arm portion extending from the first left arm portion, and the first right arm comprises a first right arm portion extending from the right side of the upright portion and a second right arm portion extending from the first right arm portion.

Clause 30. The multi-band antenna of clause 29, wherein the first right arm portion has a varying width along a length of the first right arm portion and the first left arm portion has a varying width along a length of the first left arm portion.

Clause 31. The multi-band antenna of clause 29 or clause 30, wherein the second left arm portion has a consistent width along a length of the second left arm portion and the second right arm portion has a consistent width along a length of the second right arm portion.

Clause 32. The multi-band antenna of any of clauses 29 to 31, wherein the second left arm portion and the second right arm portion are substantially orthogonal to the upright portion.

Clause 33. The multi-band antenna of any of clauses 22 to 32, wherein the one or more second arms comprise a second left arm that extends from a left side of the upright portion and a second right arm that extends from a right side of the upright portion.

Clause 34. The multi-band antenna of clause 33, wherein the second left arm and the second right arm are coplanar with the upright portion.

Clause 35. The multi-band antenna of any of clauses 22 to 34, wherein the one or more second arms are positioned on the upright portion between the head portion and the one or more first arms.

Clause 36. The multi-band antenna of any of clauses 22 to 35, wherein the upright portion comprises one or more slots configured to receive projection of a ground connection.

Clause 37. The multi-band antenna of any of clauses 22 to 36, further comprising a feed point extending from a bottom edge of the upright portion.

Clause 38. The multi-band antenna of any of clauses 22 to 37, wherein the head portion further comprises a first set of apertures located proximate to the top edge of the upright portion.

Clause 39. The multi-band antenna of any of clauses 22 to 38, further comprising one or more additional low-band portions extending from the head portion or the upright portion and configured for low-band radiation.

Clause 40. The multi-band antenna of any of clauses 22 to 39, wherein at least one of the upright portion and the head portion is configured to have multiple resonances that are odd multiples of a lowest low-band resonance.

Clause 41. The multi-band antenna of any of clauses 22 to 40, wherein at least one of the one or more first arms and the one or more second arms is configured to have multiple resonances that are even multiples of a lowest low-band resonance.

Clause 42. The multi-band antenna of any of clauses 22 to 41, further comprising a ground connection, the ground connection comprising: a face plate configured to be coupled to a ground reference; a body portion configured to be coupled to the upright portion; and an arm portion extending between the face plate and the body portion.

Clause 43. The multi-band antenna of clause 42, wherein the body portion further comprises one or more tabs, the one or more tabs configured to be received within slots of the upright portion to electrically connect the ground connection to the radiating element.

Clause 44. The multi-band antenna of clause 43, wherein the one or more tabs are configured to be twisted once received within the slots of the upright portion to mechanically connect the ground connection to the radiating element.

Clause 45. The multi-band antenna of any of clauses 42 to 44, wherein the arm portion has a smaller width than the body portion.

Clause 46. The multi-band antenna of any of clauses 42 to 45, wherein the arm portion extends from one side of a back side of the body portion such that a coaxial cable can extend past the arm portion and under the body portion when the coaxial cable is coupled to the radiating element.

Clause 47. A multi-band antenna comprising: an upright portion configured as a first resonating component; a head portion extending angularly from the upright portion, the head portion configured as a second resonating component; a first left arm extending from a left edge of the upright portion, the first left arm configured as a third resonating component; a first right arm extending from a right edge of the upright portion, the first right arm configured as a fourth resonating component; a second left arm extending from the left edge of the upright portion, the second left arm configured as a fifth resonating component; and a second right arm extending from the right edge of the upright portion, the second right arm configured as a sixth resonating component.

Clause 48. The multi-band antenna of clause 47, wherein the first resonating component and the second resonating component are configured to resonate within a low-frequency band of between 600 MHz and 900 MHz during use.

Clause 49. The multi-band antenna of clause 47 or clause 48, wherein the third resonating component and the fourth resonating component are configured to resonate within a mid-frequency band of between 1.7 GHz and 2.7 GHz during use.

Clause 50. The multi-band antenna of any of clauses 47 to 49, wherein the fifth resonating component and the sixth resonating component are configured to resonate within a CBRS-frequency band of between 3.4 GHz and 4.2 GHz during use.

Clause 51. The multi-band antenna of any of clauses 47 to 50, wherein the multi-band antenna is formed from a conductive sheet comprising the upright portion, the head portion, the first left arm, the first right arm, the second left arm, and the second right arm.

Clause 52. The multi-band antenna of any of clauses 47 to 51, wherein the multi-band antenna is formed of one or more PCB portions, the one or more PCB portions comprising the upright portion, the head portion, the first left arm, the first right arm, the second left arm, and the second right arm.

Clause 53. The multi-band antenna of any of clauses 47 to 52, wherein the head portion extends from the upright portion at an angle at or within 89-91 degrees.

Clause 54. The multi-band antenna of any of clauses 47 to 53, wherein the first left arm and the first right arm extend angularly from the upright portion.

Clause 55. The multi-band antenna of any of clauses 47 to 54, wherein the first left arm comprises a first left arm portion extending from the left edge of the upright portion and a second left arm portion extending from the first left arm portion, and the first right arm comprises a first right arm portion extending from the right edge of the upright portion and a second right arm portion extending from the first right arm portion.

Clause 56. The multi-band antenna of clause 55, wherein the first right arm portion has a varying width along a length of the first right arm portion and the first left arm portion has a varying width along a length of the first left arm portion.

Clause 57. The multi-band antenna of clause 55 or clause 56, wherein the second left arm portion has a consistent width along a length of the second left arm portion and the second right arm portion has a consistent width along a length of the second right arm portion.

Clause 58. The multi-band antenna of any of clauses 55 to 57, wherein the second left arm portion and the second right arm portion are substantially orthogonal to the upright portion.

Clause 59. The multi-band antenna of any of clauses 47 to 58, wherein the second left arm and the second right arm are coplanar with the upright portion.

Clause 60. The multi-band antenna of any of clauses 47 to 59, wherein the second left arm and the second right arm are positioned on the upright portion between the head portion and the first left arm and the first right arm.

Clause 61. The multi-band antenna of any of clauses 47 to 60, wherein the upright portion comprises one or more slots configured to receive projection of a ground connection.

Clause 62. The multi-band antenna of any of clauses 47 to 61, further comprising a feed point extending from a bottom edge of the upright portion.

Clause 63. The multi-band antenna of any of clauses 47 to 62, wherein the head portion further comprises a first set of apertures located proximate to a top edge of the upright portion.

Clause 64. The multi-band antenna of any of clauses 47 to 63, further comprising one or more additional low-band portions extending from the head portion or the upright portion and configured for low-band radiation.

Clause 65. The multi-band antenna of any of clauses 47 to 64, wherein at least one of the upright portion and the head portion is configured to have multiple resonances that are odd multiples of a lowest low-band resonance.

Clause 66. The multi-band antenna of any of clauses 47 to 65, wherein at least one of the first left arm, the first right arm, the second left arm, and the second right arm is configured to have multiple resonances that are even multiples of a lowest low-band resonance.

Clause 67. The multi-band antenna of any of clauses 47 to 66, further comprising a ground connection, the ground connection comprising: a face plate configured to be coupled to a ground reference; a body portion configured to be coupled to the upright portion; and an arm portion extending between the face plate and the body portion.

Clause 68. The multi-band antenna of clause 67, wherein the body portion further comprises one or more tabs, the one or more tabs configured to be received within slots of the upright portion to electrically connect the ground connection to the upright portion.

Clause 69. The multi-band antenna of clause 68, wherein the one or more tabs are configured to be twisted once received within the slots of the upright portion to mechanically connect the ground connection to the upright portion.

Clause 70. The multi-band antenna of any of clauses 67 to 69, wherein the arm portion has a smaller width than the body portion.

Clause 71. The multi-band antenna of any of clauses 67 to 70, wherein the arm portion extends from one side of a back side of the body portion such that a coaxial cable can extend past the arm portion and under the body portion when the coaxial cable is coupled to the upright portion.

Clause 72. An antenna assembly comprising: a base, the base comprising a conductive material and configured as a ground reference for the antenna assembly; a radome configured to be coupled to the base to define an internal volume; and a multi-element multi-band antenna comprising: one or more multi-band antennas coupled to the base; and one or more second radiating elements coupled to the base.

Clause 73. The antenna assembly of clause 72, wherein the one or more multi-band antennas each comprise the multi-band antenna defined by any of clauses 22 to 46.

Clause 74. The antenna assembly of clause 72, wherein the one or more multi-band antennas each comprise the multi-band antenna defined by any of clauses 47 to 71.

Clause 75. The antenna assembly of any of clauses 72 to 74, wherein the one or more second radiating elements comprise a conductive portion formed on a PCB portion.

Clause 76. The antenna assembly of clause 75, wherein the conductive portion has a generally rectangular shape and extends to a feed point at a bottom of the conductive portion.

Clause 77. The antenna assembly of clause 75, wherein the conductive portion comprises: a central conductive portion being generally T-shaped; a first arm; and a second arm.

Clause 78. The antenna assembly of clause 77, wherein the central conductive portion is configured to resonate within a mid-frequency band of between 2.4 GHz and 2.5 GHz during use and the first arm and second arm are configured to resonate within a Wi-Fi-frequency band of between 4.8 GHz and 7.25 GHz during use.

Clause 79. The antenna assembly of any of clauses 75 to 78, wherein the one or more second radiating elements are configured as multi-band Wi-Fi radios and are configured for operation at frequencies above 1 GHz.

Clause 80. The antenna assembly of any of clauses 72 to 79, wherein the multi-element multi-band antenna further comprises one or more millimeter wave radios configured for operation at frequencies between 30 GHz and 300 GHz.

Clause 81. The antenna assembly of clause 80, wherein the one or more millimeter wave radios comprise slotted waveguide array millimeter wave radios, dipole array millimeter wave radios, microstrip patch array millimeter wave radios, or coplanar waveguide feed cylindrical dielectric resonator array millimeter wave radios.

Clause 82. The antenna assembly of any of clauses 72 to 81, further comprises a GPS antenna.

Clause 83. The antenna assembly of any of clauses 72 to 82, wherein the one or more multi-band antennas and the one or more second radiating elements are arranged around a perimeter of the base.

Clause 84. The antenna assembly of any of clauses 72 to 83, wherein the base comprises a central opening configured for routing coaxial cables through the base and to the one or more multi-band antennas and the one or more second radiating elements.

Clause 85. The antenna assembly of any of clauses 72 to 84, wherein the base comprises a plurality of ribs configured to provide structural support for the base.

Clause 86. The antenna assembly of any of clauses 72 to 85, wherein the antenna assembly is IP67 rated.

Clause 87. The antenna assembly of any of clauses 72 to 86, wherein the base comprises a rim extending around a perimeter of the base, the rim configured to receive a gasket to prevent ingress of fluid and dust into the internal volume.

Clause 88. The antenna assembly of any of clauses 72 to 87, wherein the base is circular shaped and has a diameter of less than 11 inches.

Clause 89. The antenna assembly of any of clauses 72 to 88, wherein the base and radome when coupled have a maximum height of less than 2.5 inches.

### Additional Considerations and Terminology

Features, materials, characteristics, or groups described in conjunction with a particular aspect, implementation, or example are to be understood to be applicable to any other aspect, implementation or example described herein unless incompatible therewith. All of the features disclosed in this specification (including any accompanying claims, abstract and drawings), or all of the steps of any method or process so disclosed, may be combined in any combination, except combinations where at least some of such features or steps are mutually exclusive. The protection is not restricted to the details of any foregoing implementations. The protection extends to any novel one, or any novel combination, of the features disclosed in this specification (including any accompanying claims, abstract and drawings), or to any novel one, or any novel combination, of the steps of any method or process so disclosed.

While certain implementations have been described, these implementations have been presented by way of example only and are not intended to limit the scope of protection. Indeed, the novel methods and systems described herein may be embodied in a variety of other forms. Furthermore, various omissions, substitutions and changes in the form of the methods and systems described herein may be made. Those skilled in the art will appreciate that in some implementations, the actual steps taken in the processes illustrated or disclosed may differ from those shown in the figures. Depending on the implementation, certain of the steps described above may be removed, others may be added. For example, the actual steps or order of steps taken in the disclosed processes may differ from those shown in the figure. Depending on the implementation, certain of the steps described above may be removed, others may be added. Furthermore, the features and attributes of the specific implementations disclosed above may be combined in different ways to form additional implementations, all of which fall within the scope of the present disclosure.

Although the present disclosure includes certain implementations, examples and applications, it will be understood by those skilled in the art that the present disclosure extends beyond the specifically disclosed implementations to other alternative implementations or uses and obvious modifications and equivalents thereof, including implementations which do not provide all of the features and advantages set forth herein. Accordingly, the scope of the present disclosure is not intended to be limited by the described implementations and may be defined by claims as presented herein or as presented in the future.

Conditional language, such as “can,” “could,” “might,” or “may,” unless specifically stated otherwise, or otherwise understood within the context as used, is generally intended to convey that certain implementations include, while other implementations do not include, certain features, elements, or steps. Thus, such conditional language is not generally intended to imply that features, elements, or steps are in any way required for one or more implementations or that one or more implementations necessarily include logic for deciding, with or without user input or prompting, whether these features, elements, or steps are included or are to be performed in any particular implementation. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Likewise, the term “and/or” in reference to a list of two or more items, covers all of the following interpretations of the word: any one of the items in the list, all of the items in the list, and any combination of the items in the list. Further, the term “each,” as used herein, in addition to having its ordinary meaning, can mean any subset of a set of elements to which the term “each” is applied. Additionally, the words “herein,” “above,” “below,” and words of similar import, when used in this application, refer to this application as a whole and not to any particular portions of this application.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain implementations require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain implementations, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

1-168. (canceled)

169. An antenna unit comprising:
a case comprising:
a base defining a first internal volume; and
a lid defining a second internal volume, the lid coupled to the base, the lid configured to move between a closed configuration and an open configuration to selectively permit access to an interior of the case, the case including an antenna mount configured to support a satellite terminal;
a baseplate configured to be removably coupled to the lid; and
an antenna assembly comprising a plurality of antennas, the plurality of antennas coupled to the baseplate and located within the second internal volume,
wherein the antenna assembly is configured to be operationally connected to the satellite terminal during use.

170. The antenna unit of claim 169, wherein the case is configured to house a first modem for the satellite terminal and a second modem for the plurality of antennas, wherein the first modem is configured for satellite communications, and the second modem is configured for terrestrial based communication.

171. The antenna unit of claim 169, wherein the satellite terminal is configured to provide a wireless internet communication backhaul for the antenna assembly.

172. The antenna unit of claim 169, wherein the satellite terminal is removable from the antenna mount for storage within the case.

173. The antenna unit of claim 169, wherein the antenna mount is at least partially disposed within the second internal volume of the lid.

174. The antenna unit of claim 169, wherein the satellite terminal is configured for use while positioned within the interior of the case.

175. The antenna unit of claim 169, further comprising the satellite terminal.

176. The antenna unit of claim 169, wherein at least one of the plurality of antennas is a directional antenna, and wherein changing a position of the lid relative to the base changes a primary direction of radio-frequency signals radiated from the directional antenna.

177. The antenna unit of claim 176, wherein the directional antenna is configured to communicate with an external satellite.

178. The antenna unit of claim 176, wherein the directional antenna is a stacked patch antenna.

179. The antenna unit of claim 169, further comprising a fan and a vent.

180. The antenna unit of claim 179, wherein the fan extends through a first wall of the base, the vent extends through a second wall of the base, wherein the vent is configured to allow air to enter the first internal volume, wherein the fan is configured to blow air from the first internal volume to an outside environment, and wherein the fan has an open configuration and a closed configuration, wherein in the open configuration, the fan is configured to allow air to exit the first internal volume, wherein in the closed configuration, the fan is configured to prevent fluid from entering the first internal volume.

181. The antenna unit of claim 179, wherein the vent includes a filter configured to prevent debris from entering the case through the vent.

182. The antenna unit of claim 169, further comprising a base frame, the base frame configured to be coupled to the base and positioned within the first internal volume, the base frame configured to provide separation between a router and a battery.

183. The antenna unit of claim 182, wherein the base frame comprises a plurality of slots, the plurality of slots configured to promote airflow to the router and the battery.

184. The antenna unit of claim 182, wherein the base frame is configured to provide shock isolation for one or more of the router or the battery.

185. The antenna unit of claim 169, further comprising a modular battery support tray system comprising one or more barriers and/or support structures defining a modular opening configured and adapted to receive at least one of a plurality of modular battery support tray configurations adapted to be removably coupled to the base when positioned within the modular opening.

186. The antenna unit of claim 169, wherein the antenna mount is configured to support the satellite terminal at an angle relative to the lid.

187. An antenna unit comprising:
a case comprising:
a base defining a first internal volume; and
a lid defining a second internal volume, the lid coupled to the base, the lid configured to move between a closed configuration and an open configuration to selectively permit access to an interior of the case;
a baseplate configured to be coupled to the lid; and
an antenna assembly comprising a plurality of antennas, the plurality of antennas coupled to the baseplate and located within the second internal volume,
wherein the antenna unit is configured to support and connect to a satellite terminal.

188. An antenna unit comprising:
a case comprising:
a base defining a first internal volume; and
a lid defining a second internal volume, the lid coupled to the base, the lid configured to move between a closed configuration and an open configuration to selectively permit access to an interior of the case;
an antenna assembly comprising a plurality of antennas, the plurality of antennas located within the second internal volume; and
a satellite terminal configured to be mounted to the lid.
